(19) United States
(12) Patent Application Publication
(10) Pub. No.: US 2025/0147291 A1
(43) Pub. Date: May 8, 2025

(54) VARIABLE MAGNIFICATION OPTICAL SYSTEM AND IMAGING APPARATUS

(71) Applicant: FUJIFILM Corporation, Tokyo (JP)

(72) Inventor: Masato KONDO, Saitama-shi (JP)

(73) Assignee: FUJIFILM Corporation, Tokyo (JP)

(21) Appl. No.: 19/003,363

(22) Filed: Dec. 27, 2024

Related U.S. Application Data
(63) Continuation of application No. PCT/JP2023/024291, filed on Jun. 29, 2023.

(30) Foreign Application Priority Data
Jul. 12, 2022 (JP) 2022-111986

(51) Int. Cl. G02B 15/14; G02B 7/02; G02B 13/18

(52) U.S. Cl. CPC G02B 15/1461; G02B 7/025; G02B 13/18

(57) ABSTRACT

A variable magnification optical system consists of, in order from an object side, a first lens group having a positive refractive power, a second lens group having a negative refractive power, an intermediate group consisting of two or more and five or fewer lens groups, and a final lens group having a refractive power. During changing magnification, a spacing between the first lens group and the second lens group changes, a spacing between the second lens group and the intermediate group changes, a spacing between the intermediate group and the final lens group changes, and all spacings between adjacent lens groups in the intermediate group change. The variable magnification optical system satisfies a predetermined conditional expression.

### CROSS-REFERENCE TO RELATED APPLICATIONS

This application is a continuation application of International Application No. PCT/JP2023/024291, filed on Jun. 29, 2023, which claims priority from Japanese Patent Application No. 2022-111986, filed on Jul. 12, 2022. The entire disclosure of each of the above applications is incorporated herein by reference.

### BACKGROUND OF

### Technical Field

The disclosed technology relates to a variable magnification optical system and an imaging apparatus.

### Related Art

In the related art, zoom lenses according to JP6859230B, JP2020-197597A, and JP2020-170102A have been known as variable magnification optical systems usable in an imaging apparatus such as a digital camera.

### SUMMARY

A variable magnification optical system that is configured to be reduced in size and that maintains favorable optical performance in an entire magnification range is desired. A level of such demands is increased year by year.

The present disclosure provides a variable magnification optical system that is configured to be reduced in size and that maintains favorable optical performance in an entire magnification range, and an imaging apparatus comprising the variable magnification optical system.

According to an aspect of the present disclosure, there is provided a variable magnification optical system consisting of, in order from an object side to an image side, a first lens group having a positive refractive power, a second lens group having a negative refractive power, an intermediate group, and a final lens group having a refractive power, in which the intermediate group consists of two or more and five or fewer lens groups, during changing magnification, a spacing between the first lens group and the second lens group changes, a spacing between the second lens group and the intermediate group changes, a spacing between the intermediate group and the final lens group changes, and all spacings between adjacent lens groups in the intermediate group change, and in a case where a back focus of an entire system as an air conversion distance at a wide angle end is denoted by Bfw, a focal length of the entire system in a state where an infinite distance object is in focus at a telephoto end is denoted by ft, and a maximum half angle of view in the state where the infinite distance object is in focus at the telephoto end is denoted by ωt, Conditional Expression (1) is satisfied, which is represented by

$$0. 4 < Bfw / ( ft \times tan ω t ) < 1.7 . \qquad ( 1 )$$

In a case where a sum of a distance on an optical axis from a lens surface of the first lens group closest to the object side to a lens surface of the final lens group closest to the image side and the back focus of the entire system as the air conversion distance in a state where the infinite distance object is in focus at the wide angle end is denoted by TLw, the variable magnification optical system of the aspect preferably satisfies Conditional Expression (2) represented by

$$4 < TLw / ( f t \times tan ω t ) < 7. \qquad ( 2 )$$

In a case where a sum of a distance on an optical axis from a lens surface of the first lens group closest to the object side to a lens surface of the final lens group closest to the image side and the back focus of the entire system as the air conversion distance in a state where the infinite distance object is in focus at the wide angle end is denoted by TLw, the variable magnification optical system of the aspect preferably satisfies Conditional Expression (3) represented by

$$0.75 < TLw / f t < 1.35 . \qquad ( 3 )$$

In a case where an open F-number in the state where the infinite distance object is in focus at the telephoto end is denoted by FNot, and a focal length of the entire system in a state where the infinite distance object is in focus at the wide angle end is denoted by fw, the variable magnification optical system of the aspect preferably satisfies Conditional Expression (4) represented by

$$1.1 < FNot / ( f t / fw ) < 3. \qquad ( 4 )$$

In a case where a focal length of the entire system in a state where the infinite distance object is in focus at the wide angle end is denoted by fw, the variable magnification optical system of the aspect preferably satisfies Conditional Expression (5) represented by

$$0.9 < fw / ( f t \times tan ω t ) < 1.32 . \qquad ( 5 )$$

In a case where a focal length of the entire system in a state where the infinite distance object is in focus at the wide angle end is denoted by fw, and a sum of a distance on an optical axis from a lens surface of the first lens group closest to the object side to a lens surface of the final lens group closest to the image side and the back focus of the entire system as the air conversion distance in a state where the infinite distance object is in focus at the wide angle end is denoted by TLw, the variable magnification optical system of the aspect preferably satisfies Conditional Expression (6) represented by

$$0.11 < ( f w \times T Lw ) / f {t}^{2} < 0.6 . \qquad ( 6 )$$

In a configuration in which the first lens group includes at least two lenses, in a case where a sum of a distance on an optical axis from a lens surface of the first lens group closest to the object side to a lens surface of the final lens group closest to the image side and the back focus of the entire system as the air conversion distance in a state where the infinite distance object is in focus at the wide angle end is denoted by TLw, an open F-number in the state where the infinite distance object is in focus at the telephoto end is denoted by FNot, and a focal length of the entire system in a state where the infinite distance object is in focus at the wide angle end is denoted by fw, the variable magnification optical system of the aspect preferably satisfies Conditional Expressions (2-3), (3), (4-2), and (5) represented by

$$4.7 < TLw / ( f t \times tan ω t ) < 6.7 , \qquad ( 2 - 3 )$$

$$0.75 < TLw / f t < 1.35 , \qquad ( 3 )$$

$$28 < F Not / ( f t / fw ) < 1.9 , and \qquad ( 4 - 2 )$$

$$0.9 < fw / ( f t \times tan ω t ) < 1.32 . \qquad ( 5 )$$

In a case where a focal length of the first lens group is denoted by f1, and a focal length of the second lens group is denoted by f2, the variable magnification optical system of the aspect preferably satisfies Conditional Expression (7) represented by

$$2 < f 1 / ( - f 2 ) < 15. \qquad ( 7 )$$

In a case where a focal length of the entire system in a state where the infinite distance object is in focus at the wide angle end is denoted by fw, and a focal length of the final lens group is denoted by fE, the variable magnification optical system of the aspect preferably satisfies Conditional Expression (8) represented by

$$- 1 < fw / fE < 1. \qquad ( 8 )$$

In a case where a focal length of the first lens group is denoted by f1, and a focal length of the entire system in a state where the infinite distance object is in focus at the wide angle end is denoted by fw, the variable magnification optical system of the aspect preferably satisfies Conditional Expression (9) represented by

$$0.5 < f 1 / {( fw \times f t )}^{1 / 2} < 5. \qquad ( 9 )$$

In a case where a focal length of the second lens group is denoted by f2, and a focal length of the entire system in a state where the infinite distance object is in focus at the wide angle end is denoted by fw, the variable magnification optical system of the aspect preferably satisfies Conditional Expression (10) represented by

$$0.1 < ( - f 2 ) / {( fw \times f t )}^{1 / 2} < 1. \qquad ( 10 )$$

In a case where a focal length of the first lens group is denoted by f1, and an open F-number in the state where the infinite distance object is in focus at the telephoto end is denoted by FNot, the variable magnification optical system of the aspect preferably satisfies Conditional Expression (11) represented by

$$4 < f 1 / ( f t / FNot < 15. \qquad ( 11 )$$

In a case where a sum of a distance on an optical axis from a lens surface of the first lens group closest to the object side to a lens surface of the final lens group closest to the image side and the back focus of the entire system as the air conversion distance in a state where the infinite distance object is in focus at the wide angle end is denoted by TLw, and a focal length of the entire system in a state where the infinite distance object is in focus at the wide angle end is denoted by fw, the variable magnification optical system of the aspect preferably satisfies Conditional Expression (12) represented by

$$3.5 < TLw / fw < 6.5 . \qquad ( 12 )$$

In a case where a sum of a distance on an optical axis from a lens surface of the first lens group closest to the object side to a lens surface of the final lens group closest to the image side and the back focus of the entire system as the air conversion distance in the state where the infinite distance object is in focus at the telephoto end is denoted by TLt, the variable magnification optical system of the aspect preferably satisfies Conditional Expression (13) represented by

$$1 < TLt / f t < 2.5 . \qquad ( 13 )$$

In a case where a sum of a distance on an optical axis from a lens surface of the first lens group closest to the object side to a lens surface of the final lens group closest to the image side and the back focus of the entire system as the air conversion distance in the state where the infinite distance object is in focus at the telephoto end is denoted by TLt, the variable magnification optical system of the aspect preferably satisfies Conditional Expression (14) represented by

$$7 < TLt / ( f t \times tan ω t ) < 11.5 . \qquad ( 14 )$$

In a case where a maximum half angle of view in a state where the infinite distance object is in focus at the wide angle end is denoted by ww, and an open F-number in the state where the infinite distance object is in focus at the wide angle end is denoted by FNow, the variable magnification optical system of the aspect preferably satisfies Conditional Expression (15) represented by

$$0.17 < tan ω w / FNow < 0.35 . \qquad ( 15 )$$

In a configuration in which an aperture stop is disposed closer to the image side than a lens surface of the second lens group closest to the image side, in a case where a distance on an optical axis from a lens surface of the first lens group closest to the object side to the aperture stop in a state where the infinite distance object is in focus at the wide angle end is denoted by DDG1STw, and a focal length of the first lens group is denoted by f1, the variable magnification optical system of the aspect preferably satisfies Conditional Expression (16) represented by

$$0.15 < DDG 1 STw / f 1 < 1. \qquad ( 16 )$$

In a case where a distance on an optical axis from a lens surface of the first lens group closest to the object side to a paraxial entrance pupil position in a state where the infinite distance object is in focus at the wide angle end is denoted by Denw, a focal length of the entire system in the state where the infinite distance object is in focus at the wide angle end is denoted by fw, and a maximum half angle of view in the state where the infinite distance object is in focus at the wide angle end is denoted by ωw, the variable magnification optical system of the aspect preferably satisfies Conditional Expression (17) represented by

$$1 < Denw / \{ ( f w \times tan ω w ) \times log ( f t / fw ) \} < 3.5 . \qquad ( 17 )$$

In a case where a distance on an optical axis from a lens surface of the first lens group closest to the object side to a paraxial entrance pupil position in a state where the infinite distance object is in focus at the wide angle end is denoted by Denw, and a focal length of the entire system in the state where the infinite distance object is in focus at the wide angle end is denoted by fw, the variable magnification optical system of the aspect preferably satisfies Conditional Expression (18) represented by

$$0.3 < Denw / {( fw \times ft )}^{1 / 2} < 1. \qquad ( 18 )$$

In a configuration in which the variable magnification optical system of the aspect includes an aperture stop, in a case where a distance on an optical axis from a lens surface of the first lens group closest to the object side to the aperture stop in a state where the infinite distance object is in focus at the wide angle end is denoted by DDG1STw, and a sum of a distance on the optical axis from the lens surface of the first lens group closest to the object side to a lens surface of the final lens group closest to the image side and the back focus of the entire system as the air conversion distance in the state where the infinite distance object is in focus at the wide angle end is denoted by TLw, the variable magnification optical system of the aspect preferably satisfies Conditional Expression (19) represented by

$$0.25 < DDG 1 STw / TLw < 0.6 . \qquad ( 19 )$$

In a case where a focal length of the entire system in a state where the infinite distance object is in focus at the wide angle end is denoted by fw, and a sum of a distance on an optical axis from a paraxial exit pupil position to a lens surface of the final lens group closest to the image side and the back focus of the entire system as the air conversion distance in the state where the infinite distance object is in focus at the wide angle end is denoted by Dexw, the variable magnification optical system of the aspect preferably satisfies Conditional Expression (20) represented by

$$0.3 < fw / Dexw < 0.65 . \qquad ( 20 )$$

In a case where a moving amount of the first lens group during changing magnification from the wide angle end to the telephoto end is denoted by M1, a sign of M1 is positive in moving from the object side to the image side and is negative in moving from the image side to the object side, and a sum of a distance on an optical axis from a lens surface of the first lens group closest to the object side to a lens surface of the final lens group closest to the image side and the back focus of the entire system as the air conversion distance in the state where the infinite distance object is in focus at the telephoto end is denoted by TLt, the variable magnification optical system of the aspect preferably satisfies Conditional Expression (21) represented by

$$0. 2 < ( - M 1 ) / TLt < 0.5 . \qquad ( 21 )$$

In a case where a moving amount of the second lens group during changing magnification from the wide angle end to the telephoto end is denoted by M2, a sign of M2 is positive in moving from the object side to the image side and is negative in moving from the image side to the object side, and a sum of a distance on an optical axis from a lens surface of the first lens group closest to the object side to a lens surface of the final lens group closest to the image side and the back focus of the entire system as the air conversion distance in the state where the infinite distance object is in focus at the telephoto end is denoted by TLt, the variable magnification optical system of the aspect preferably satisfies Conditional Expression (22) represented b

$$0.04 < ( - M 2 ) / TLt < 0.4 . \qquad ( 22 )$$

In a case where a focal length of the entire system in a state where the infinite distance object is in focus at the wide angle end is denoted by fw, and a focal length of the intermediate group in the state where the infinite distance object is in focus at the wide angle end is denoted by fMw, the variable magnification optical system of the aspect preferably satisfies Conditional Expression (23) represented by

$$0.3 < fw / fMw < 2. \qquad ( 23 )$$

In a case where a focal length of the intermediate group in the state where the infinite distance object is in focus at the telephoto end is denoted by fMt, the variable magnification optical system of the aspect preferably satisfies Conditional Expression (24) represented by

$$1 < ft / fMt < 10. \qquad ( 24 )$$

In a case where a distance on an optical axis from a lens surface of the first lens group closest to the object side to a lens surface of the first lens group closest to the image side is denoted by D1sum, and an open F-number in the state where the infinite distance object is in focus at the telephoto end is denoted by FNot, the variable magnification optical system of the aspect preferably satisfies Conditional Expression (25) represented by

$$0.2 < D 1 sum / ( ft / FNot ) < 1.6 . \qquad ( 25 )$$

In a case where a lateral magnification of the second lens group in the state where the infinite distance object is in focus at the telephoto end is denoted by β2t, and a lateral magnification of the second lens group in a state where the infinite distance object is in focus at the wide angle end is denoted by β2w, the variable magnification optical system of the aspect preferably satisfies Conditional Expression (26) represented by

$$1 < β2 t / β2 w < 3. \qquad ( 26 )$$

In a case where an average value of Abbe numbers based on a d line for all positive lenses of the first lens group is denoted by v1pave, the variable magnification optical system of the aspect preferably satisfies Conditional Expression (27) represented by

$$40 < v 1 pave < 95. \qquad ( 27 )$$

In a configuration in which a surface, on the image side, of an Lp positive lens that is a positive lens having a strongest positive refractive power among non-cemented single lenses of the intermediate group is a convex surface, in a case where a focal length of the Lp positive lens is fp, and a focal length of the intermediate group in a state where the infinite distance object is in focus at the wide angle end is denoted by fMw, the variable magnification optical system of the aspect preferably satisfies Conditional Expression (28) represented by

$$0. 4 < fMw / fp < 2. \qquad ( 28 )$$

The Lp positive lens is preferably a biconvex lens. A surface of the Lp positive lens on the object side and the surface of the Lp positive lens on the image side may be configured to be aspherical surfaces.

In a case where an effective diameter of a lens surface of the first lens group closest to the object side is denoted by EDf, and an effective diameter of a lens surface of the final lens group closest to the image side is denoted by EDr, the variable magnification optical system of the aspect preferably satisfies Conditional Expression (29) represented by

$$1.2 < EDf / EDr < 3. \qquad ( 29 )$$

In a case where an effective diameter of a lens surface of the first lens group closest to the object side is denoted by EDf, and a sum of a distance on an optical axis from the lens surface of the first lens group closest to the object side to a lens surface of the final lens group closest to the image side and the back focus of the entire system as the air conversion distance in a state where the infinite distance object is in focus at the wide angle end is denoted by TLw, the variable magnification optical system of the aspect preferably satisfies Conditional Expression (30) represented by

$$0.25 < EDf / TLw < 0.6 . \qquad ( 30 )$$

The first lens group preferably includes, in consecutive order from a position closest to the object side to the image side, a first lens that is a negative lens, and a second lens that is a positive lens.

In a case where a center thickness of the first lens is denoted by d1 and an effective diameter of a lens surface of the first lens group closest to the object side is denoted by EDf, the variable magnification optical system of the aspect preferably satisfies Conditional Expression (31) represented by

$$0.01 < d 1 / EDf < 0.4 . \qquad ( 31 )$$

In a case where a center thickness of the first lens is denoted by d1, a distance on an optical axis from a lens surface of the first lens group closest to the object side to a paraxial entrance pupil position in a state where the infinite distance object is in focus at the wide angle end is denoted by Denw, and a maximum half angle of view in a state where the infinite distance object is in focus at the wide angle end is denoted by ωw, the variable magnification optical system of the aspect preferably satisfies Conditional Expression (32) represented by

$$0.01 < d 1 / ( Denw \times tan ω w ) < 0.15 . \qquad ( 32 )$$

In a case where a center thickness of the second lens is denoted by d2, a paraxial curvature radius of a surface of the second lens on the object side is denoted by R2f, and a paraxial curvature radius of a surface of the second lens on the image side is denoted by R2r, the variable magnification optical system of the aspect preferably satisfies Conditional Expression (33) represented by

$$0.01 < d 2 \times ( 1 / R 2 f - 1 / R 2 r ) < 0.4 . \qquad ( 33 )$$

In a case where a center thickness of the first lens is denoted by d1, and a focal length of the first lens group is denoted by f1, the variable magnification optical system of the aspect preferably satisfies Conditional Expression (34) represented by

$$0.005 < d 1 / f 1 < 0.025 . \qquad ( 34 )$$

In a case where a center thickness of the first lens is denoted by d1, and a distance on an optical axis from a lens surface of the first lens group closest to the object side to a lens surface of the first lens group closest to the image side is denoted by D1sum, the variable magnification optical system of the aspect preferably satisfies Conditional Expression (35) represented by

$$0.05 < d 1 / D 1 sum < 0.3 . \qquad ( 35 )$$

In a case where an average value of a relative density of the first lens and a relative density of the second lens is denoted by G12ave, the variable magnification optical system of the aspect preferably satisfies Conditional Expression (36) represented by

$$2 < G 12 ave < 5.5 . \qquad ( 36 )$$

The first lens group may be configured to consist of, in order from the object side to the image side, the first lens, the second lens, and one positive lens.

In a configuration in which the first lens and the second lens are cemented, in a case where an Abbe number based on a d line for the second lens is denoted by v2, the variable magnification optical system of the aspect preferably satisfies Conditional Expression (37) represented by

$$40 < v 2 < 95. \qquad ( 37 )$$

In a configuration in which the first lens group consists of, in order from the object side to the image side, the first lens, the second lens, and one positive lens, in a case where an Abbe number based on a d line for the positive lens closest to the image side in the first lens group is denoted by v3, the variable magnification optical system of the aspect preferably satisfies Conditional Expression (38) represented by

$$40 < v 3 < 95. \qquad ( 38 )$$

In a configuration in which a negative lens is disposed closest to the object side in the second lens group, the second lens group preferably further includes at least one negative lens different from the negative lens closest to the object side and at least one positive lens.

In a case where a focal length of the negative lens closest to the object side in the second lens group is denoted by fL21, and a focal length of the second lens group is denoted by f2, the variable magnification optical system of the aspect preferably satisfies Conditional Expression (39) represented by

$$0.5 < fL 21 / f 2 < 3. \qquad ( 39 )$$

In a case where a paraxial curvature radius of a surface, on the object side, of the negative lens closest to the object side in the second lens group is denoted by RL21f, and a paraxial curvature radius of a surface, on the image side, of the negative lens closest to the object side in the second lens group is denoted by RL21r, the variable magnification optical system of the aspect preferably satisfies Conditional Expression (40) represented by

$$0.5 < ( RL 21 f + RL 21 r ) / ( RL 21 f - R L 21 r ) < 3.5 . \qquad ( 40 )$$

In a case where a focal length of a lens that is the second from the object side in the second lens group is denoted by fL22, and a focal length of the second lens group is denoted by f2, the variable magnification optical system of the aspect preferably satisfies Conditional Expression (41) represented by

$$0.4 < fL 22 / f 2 < 5. \qquad ( 41 )$$

In a case where a focal length of the entire system in a state where the infinite distance object is in focus at the wide angle end is denoted by fw, the variable magnification optical system of the aspect preferably satisfies Conditional Expression (42) represented by

$$2.5 < ft / fw < 7. \qquad ( 42 )$$

In a case where a focal length of the second lens group is denoted by f2, and a focal length of a lens group closest to the object side in the intermediate group is denoted by f3, the variable magnification optical system of the aspect preferably satisfies Conditional Expression (43) represented by

$$- 1.2 < f 2 / f 3 < 1. \qquad ( 43 )$$

The variable magnification optical system of the aspect preferably includes at least three aspherical surfaces.

The variable magnification optical system of the aspect preferably includes at least one plastic lens of which a surface on the object side and a surface on the image side are aspherical surfaces, and in a case where a relative density of the plastic lens is denoted by GP, preferably satisfies Conditional Expression (44) represented by

$$0.8 < GP < 1.5 . \qquad ( 44 )$$

The plastic lens is preferably disposed in at least one of a position closest to the image side in the intermediate group or the final lens group.

The intermediate group preferably includes at least one cemented lens consisting of one positive lens and one negative lens.

In a configuration in which the intermediate group includes a vibration-proof group that moves in a direction intersecting with an optical axis during image shake correction, in a case where a focal length of the vibration-proof group is denoted by fIS, the variable magnification optical system of the aspect preferably satisfies Conditional Expression (45) represented by

$$0.1 < \vert fIS / ft \vert < 0.7 . \qquad ( 45 )$$

The vibration-proof group preferably includes a biconvex lens. In a case where an average value of relative densities of all biconvex lenses of the vibration-proof group is denoted by GISave, the variable magnification optical system of the aspect preferably satisfies Conditional Expression (46) represented by

$$2 < GISave < 5. \qquad ( 46 )$$

During changing the magnification, the first lens group, the second lens group, and all lens groups in the intermediate group preferably move.

The intermediate group preferably has a positive refractive power as a whole in an entire magnification range.

One of the lens groups included in the intermediate group is preferably a focus lens group that moves along an optical axis during changing the magnification and during focusing.

The focus lens group may be configured to consist of one positive lens and one negative lens. In this case, the focus lens group may be configured to consist of a cemented lens in which the positive lens and the negative lens are cemented. Alternatively, the focus lens group may be configured to consist of one negative lens.

The intermediate group may be configured to include only one focus lens group.

In a configuration in which the variable magnification optical system of the aspect includes a vibration-proof group that moves in a direction intersecting with an optical axis during image shake correction, the focus lens group is preferably disposed closer to the image side than the vibration-proof group.

The focus lens group may be configured to be a lens group closest to the image side in the intermediate group.

The final lens group may be configured to consist of, in order from the object side to the image side, one negative lens of which a surface on the object side is a concave surface, and one positive lens.

In a configuration in which the final lens group consists of, in order from the object side to the image side, one negative lens of which a surface on the object side is a concave surface, and one positive lens, in a case where a paraxial curvature radius of the surface, on the object side, of the negative lens of the final lens group is denoted by REnf, and a paraxial curvature radius of a surface, on the image side, of the negative lens of the final lens group is denoted by REnr, the variable magnification optical system of the aspect preferably satisfies Conditional Expression (47) represented by

$$- 15 < ( REnf + REnr ) / ( REnf - REnr ) < - 0.1 . \qquad ( 47 )$$

In a configuration in which the final lens group consists of, in order from the object side to the image side, one negative lens of which a surface on the object side is a concave surface, and one positive lens, in a case where a paraxial curvature radius of a surface, on the object side, of the positive lens of the final lens group is denoted by REpf, and a paraxial curvature radius of a surface, on the image side, of the positive lens of the final lens group is denoted by REpr, the variable magnification optical system of the aspect preferably satisfies Conditional Expression (48) represented by

$$- 1.3 < ( REpf + REpr ) / ( REpf - REpr ) < - 0.1 . \qquad ( 48 )$$

Moving paths of each lens group that moves during changing magnification from the wide angle end to the telephoto end may be configured to include exactly five or six moving paths that are different from each other.

The variable magnification optical system of the aspect may be configured to include a plurality of lens groups that move on the same moving path during changing the magnification from the wide angle end to the telephoto end. In this case, at least one lens that moves along an optical axis during focusing may be configured to be disposed between the plurality of lens groups that move on the same moving path.

The intermediate group may be configured to consist of, in order from the object side to the image side, a lens group having a positive refractive power, and a lens group having a negative refractive power.

The intermediate group may be configured to consist of, in order from the object side to the image side, a lens group having a negative refractive power, a lens group having a positive refractive power, and a lens group having a negative refractive power.

The intermediate group may be configured to consist of, in order from the object side to the image side, a lens group having a positive refractive power, a lens group having a positive refractive power, and a lens group having a negative refractive power.

The intermediate group may be configured to consist of, in order from the object side to the image side, a lens group having a positive refractive power, a lens group having a positive refractive power, a lens group having a negative refractive power, and a lens group having a positive refractive power.

The intermediate group may be configured to consist of, in order from the object side to the image side, a lens group having a positive refractive power, a lens group having a positive refractive power, a lens group having a positive refractive power, and a lens group having a negative refractive power.

The intermediate group may be configured to consist of, in order from the object side to the image side, a lens group having a positive refractive power, a lens group having a negative refractive power, a lens group having a positive refractive power, and a lens group having a negative refractive power.

The intermediate group may be configured to consist of, in order from the object side to the image side, a lens group having a positive refractive power, a lens group having a negative refractive power, a lens group having a positive refractive power, a lens group having a negative refractive power, and a lens group having a negative refractive power. In this configuration, during changing the magnification, the final lens group may be configured to be fixed with respect to an image plane.

The intermediate group may be configured to consist of, in order from the object side to the image side, a lens group having a positive refractive power, a lens group having a positive refractive power, a lens group having a positive refractive power, a lens group having a negative refractive power, and a lens group having a negative refractive power. In this configuration, during changing the magnification, the final lens group may be configured to be fixed with respect to an image plane.

According to another aspect of the present disclosure, there is provided an imaging apparatus comprising the variable magnification optical system according to the aspect of the present disclosure.

In the present specification, the expressions “consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the illustrated constituents.

The term “group having a positive refractive power” in the present specification means that the entire group has a positive refractive power. The term “group having a negative refractive power” means that the entire group has a negative refractive power. The term “lens having a positive refractive power” is synonymous with the term “positive lens”. The term “lens having a negative refractive power” is synonymous with the term “negative lens”. The terms “first lens group”, “second lens group”, “lens group”, “final lens group”, “focus lens group”, and “vibration-proof group” in the present specification are not limited to a configuration consisting of a plurality of lenses and may be a configuration consisting of only one lens.

The term “single lens” means one non-cemented lens. A compound aspherical lens (a lens that is composed of a spherical lens and a film of an aspherical shape formed on the spherical lens in an integrated manner and that functions as one aspherical lens as a whole) is not regarded as a cemented lens and is treated as one lens. Unless otherwise specified, a sign of a refractive power and a surface shape related to a lens including an aspherical surface in a paraxial region are used. A sign of the paraxial curvature radius of a surface having a convex shape facing the object side is positive, and a sign of the paraxial curvature radius of a surface having a convex shape facing the image side is negative.

In the present specification, the term “entire system” means the variable magnification optical system. The term “focal length” used in the conditional expressions is a paraxial focal length. Unless otherwise specified, the term “distance on the optical axis” used in the conditional expressions is considered to be a geometrical length. Unless otherwise specified, values used in the conditional expressions are values based on the d line in the state where the infinite distance object is in focus.

The terms “d line”, “C line”, and “F line” according to the present specification are bright lines. A wavelength of the d line is 587.56 nanometers (nm). A wavelength of the C line is 656.27 nanometers (nm). A wavelength of the F line is 486.13 nanometers (nm).

According to the present disclosure, a variable magnification optical system that is configured to be reduced in size and that maintains favorable optical performance in an entire magnification range, and an imaging apparatus comprising the variable magnification optical system can be provided.

### BRIEF DESCRIPTION OF THE DRAWINGS

FIG. 1 is a diagram that corresponds to a variable magnification optical system of Example 1 and that illustrates a cross-sectional view and a moving path of a configuration of a variable magnification optical system according to one embodiment.

FIG. 2 is a diagram illustrating the configuration and luminous fluxes of the variable magnification optical system in FIG. 1 in each magnification state.

FIG. 3 is a diagram for describing an effective diameter.

FIG. 4 is each aberration diagram of the variable magnification optical system of Example 1.

FIG. 5 is a diagram illustrating a cross-sectional view and a moving path of a configuration of a variable magnification optical system of Example 2.

FIG. 6 is each aberration diagram of the variable magnification optical system of Example 2.

FIG. 7 is a diagram illustrating a cross-sectional view and a moving path of a configuration of a variable magnification optical system of Example 3.

FIG. 8 is each aberration diagram of the variable magnification optical system of Example 3.

FIG. 9 is a diagram illustrating a cross-sectional view and a moving path of a configuration of a variable magnification optical system of Example 4.

FIG. 10 is each aberration diagram of the variable magnification optical system of Example 4.

FIG. 11 is a diagram illustrating a cross-sectional view and a moving path of a configuration of a variable magnification optical system of Example 5.

FIG. 12 is each aberration diagram of the variable magnification optical system of Example 5.

FIG. 13 is a diagram illustrating a cross-sectional view and a moving path of a configuration of a variable magnification optical system of Example 6.

FIG. 14 is each aberration diagram of the variable magnification optical system of Example 6.

FIG. 15 is a diagram illustrating a cross-sectional view and a moving path of a configuration of a variable magnification optical system of Example 7.

FIG. 16 is each aberration diagram of the variable magnification optical system of Example 7.

FIG. 17 is a diagram illustrating a cross-sectional view and a moving path of a configuration of a variable magnification optical system of Example 8.

FIG. 18 is each aberration diagram of the variable magnification optical system of Example 8.

FIG. 19 is a diagram illustrating a cross-sectional view and a moving path of a configuration of a variable magnification optical system of Example 9.

FIG. 20 is each aberration diagram of the variable magnification optical system of Example 9.

FIG. 21 is a diagram illustrating a cross-sectional view and a moving path of a configuration of a variable magnification optical system of Example 10.

FIG. 22 is each aberration diagram of the variable magnification optical system of Example 10.

FIG. 23 is a diagram illustrating a cross-sectional view and a moving path of a configuration of a variable magnification optical system of Example 11.

FIG. 24 is each aberration diagram of the variable magnification optical system of Example 11.

FIG. 25 is a diagram illustrating a cross-sectional view and a moving path of a configuration of a variable magnification optical system of Example 12.

FIG. 26 is each aberration diagram of the variable magnification optical system of Example 12.

FIG. 27 is a diagram illustrating a cross-sectional view and a moving path of a configuration of a variable magnification optical system of Example 13.

FIG. 28 is each aberration diagram of the variable magnification optical system of Example 13.

FIG. 29 is a diagram illustrating a cross-sectional view and a moving path of a configuration of a variable magnification optical system of Example 14.

FIG. 30 is each aberration diagram of the variable magnification optical system of Example 14.

FIG. 31 is a diagram illustrating a cross-sectional view and a moving path of a configuration of a variable magnification optical system of Example 15.

FIG. 32 is each aberration diagram of the variable magnification optical system of Example 15.

FIG. 33 is a diagram illustrating a cross-sectional view and a moving path of a configuration of a variable magnification optical system of Example 16.

FIG. 34 is each aberration diagram of the variable magnification optical system of Example 16.

FIG. 35 is a diagram illustrating a cross-sectional view and a moving path of a configuration of a variable magnification optical system of Example 17.

FIG. 36 is each aberration diagram of the variable magnification optical system of Example 17.

FIG. 37 is a diagram illustrating a cross-sectional view and a moving path of a configuration of a variable magnification optical system of Example 18.

FIG. 38 is each aberration diagram of the variable magnification optical system of Example 18.

FIG. 39 is a diagram illustrating a cross-sectional view and a moving path of a configuration of a variable magnification optical system of Example 19.

FIG. 40 is each aberration diagram of the variable magnification optical system of Example 19.

FIG. 41 is a diagram illustrating a cross-sectional view and a moving path of a configuration of a variable magnification optical system of Example 20.

FIG. 42 is each aberration diagram of the variable magnification optical system of Example 20.

FIG. 43 is a diagram illustrating a cross-sectional view and a moving path of a configuration of a variable magnification optical system of Example 21.

FIG. 44 is each aberration diagram of the variable magnification optical system of Example 21.

FIG. 45 is a diagram illustrating a cross-sectional view and a moving path of a configuration of a variable magnification optical system of Example 22.

FIG. 46 is each aberration diagram of the variable magnification optical system of Example 22.

FIG. 47 is a diagram illustrating a cross-sectional view and a moving path of a configuration of a variable magnification optical system of Example 23.

FIG. 48 is each aberration diagram of the variable magnification optical system of Example 23.

FIG. 49 is a diagram illustrating a cross-sectional view and a moving path of a configuration of a variable magnification optical system of Example 24.

FIG. 50 is each aberration diagram of the variable magnification optical system of Example 24.

FIG. 51 is a diagram illustrating a cross-sectional view and a moving path of a configuration of a variable magnification optical system of Example 25.

FIG. 52 is each aberration diagram of the variable magnification optical system of Example 25.

FIG. 53 is a diagram illustrating a cross-sectional view and a moving path of a configuration of a variable magnification optical system of Example 26.

FIG. 54 is each aberration diagram of the variable magnification optical system of Example 26.

FIG. 55 is a diagram illustrating a cross-sectional view and a moving path of a configuration of a variable magnification optical system of Example 27.

FIG. 56 is each aberration diagram of the variable magnification optical system of Example 27.

FIG. 57 is a diagram illustrating a cross-sectional view and a moving path of a configuration of a variable magnification optical system of Example 28.

FIG. 58 is each aberration diagram of the variable magnification optical system of Example 28.

FIG. 59 is a diagram illustrating a cross-sectional view and a moving path of a configuration of a variable magnification optical system of Example 29.

FIG. 60 is each aberration diagram of the variable magnification optical system of Example 29.

FIG. 61 is a diagram illustrating a cross-sectional view and a moving path of a configuration of a variable magnification optical system of Example 30.

FIG. 62 is each aberration diagram of the variable magnification optical system of Example 30.

FIG. 63 is a diagram illustrating a cross-sectional view and a moving path of a configuration of a variable magnification optical system of Example 31.

FIG. 64 is each aberration diagram of the variable magnification optical system of Example 31.

FIG. 65 is a diagram illustrating a cross-sectional view and a moving path of a configuration of a variable magnification optical system of Example 32.

FIG. 66 is each aberration diagram of the variable magnification optical system of Example 32.

FIG. 67 is a diagram illustrating a cross-sectional view and a moving path of a configuration of a variable magnification optical system of Example 33.

FIG. 68 is each aberration diagram of the variable magnification optical system of Example 33.

FIG. 69 is a diagram illustrating a cross-sectional view and a moving path of a configuration of a variable magnification optical system of Example 34.

FIG. 70 is each aberration diagram of the variable magnification optical system of Example 34.

FIG. 71 is a perspective view of a front surface side of an imaging apparatus according to one embodiment.

FIG. 72 is a perspective view of a rear surface side of the imaging apparatus according to one embodiment.

### DETAILED DESCRIPTION

Hereinafter, an embodiment of the present disclosure will be described with reference to the drawings.

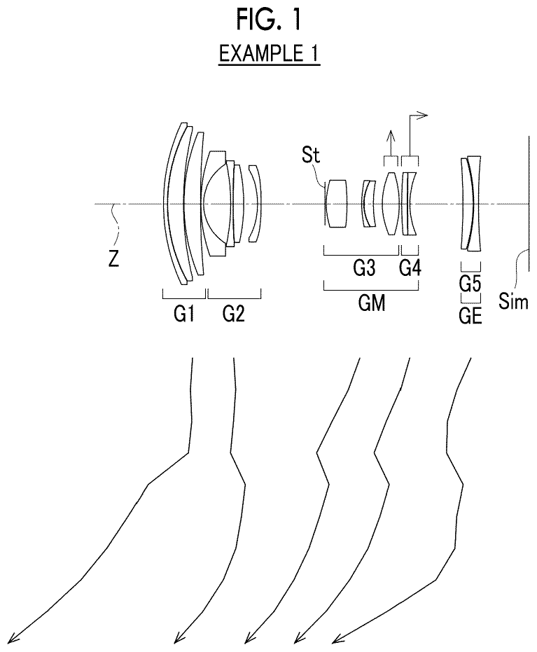

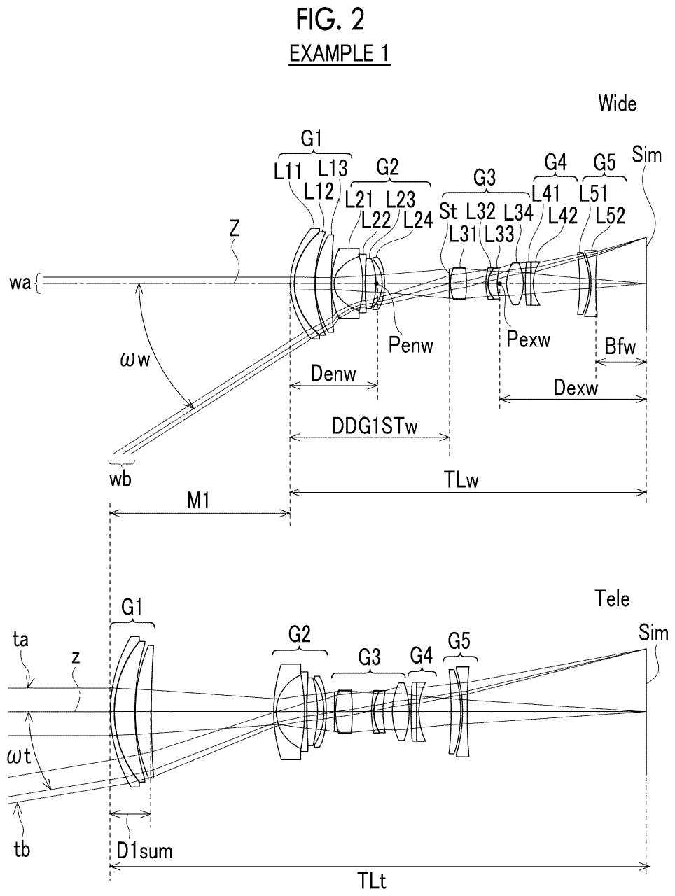

FIG. 1 illustrates a cross-sectional view and a moving path of a configuration of a variable magnification optical system according to one embodiment of the present disclosure at a wide angle end. FIG. 2 illustrates a cross-sectional view and luminous fluxes of the configuration of the variable magnification optical system in FIG. 1 in each state. In FIG. 2, a wide angle end state is illustrated in an upper part labeled “Wide”, and a telephoto end state is illustrated in a lower part labeled “Tele”. As the luminous fluxes, FIG. 2 illustrates an on-axis luminous flux wa and a luminous flux wb at a maximum half angle of view ow in the wide angle end state and an on-axis luminous flux ta and a luminous flux tb at a maximum half angle of view ωt in the telephoto end state. Examples illustrated in FIGS. 1 and 2 correspond to a variable magnification optical system of Example 1, described later. FIGS. 1 and 2 illustrate a state where an infinite distance object is in focus, in which a left side is an object side, and a right side is an image side.

The variable magnification optical system of the present disclosure consists of, in order from the object side to the image side along an optical axis Z, a first lens group G1 having a positive refractive power, a second lens group G2 having a negative refractive power, an intermediate group GM, and a final lens group GE having a refractive power. The intermediate group GM consists of two or more and five or fewer lens groups. During changing magnification, a spacing between the first lens group G1 and the second lens group G2 changes, and a spacing between the second lens group G2 and the intermediate group GM changes. In addition, a spacing between the intermediate group GM and the final lens group GE changes, and all spacings between adjacent lens groups in the intermediate group GM change. The above configuration achieves an advantage in suppressing various aberrations in the entire magnification range.

The terms “first lens group G1”, “second lens group G2”. “lens groups” included in the intermediate group GM, and “final lens group GE” in the present specification mean parts that are constituents of the variable magnification optical system and that include at least one lens separated by air spacings which change during changing the magnification. During changing the magnification, each lens group is moved or fixed in lens group units, and a mutual spacing between lenses in each lens group does not change. That is, in the present specification, one lens group is a group in which, during changing the magnification, a spacing with respect to an adjacent group changes, and all spacings between adjacent lenses in the group do not change. The term “lens group” may include a constituent not having a refractive power, for example, an aperture stop St other than a lens.

For example, the variable magnification optical system illustrated in FIGS. 1 and 2 consists of, in order from the object side to the image side, the first lens group G1, the second lens group G2, a third lens group G3, a fourth lens group G4, and a fifth lens group G5. In the example in FIG. 1, the intermediate group GM consists of the third lens group G3 and the fourth lens group G4, and the final lens group GE consists of the fifth lens group G5.

For example, each lens group in FIG. 2 is configured as follows. The first lens group G1 consists of three lenses including lenses L11 to L13 in order from the object side to the image side. The second lens group G2 consists of four lenses including lenses L21 to L24 in order from the object side to the image side. The third lens group G3 consists of the aperture stop St and four lenses including lenses L31 to L34 in order from the object side to the image side. The fourth lens group G4 consists of two lenses including lenses L41 and L42 in order from the object side to the image side. The fifth lens group G5 consists of two lenses including lenses L51 and L52 in order from the object side to the image side. The aperture stop St in FIGS. 1 and 2 does not indicate a shape and a size and indicates a position in an optical axis direction.

In the examples in FIGS. 1 and 2, during changing the magnification, all lens groups move along the optical axis Z by changing spacings with respect to adjacent lens groups. In FIG. 1, a schematic moving path of each lens group during changing magnification from the wide angle end to a telephoto end is illustrated by an arrow under each of the five lens groups. As in the example in FIG. 1, in a case where all lens groups are configured to move during changing the magnification, an advantage in suppressing various aberrations in the entire magnification range is achieved.

The first lens group G1, the second lens group G2, and all lens groups in the intermediate group GM preferably move during changing the magnification. Doing so achieves an advantage in suppressing fluctuation of aberrations during changing the magnification. In the disclosed technology, during changing the magnification, the final lens group GE may be configured to move, or the final lens group GE may be configured to be fixed with respect to an image plane Sim. In the configuration in which the final lens group GE is fixed with respect to the image plane Sim during changing the magnification, a drive mechanism for the lens group can be simplified.

The first lens group G1 preferably includes at least two lenses. Doing so achieves an advantage in suppressing a spherical aberration at the telephoto end.

The first lens group G1 preferably includes, in consecutive order from a position closest to the object side to the image side, a first lens that is a negative lens, and a second lens that is a positive lens. Doing so achieves an advantage in suppressing an axial chromatic aberration and the spherical aberration at the telephoto end.

The first lens group G1 may be configured to consist of, in order from the object side to the image side, the first lens, the second lens, and one positive lens. Doing so achieves an advantage in further suppressing the axial chromatic aberration and the spherical aberration at the telephoto end. In addition, doing so achieves an advantage in reduction in size compared to a configuration in which the first lens group G1 consists of four or more lenses.

A negative lens is preferably disposed closest to the object side in the second lens group G2, and the second lens group G2 preferably further includes at least one negative lens different from the negative lens disposed closest to the object side in the second lens group G2, and at least one positive lens. Doing so achieves an advantage in suppressing fluctuation of the aberrations during changing the magnification.

The intermediate group GM preferably has a positive refractive power as a whole in the entire magnification range. Doing so achieves an advantage in reduction of a total length of the optical system.

The intermediate group GM preferably includes at least one cemented lens consisting of one positive lens and one negative lens. Doing so achieves an advantage in suppressing a lateral chromatic aberration and the axial chromatic aberration in the entire magnification range.

The intermediate group GM preferably includes a vibration-proof group that moves in a direction intersecting with the optical axis Z during image shake correction. The image shake correction is performed by moving the vibration-proof group. In the example in FIG. 1, the vibration-proof group consists of a lens closest to the image side in the third lens group G3 (that is, the lens L34 in FIG. 2). In FIG. 1, a bracket and a vertical upward arrow are provided above a lens corresponding to the vibration-proof group.

The vibration-proof group preferably includes a biconvex lens. Doing so achieves an advantage in suppressing fluctuation of various aberrations during the image shake correction.

The vibration-proof group may be configured to consist of two or fewer lenses. Doing so achieves an advantage in reduction in size. For example, the vibration-proof group may be configured to consist of one lens. Doing so achieves an advantage in further reduction in size. Alternatively, the vibration-proof group may be configured to consist of one cemented lens in which one negative lens and one positive lens are configured to be cemented. Doing so achieves an advantage in suppressing fluctuation of a chromatic aberration during the image shake correction.

One of the lens groups included in the intermediate group GM is preferably a focus lens group that moves along the optical axis Z during changing the magnification and focusing. The focusing is performed by moving the focus lens group. Disposing the focus lens group in the intermediate group GM facilitates reduction of a diameter of the focus lens group and thus, facilitates control of the focus lens group. In the example in FIG. 1, the focus lens group consists of the fourth lens group G4. The bracket and the rightward arrow above the fourth lens group G4 in FIG. 1 indicate that the fourth lens group G4 is a focus lens group that moves to the image side during focusing from the infinite distance object to a short range object.

The focus lens group may be configured to consist of one positive lens and one negative lens. Doing so reduces the number of lenses constituting the focus lens group and thus, can simplify a mechanism for controlling the focus lens group and facilitates quick focusing. Furthermore, doing so can offset various aberrations via the negative lens and the positive lens in the focus lens group and thus, facilitates suppression of fluctuation of the aberrations during the focusing and achieves an advantage in achieving high performance.

The focus lens group may be configured to consist of a cemented lens in which one positive lens and one negative lens are cemented. Doing so can achieve further reduction in size compared to a case where non-cemented lenses are used. Reducing the focus lens group in size can simplify the mechanism for controlling the focus lens group and facilitates quick focusing.

The focus lens group may be configured to consist of one negative lens. Doing so can achieve further reduction in size compared to a case where the focus lens group consists of two or more lenses. Reducing the focus lens group in size can simplify the mechanism for controlling the focus lens group and facilitates quick focusing. Furthermore, causing the focus lens group to have a negative refractive power facilitates provision of a strong refractive power in the focus lens group and thus, achieves an advantage in suppressing a moving amount of the focus lens group during the focusing.

The intermediate group GM preferably includes only one focus lens group. Doing so can simplify a mechanism for the focusing. In order to simplify the mechanism, the entire variable magnification optical system is preferably configured to include only one focus lens group.

The focus lens group may be configured to be a lens group closest to the image side in the intermediate group GM. Doing so facilitates securing of a space for moving the focus lens group during the focusing.

In a case where the variable magnification optical system includes the vibration-proof group and the focus lens group, the focus lens group is preferably disposed closer to the image side than the vibration-proof group. In a case where a mechanism for the image shake correction and the mechanism for the focusing are disposed not to interfere with each other, positioning the vibration-proof group on the image side of the focus lens group restricts the moving amount of the focus lens group during the focusing. Accordingly, disposing the focus lens group closer to the image side than the vibration-proof group facilitates securing of the space for moving the focus lens group during the focusing.

The final lens group GE may be a lens group having a positive refractive power or a lens group having a negative refractive power. The final lens group GE may be configured to consist of two or fewer lenses. Doing so achieves an advantage in reduction in size. The final lens group GE may be configured to consist of one negative lens and one positive lens. Doing so can offset various aberrations via the negative lens and the positive lens in the final lens group GE and thus, achieves an advantage in achieving high performance.

More specifically, the final lens group GE may be configured to consist of, in order from the object side to the image side, one negative lens of which a surface on the object side is a concave surface, and one positive lens. Doing so achieves an advantage in suppressing an astigmatism at the wide angle end and also achieves an advantage in securing an edge part light quantity.

The aperture stop St may be disposed closer to the image side than a lens surface of the second lens group G2 closest to the image side. The aperture stop St may be disposed closer to the object side than a lens surface of the final lens group GE closest to the object side.

The variable magnification optical system may be configured to include at least three aspherical surfaces. Doing so achieves an advantage in achieving high optical performance by suppressing various aberrations.

The variable magnification optical system may be configured to include at least one plastic lens of which a surface on the object side and a surface on the image side are aspherical surfaces. Doing so achieves an advantage in achieving high optical performance while establishing both of reduction in weight and reduction in cost. The plastic lens of which the surface on the object side and the surface on the image side are aspherical surfaces is preferably disposed in at least one of a position closest to the image side in the intermediate group GM or the final lens group GE. Since a luminous flux diameter is relatively small in the position closest to the image side in the intermediate group GM and in the final lens group GE, disposing the plastic lens in such a position achieves an advantage in maintaining low sensitivity to an error in an aspherical shape on both surfaces of the plastic lens. This achieves an advantage in achieving high performance.

Next, preferable configurations and available configurations related to conditional expressions of the variable magnification optical system of the present disclosure will be described. In the following description related to the conditional expressions, in order to avoid redundant description, the same symbol will be used for the same definition to partially omit duplicate descriptions of the symbol. In addition, hereinafter, the “variable magnification optical system of the present disclosure” will be simply referred to as the “variable magnification optical system” in order to avoid redundant description.

The variable magnification optical system preferably satisfies Conditional Expression (1). A back focus of the entire system as an air conversion distance at the wide angle end is denoted by Bfw. A focal length of the entire system in a state where the infinite distance object is in focus at the telephoto end is denoted by ft. A maximum half angle of view in the state where the infinite distance object is in focus at the telephoto end is denoted by ωt. In Conditional Expression (1), tan denotes a tangent, and the same representation applies to other conditional expressions. Ensuring that a corresponding value of Conditional Expression (1) is not less than or equal to its lower limit prevents an excessively short back focus Bfw defined above and thus, facilitates attachment of a mount replacement mechanism. Ensuring that the corresponding value of Conditional Expression (1) is not greater than or equal to its upper limit prevents an excessively long back focus Bfw defined above and thus, facilitates reduction in size. In order to obtain more favorable characteristics, the variable magnification optical system more preferably satisfies Conditional Expression (1-1) and further preferably satisfies Conditional Expression (1-2).

$$0.4 < Bfw / ( ft \times tan ω t ) < 1.7 \qquad ( 1 )$$

$$0.6 < Bfw / ( ft \times tan ω t ) < 1.5 \qquad ( 1 - 1 )$$

$$0.7 < Bfw / ( ft \times tan ω t ) < 1.3 \qquad ( 1 - 2 )$$

For example, FIG. 2 illustrates the back focus Bfw. The term “back focus” means a distance on the optical axis from a lens surface of the variable magnification optical system closest to the image side to the image plane Sim. As in the example in FIG. 2, in a case where any member is not disposed between the lens surface of the variable magnification optical system closest to the image side and the image plane Sim, a geometrical length from the lens surface of the variable magnification optical system closest to the image side to the image plane Sim is equal to the “back focus” as an air conversion distance. However, unlike the example in FIG. 2, in a case where a member such as a filter or a cover glass is disposed between the lens surface of the variable magnification optical system closest to the image side and the image plane Sim, the geometrical length from the lens surface of the variable magnification optical system closest to the image side to the image plane Sim is different from the “back focus” as the air conversion distance. Thus, the “back focus” is calculated by obtaining an air conversion thickness of the member on the optical axis.

The variable magnification optical system preferably satisfies Conditional Expression (2). A sum of a distance on the optical axis from a lens surface of the first lens group G1 closest to the object side to a lens surface of the final lens group GE closest to the image side and the back focus of the entire system as the air conversion distance in a state where the infinite distance object is in focus at the wide angle end is denoted by TLw. That is, TLw denotes the total length in the state where the infinite distance object is in focus at the wide angle end. For example, FIG. 2 illustrates the total length TLw. Ensuring that a corresponding value of Conditional Expression (2) is not less than or equal to its lower limit achieves an advantage in suppressing various aberrations in the entire magnification range. Ensuring that the corresponding value of Conditional Expression (2) is not greater than or equal to its upper limit achieves an advantage in reduction of the entire optical system in size. In order to obtain more favorable characteristics, the variable magnification optical system more preferably satisfies Conditional Expression (2-1), further preferably satisfies Conditional Expression (2-2), and still more preferably satisfies Conditional Expression (2-3).

$$4 < TLw / ( ft \times tan ω t ) < 7 \qquad ( 2 )$$

$$4.3 < TLw / ( ft \times tan ω t ) < 6.9 \qquad ( 2 - 1 )$$

$$4.5 < TLw / ( ft \times tan ω t ) < 6.8 \qquad ( 2 - 2 )$$

$$4.7 < TLw / ( ft \times tan ω t ) < 6.7 \qquad ( 2 - 3 )$$

The variable magnification optical system preferably satisfies Conditional Expression (3). Ensuring that a corresponding value of Conditional Expression (3) is not less than or equal to its lower limit achieves an advantage in suppressing various aberrations in the entire magnification range. Ensuring that the corresponding value of Conditional Expression (3) is not greater than or equal to its upper limit achieves an advantage in reduction of the entire optical system in size. In order to obtain more favorable characteristics, the variable magnification optical system more preferably satisfies Conditional Expression (3-1) and further preferably satisfies Conditional Expression (3-2).

$$0.75 < TLw / ft < 1.35 \qquad ( 3 )$$

$$0.85 < TLw / ft < 1.25 \qquad ( 3 - 1 )$$

$$0.9 < TLw / ft < 1.2 \qquad ( 3 - 2 )$$

The variable magnification optical system preferably satisfies Conditional Expression (4). An open F-number in the state where the infinite distance object is in focus at the telephoto end is denoted by FNot. A focal length of the entire system in the state where the infinite distance object is in focus at the wide angle end is denoted by fw. Ensuring that a corresponding value of Conditional Expression (4) is not less than or equal to its lower limit achieves an advantage in reduction of the entire optical system in size or an advantage in suppressing various aberrations particularly at the telephoto end. Ensuring that the corresponding value of Conditional Expression (4) is not greater than or equal to its upper limit facilitates obtaining of sufficient brightness at the telephoto end. In order to obtain more favorable characteristics, the variable magnification optical system more preferably satisfies Conditional Expression (4-1) and further preferably satisfies Conditional Expression (4-2).

$$1.1 < FNot / ( ft / fw ) < 3 \qquad ( 4 )$$

$$1.2 < FNot / ( ft / fw ) < 2.4 \qquad ( 4 - 1 )$$

$$1.28 < FNot / ( ft / fw ) < 1.9 \qquad ( 4 - 2 )$$

The variable magnification optical system preferably satisfies Conditional Expression (5). Ensuring that a corresponding value of Conditional Expression (5) is not less than or equal to its lower limit achieves an advantage in suppressing various aberrations. Ensuring that the corresponding value of Conditional Expression (5) is not greater than or equal to its upper limit achieves an advantage in achieving a wide angle of view at the wide angle end. In order to obtain more favorable characteristics, the variable magnification optical system more preferably satisfies Conditional Expression (5-1).

$$0.9 < fw / ( ft \times tan ω t ) < 1.32 \qquad ( 5 )$$

$$1 < fw / ( ft \times tan ω t ) < 1.28 \qquad ( 5 - 1 )$$

The variable magnification optical system preferably satisfies Conditional Expression (6). Ensuring that a corresponding value of Conditional Expression (6) is not less than or equal to its lower limit achieves an advantage in suppressing various aberrations in the entire magnification range. Ensuring that the corresponding value of Conditional Expression (6) is not greater than or equal to its upper limit achieves an advantage in reduction of the entire optical system in size or an advantage in obtaining a sufficient zoom ratio as the variable magnification optical system. In order to obtain more favorable characteristics, the variable magnification optical system more preferably satisfies Conditional Expression (6-1) and further preferably satisfies Conditional Expression (6-2).

$$0.11 < ( fw \times TLw ) / {ft}^{2} < 0.6 \qquad ( 6 )$$

$$0.12 < ( fw \times TLw ) / {ft}^{2} < 0.45 \qquad ( 6 - 1 )$$

$$0.13 < ( fw \times TLw ) / {ft}^{2} < 0.25 \qquad ( 6 - 2 )$$

In a case where a focal length of the first lens group G1 is denoted by f1, and a focal length of the second lens group G2 is denoted by f2, the variable magnification optical system preferably satisfies Conditional Expression (7). Ensuring that a corresponding value of Conditional Expression (7) is not less than or equal to its lower limit prevents an excessively weak refractive power of the second lens group G2 and thus, facilitates reduction of a moving amount of the first lens group G1 during changing the magnification in a case where the first lens group G1 and the second lens group G2 move during changing the magnification. This achieves an advantage in reduction in size. Ensuring that the corresponding value of Conditional Expression (7) is not greater than or equal to its upper limit prevents an excessively weak refractive power of the first lens group G1 and thus, achieves an advantage in suppressing an increase of the first lens group G1 in size. In order to obtain more favorable characteristics, the variable magnification optical system more preferably satisfies Conditional Expression (7-1) and further preferably satisfies Conditional Expression (7-2).

$$2 < f 1 / ( - f 2 ) < 15 \qquad ( 7 )$$

$$3 < f 1 / ( - f 2 ) < 12 \qquad ( 7 - 1 )$$

$$4 < f 1 / ( - f 2 ) < 10 \qquad ( 7 - 2 )$$

In a case where a focal length of the final lens group GE is denoted by fE, the variable magnification optical system preferably satisfies Conditional Expression (8). Ensuring that a corresponding value of Conditional Expression (8) is not less than or equal to its lower limit facilitates reduction of an incidence angle of an off-axis principal ray on the image plane Sim at the wide angle end and thus, achieves an advantage in securing the edge part light quantity. Ensuring that the corresponding value of Conditional Expression (8) is not greater than or equal to its upper limit achieves an advantage in suppressing a distortion at the wide angle end. In order to obtain more favorable characteristics, the variable magnification optical system more preferably satisfies Conditional Expression (8-1) and further preferably satisfies Conditional Expression (8-2).

$$- 1 < fw / fE < 1 \qquad ( 8 )$$

$$- 0.6 < fw / fE < 0.6 \qquad ( 8 - 2 )$$

$$- 0.5 < fw / fE < 0.5 \qquad ( 8 - 2 )$$

In a case where the focal length of the first lens group G1 is denoted by f1, the variable magnification optical system preferably satisfies Conditional Expression (9). Ensuring that a corresponding value of Conditional Expression (9) is not less than or equal to its lower limit prevents an excessively strong refractive power of the first lens group G1 and thus, achieves an advantage in suppressing fluctuation of the aberrations during changing the magnification. Ensuring that the corresponding value of Conditional Expression (9) is not greater than or equal to its upper limit prevents an excessively weak refractive power of the first lens group G1 and thus, achieves an advantage in reduction in size. In order to obtain more favorable characteristics, the variable magnification optical system more preferably satisfies Conditional Expression (9-1) and further preferably satisfies Conditional Expression (9-2).

$$0.5 < f 1 / {( fw \times ft )}^{1 / 2} < 5 \qquad ( 9 )$$

$$1 < f 1 / {( fw \times ft )}^{1 / 2} < 4 \qquad ( 9 - 1 )$$

$$1.5 < f 1 / {( fw \times ft )}^{1 / 2} < 3 \qquad ( 9 - 2 )$$

In a case where the focal length of the second lens group G2 is denoted by f2, the variable magnification optical system preferably satisfies Conditional Expression (10). Ensuring that a corresponding value of Conditional Expression (10) is not less than or equal to its lower limit prevents an excessively strong refractive power of the second lens group G2 and thus, can suppress a field curvature occurring in the second lens group G2. This facilitates correction of the aberrations during changing the magnification. Ensuring that the corresponding value of Conditional Expression (10) is not greater than or equal to its upper limit prevents an excessively weak refractive power of the second lens group G2 and thus, can reduce a moving amount of the second lens group G2 during changing the magnification. This achieves an advantage in reduction of the total length of the optical system. In order to obtain more favorable characteristics, the variable magnification optical system more preferably satisfies Conditional Expression (10-1) and further preferably satisfies Conditional Expression (10-2).

$$0.1 < ( - f 2 ) / {( fw \times ft )}^{1 / 2} < 1 \qquad ( 10 )$$

$$0.15 < ( - f 2 ) / {( fw \times ft )}^{1 / 2} < 0.8 \qquad ( 10 - 1 )$$

$$0.2 < ( - f 2 ) / {( fw \times ft )}^{1 / 2} < 0.7 \qquad ( 10 - 2 )$$

The variable magnification optical system preferably satisfies Conditional Expression (11). Ensuring that a corresponding value of Conditional Expression (11) is not less than or equal to its lower limit achieves an advantage in achieving high performance. Ensuring that the corresponding value of Conditional Expression (11) is not greater than or equal to its upper limit prevents an excessively weak refractive power of the first lens group G1 and thus, achieves an advantage in reduction of the first lens group G1 in size. In order to obtain more favorable characteristics, the variable magnification optical system more preferably satisfies Conditional Expression (11-1) and further preferably satisfies Conditional Expression (11-2).

$$4 < f 1 / ( ft / FNot ) < 15 \qquad ( 11 )$$

$$5 < f 1 / ( ft / FNot ) < 13 \qquad ( 11 - 1 )$$

$$6 < f 1 / ( ft / FNot ) < 12 \qquad ( 11 - 2 )$$

The variable magnification optical system preferably satisfies Conditional Expression (12). Ensuring that a corresponding value of Conditional Expression (12) is not less than or equal to its lower limit achieves an advantage in suppressing various aberrations at the wide angle end. Ensuring that the corresponding value of Conditional Expression (12) is not greater than or equal to its upper limit achieves an advantage in reduction of the total length of the optical system at the wide angle end. In order to obtain more favorable characteristics, the variable magnification optical system more preferably satisfies Conditional Expression (12-1) and further preferably satisfies Conditional Expression (12-2).

$$3.5 < TLw / fw < 6.5 \qquad ( 12 )$$

$$4 < TLw / fw < 6 \qquad ( 12 - 1 )$$

$$4.3 < TLw / fw < 5.5 \qquad ( 12 - 2 )$$

The variable magnification optical system preferably satisfies Conditional Expression (13). A sum of a distance on the optical axis from the lens surface of the first lens group G1 closest to the object side to the lens surface of the final lens group GE closest to the image side and the back focus of the entire system as the air conversion distance in the state where the infinite distance object is in focus at the telephoto end is denoted by TLt. That is, TLt denotes the total length in the state where the infinite distance object is in focus at the telephoto end. For example, FIG. 2 illustrates the total length TLt. Ensuring that a corresponding value of Conditional Expression (13) is not less than or equal to its lower limit achieves an advantage in suppressing various aberrations at the telephoto end. Ensuring that the corresponding value of Conditional Expression (13) is not greater than or equal to its upper limit achieves an advantage in reduction of the total length of the optical system at the telephoto end. In order to obtain more favorable characteristics, the variable magnification optical system more preferably satisfies Conditional Expression (13-1) and further preferably satisfies Conditional Expression (13-2).

$$1 < TLt / ft < 2.5 \qquad ( 13 )$$

$$1.2 < TLt / ft < 2.2 \qquad ( 13 - 1 )$$

$$1.4 < TLt / ft < 18 \qquad ( 13 - 2 )$$

The variable magnification optical system preferably satisfies Conditional Expression (14). Ensuring that a corresponding value of Conditional Expression (14) is not less than or equal to its lower limit can cause the on-axis luminous flux ta to gradually converge to the image plane Sim at the telephoto end and thus, facilitates suppression of the axial chromatic aberration that occurs during converging of the on-axis luminous flux ta. Ensuring that the corresponding value of Conditional Expression (14) is not greater than or equal to its upper limit achieves an advantage in reduction of the total length of the optical system at the telephoto end. In order to obtain more favorable characteristics, the variable magnification optical system more preferably satisfies Conditional Expression (14-1) and further preferably satisfies Conditional Expression (14-2).

$$7 < TLt / ( ft \times tan ω t ) < 11.5 \qquad ( 14 )$$

$$7.5 < TLt / ( ft \times tan ω t ) < 10.5 \qquad ( 14 - 1 )$$

$$8 < TLt / ( ft \times tan ω t ) < 9.5 \qquad ( 14 - 2 )$$

The variable magnification optical system preferably satisfies Conditional Expression (15). A maximum half angle of view in the state where the infinite distance object is in focus at the wide angle end is denoted by ωw. An open F-number in the state where the infinite distance object is in focus at the wide angle end is denoted by FNow. Ensuring that a corresponding value of Conditional Expression (15) is not less than or equal to its lower limit facilitates reduction of the open F-number at the wide angle end while an angle of view at the wide angle end is increased. Ensuring that the corresponding value of Conditional Expression (15) is not greater than or equal to its upper limit achieves an advantage in suppressing an increase in the number of lenses and suppressing an increase of the optical system in size while obtaining favorable optical performance. In order to obtain more favorable characteristics, the variable magnification optical system more preferably satisfies Conditional Expression (15-1) and further preferably satisfies Conditional Expression (15-2).

$$0.17 < tan ω w / FNow < 0.35 \qquad ( 15 )$$

$$0.19 < tan ω w / FNow < 0 \text{.32} \qquad ( 15 - 1 )$$

$$0.21 < tan ω w / FNow < 0 \text{.28} \qquad ( 15 - 2 )$$

In the configuration in which the aperture stop St is disposed closer to the image side than the lens surface of the second lens group G2 closest to the image side, the variable magnification optical system preferably satisfies Conditional Expression (16). A distance on the optical axis from the lens surface of the first lens group G1 closest to the object side to the aperture stop St in the state where the infinite distance object is in focus at the wide angle end is denoted by DDG1STw. For example, FIG. 2 illustrates the distance DDG1STw. Ensuring that a corresponding value of Conditional Expression (16) is not less than or equal to its lower limit prevents an excessively small movable range of the second lens group G2 during changing the magnification and thus, achieves an advantage in achieving a high zoom ratio.

Alternatively, ensuring that the corresponding value of Conditional Expression (16) is not less than or equal to its lower limit prevents an excessively weak refractive power of the first lens group G1 and thus, facilitates establishment of both of reduction in size and achievement of a high zoom ratio. Ensuring that the corresponding value of Conditional Expression (16) is not greater than or equal to its upper limit prevents an excessively long distance from the lens surface of the first lens group G1 closest to the object side to an entrance pupil position on a wide angle side and thus, can suppress an increase of the first lens group G1 in diameter. This achieves an advantage in reduction in size. Alternatively, ensuring that the corresponding value of Conditional Expression (16) is not greater than or equal to its upper limit prevents an excessively strong refractive power of the first lens group G1 and thus, achieves an advantage in achieving high performance. In order to obtain more favorable characteristics, the variable magnification optical system more preferably satisfies Conditional Expression (16-1) and further preferably satisfies Conditional Expression (16-2).

$$0.15 < DDG 1 STw / f 1 < 1 \qquad ( 16 )$$

$$0.25 < DDG 1 STw / f 1 < 0.8 \qquad ( 16 - 1 )$$

$$0.35 < DDG 1 STw / f 1 < 0.7 \qquad ( 16 - 2 )$$

In a case where a distance on the optical axis from the lens surface of the first lens group G1 closest to the object side to a paraxial entrance pupil position Penw in the state where the infinite distance object is in focus at the wide angle end is denoted by Denw, the variable magnification optical system preferably satisfies Conditional Expression (17). For example, FIG. 2 illustrates the distance Denw and the paraxial entrance pupil position Penw. In the present specification, a sign of Denw is negative in a case where the paraxial entrance pupil position Penw is closer to the object side than the lens surface of the first lens group G1 closest to the object side, and is positive in a case where the paraxial entrance pupil position Penw is closer to the image side than the lens surface of the first lens group G1 closest to the object side. Ensuring that a corresponding value of Conditional Expression (17) is not less than or equal to its lower limit prevents an excessively short distance from the lens surface of the first lens group G1 closest to the object side to the paraxial entrance pupil position Penw on the wide angle side and thus, facilitates suppression of fluctuation of the aberrations during changing the magnification. Ensuring that the corresponding value of Conditional Expression (17) is not greater than or equal to its upper limit prevents an excessively long distance from the lens surface of the first lens group G1 closest to the object side to the paraxial entrance pupil position Penw on the wide angle side and thus, can suppress an increase of the first lens group G1 in diameter. This facilitates reduction in size. In order to obtain more favorable characteristics, the variable magnification optical system more preferably satisfies Conditional Expression (17-1) and further preferably satisfies Conditional Expression (17-2).

$$1 < Denw / \{ ( fw \times tan ω w ) \times log ( ft / fw ) \} < 3.5 \qquad ( 17 )$$

$$1.2 < Denw / \{ ( fw \times tan ω w ) \times log ( ft / fw ) \} < 3 \qquad ( 17 - 1 )$$

$$1.4 < Denw / \{ ( fw \times tan ω w ) \times log ( ft / fw ) \} < 2.5 \qquad ( 17 - 2 )$$

The variable magnification optical system preferably satisfies Conditional Expression (18). Ensuring that a corresponding value of Conditional Expression (18) is not less than or equal to its lower limit prevents an excessively short distance from the lens surface of the first lens group G1 closest to the object side to the paraxial entrance pupil position Penw on the wide angle side and thus, facilitates suppression of fluctuation of the aberrations during changing the magnification. Ensuring that the corresponding value of Conditional Expression (18) is not greater than or equal to its upper limit prevents an excessively long distance from the lens surface of the first lens group G1 closest to the object side to the paraxial entrance pupil position Penw on the wide angle side and thus, can suppress an increase of the first lens group G1 in diameter. This facilitates reduction in size. In order to obtain more favorable characteristics, the variable magnification optical system more preferably satisfies Conditional Expression (18-1) and further preferably satisfies Conditional Expression (18-2).

$$0.3 < Denw / {( fw \times ft )}^{1 / 2} < 1 \qquad ( 18 )$$

$$0.4 < Denw / {( fw \times ft )}^{1 / 2} < 0.8 \qquad ( 18 - 1 )$$

$$0.45 < Denw / {( fw \times ft )}^{1 / 2} < 0.7 \qquad ( 18 - 2 )$$

In a case where the variable magnification optical system includes the aperture stop St, the variable magnification optical system preferably satisfies Conditional Expression (19). Ensuring that a corresponding value of Conditional Expression (19) is not less than or equal to its lower limit prevents an excessively short distance between the aperture stop St and the first lens group G1 on the wide angle side and thus, also prevents an excessively short distance from the lens surface of the first lens group G1 closest to the object side to the entrance pupil position. This facilitates suppression of fluctuation of the aberrations during changing the magnification. Ensuring that the corresponding value of Conditional Expression (19) is not greater than or equal to its upper limit prevents an excessively long distance between the aperture stop St and the first lens group G1 on the wide angle side and thus, also prevents an excessively long distance from the lens surface of the first lens group G1 closest to the object side to the entrance pupil position. This can suppress an increase of the first lens group G1 in diameter and thus, achieves an advantage in reduction in size. In order to obtain more favorable characteristics, the variable magnification optical system more preferably satisfies Conditional Expression (19-1) and further preferably satisfies Conditional Expression (19-2).

$$0.25 < DDG 1 STw / TLw < 0.6 \qquad ( 19 )$$

$$0.3 < DDG 1 STw / TLw < 0.55 \qquad ( 19 - 1 )$$

$$0.35 < DDG 1 STw / TLw < 0.5 \qquad ( 19 - 2 )$$

In a case where a sum of a distance on the optical axis from a paraxial exit pupil position Pexw to the lens surface of the final lens group GE closest to the image side and the back focus of the entire system as the air conversion distance in the state where the infinite distance object is in focus at the wide angle end is denoted by Dexw, the variable magnification optical system preferably satisfies Conditional Expression (20). For example, FIG. 2 illustrates the distance Dexw and the paraxial exit pupil position Pexw. In the present specification, a sign of Dexw is positive in a case where the paraxial exit pupil position Pexw is closer to the object side than the image plane Sim, and is negative in a case where the paraxial exit pupil position Pexw is closer to the image side than the image plane Sim. Ensuring that a corresponding value of Conditional Expression (20) is not less than or equal to its lower limit facilitates reduction of the total length of the optical system and thus, achieves an advantage in reduction in size. Ensuring that the corresponding value of Conditional Expression (20) is not greater than or equal to its upper limit facilitates reduction of the incidence angle of the off-axis principal ray on the image plane Sim and thus, achieves an advantage in securing the edge part light quantity. In order to obtain more favorable characteristics, the variable magnification optical system more preferably satisfies Conditional Expression (20-1) and further preferably satisfies Conditional Expression (20-2).

$$0.3 < fw / Dexw < 0.65 \qquad ( 20 )$$

$$0.35 < fw / Dexw < 0.6 \qquad ( 20 - 1 )$$

$$0.4 < fw / Dexw < 0.55 \qquad ( 20 - 2 )$$

In a case where the moving amount of the first lens group G1 during changing the magnification from the wide angle end to the telephoto end is denoted by M1, the variable magnification optical system preferably satisfies Conditional Expression (21). A sign of M1 is positive in a case of moving from the object side to the image side and is negative in a case of moving from the image side to the object side. For example, FIG. 2 illustrates the moving amount M1. Ensuring that a corresponding value of Conditional Expression (21) is not less than or equal to its lower limit achieves an advantage in securing a suitable zoom ratio. Ensuring that the corresponding value of Conditional Expression (21) is not greater than or equal to its upper limit achieves an advantage in suppressing a change in a position of a centroid during changing the magnification. In order to obtain more favorable characteristics, the variable magnification optical system more preferably satisfies Conditional Expression (21-1) and further preferably satisfies Conditional Expression (21-2).

$$0.2 < ( - M 1 ) / TLt < 0.5 \qquad ( 21 )$$

$$0.23 < ( - M 1 ) / TLt < 0 \text{.45} \qquad ( 2 - 11 )$$

$$0.25 < ( - M 1 ) / TLt < 0.4 \qquad ( 21 - 2 )$$

In a case where the moving amount of the second lens group G2 during changing the magnification from the wide angle end to the telephoto end is denoted by M2, the variable magnification optical system preferably satisfies Conditional Expression (22). A sign of M2 is positive in a case of moving from the object side to the image side and is negative in a case of moving from the image side to the object side. Ensuring that a corresponding value of Conditional Expression (22) is not less than or equal to its lower limit achieves an advantage in securing a suitable zoom ratio. Ensuring that the corresponding value of Conditional Expression (22) is not greater than or equal to its upper limit achieves an advantage in suppressing the distortion during changing the magnification. In order to obtain more favorable characteristics, the variable magnification optical system more preferably satisfies Conditional Expression (22-1) and further preferably satisfies Conditional Expression (22-2).

$$0.04 < ( - M 2 ) / TLt < 0.4 \qquad ( 22 )$$

$$0.06 < ( - M 2 ) / TLt < 0.3 \qquad ( 22 - 1 )$$

$$0.07 < ( - M 2 ) / TLt < 0 \text{.25} \qquad ( 22 - 2 )$$

In a case where a focal length of the intermediate group GM in the state where the infinite distance object is in focus at the wide angle end is denoted by fMw, the variable magnification optical system preferably satisfies Conditional Expression (23). Ensuring that a corresponding value of Conditional Expression (23) is not less than or equal to its lower limit facilitates reduction of the total length of the optical system at the wide angle end and thus, achieves an advantage in reduction in size. Ensuring that the corresponding value of Conditional Expression (23) is not greater than or equal to its upper limit achieves an advantage in correcting the spherical aberration at the wide angle end. In order to obtain more favorable characteristics, the variable magnification optical system more preferably satisfies Conditional Expression (23-1) and further preferably satisfies Conditional Expression (23-2).

$$0.3 < fw / fMw < 2 \qquad ( 23 )$$

$$0.5 < fw / fMw < 1.5 \qquad ( 23 - 1 )$$

$$0.6 < fw / fMw < 1.2 \qquad ( 23 - 2 )$$

In a case where a focal length of the intermediate group GM in the state where the infinite distance object is in focus at the telephoto end is denoted by fMt, the variable magnification optical system preferably satisfies Conditional Expression (24). Ensuring that a corresponding value of Conditional Expression (24) is not less than or equal to its lower limit facilitates reduction of the total length of the optical system at the telephoto end and thus, achieves an advantage in reduction in size. Ensuring that the corresponding value of Conditional Expression (24) is not greater than or equal to its upper limit achieves an advantage in correcting the spherical aberration at the telephoto end. In order to obtain more favorable characteristics, the variable magnification optical system more preferably satisfies Conditional Expression (24-1) and further preferably satisfies Conditional Expression (24-2).

$$1 < ft / fMt < 10 \qquad ( 24 )$$

$$1.5 < ft / fMt < 9 \qquad ( 24 - 1 )$$

$$2 < ft / fMt < 8 \qquad ( 24 - 2 )$$

In a case where a distance on the optical axis from the lens surface of the first lens group G1 closest to the object side to a lens surface of the first lens group G1 closest to the image side is denoted by D1sum, the variable magnification optical system preferably satisfies Conditional Expression (25). For example, FIG. 2 illustrates the distance D1sum. Ensuring that a corresponding value of Conditional Expression (25) is not less than or equal to its lower limit facilitates securing of mechanical strength of the first lens group G1. Ensuring that the corresponding value of Conditional Expression (25) is not greater than or equal to its upper limit achieves an advantage in reduction of the first lens group G1 in weight. In order to obtain more favorable characteristics, the variable magnification optical system more preferably satisfies Conditional Expression (25-1) and further preferably satisfies Conditional Expression (25-2).

$$0.2 < D 1 sum / ( ft / FNot ) < 1.6 \qquad ( 25 )$$

$$0.3 < D 1 sum / ( ft / FNot ) < 1.3 \qquad ( 25 - 1 )$$

$$0.4 < D 1 sum / ( ft / FNot ) < 1.1 \qquad ( 25 - 2 )$$

The variable magnification optical system preferably satisfies Conditional Expression (26). A lateral magnification of the second lens group G2 in the state where the infinite distance object is in focus at the telephoto end is denoted by β2t. A lateral magnification of the second lens group G2 in the state where the infinite distance object is in focus at the wide angle end is denoted by β2w. Ensuring that a corresponding value of Conditional Expression (26) is not less than or equal to its lower limit achieves an advantage in achieving a high zoom ratio. Ensuring that the corresponding value of Conditional Expression (26) is not greater than or equal to its upper limit achieves an advantage in suppressing fluctuation of the aberrations during changing the magnification. In order to obtain more favorable characteristics, the variable magnification optical system more preferably satisfies Conditional Expression (26-1) and further preferably satisfies Conditional Expression (26-2).

$$1 < β 2 t / β 2 w < 3 \qquad ( 26 )$$

$$1.2 < β2 t / β 2 w < 2.7 \qquad ( 26 - 1 )$$

$$1.3 < β 2 t / β 2 w < 2.5 \qquad ( 26 - 2 )$$

In a case where an average value of Abbe numbers based on a d line for all positive lenses of the first lens group G1 is denoted by v1pave, the variable magnification optical system preferably satisfies Conditional Expression (27). Ensuring that a corresponding value of Conditional Expression (27) is not less than or equal to its lower limit achieves an advantage in correcting the axial chromatic aberration particularly at the telephoto end. Ensuring that the corresponding value of Conditional Expression (27) is not greater than or equal to its upper limit achieves an advantage in correcting various aberrations other than the chromatic aberration. In order to obtain more favorable characteristics, the variable magnification optical system more preferably satisfies Conditional Expression (27-1) and further preferably satisfies Conditional Expression (27-2).

$$40 < v 1 pave < 95 \qquad ( 27 )$$

$$60 < v 1 pave < 90 \qquad ( 27 - 1 )$$

$$70 < v 1 pave < 80 \qquad ( 27 - 2 )$$

In a case where a positive lens having the strongest positive refractive power among non-cemented single lenses of the intermediate group GM is referred to as an Lp positive lens, a surface of the Lp positive lens on the image side is preferably a convex surface. Doing so achieves an advantage in correcting the spherical aberration in the entire magnification range. In the example in FIG. 2, the lens L34 corresponds to the Lp positive lens.

In a case where a focal length of the Lp positive lens is denoted by fp, and the focal length of the intermediate group GM in the state where the infinite distance object is in focus at the wide angle end is denoted by fMw, the variable magnification optical system preferably satisfies Conditional Expression (28). Particularly, in the configuration in which the surface of the Lp positive lens on the image side is a convex surface, the variable magnification optical system preferably satisfies Conditional Expression (28). Ensuring that a corresponding value of Conditional Expression (28) is not less than or equal to its lower limit achieves an advantage in correcting the spherical aberration particularly at the telephoto end. Ensuring that the corresponding value of Conditional Expression (28) is not greater than or equal to its upper limit facilitates reduction of the incidence angle of the off-axis principal ray on the image plane Sim particularly at the wide angle end and thus, achieves an advantage in securing the edge part light quantity. In order to obtain more favorable characteristics, the variable magnification optical system more preferably satisfies Conditional Expression (28-1) and further preferably satisfies Conditional Expression (28-2).

$$0.4 < fMw / fp < 2 \qquad ( 28 )$$

$$0.5 < fMw / fp < 1.5 \qquad ( 28 - 1 )$$

$$0.6 < fMw / fp < 1.3 \qquad ( 28 - 2 )$$

The Lp positive lens is preferably a biconvex lens. Doing so achieves an advantage in correcting the spherical aberration particularly at the telephoto end. In a case where the Lp positive lens is a biconvex lens, a surface of the Lp positive lens on the object side and the surface of the Lp positive lens on the image side are preferably aspherical surfaces. Doing so achieves an advantage in further correcting the spherical aberration particularly at the telephoto end. The variable magnification optical system more preferably satisfies Conditional Expression (28) and has a preferable configuration related to the above shape of the Lp positive lens.

In a case where an effective diameter of the lens surface of the first lens group G1 closest to the object side is denoted by EDf, and an effective diameter of the lens surface of the final lens group GE closest to the image side is denoted by EDr, the variable magnification optical system preferably satisfies Conditional Expression (29). Generally, in order to decrease a diameter of a lens closest to the object side, the refractive power of the first lens group G1 is increased. In a case where the refractive power of the first lens group G1 is increased, fluctuation of the aberrations during changing the magnification is likely to be increased. From such circumstances, ensuring that a corresponding value of Conditional Expression (29) is not less than or equal to its lower limit prevents an excessively small diameter of the lens closest to the object side and thus, also prevents an excessively strong refractive power of the first lens group G1. This achieves an advantage in suppressing fluctuation of the aberrations during changing the magnification. Alternatively, ensuring that the corresponding value of Conditional Expression (29) is not less than or equal to its lower limit prevents an excessively small diameter of the lens closest to the object side and thus, achieves an advantage in securing a ratio of the edge part light quantity at a maximum image height. Ensuring that the corresponding value of Conditional Expression (29) is not greater than or equal to its upper limit can suppress an increase of the lens closest to the object side in diameter and thus, facilitates reduction in size. In order to obtain more favorable characteristics, the variable magnification optical system more preferably satisfies Conditional Expression (29-1) and further preferably satisfies Conditional Expression (29-2).

$$1.2 < EDf / EDr < 3 \qquad ( 29 )$$

$$1.4 < EDf / EDr < 2.6 \qquad ( 29 - 1 )$$

$$16 < EDf / EDr < 2.2 \qquad ( 29 - 2 )$$

In the present specification, twice a distance from an intersection between a lens surface and a ray passing through an outermost side of the lens surface to the optical axis Z among rays that are incident on the lens surface from the object side and that exit to the image side is referred to as an “effective diameter” of the lens surface. The term “outer side” means an outer side in a diameter direction centered on the optical axis Z, that is, a side away from the optical axis Z. The “ray passing through the outermost side” is determined considering the entire magnification range.

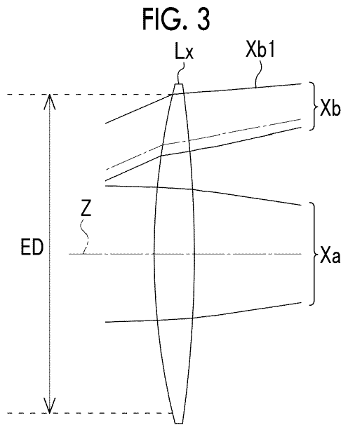

FIG. 3 illustrates an example of the effective diameter ED as a diagram for description. In FIG. 3, a left side is the object side, and a right side is the image side. FIG. 3 illustrates an on-axis luminous flux Xa and an off-axis luminous flux Xb that pass through a lens Lx. In the example in FIG. 3, a ray Xbl that is an upper ray of the off-axis luminous flux Xb is the ray passing through the outermost side. Thus, in the example in FIG. 3, twice a distance from an intersection between a surface of the lens Lx on the object side and the ray Xbl to the optical axis Z is the effective diameter ED of the surface of the lens Lx on the object side. While the upper ray of the off-axis luminous flux Xb is the ray passing through the outermost side in FIG. 3, which ray is the ray passing through the outermost side varies depending on the optical system.

The variable magnification optical system preferably satisfies Conditional Expression (30). Ensuring that a corresponding value of Conditional Expression (30) is not less than or equal to its lower limit can suppress an increase in the total length of the optical system and thus, facilitates reduction in size in the optical axis direction. Ensuring that the corresponding value of Conditional Expression (30) is not greater than or equal to its upper limit can suppress an increase of the lens closest to the object side in diameter and thus, facilitates reduction in size in the diameter direction. In order to obtain more favorable characteristics, the variable magnification optical system more preferably satisfies Conditional Expression (30-1) and further preferably satisfies Conditional Expression (30-2).

$$0.25 < EDf / TLw < 0.6 \qquad ( 30 )$$

$$0.3 < EDf / TLw < 0 \text{.55} \qquad ( 30 - 1 )$$

$$0.36 < EDf / TLw < 0.5 \qquad ( 30 - 2 )$$

In the configuration in which the first lens group G1 includes, in consecutive order from the position closest to the object side to the image side, the first lens that is a negative lens, and the second lens that is a positive lens, in a case where a center thickness of the first lens is denoted by d1, the variable magnification optical system preferably satisfies Conditional Expression (31). Ensuring that a corresponding value of Conditional Expression (31) is not less than or equal to its lower limit achieves an advantage in securing strength of the first lens. Ensuring that the corresponding value of Conditional Expression (31) is not greater than or equal to its upper limit achieves an advantage in reduction of the first lens group G1 in weight. In order to obtain more favorable characteristics, the variable magnification optical system more preferably satisfies Conditional Expression (31-1) and further preferably satisfies Conditional Expression (31-2).

$$0.01 < d 1 / EDf < 0.4 \qquad ( 31 )$$

$$0.015 < d 1 / EDf < 0.3 \qquad ( 31 - 1 )$$

$$0.02 < d 1 / EDf < 0.2 \qquad ( 31 - 2 )$$

In the configuration in which the first lens group G1 includes, in consecutive order from the position closest to the object side to the image side, the first lens and the second lens, the variable magnification optical system preferably satisfies Conditional Expression (32). Ensuring that a corresponding value of Conditional Expression (32) is not less than or equal to its lower limit achieves an advantage in securing the strength of the first lens. Ensuring that the corresponding value of Conditional Expression (32) is not greater than or equal to its upper limit achieves an advantage in reduction of the first lens group G1 in weight. In order to obtain more favorable characteristics, the variable magnification optical system more preferably satisfies Conditional Expression (32-1) and further preferably satisfies Conditional Expression (32-2).

$$0.01 < d 1 / ( Denw \times tan ω w ) < 0.15 \qquad ( 32 )$$

$$0.02 < d 1 / ( Denw \times tan ω w ) < 0.12 \qquad ( 32 - 1 )$$

$$0.03 < d 1 / ( Denw \times tan ω w ) < 0.09 \qquad ( 32 - 2 )$$

In the configuration in which the first lens group G1 includes, in consecutive order from the position closest to the object side to the image side, the first lens and the second lens, the variable magnification optical system preferably satisfies Conditional Expression (33). A center thickness of the second lens is denoted by d2. A paraxial curvature radius of a surface of the second lens on the object side is denoted by R2f A paraxial curvature radius of a surface of the second lens on the image side is denoted by R2r. Ensuring that a corresponding value of Conditional Expression (33) is not less than or equal to its lower limit achieves an advantage in securing strength of the second lens. Ensuring that the corresponding value of Conditional Expression (33) is not greater than or equal to its upper limit achieves an advantage in reduction of the first lens group G1 in weight. In order to obtain more favorable characteristics, the variable magnification optical system more preferably satisfies Conditional Expression (33-1) and further preferably satisfies Conditional Expression (33-2).

$$0.01 < d 2 \times ( 1 / R 2 f - 1 / R 2 r ) < 0.4 \qquad ( 33 )$$

$$0.02 < d 2 \times ( 1 / R 2 f - 1 / R 2 r ) < 0 \text{.35} \qquad ( 33 - 1 )$$

$$0.04 < d 2 \times ( 1 / R 2 f - 1 / R 2 r ) < 0.3 \qquad ( 33 - 2 )$$

In the configuration in which the first lens group G1 includes, in consecutive order from the position closest to the object side to the image side, the first lens and the second lens, the variable magnification optical system preferably satisfies Conditional Expression (34). Ensuring that a corresponding value of Conditional Expression (34) is not less than or equal to its lower limit achieves an advantage in securing the strength of the first lens. Ensuring that the corresponding value of Conditional Expression (34) is not greater than or equal to its upper limit achieves an advantage in reduction of the first lens group G1 in weight. In order to obtain more favorable characteristics, the variable magnification optical system more preferably satisfies Conditional Expression (34-1) and further preferably satisfies Conditional Expression (34-2).

$$0.005 < d 1 / f 1 < 0.025 \qquad ( 34 )$$

$$0.007 < d 1 / f 1 < 0.02 \qquad ( 34 - 1 )$$

$$0.008 < d 1 / f 1 < 0. 015 \qquad ( 34 - 2 )$$

In the configuration in which the first lens group G1 includes, in consecutive order from the position closest to the object side to the image side, the first lens and the second lens, the variable magnification optical system preferably satisfies Conditional Expression (35). A distance on the optical axis from the lens surface of the first lens group G1 closest to the object side to the lens surface of the first lens group G1 closest to the image side is denoted by D1sum. Ensuring that a corresponding value of Conditional Expression (35) is not less than or equal to its lower limit achieves an advantage in securing the strength of the first lens. Ensuring that the corresponding value of Conditional Expression (35) is not greater than or equal to its upper limit achieves an advantage in reduction of the first lens group G1 in weight. In order to obtain more favorable characteristics, the variable magnification optical system more preferably satisfies Conditional Expression (35-1) and further preferably satisfies Conditional Expression (35-2).

$$0.05 < d 1 / D 1 sum < 0.3 \qquad ( 35 )$$

$$0.075 < d 1 / D 1 sum < 0.5 \qquad ( 35 - 1 )$$

$$0.1 < d 1 / D 1 sum < 0.2 \qquad ( 35 - 2 )$$

In the configuration in which the first lens group G1 includes, in consecutive order from the position closest to the object side to the image side, the first lens and the second lens, the variable magnification optical system preferably satisfies Conditional Expression (36). An average value of a relative density of the first lens and a relative density of the second lens is denoted by G12ave. Ensuring that a corresponding value of Conditional Expression (36) is not less than or equal to its lower limit enables use of an easily obtainable material and thus, achieves an advantage in implementing a variable magnification optical system in which the spherical aberration and the axial chromatic aberration are suppressed. Ensuring that the corresponding value of Conditional Expression (36) is not greater than or equal to its upper limit achieves an advantage in reduction of the first lens group G1 in weight. In order to obtain more favorable characteristics, the variable magnification optical system more preferably satisfies Conditional Expression (36-1) and further preferably satisfies Conditional Expression (36-2).

$$2 < G 12 ave < 5.5 \qquad ( 36 )$$

$$2.5 < G 12 ave < 5 \qquad ( 36 - 1 )$$

$$2.8 < G 12 ave < 4 \qquad ( 36 - 2 )$$

In the configuration in which the first lens group G1 includes, in consecutive order from the position closest to the object side to the image side, the first lens and the second lens, the first lens and the second lens are preferably cemented. Doing so achieves an advantage in reduction in size. In the above configuration in which the first lens and the second lens are cemented, in a case where an Abbe number based on a d line for the second lens is denoted by v2, the variable magnification optical system preferably satisfies Conditional Expression (37). Ensuring that a corresponding value of Conditional Expression (37) is not less than or equal to its lower limit achieves an advantage in suppressing the axial chromatic aberration at the telephoto end. Ensuring that the corresponding value of Conditional Expression (37) is not greater than or equal to its upper limit can suppress excessive correction of the axial chromatic aberration at the telephoto end. In order to obtain more favorable characteristics, the variable magnification optical system more preferably satisfies Conditional Expression (37-1) and further preferably satisfies Conditional Expression (37-2).

$$40 < v 2 < 95 \qquad ( 37 )$$

$$55 < v 2 < 90 \qquad ( 37 - 1 )$$

$$68 < v 2 < 83 \qquad ( 37 - 2 )$$

In a configuration in which the first lens group G1 consists of, in order from the object side to the image side, the first lens, the second lens, and a positive lens, in a case where an Abbe number based on a d line for a positive lens closest to the image side in the first lens group G1 is denoted by v3, the variable magnification optical system preferably satisfies Conditional Expression (38). Ensuring that a corresponding value of Conditional Expression (38) is not less than or equal to its lower limit achieves an advantage in suppressing the axial chromatic aberration at the telephoto end. Ensuring that the corresponding value of Conditional Expression (38) is not greater than or equal to its upper limit can suppress excessive correction of the axial chromatic aberration at the telephoto end. In order to obtain more favorable characteristics, the variable magnification optical system more preferably satisfies Conditional Expression (38-1) and further preferably satisfies Conditional Expression (38-2).

$$40 < v 3 < 95 \qquad ( 38 )$$

$$50 < v 3 < 90 \qquad ( 38 - 1 )$$

$$60 < v 3 < 85 \qquad ( 38 - 2 )$$

In a configuration in which a negative lens is disposed closest to the object side in the second lens group G2, and the second lens group G2 further includes at least one negative lens different from the negative lens disposed closest to the object side and at least one positive lens, the variable magnification optical system preferably satisfies Conditional Expression (39). A focal length of the negative lens closest to the object side in the second lens group G2 is denoted by fL21. Ensuring that a corresponding value of Conditional Expression (39) is not less than or equal to its lower limit achieves an advantage in achieving a wide angle of view at the wide angle end. Ensuring that the corresponding value of Conditional Expression (39) is not greater than or equal to its upper limit achieves an advantage in suppressing the distortion. In order to obtain more favorable characteristics, the variable magnification optical system more preferably satisfies Conditional Expression (39-1) and further preferably satisfies Conditional Expression (39-2).

$$0.5 < fL 21 / f 2 < 3 \qquad ( 39 )$$

$$0.8 < fL 21 / f 2 < 2.5 \qquad ( 39 - 1 )$$

$$1 < fL 21 / f 2 < 2 \qquad ( 39 - 2 )$$

In the configuration in which the negative lens is disposed closest to the object side in the second lens group G2, and the second lens group G2 further includes at least one negative lens different from the negative lens disposed closest to the object side and at least one positive lens, the variable magnification optical system preferably satisfies Conditional Expression (40). A paraxial curvature radius of a surface, on the object side, of the negative lens closest to the object side in the second lens group G2 is denoted by RL21f. A paraxial curvature radius of a surface, on the image side, of the negative lens closest to the object side in the second lens group G2 is denoted by RL21r. Ensuring that a corresponding value of Conditional Expression (40) is not less than or equal to its lower limit achieves an advantage in suppressing the distortion. Ensuring that the corresponding value of Conditional Expression (40) is not greater than or equal to its upper limit achieves an advantage in achieving a wide angle of view at the wide angle end. In order to obtain more favorable characteristics, the variable magnification optical system more preferably satisfies Conditional Expression (40-1) and further preferably satisfies Conditional Expression (40-2).

$$0.5 < ( RL 21 f + RL 21 r ) / ( RL 21 f - RL 21 r ) < 3.5 \qquad ( 40 )$$

$$0.75 < ( RL 21 f + RL 21 r ) / ( RL 21 f - RL 21 r ) < 3 \qquad ( 40 - 1 )$$

$$1 < ( RL 21 f + RL 21 r ) / ( RL 21 f - RL 21 r ) < 2 \text{.75} \qquad ( 40 - 2 )$$

In the configuration in which the negative lens is disposed closest to the object side in the second lens group G2, and the second lens group G2 further includes at least one negative lens different from the negative lens disposed closest to the object side and at least one positive lens, the variable magnification optical system preferably satisfies Conditional Expression (41). A focal length of a lens that is the second from the object side in the second lens group G2 is denoted by fL22. Ensuring that a corresponding value of Conditional Expression (41) is not less than or equal to its lower limit achieves an advantage in suppressing the lateral chromatic aberration. Ensuring that the corresponding value of Conditional Expression (41) is not greater than or equal to its upper limit achieves an advantage in suppressing the distortion. In order to obtain more favorable characteristics, the variable magnification optical system more preferably satisfies Conditional Expression (41-1) and further preferably satisfies Conditional Expression (41-2).

$$0.4 < fL 22 / f 2 < 5 \qquad ( 41 )$$

$$0.6 < fL 22 / f 2 < 4 \qquad ( 41 - 1 )$$

$$0.8 < fL 22 / f 2 < 3.5 \qquad ( 41 - 2 )$$

The variable magnification optical system preferably satisfies Conditional Expression (42). Ensuring that a corresponding value of Conditional Expression (42) is not less than or equal to its lower limit prevents an excessively low zoom ratio and thus, can sufficiently exhibit value of the variable magnification optical system. Ensuring that the corresponding value of Conditional Expression (42) is not greater than or equal to its upper limit prevents an excessively high zoom ratio and thus, achieves an advantage in reduction in size. In order to obtain more favorable characteristics, the variable magnification optical system more preferably satisfies Conditional Expression (42-1) and further preferably satisfies Conditional Expression (42-2).

$$2.5 < ft / fw < 7 \qquad ( 42 )$$

$$3 < ft / fw < 6 \qquad ( 42 - 1 )$$

$$3.5 < ft / fw < 5 \qquad ( 42 - 2 )$$

In a case where a focal length of a lens group closest to the object side in the intermediate group GM is denoted by f3, the variable magnification optical system preferably satisfies Conditional Expression (43). Ensuring that a corresponding value of Conditional Expression (43) is not less than or equal to its lower limit achieves an advantage in suppressing fluctuation of the spherical aberration during changing the magnification. Ensuring that the corresponding value of Conditional Expression (43) is not greater than or equal to its upper limit achieves an advantage in suppressing fluctuation of the distortion during changing the magnification. In order to obtain more favorable characteristics, the variable magnification optical system more preferably satisfies Conditional Expression (43-1) and further preferably satisfies Conditional Expression (43-2).

$$- 1.2 < f 2 / f 3 < 1 \qquad ( 43 )$$

$$- 1.1 < f 2 / f 3 < 0.9 \qquad ( 43 - 1 )$$

$$- 1 < f 2 / f 3 < 0.8 \qquad ( 43 - 2 )$$

In the configuration in which the variable magnification optical system includes at least one plastic lens of which the surface on the object side and the surface on the image side are aspherical surfaces, in a case where a relative density of the plastic lens of which the surface on the object side and the surface on the image side are aspherical surfaces is denoted by GP, the variable magnification optical system preferably satisfies Conditional Expression (44). Ensuring that a corresponding value of Conditional Expression (44) is not less than or equal to its lower limit enables use of an easily obtainable material and thus, achieves an advantage in suppressing fluctuation of the aberrations during changing the magnification. Ensuring that the corresponding value of Conditional Expression (44) is not greater than or equal to its upper limit achieves an advantage in reduction in weight.

$$0.8 < GP < 1.5 \qquad ( 44 )$$

In the configuration in which the intermediate group GM includes the vibration-proof group, in a case where a focal length of the vibration-proof group is denoted by fIS, the variable magnification optical system preferably satisfies Conditional Expression (45). Ensuring that a corresponding value of Conditional Expression (45) is not less than or equal to its lower limit achieves an advantage in reduction of the total length of the optical system. Ensuring that the corresponding value of Conditional Expression (45) is not greater than or equal to its upper limit can secure a refractive power of the vibration-proof group and thus, facilitates suppression of a moving amount of the vibration-proof group during the image shake correction. This achieves an advantage in reduction in size. In order to obtain more favorable characteristics, the variable magnification optical system more preferably satisfies Conditional Expression (45-1) and further preferably satisfies Conditional Expression (45-2).

$$0.1 < \vert fIS / ft \vert < 0.7 \qquad ( 45 )$$

$$0.15 < \vert fIS / ft \vert < 0.65 \qquad ( 45 - 1 )$$

$$0.2 < \vert fIS / ft \vert < 0.6 \qquad ( 45 - 2 )$$

In the configuration in which the vibration-proof group includes the biconvex lens, in a case where an average value of relative densities of all biconvex lenses of the vibration-proof group is denoted by GISave, the variable magnification optical system preferably satisfies Conditional Expression (46). Ensuring that a corresponding value of Conditional Expression (46) is not less than or equal to its lower limit enables use of an easily obtainable material and thus, achieves an advantage in suppressing fluctuation of the aberrations during the image shake correction. Ensuring that the corresponding value of Conditional Expression (46) is not greater than or equal to its upper limit achieves an advantage in reduction of the vibration-proof group in weight. In order to obtain more favorable characteristics, the variable magnification optical system more preferably satisfies Conditional Expression (46-1) and further preferably satisfies Conditional Expression (46-2).

$$2 < GISave < 5 \qquad ( 46 )$$

$$2.25 < GISave < 4.5 \qquad ( 46 - 1 )$$

$$2.5 < GISave < 4 \qquad ( 46 - 2 )$$

In the configuration in which the final lens group GE consists of, in order from the object side to the image side, one negative lens of which the surface on the object side is a concave surface, and one positive lens, the variable magnification optical system preferably satisfies Conditional Expression (47). A paraxial curvature radius of a surface, on the object side, of the negative lens of the final lens group GE is denoted by REnf. A paraxial curvature radius of a surface, on the image side, of the negative lens of the final lens group GE is denoted by REnr. Ensuring that a corresponding value of Conditional Expression (47) is not less than or equal to its lower limit prevents an excessively small absolute value of a curvature radius of the concave surface of the negative lens on the object side and thus, facilitates suppression of stray light caused by reflection on the negative lens. Ensuring that the corresponding value of Conditional Expression (47) is not greater than or equal to its upper limit achieves an advantage in correcting the field curvature. In order to obtain more favorable characteristics, the variable magnification optical system more preferably satisfies Conditional Expression (47-1) and further preferably satisfies Conditional Expression (47-2).

$$- 15 < ( REnf + REnr ) / ( REnf - REnr ) < - 0.1 \qquad ( 47 )$$

$$- 12 < ( REnf + REnr ) / ( REnf - REnr ) < - 0.5 \qquad ( 47 - 1 )$$

$$- 10 < ( REnf + REnr ) / ( REnf - REnr ) < - 1.2 \qquad ( 47 - 1 )$$

In the configuration in which the final lens group GE consists of, in order from the object side to the image side, one negative lens of which the surface on the object side is a concave surface, and one positive lens, the variable magnification optical system preferably satisfies Conditional Expression (48). A paraxial curvature radius of a surface, on the object side, of the positive lens of the final lens group GE is denoted by REpf. A paraxial curvature radius of a surface, on the image side, of the positive lens of the final lens group GE is denoted by REpr. Ensuring that a corresponding value of Conditional Expression (48) is not less than or equal to its lower limit achieves an advantage in correcting the astigmatism. Ensuring that the corresponding value of Conditional Expression (48) is not greater than or equal to its upper limit prevents an excessively short back focus and thus, achieves an advantage in securing an appropriate length of the back focus. In order to obtain more favorable characteristics, the variable magnification optical system more preferably satisfies Conditional Expression (48-1) and further preferably satisfies Conditional Expression (48-2).

$$- 1.3 < ( REpf + REpr ) / ( REpf - REpr ) < - 0.1 \qquad ( 48 )$$

$$- 1.2 < ( REpf + REpr ) / ( REpf - REpr ) < - 0.3 \qquad ( 48 - 1 )$$

$$- 1.1 < ( REpf + REpr ) / ( REpf - REpr ) < - 0.5 \qquad ( 48 - 2 )$$

Moving paths of each lens group that moves during changing the magnification from the wide angle end to the telephoto end may be configured include exactly five or six moving paths that are different from each other. In other words, moving paths of each lens group that moves during changing the magnification may be configured to include five types or six types. Doing so can simplify the drive mechanism for the lens group. For example, as in the examples described later, in a case where there are a plurality of lens groups that move on the same moving path during changing the magnification from the wide angle end to the telephoto end, the number of types of moving paths of the plurality of lens groups is counted as one. In the disclosed technology, in a case where moving paths are different from each other in a partial magnification range in the entire magnification range, the moving paths are considered to be different from each other during changing the magnification from the wide angle end to the telephoto end even in a case where the moving paths are the same in the rest of the magnification range. Naturally, the term “moving path” is related to a lens group that moves during changing the magnification, and is not related to a lens group that is fixed during changing the magnification.

The variable magnification optical system may be configured to include a plurality of lens groups that move on the same moving path during changing the magnification from the wide angle end to the telephoto end. Doing so enables the lens groups that move on the same moving path to be driven by one cam and thus, can simplify the drive mechanism for the lens group. The term “same moving path during changing the magnification from the wide angle end to the telephoto end” means the same moving path in the entire magnification range from the wide angle end to the telephoto end.

In a case where the variable magnification optical system includes the plurality of lens groups that move on the same moving path during changing the magnification from the wide angle end to the telephoto end, at least one lens that moves along the optical axis Z during the focusing may be configured to be disposed between the plurality of lens groups that move on the same moving path. Doing so enables a mechanism for driving during the focusing to be used for driving during changing the magnification, while driving the plurality of lens groups that move on the same moving path and at least one lens that moves along the optical axis Z during the focusing via one cam, and thus, can simplify the drive mechanism. The term “at least one lens that moves along the optical axis Z during the focusing” may mean the focus lens group. For example, in Example 9 described later, during changing the magnification, the fourth lens group G4 and the sixth lens group G6 move on the same moving path, and the fifth lens group G5 that is the focus lens group is disposed between the fourth lens group G4 and the sixth lens group G6.

The example illustrated in FIG. 1 is merely an example, and various modifications can be made without departing from the gist of the disclosed technology. For example, the number of lenses included in each lens group and the number of lens groups included in the intermediate group GM may be different from the numbers in the example in FIG. 1.

For example, the first lens group G1 may be configured to consist of, in order from the object side to the image side, the first lens and the second lens. Doing so achieves an advantage in reduction in size compared to a configuration in which the first lens group G1 consists of three lenses. Alternatively, the first lens group G1 may be configured to consist of one positive lens. Doing so achieves an advantage in further reduction in size.

The second lens group G2 may be configured to consist of, in order from the object side to the image side, a negative lens, a negative lens, a positive lens, and a negative lens. Alternatively, the second lens group G2 may be configured to consist of, in order from the object side to the image side, a negative lens, a negative lens, and a positive lens.

The intermediate group GM preferably consists of a plurality of lens groups including two or more and five or fewer lens groups and is preferably configured to include both of a lens group having a positive refractive power and a lens group having a negative refractive power in the plurality of lens groups. Doing so facilitates suppression of fluctuation of the aberrations during changing the magnification. According to this viewpoint, the intermediate group GM may be configured as follows.

The intermediate group GM may be configured to consist of, in order from the object side to the image side, a lens group having a positive refractive power and a lens group having a negative refractive power. The intermediate group GM may be configured to consist of, in order from the object side to the image side, a lens group having a negative refractive power, a lens group having a positive refractive power, and a lens group having a negative refractive power. The intermediate group GM may be configured to consist of, in order from the object side to the image side, a lens group having a positive refractive power, a lens group having a positive refractive power, and a lens group having a negative refractive power. The intermediate group GM may be configured to consist of, in order from the object side to the image side, a lens group having a positive refractive power, a lens group having a positive refractive power, a lens group having a negative refractive power, and a lens group having a positive refractive power. The intermediate group GM may be configured to consist of, in order from the object side to the image side, a lens group having a positive refractive power, a lens group having a positive refractive power, a lens group having a positive refractive power, and a lens group having a negative refractive power. The intermediate group GM may be configured to consist of, in order from the object side to the image side, a lens group having a positive refractive power, a lens group having a negative refractive power, a lens group having a positive refractive power, and a lens group having a negative refractive power. The intermediate group GM may be configured to consist of, in order from the object side to the image side, a lens group having a positive refractive power, a lens group having a negative refractive power, a lens group having a positive refractive power, a lens group having a negative refractive power, and a lens group having a negative refractive power. The intermediate group GM may be configured to consist of, in order from the object side to the image side, a lens group having a positive refractive power, a lens group having a positive refractive power, a lens group having a positive refractive power, a lens group having a negative refractive power, and a lens group having a negative refractive power.

In a case where the intermediate group GM consists of, in order from the object side to the image side, a lens group having a positive refractive power, a lens group having a negative refractive power, a lens group having a positive refractive power, a lens group having a negative refractive power, and a lens group having a negative refractive power, the final lens group GE is preferably fixed with respect to the image plane Sim. In a case where the intermediate group GM consists of, in order from the object side to the image side, a lens group having a positive refractive power, a lens group having a positive refractive power, a lens group having a positive refractive power, a lens group having a negative refractive power, and a lens group having a negative refractive power, the final lens group GE is preferably fixed with respect to the image plane Sim.

The final lens group GE may be configured to consist of one positive lens. Alternatively, the final lens group GE may be configured to consist of one negative lens.

The focus lens group may be configured to be a lens group that is the second from the image side in the intermediate group GM. The focus lens group and the vibration-proof group may be consecutively disposed or may be non-consecutively disposed.

The variable magnification optical system of the present disclosure may be a zoom lens or a varifocal lens.

The above preferable configurations and available configurations can be combined with each other in any manner and are preferably selectively adopted, as appropriate, in accordance with required specifications. The conditional expressions preferably satisfied by the variable magnification optical system of the present disclosure are not limited to the conditional expressions described in expression forms and include all conditional expressions obtained by combining the lower limits and the upper limits with each other in any manner from the preferable, more preferable, further preferable, and still more preferable conditional expressions.

According to a preferable first aspect of the present disclosure, there is provided a variable magnification optical system consisting of, in order from the object side to the image side, the first lens group G1 having a positive refractive power, the second lens group G2 having a negative refractive power, the intermediate group GM, and the final lens group GE having a refractive power, in which the intermediate group GM consists of two or more and five or fewer lens groups, during changing the magnification, the spacing between the first lens group G1 and the second lens group G2 changes, the spacing between the second lens group G2 and the intermediate group GM changes, the spacing between the intermediate group GM and the final lens group GE changes, and all spacings between the adjacent lens groups in the intermediate group GM change, and Conditional Expression (1) is satisfied.

According to a preferable second aspect of the present disclosure, there is provided a variable magnification optical system having the configuration of the first aspect, in which the first lens group G1 includes at least two lenses, and Conditional Expressions (2-3), (3), (4-2), and (5) are satisfied.

Next, examples of the variable magnification optical system of the present disclosure will be described with reference to the drawings. Reference numerals provided to the lenses in the cross-sectional view of each example are independently used for each example in order to avoid complication of description and the drawings caused by an increasing number of digits of the reference numerals. Accordingly, a common reference numeral provided in the drawings of different examples does not necessarily indicate a common configuration.

### Example 1

A configuration and a moving path of the variable magnification optical system of Example 1 are illustrated in FIG. 1, and its illustration method and configuration are the same as described above. Thus, duplicate descriptions will be partially omitted. The variable magnification optical system of Example 1 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a negative refractive power. The intermediate group GM consists of the third lens group G3 and the fourth lens group G4. The final lens group GE consists of the fifth lens group G5. During changing the magnification from the wide angle end to the telephoto end, the five lens groups move on different moving paths along the optical axis Z by changing spacings with respect to adjacent lens groups. The vibration-proof group consists of one lens closest to the image side in the third lens group G3. The focus lens group consists of the fourth lens group G4 and moves to the image side during the focusing from the infinite distance object to the short range object.

For the variable magnification optical system of Example 1, Table 1 shows basic lens data, Table 2 shows specifications and a variable surface spacing, and Table 3 shows aspherical coefficients. The table of the basic lens data is described as follows. A column of Sn shows surface numbers in a case where the number is increased by one at a time toward the image side from a surface closest to the object side as a first surface. A column of R shows a curvature radius of each surface. A column of D shows a surface spacing on the optical axis between each surface and its adjacent surface on the image side. A column of Nd shows a refractive index with respect to a d line for each constituent. A column of vd shows an Abbe number based on the d line for each constituent. A column of ED shows effective diameters of a lens surface closest to the object side and a lens surface closest to the image side. A column of SG shows a relative density of a lens related to the conditional expressions including a relative density. The rightmost column of a row corresponding to the plastic lenses of which the surface on the object side and the surface on the image side are aspherical surfaces shows “Pla”.

In the table of the basic lens data, a sign of the curvature radius of the surface having a convex shape facing the object side is positive, and a sign of the curvature radius of the surface having a convex shape facing the image side is negative. In Table 1, a field of the surface number of the surface corresponding to the aperture stop St shows the surface number and a text (St). A value in the lowermost field of the column ofD in the table indicates a spacing between a surface closest to the image side in the table and the image plane Sim. A symbol DD[ ]is used for the variable surface spacing. A surface number on the object side of the spacing is provided in [ ] in the column of the surface spacing.

Table 2 shows a zoom ratio Zr, a focal length f, a back focus Bf as an air conversion distance, an open F-number FNo., a maximum full angle of view 2o, and the variable surface spacing based on the d line. In a case where the variable magnification optical system is a zoom lens, the zoom ratio is synonymous with a zoom magnification. In a field of 2ω, [° ] indicates a degree unit. Table 2 shows each value of the wide angle end state, a middle focal length state, and the telephoto end state in columns labeled “Wide”, “Middle”, and “Tele”, respectively.

In the basic lens data, a surface number of an aspherical surface is marked with *, and a value of a paraxial curvature radius is shown in a field of the curvature radius of the aspherical surface. In Table 3, the column of Sn shows the surface number of the aspherical surface, and columns of KA and Am show a numerical value of the aspherical coefficient for each aspherical surface. m in Am is an integer greater than or equal to 3 and varies depending on the surface. For example, m=3, 4, 5, 6, 7, 8, 9, and 10 is established for an eleventh surface of Example 1. In the numerical value of the aspherical coefficient in Table 3, “E±n” (n: integer) means “×10^{±n}”. KA and Am are aspherical coefficients in an aspheric equation represented by the following expression.

$$Z d = C \times {h}^{2} / \{ 1 + {( 1 - K A \times {C}^{2} \times {h}^{2} )}^{1 / 2} \} + Σ A m \times {h}^{m}$$

where
Zd: a depth of the aspherical surface (a length of a perpendicular line drawn from a point on the aspherical surface at a height h to a plane that is in contact with an aspherical surface apex and that is perpendicular to the optical axis Z)
h: a height (a distance from the optical axis Z to the lens surface)
C: a reciprocal of the paraxial curvature radius
KA and Am: aspherical coefficients
∈ in the aspheric equation means a sum total related to m.

In the data of each table, a degree unit is used for angles, and a millimeter unit is used for lengths. However, since the optical system can also be proportionally enlarged or proportionally reduced to be used, other appropriate units can also be used. Numerical values rounded to predetermined digits are described in each table shown below.

TABLE 1
Example 1

| Sn | R | D | Nd | νd | ED | SG | |
|---|---|---|---|---|---|---|---|
| 1 | 39.8414 | 0.8488 | 1.97314 | 16.44 | 34.00 | 4.62 | |
| 2 | 33.8970 | 3.3817 | 1.49782 | 82.57 | | 3.86 | |
| 3 | 65.3117 | 0.1000 | | | | | |
| 4 | 39.1089 | 3.4787 | 1.57373 | 69.92 | | | |
| 5 | 167.5854 | DD[5] | | | | | |
| 6 | 32.0688 | 0.5706 | 1.90552 | 38.26 | | | |
| 7 | 9.7301 | 5.7252 | | | | | |
| 8 | −41.2372 | 0.5056 | 1.79721 | 49.34 | | | |
| 9 | 138.5597 | 2.2452 | 2.00001 | 15.00 | | | |
| 10 | −36.6631 | 2.9118 | | | | | |
| *11 | −18.2422 | 0.7549 | 1.53409 | 55.87 | | 1.01 | Pla |
| *12 | −83.8196 | DD[12] | | | | | |
| 13 (St) | ∞ | 0.2498 | | | | | |
| *14 | 14.7643 | 4.3693 | 1.62683 | 60.08 | | | |
| *15 | −52.1230 | 3.1232 | | | | | |
| 16 | 22.5783 | 0.4620 | 1.95389 | 23.91 | | | |
| 17 | 9.2654 | 1.9974 | 1.44196 | 65.88 | | | |
| 18 | 23.7664 | 1.8864 | | | | | |
| *19 | 14.5885 | 3.5813 | 1.50444 | 69.58 | | 2.89 | |
| *20 | −19.8354 | DD[20] | | | | | |
| 21 | 74.4121 | 1.2221 | 1.99577 | 16.14 | | | |
| 22 | 347.8901 | 0.5032 | 1.64517 | 60.41 | | | |
| 23 | 16.2997 | DD[23] | | | | | |
| 24 | −116.1456 | 2.1504 | 1.48845 | 57.17 | | | |
| 25 | −32.2538 | 0.1283 | | | | | |
| 26 | −35.2644 | 0.9998 | 1.57912 | 69.10 | | | |
| 27 | 109.6980 | DD[27] | | | 19.92 | | |

TABLE 2
Example 1

| | Wide | Middle | Tele |
|---|---|---|---|
| Zr | 1.0 | 2.4 | 4.7 |
| f | 16.41 | 38.82 | 77.28 |
| Bf | 10.68 | 13.70 | 39.78 |
| FNo. | 4.11 | 5.19 | 7.19 |
| 2ω[°] | 84.0 | 38.0 | 19.8 |
| DD[5] | 0.09 | 15.25 | 26.39 |
| DD[12] | 13.52 | 3.41 | 1.82 |
| DD[20] | 0.41 | 2.72 | 0.41 |
| DD[23] | 11.21 | 14.38 | 6.32 |
| DD[27] | 10.68 | 13.70 | 39.78 |

TABLE 3
Example 1

| Sn | 11 | 12 | 14 | 15 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.7621994E−04 | −2.2536504E−04 | −9.4842288E−05 | −6.4324131E−05 |
| A5 | −7.1362665E−06 | −5.3962879E−06 | −8.9349624E−08 | 3.3326408E−06 |
| A6 | 3.3521926E−06 | 3.2436990E−06 | −1.1615398E−06 | −2.3095175E−06 |
| A7 | −8.0086542E−11 | −7.9492452E−09 | 1.5058188E−08 | 3.6101825E−07 |
| A8 | −3.3870173E−08 | −3.5987282E−08 | 1.8604699E−08 | −2.3185104E−08 |
| A9 | −6.9996578E−10 | −9.6114165E−11 | −1.6263810E−09 | −4.3962972E−09 |
| A10 | 2.0281790E−10 | 1.9827207E−10 | −4.8943783E−10 | 2.4349976E−10 |

| Sn | 19 | 20 |
|---|---|---|
| KA | 1.0000000E+00 | 1.0000000E+00 |
| A3 | 0.0000000E+00 | 0.0000000E+00 |
| A4 | −9.9603966E−05 | 2.5775847E−05 |
| A5 | 3.5411243E−06 | 2.8542653E−06 |
| A6 | 5.3664507E−06 | 4.0418433E−06 |
| A7 | −2.5184963E−06 | −1.9743651E−06 |
| A8 | 4.4574574E−07 | 3.3717935E−07 |
| A9 | −3.2624424E−08 | −2.2271322E−08 |
| A10 | 5.5263937E−10 | 1.7008665E−10 |

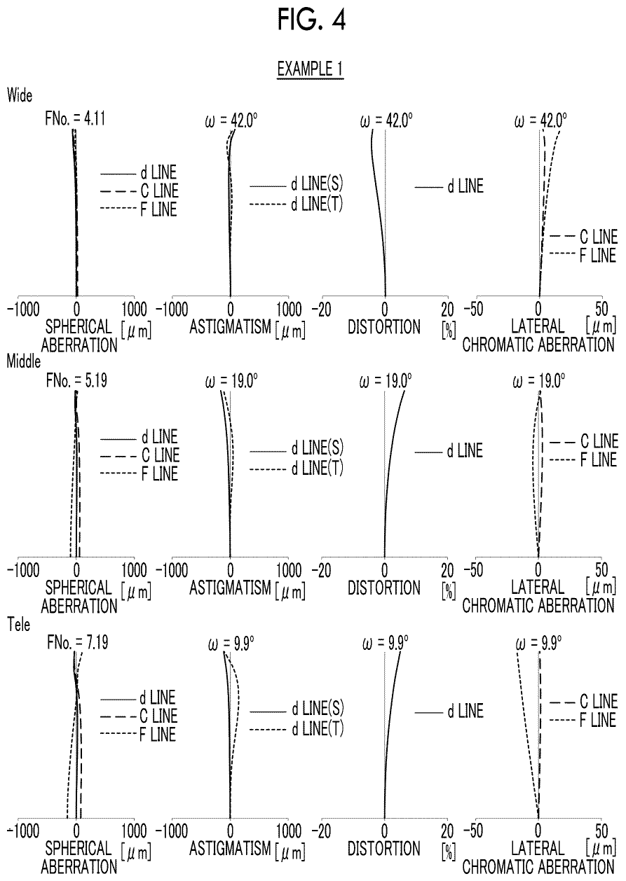

FIG. 4 illustrates each aberration diagram of the variable magnification optical system of Example 1 in the state where the infinite distance object is in focus. In FIG. 4, the spherical aberration, the astigmatism, the distortion, and the lateral chromatic aberration are illustrated in this order from the left. In FIG. 4, the aberrations in the wide angle end state are illustrated in an upper part labeled “Wide”, the aberrations in the middle focal length state are illustrated in a middle part labeled “Middle”, and the aberrations in the telephoto end state are illustrated in a lower part labeled “Tele”. In the spherical aberration diagram, aberrations on ad line, a C line, and an F line are illustrated by a solid line, a long broken line, and a short broken line, respectively. In the astigmatism diagram, an aberration on the d line in a sagittal direction is illustrated by a solid line, and an aberration on the d line in a tangential direction is illustrated by a short broken line. In the distortion diagram, an aberration on the d line is illustrated by a solid line. In the lateral chromatic aberration diagram, aberrations on the C line and the F line are illustrated by a long broken line and a short broken line, respectively. In the spherical aberration diagram, a value of the open F-number is shown after “FNo.=”. In other aberration diagrams, a value of the maximum half angle of view is shown after ω=.

Symbols, meanings, description methods, and illustration methods of each data related to Example 1 are basically the same for the following examples unless otherwise specified. Thus, duplicate descriptions will be omitted below.

### Example 2

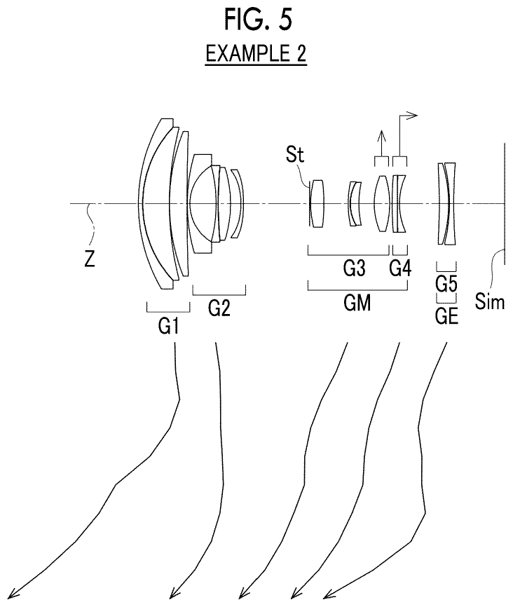

A configuration and a moving path of a variable magnification optical system of Example 2 are illustrated in FIG. 5. The variable magnification optical system of Example 2 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a negative refractive power. The intermediate group GM consists of the third lens group G3 and the fourth lens group G4. The final lens group GE consists of the fifth lens group G5. During changing the magnification from the wide angle end to the telephoto end, the five lens groups move on different moving paths along the optical axis Z by changing spacings with respect to adjacent lens groups. The vibration-proof group consists of one lens closest to the image side in the third lens group G3. The focus lens group consists of the fourth lens group G4 and moves to the image side during the focusing from the infinite distance object to the short range object.

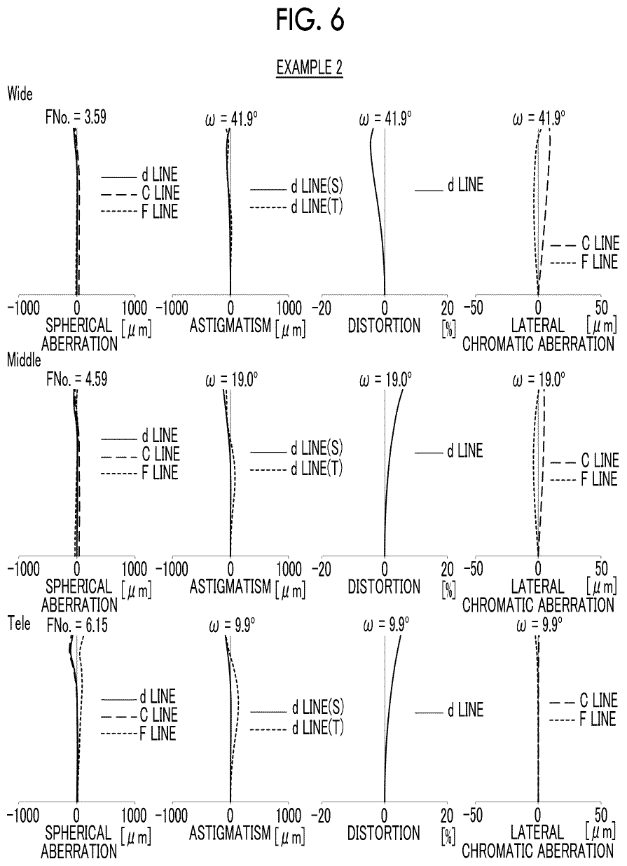

For the variable magnification optical system of Example 2, Table 4 shows basic lens data, Table 5 shows specifications and a variable surface spacing, Table 6 shows aspherical coefficients, and FIG. 6 illustrates each aberration diagram.

TABLE 4
Example 2

| Sn | R | D | Nd | νd | ED | SG |
|---|---|---|---|---|---|---|
| 1 | 39.5201 | 1.0092 | 1.60414 | 37.86 | 40.00 | 2.53 |
| 2 | 26.2100 | 6.2806 | 1.49260 | 82.28 | | 3.52 |
| 3 | 70.0136 | 0.0115 | | | | |
| 4 | 45.9762 | 4.1397 | 1.44040 | 90.23 | | |
| 5 | 498.7173 | DD[5] | | | | |
| 6 | 41.2776 | 0.6011 | 1.91693 | 37.10 | | |
| 7 | 10.4548 | 6.1741 | | | | |
| 8 | −35.3957 | 0.5084 | 1.87150 | 41.74 | | |
| 9 | 97.4628 | 2.8804 | 1.92603 | 18.70 | | |
| 10 | −28.3411 | 2.4529 | | | | |
| *11 | −18.4103 | 0.5900 | 1.61229 | 44.93 | | |
| *12 | −39.6107 | DD[12] | | | | |
| 13 (St) | ∞ | 0.2498 | | | | |
| *14 | 19.1976 | 3.1182 | 1.62521 | 53.15 | | |
| *15 | −55.9168 | 5.7172 | | | | |
| 16 | 23.3961 | 0.4976 | 1.94472 | 21.14 | | |
| 17 | 9.9626 | 2.0333 | 1.58030 | 39.97 | | |
| 18 | 23.5693 | 3.5931 | | | | |
| *19 | 15.2553 | 3.6412 | 1.51062 | 79.53 | | 3.57 |
| *20 | −20.7690 | DD[20] | | | | |
| 21 | 88.4889 | 1.2188 | 2.00001 | 15.00 | | |
| 22 | 428.2944 | 0.5075 | 1.62072 | 62.42 | | |
| 23 | 15.8378 | DD[23] | | | | |
| 24 | −147.2898 | 2.1924 | 1.43600 | 67.00 | | |
| 25 | −31.2724 | 0.2000 | | | | |
| 26 | −38.2286 | 0.9998 | 1.60825 | 64.55 | | |
| 27 | 126.7869 | DD[27] | | | 19.19 | |

TABLE 5
Example 2

| | Wide | Middle | Tele |
|---|---|---|---|
| Zr | 1.0 | 2.4 | 4.7 |
| f | 16.46 | 38.93 | 77.52 |
| Bf | 11.99 | 17.88 | 40.90 |
| FNo. | 3.59 | 4.59 | 6.15 |
| 2ω[°] | 83.8 | 38.0 | 19.8 |
| DD[5] | 0.07 | 15.75 | 28.49 |
| DD[12] | 15.43 | 3.52 | 0.87 |
| DD[20] | 0.59 | 2.09 | 0.48 |
| DD[23] | 9.37 | 12.10 | 5.87 |
| DD[27] | 11.99 | 17.88 | 40.90 |

TABLE 6
Example 2

| Sn | 11 | 12 | 14 | 15 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.8991283E−04 | −2.2269047E−04 | −8.8739146E−05 | −7.2864670E−05 |
| A5 | −7.2393010E−06 | −5.4814525E−06 | −4.8871735E−08 | 3.0741780E−06 |
| A6 | 3.3763409E−06 | 3.2277328E−06 | −1.1818299E−06 | −2.3684187E−06 |
| A7 | 4.7844470E−09 | −9.8967125E−09 | 1.2385635E−08 | 3.5883277E−07 |
| A8 | −3.3820227E−08 | −3.5215637E−08 | 1.7676027E−08 | −2.0565197E−08 |
| A9 | −8.7298826E−10 | 9.5884262E−11 | −1.3947147E−09 | −3.6285423E−09 |
| A10 | 2.0745048E−10 | 1.5454738E−10 | −5.7099741E−10 | −1.8130049E−11 |

| Sn | 19 | 20 |
|---|---|---|
| KA | 1.0000000E+00 | 1.0000000E+00 |
| A3 | 0.0000000E+00 | 0.0000000E+00 |
| A4 | −9.5181852E−05 | 1.6433911E−05 |
| A5 | 3.0859316E−06 | 2.7115539E−06 |
| A6 | 5.3651158E−06 | 4.0272351E−06 |
| A7 | −2.5188996E−06 | −1.9765097E−06 |
| A8 | 4.4468834E−07 | 3.3665343E−07 |
| A9 | −3.3008952E−08 | −2.2235830E−08 |
| A10 | 6.3564355E−10 | 2.0368645E−10 |

### Example 3

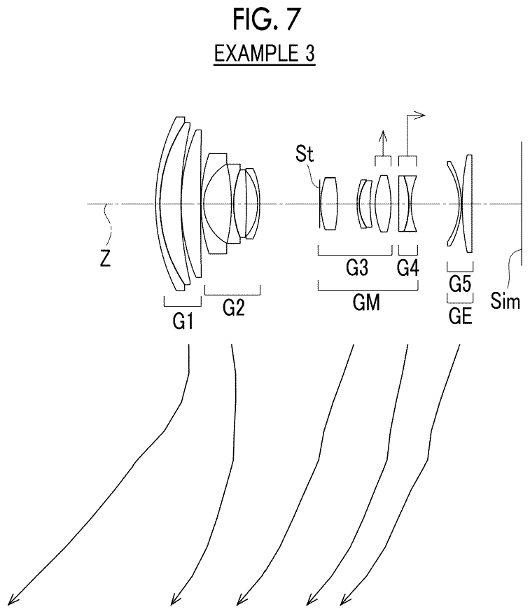

A configuration and a moving path of a variable magnification optical system of Example 3 are illustrated in FIG. 7. The variable magnification optical system of Example 3 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a positive refractive power. The intermediate group GM consists of the third lens group G3 and the fourth lens group G4. The final lens group GE consists of the fifth lens group G5. During changing the magnification from the wide angle end to the telephoto end, the five lens groups move on different moving paths along the optical axis Z by changing spacings with respect to adjacent lens groups. The vibration-proof group consists of one lens closest to the image side in the third lens group G3. The focus lens group consists of the fourth lens group G4 and moves to the image side during the focusing from the infinite distance object to the short range object.

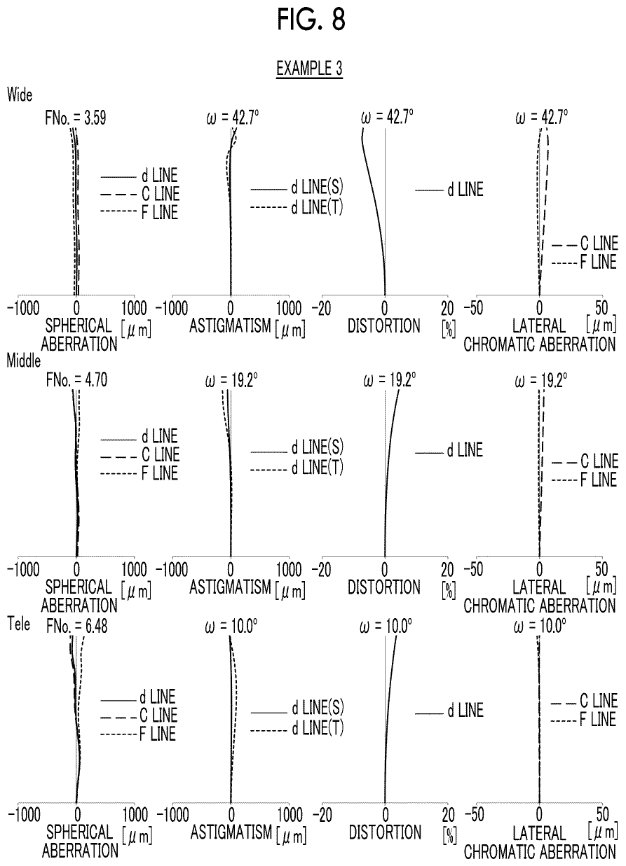

For the variable magnification optical system of Example 3, Table 7 shows basic lens data, Table 8 shows specifications and a variable surface spacing, Table 9 shows aspherical coefficients, and FIG. 8 illustrates each aberration diagram.

TABLE 7
Example 3

| Sn | R | D | No | νd | ED | SG |
|---|---|---|---|---|---|---|
| 1 | 44.3766 | 0.9999 | 1.96717 | 31.96 | 40.00 | 5.38 |
| 2 | 33.3330 | 4.8604 | 1.49742 | 81.54 | | 3.55 |
| 3 | 77.3150 | 0.0460 | | | | |
| 4 | 43.6700 | 4.5002 | 1.49964 | 81.20 | | |
| 5 | 954.0526 | DD[5] | | | | |
| 6 | 36.6737 | 0.5994 | 1.81772 | 47.25 | | |
| 7 | 10.4358 | 6.4170 | | | | |
| 8 | −40.9332 | 0.5099 | 1.76619 | 52.52 | | |
| 9 | 21.0190 | 2.9649 | 1.86377 | 21.81 | | |
| 10 | −118.6894 | 2.5736 | | | | |
| *11 | −13.4567 | 0.5043 | 1.44914 | 88.90 | | |
| *12 | −32.4970 | DD[12] | | | | |
| 13 (St) | 00 | 0.2498 | | | | |
| *14 | 16.2616 | 3.8503 | 1.55371 | 72.97 | | |
| *15 | −39.3579 | 4.5336 | | | | |
| 16 | 16.4971 | 0.4996 | 1.98238 | 23.99 | | |
| 17 | 9.5210 | 2.5000 | 1.45018 | 66.09 | | |
| 18 | 32.2734 | 1.1834 | | | | |
| *19 | 15.8994 | 3.6597 | 1.43599 | 90.90 | | 3.15 |
| *20 | −22.1896 | DD[20] | | | | |
| 21 | −27539.2970 | 2.3309 | 1.94963 | 24.18 | | |
| 22 | −18.5915 | 0.5098 | 1.80165 | 48.89 | | |
| 23 | 16.3770 | DD[23] | | | | |
| 24 | −15.7492 | 0.4998 | 1.87646 | 21.18 | | |
| 25 | −19.9783 | 0.2000 | | | | |
| 26 | 54.4601 | 2.2502 | 1.79586 | 49.48 | | |
| 27 | ∞ | DD[27] | | | 22.40 | |

TABLE 8
Example 3

| | Wide | Middle | Tele |
|---|---|---|---|
| Zr | 1.0 | 2.4 | 4.7 |
| f | 16.50 | 39.03 | 77.71 |
| Bf | 11.50 | 22.70 | 39.03 |
| FNo. | 3.59 | 4.70 | 6.48 |
| 2ω[°] | 85.4 | 38.4 | 20.0 |
| DD[5] | 0.10 | 15.69 | 27.84 |
| DD[12] | 13.72 | 4.10 | 0.90 |
| DD[20] | 1.80 | 5.32 | 5.30 |
| DD[23] | 11.11 | 7.48 | 6.87 |
| DD[27] | 11.50 | 22.70 | 39.03 |

TABLE 9
Example 3

| Sn | 11 | 12 | 14 | 15 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.6277319E−04 | −1.9539313E−04 | −6.9440858E−05 | −1.7166172E−05 |
| A5 | −4.6593165E−06 | −3.4685805E−06 | 2.9628264E−06 | 9.9364012E−07 |
| A6 | 2.9975821E−06 | 3.1664290E−06 | −1.5939235E−06 | −1.8891733E−06 |
| A7 | −2.5752323E−08 | −6.8301538E−08 | 4.3727385E−08 | 3.3790300E−07 |
| A8 | −3.6596293E−08 | −4.1060933E−08 | 2.3324346E−08 | −1.6494733E−08 |
| A9 | −1.3640872E−09 | 9.6556790E−10 | −1.7035509E−09 | −3.0127561E−09 |
| A10 | 3.9084880E−10 | 2.2823428E−10 | −4.6311918E−10 | −7.8919724E−11 |

| Sn | 19 | 20 |
|---|---|---|
| KA | 1.0000000E+00 | 1.0000000E+00 |
| A3 | 0.0000000E+00 | 0.0000000E+00 |
| A4 | −4.5014476E−05 | 5.5128769E−05 |
| A5 | −3.0388018E−06 | −5.4584685E−06 |
| A6 | 5.6454037E−06 | 5.0161608E−06 |
| A7 | −2.3685446E−06 | −1.9443752E−06 |
| A8 | 4.3673532E−07 | 3.3203597E−07 |
| A9 | −3.4414567E−08 | −2.2810813E−08 |
| A10 | 6.5034734E−10 | 1.3264971E−10 |

### Example 4

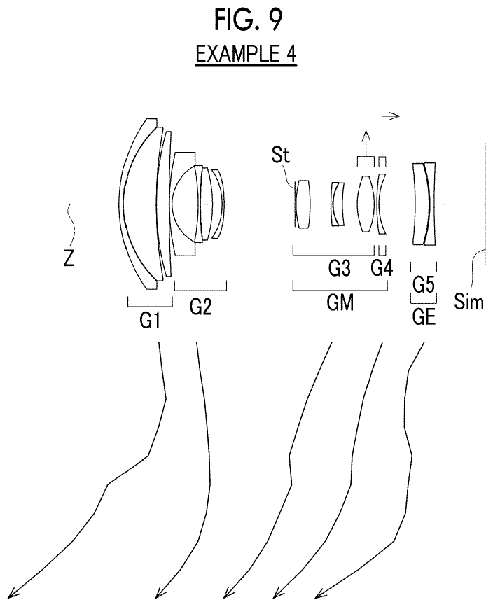

A configuration and a moving path of a variable magnification optical system of Example 4 are illustrated in FIG. 9. The variable magnification optical system of Example 4 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a negative refractive power. The intermediate group GM consists of the third lens group G3 and the fourth lens group G4. The final lens group GE consists of the fifth lens group G5. During changing the magnification from the wide angle end to the telephoto end, the five lens groups move on different moving paths along the optical axis Z by changing spacings with respect to adjacent lens groups. The vibration-proof group consists of one lens closest to the image side in the third lens group G3. The focus lens group consists of the fourth lens group G4 and moves to the image side during the focusing from the infinite distance object to the short range object.

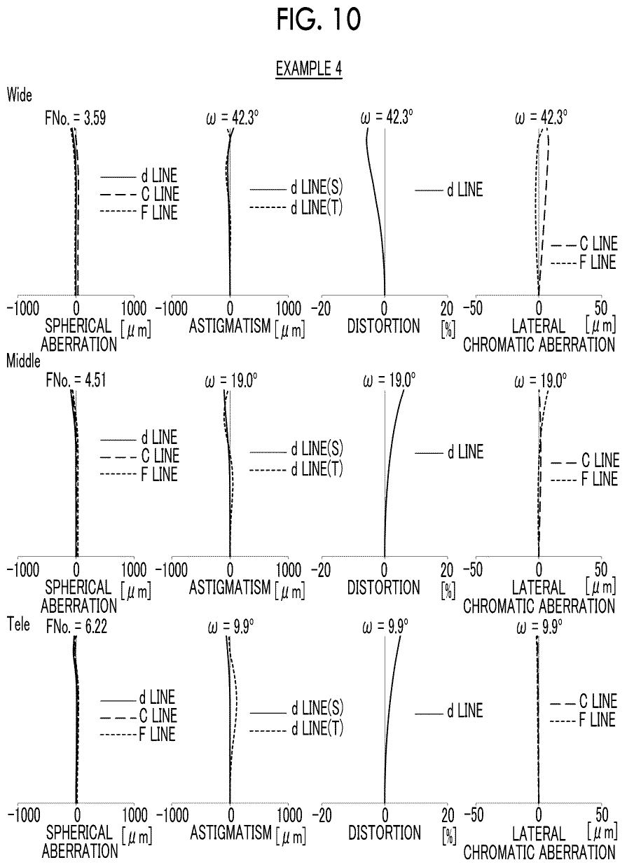

For the variable magnification optical system of Example 4, Table 10 shows basic lens data, Table 11 shows specifications and a variable surface spacing, Table 12 shows aspherical coefficients, and FIG. 10 illustrates each aberration diagram.

TABLE 10
Example 4

| Sn | R | D | Nd | νd | ED | SG |
|---|---|---|---|---|---|---|
| 1 | 34.3955 | 1.0095 | 1.63929 | 36.52 | 40.00 | 5.38 |
| 2 | 24.6615 | 7.6756 | 1.47193 | 85.42 | | 3.55 |
| 3 | 96.8722 | 0.0222 | | | | |
| 4 | 62.6618 | 2.9998 | 1.48497 | 83.44 | | |
| 5 | 306.9664 | DD[5] | | | | |
| 6 | 52.5208 | 0.6295 | 1.82215 | 46.79 | | |
| 7 | 10.1587 | 6.1520 | | | | |
| 8 | −46.2268 | 0.4992 | 1.93219 | 35.53 | | |
| 9 | 72.5149 | 2.8819 | 1.89053 | 20.47 | | |
| 10 | −30.2855 | 2.2424 | | | | |
| *11 | −17.9751 | 0.4994 | 1.54061 | 50.19 | | |
| *12 | −41.8454 | DD[12] | | | | |
| 13 (St) | ∞ | 0.2498 | | | | |
| *14 | 19.0338 | 3.3207 | 1.73855 | 53.71 | | |
| *15 | −44.3699 | 4.9092 | | | | |
| 16 | 45.6705 | 0.4993 | 1.86486 | 28.53 | | |
| 17 | 9.7649 | 2.2026 | 1.49890 | 59.23 | | |
| 18 | 31.4238 | 3.4897 | | | | |
| *19 | 15.1992 | 3.8815 | 1.43599 | 90.90 | | 3.15 |
| *20 | −17.2063 | DD[20] | | | | |
| 21 | 48.7992 | 0.4994 | 1.50183 | 80.87 | | |
| 22 | 16.2111 | DD[22] | | | | |
| 23 | −74.8685 | 3.2686 | 1.84975 | 22.51 | | |
| 24 | −32.0471 | 0.2000 | | | | |
| 25 | −32.9127 | 1.0000 | 1.72972 | 56.23 | | |
| 26 | 171.2480 | DD[26] | | | 19.22 | |

TABLE 11
Example 4

| | Wide | Middle | Tele |
|---|---|---|---|
| Zr | 1.0 | 2.4 | 4.7 |
| f | 16.48 | 38.99 | 77.62 |
| Bf | 12.00 | 15.78 | 37.51 |
| FNo. | 3.59 | 4.51 | 6.22 |
| 2ω[°] | 84.6 | 38.0 | 19.8 |
| DD[5] | 0.07 | 15.18 | 25.85 |
| DD[12] | 16.69 | 4.08 | 0.90 |
| DD[20] | 0.62 | 2.77 | 0.49 |
| DD[22] | 8.54 | 12.05 | 8.55 |
| DD[26] | 12.00 | 15.78 | 37.51 |

TABLE 12
Example 4

| Sn | 11 | 12 | 14 | 15 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.8836005E−04 | −2.3219223E−04 | −8.8278059E−05 | −6.6900781E−05 |
| A5 | −7.1660479E−06 | −5.7322214E−06 | 1.0382107E−07 | 3.0846476E−06 |
| A6 | 3.3664297E−06 | 3.2273044E−06 | −1.1922998E−06 | −2.3582085E−06 |
| A7 | 4.2625142E−09 | −1.0472966E−08 | 1.2452452E−08 | 3.6239116E−07 |
| A8 | −3.3772224E−08 | −3.5358255E−08 | 1.7984305E−08 | −1.9634044E−08 |
| A9 | −8.5670669E−10 | 7.1100361E−11 | −1.2465709E−09 | −3.6235724E−09 |
| A10 | 2.0571630E−10 | 1.5866515E−10 | −6.0162333E−10 | −4.0990011E−11 |

| Sn | 19 | 20 |
|---|---|---|
| KA | 1.0000000E+00 | 1.0000000E+00 |
| A3 | 0.0000000E+00 | 0.0000000E+00 |
| A4 | −1.1384858E−04 | 1.5134968E−05 |
| A5 | 3.1293080E−06 | 2.4030202E−06 |
| A6 | 5.3652078E−06 | 4.0275174E−06 |
| A7 | −2.5202452E−06 | −1.9744364E−06 |
| A8 | 4.4454931E−07 | 3.3696540E−07 |
| A9 | −3.2861971E−08 | −2.2306417E−08 |
| A10 | 6.2222909E−10 | 2.0200405E−10 |

### Example 5

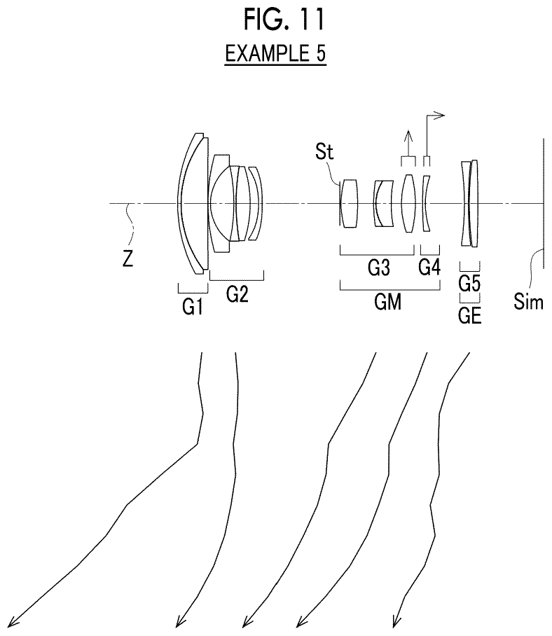

A configuration and a moving path of a variable magnification optical system of Example 5 are illustrated in FIG. 11. The variable magnification optical system of Example 5 consists of, in order from the object side to the image side, the first lens group G1 having a positive refractive power, the second lens group G2 having a negative refractive power, the third lens group G3 having a positive refractive power, the fourth lens group G4 having a negative refractive power, and the fifth lens group G5 having a negative refractive power. The intermediate group GM consists of the third lens group G3 and the fourth lens group G4. The final lens group GE consists of the fifth lens group G5. During changing the magnification from the wide angle end to the telephoto end, the five lens groups move on different moving paths along the optical axis Z by changing spacings with respect to adjacent lens groups. The vibration-proof group consists of one lens closest to the image side in the third lens group G3. The focus lens group consists of the fourth lens group G4 and moves to the image side during the focusing from the infinite distance object to the short range object.

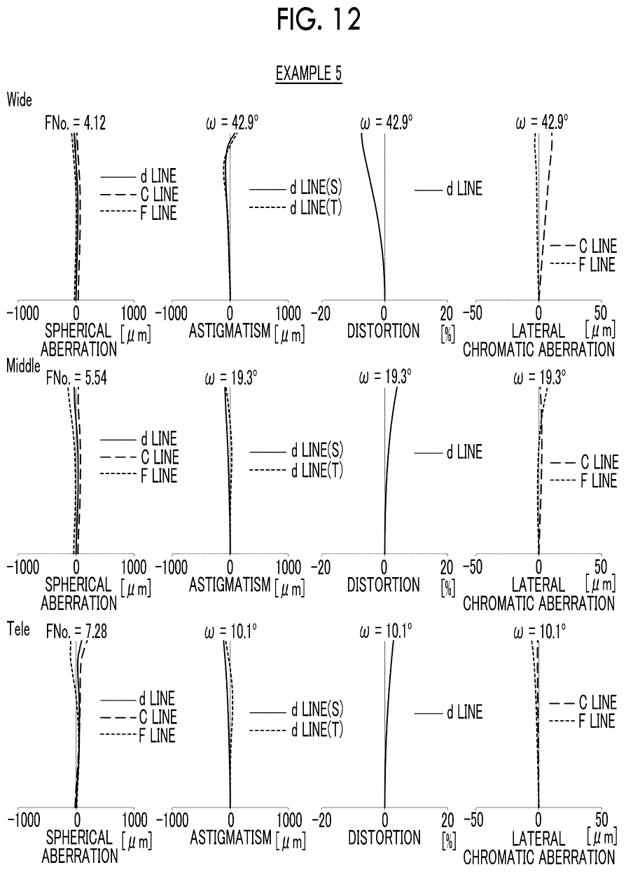

For the variable magnification optical system of Example 5, Table 13 shows basic lens data, Table 14 shows specifications and a variable surface spacing, Table 15 shows aspherical coefficients, and FIG. 12 illustrates each aberration diagram.

TABLE 13
Example 5

| Sn | R | D | Nd | νd | ED | SG | |
|---|---|---|---|---|---|---|---|
| 1 | 32.1104 | 0.7494 | 1.78835 | 36.13 | 30.80 | 4.08 | |
| 2 | 23.7961 | 5.8509 | 1.48749 | 70.32 | | 2.45 | |
| 3 | 2050.7815 | DD[3] | | | | | |
| 4 | 39.3974 | 0.5400 | 1.93897 | 34.84 | | | |
| 5 | 10.2194 | 5.1140 | | | | | |
| 6 | −39.6912 | 0.4978 | 1.83464 | 45.51 | | | |
| 7 | 48.3428 | 0.0020 | | | | | |
| 8 | 48.3428 | 3.0854 | 1.95250 | 17.38 | | | |
| 9 | −26.9622 | 1.8605 | | | | | |
| *10 | −17.8335 | 0.7864 | 1.66121 | 20.35 | | 1.23 | Pla |
| *11 | −44.1291 | DD[11] | | | | | |
| 12 (St) | ∞ | 0.2499 | | | | | |
| *13 | 16.3221 | 3.6377 | 1.75128 | 52.21 | | | |
| *14 | −52.4590 | 3.5177 | | | | | |
| 15 | 30.7414 | 0.4997 | 1.91879 | 28.72 | | | |
| 16 | 8.9144 | 3.3413 | 1.43600 | 73.11 | | | |
| 17 | 26.6027 | 2.2593 | | | | | |
| *18 | 17.6968 | 3.0349 | 1.51008 | 75.24 | | 3.25 | |
| *19 | −25.6308 | DD[19] | | | | | |
| 20 | 75.5277 | 0.6102 | 1.56537 | 71.19 | | | |
| 21 | 18.4014 | DD[21] | | | | | |
| *22 | −62.5007 | 0.8750 | 1.53409 | 55.87 | | 1.01 | Pla |
| *23 | 83.3347 | 0.2000 | | | | | |
| 24 | 72.2840 | 1.8736 | 1.82608 | 23.70 | | | |
| 25 | −249.9751 | DD[25] | | | 18.937 | | |

TABLE 14
Example 5

| | Wide | Middle | Tele |
|---|---|---|---|
| Zr | 1.0 | 2.4 | 4.7 |
| f | 16.47 | 38.95 | 77.55 |
| Bf | 14.40 | 22.96 | 31.05 |
| FNo. | 4.12 | 5.54 | 7.27 |
| 2ω[°] | 86.0 | 38.6 | 20.2 |
| DD[3] | 0.05 | 15.47 | 29.47 |
| DD[11] | 16.88 | 5.06 | 0.85 |
| DD[19] | 1.59 | 3.82 | 2.10 |
| DD[21] | 8.56 | 10.56 | 20.37 |
| DD[25] | 14.40 | 22.96 | 31.05 |

TABLE 15
Example 5

| Sn | 10 | 11 | 13 | 14 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.7903841E−04 | −2.1849964E−04 | −1.2094863E−04 | −9.9578081E−05 |
| A5 | −7.3937545E−06 | −5.5096726E−06 | 3.7935569E−06 | 2.8436864E−06 |
| A6 | 3.3430142E−06 | 3.1855933E−06 | −2.1020666E−06 | −2.4197271E−06 |
| A7 | 1.8349740E−09 | −1.5095953E−08 | −5.4037862E−08 | 3.0601843E−07 |
| A8 | −3.3953363E−08 | −3.5625003E−08 | 4.1123123E−08 | −3.6429743E−08 |
| A9 | −8.4623664E−10 | 2.0020654E−10 | −4.1085959E−09 | −1.2756968E−09 |
| A10 | 2.2771719E−10 | 1.6786606E−10 | −8.2037084E−10 | −2.5737079E−10 |

| Sn | 18 | 19 |
|---|---|---|
| KA | 1.0000000E+00 | 1.0000000E+00 |
| A3 | 0.0000000E+00 | 0.0000000E+00 |
| A4 | −7.8306477E−05 | −3.3317212E−06 |
| A5 | 3.4495453E−06 | 2.3012964E−06 |
| A6 | 5.2676649E−06 | 4.1237866E−06 |
| A7 | −2.5146781E−06 | −1.9712503E−06 |
| A8 | 4.4780889E−07 | 3.3524678E−07 |
| A9 | −3.3586224E−08 | −2.2481082E−08 |
| A10 | 5.9937877E−10 | 1.4013552E−10 |

| Sn | 22 | 23 |
|---|---|---|
| KA | 1.0000000E+00 | 1.0000000E+00 |
| A4 | −1.8793318E−09 | −3.0005150E−06 |
| A6 | 4.6370589E−09 | −5.8918331E−09 |
| A8 | 1.2774942E−12 | −5.5552645E−12 |
| A10 | −1.1749842E−13 | −5.8298300E−14 |
| A12 | −2.9570753E−15 | −1.2108220E−15 |
| A14 | −6.4125699E−17 | −3.0129066E−17 |
| A16 | −1.1037238E−18 | −1.0978037E−18 |
| A18 | −1.2346048E−20 | −2.1273932E−21 |
| A20 | −3.5005614E−23 | 1.8033370E−23 |

### Example 6

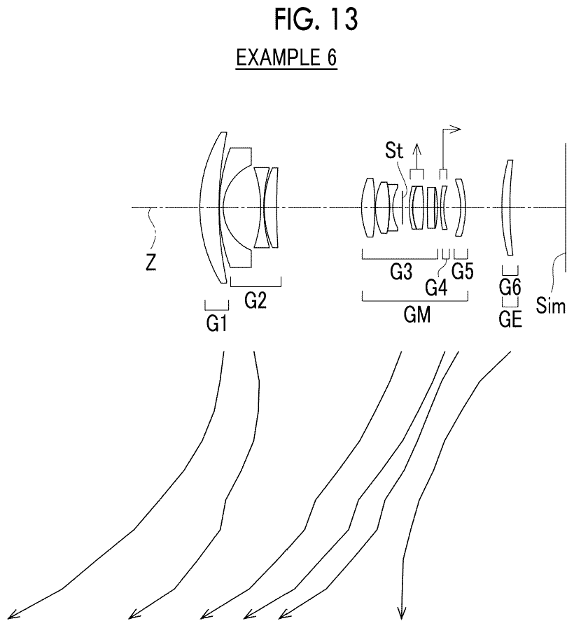

A configuration and a moving path of a variable magnification optical system of Example 6 are illustrated in FIG. 13. The variable magnification optical system of Example 6 consists of, in order from the object side to the image side, the first lens group G1 having a positive refractive power, the second lens group G2 having a negative refractive power, the third lens group G3 having a positive refractive power, the fourth lens group G4 having a negative refractive power, the fifth lens group G5 having a negative refractive power, and the sixth lens group G6 having a positive refractive power. The intermediate group GM consists of the third lens group G3, the fourth lens group G4, and the fifth lens group G5. The final lens group GE consists of the sixth lens group G6. During changing the magnification from the wide angle end to the telephoto end, the six lens groups move on different moving paths along the optical axis Z by changing spacings with respect to adjacent lens groups. The vibration-proof group consists of a cemented lens configured by cementing a lens that is the fourth and a lens that is the fifth from the object side in the third lens group G3. The focus lens group consists of the fourth lens group G4 and moves to the image side during the focusing from the infinite distance object to the short range object.

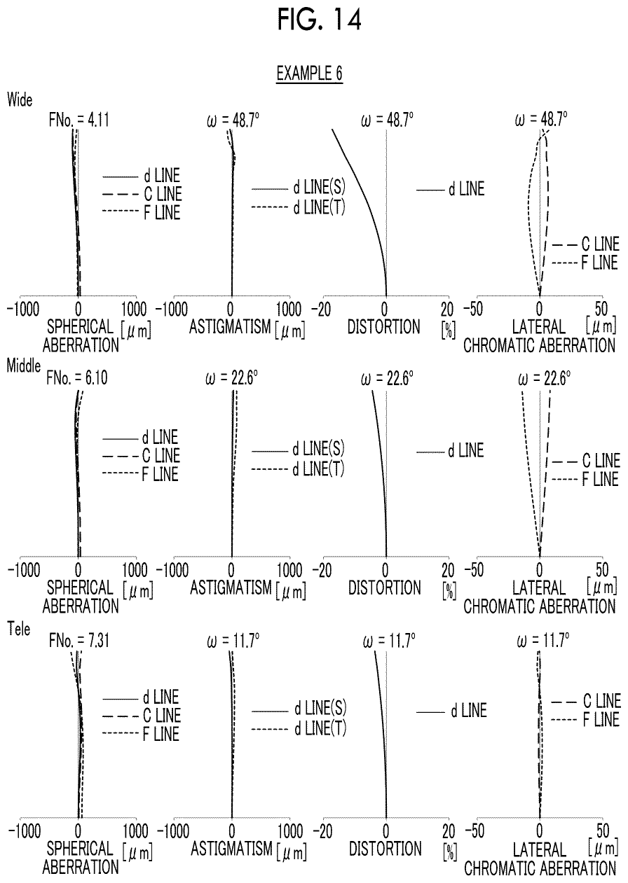

For the variable magnification optical system of Example 6, Table 16 shows basic lens data, Table 17 shows specifications and a variable surface spacing, Table 18 shows aspherical coefficients, and FIG. 14 illustrates each aberration diagram.

TABLE 16
Example 6

| Sn | R | D | Nd | νd | ED | SG |
|---|---|---|---|---|---|---|
| 1 | 31.9742 | 4.2252 | 1.72513 | 56.46 | 33.40 | 4.07 |
| 2 | 79.1678 | DD[2] | | | | 5.18 |
| 3 | 37.0230 | 0.8477 | 1.99882 | 28.44 | | |
| 4 | 10.2634 | 8.3135 | | | | |
| 5 | −26.8918 | 0.6532 | 1.61600 | 63.34 | | |
| 6 | 31.1960 | 0.1100 | | | | |
| 7 | 22.3078 | 2.7488 | 1.92582 | 18.71 | | |
| 8 | 140.7870 | DD[8] | | | | |
| *9 | 16.0740 | 2.9458 | 1.79421 | 25.87 | | |
| *10 | −57.5062 | 0.1477 | | | | |
| 11 | 13.1476 | 3.1054 | 1.61953 | 62.79 | | |
| 12 | −29.3596 | 0.7192 | 1.95978 | 23.30 | | |
| 13 | 9.9763 | 2.1066 | | | | |
| 14 (St) | ∞ | 1.5746 | | | | |
| 15 | 18.3189 | 0.7143 | 1.95570 | 33.10 | | |
| 16 | 13.2540 | 2.3948 | 1.44177 | 90.02 | | 3.13 |
| 17 | −41.3879 | 0.8752 | | | | |
| 18 | 215.0978 | 1.5751 | 1.90842 | 23.99 | | |
| 19 | 118.8728 | 0.6348 | 1.67219 | 40.40 | | |
| 20 | −24.4570 | DD[20] | | | | |
| 21 | 28.3950 | 0.7000 | 1.77739 | 51.37 | | |
| 22 | 15.4621 | DD[22] | | | | |
| *23 | −16.4020 | 1.0352 | 1.43600 | 90.90 | | |
| *24 | −24.9657 | DD[24] | | | | |
| 25 | 41.2234 | 1.7803 | 1.86871 | 27.41 | | |
| 26 | 84.0541 | DD[26] | | | 21 | |

TABLE 17
Example 6

| | Wide | Middle | Tele |
|---|---|---|---|
| Zr | 1.0 | 2.4 | 4.7 |
| f | 15.08 | 35.66 | 71.01 |
| Bf | 12.35 | 32.53 | 36.47 |
| FNo. | 4.11 | 6.10 | 7.31 |
| 2ω[°] | 97.4 | 45.2 | 23.4 |
| DD[2] | 0.10 | 8.06 | 20.16 |
| DD[8] | 18.67 | 5.94 | 2.08 |
| DD[20] | 0.71 | 0.60 | 0.66 |
| DD[22] | 3.75 | 6.58 | 8.47 |
| DD[24] | 8.07 | 4.16 | 23.53 |
| DD[26] | 12.35 | 32.53 | 36.47 |

TABLE 18
Example 6

| Sn | 9 | 10 | 23 | 24 |
|---|---|---|---|---|
| KA | 1.0000000E+00 | 1.0000000E+00 | 1.0000000E+00 | 1.0000000E+00 |
| A4 | −2.1034923E−05 | 3.6232350E−06 | −7.9526593E−05 | −9.7829641E−05 |
| A6 | −1.1234973E−07 | −2.1752203E−07 | 2.0789496E−06 | 1.5134702E−06 |
| A8 | −5.3752502E−09 | −3.6539121E−09 | −6.1796618E−09 | 8.8166369E−09 |
| A10 | −3.3997859E−10 | −4.3618103E−10 | 6.5449497E−10 | −8.0060124E−10 |
| A12 | 6.8092136E−12 | 3.9586326E−12 | −4.2591112E−11 | 4.1566888E−12 |
| A14 | −7.2825415E−14 | 2.5138110E−13 | 1.8000834E−15 | 2.2203430E−13 |
| A16 | 1.3687641E−15 | −6.5027613E−15 | 3.0114488E−14 | 7.7824448E−15 |
| A18 | −7.1603480E−17 | −3.6669940E−17 | 2.5927281E−16 | −2.8009449E−16 |
| A20 | 3.5388843E−19 | 9.3776113E−19 | −1.6501432E−17 | 1.1077887E−18 |

### Example 7

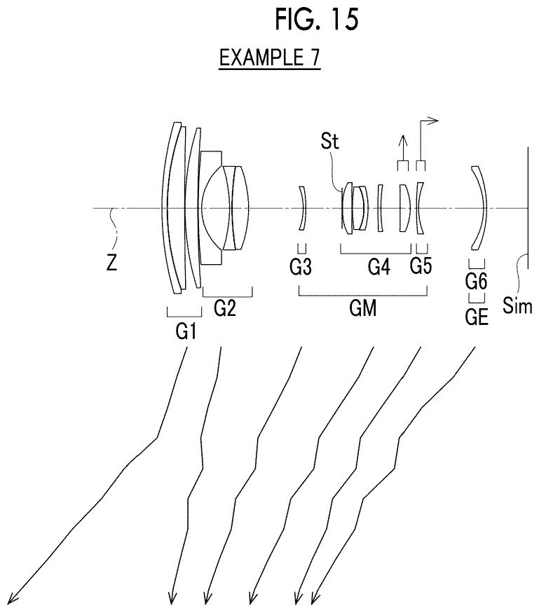

A configuration and a moving path of a variable magnification optical system of Example 7 are illustrated in FIG. 15. The variable magnification optical system of Example 7 consists of, in order from the object side to the image side, the first lens group G1 having a positive refractive power, the second lens group G2 having a negative refractive power, the third lens group G3 having a negative refractive power, the fourth lens group G4 having a negative positive power, the fifth lens group G5 having a negative refractive power, and the sixth lens group G6 having a negative refractive power. The intermediate group GM consists of the third lens group G3, the fourth lens group G4, and the fifth lens group G5. The final lens group GE consists of the sixth lens group G6. During changing the magnification from the wide angle end to the telephoto end, the six lens groups move on different moving paths along the optical axis Z by changing spacings with respect to adjacent lens groups. The vibration-proof group consists of one lens closest to the image side in the fourth lens group G4. The focus lens group consists of the fifth lens group G5 and moves to the image side during the focusing from the infinite distance object to the short range object.

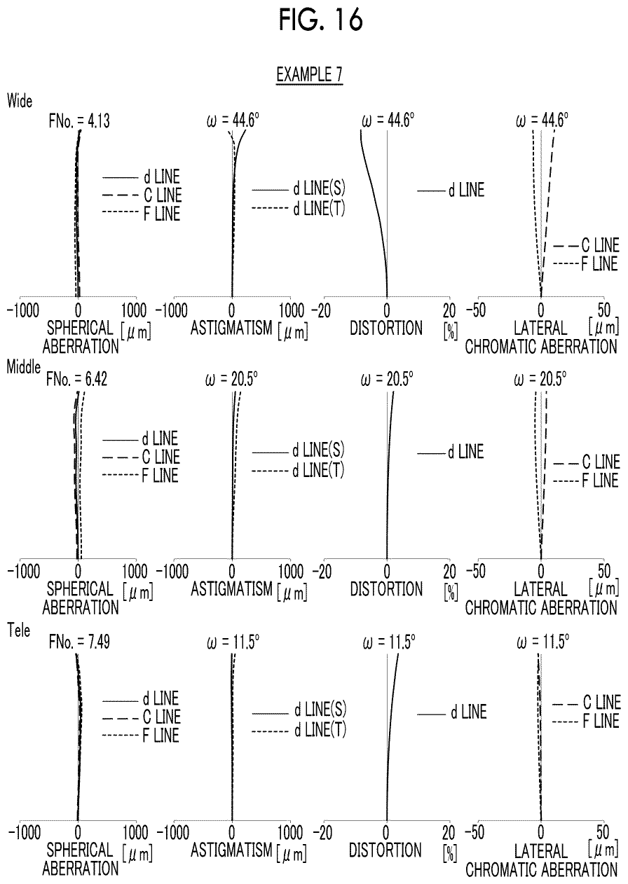

For the variable magnification optical system of Example 7, Table 19 shows basic lens data, Table 20 shows specifications and a variable surface spacing, Table 21 shows aspherical coefficients, and FIG. 16 illustrates each aberration diagram.

TABLE 19
Example 7

| Sn | R | D | Nd | νd | ED | SG | |
|---|---|---|---|---|---|---|---|
| 1 | 71.2864 | 1.2498 | 1.89387 | 20.31 | 39.064 | 3.57 | |
| 2 | 57.0793 | 4.0661 | 1.48749 | 70.24 | | 2.46 | |
| 3 | 744.3057 | 0.1000 | | | | | |
| 4 | 63.6309 | 3.0002 | 1.48761 | 83.04 | | | |
| 5 | 245.0278 | DD[5] | | | | | |
| 6 | 133.1573 | 0.8002 | 1.77087 | 52.04 | | | |
| 7 | 12.7143 | 6.5385 | | | | | |
| 8 | −31.6037 | 0.5998 | 1.90830 | 37.98 | | | |
| 9 | 58.5900 | 3.8586 | 1.82874 | 23.73 | | | |
| 10 | −27.0356 | DD[10] | | | | | |
| *11 | −14.2639 | 0.6250 | 1.53409 | 55.87 | | 1.01 | Pla |
| *12 | −28.4887 | DD[12] | | | | | |
| 13 (St) | ∞ | 0.0881 | | | | | |
| *14 | 19.5162 | 2.2498 | 1.43599 | 88.93 | | | |
| *15 | −50.7130 | 0.0998 | | | | | |
| 16 | 37.2007 | 2.6952 | 1.43647 | 90.83 | | | |
| 17 | −12.2340 | 0.9724 | 1.72448 | 34.78 | | | |
| 18 | −18.5779 | 2.3059 | | | | | |
| 19 | 120.0607 | 0.7025 | 1.69097 | 58.16 | | | |
| 20 | 38.4930 | 4.5001 | | | | | |
| *21 | 445.7498 | 2.2522 | 1.45052 | 87.86 | | 3.08 | |
| *22 | −13.4767 | DD[22] | | | | | |
| *23 | 61.3936 | 0.4998 | 1.53409 | 55.87 | | 1.01 | Pla |
| *24 | 15.3362 | DD[24] | | | | | |
| 25 | −15.8469 | 0.7498 | 1.45529 | 87.96 | | | |
| 26 | −24.3422 | DD[26] | | | 19.263 | | |

TABLE 20
Example 7

| | Wide | Middle | Tele |
|---|---|---|---|
| Zr | 1.0 | 2.4 | 4.3 |
| f | 15.71 | 37.16 | 67.55 |
| Bf | 9.69 | 35.79 | 47.87 |
| FNo. | 4.13 | 6.42 | 7.49 |
| 2ω[°] | 89.2 | 41.0 | 23.0 |
| DD[5] | 0.10 | 12.32 | 30.33 |
| DD[10] | 12.83 | 5.16 | 2.02 |
| DD[12] | 8.49 | 4.56 | 2.05 |
| DD[22] | 1.46 | 0.30 | 1.20 |
| DD[24] | 15.25 | 9.70 | 6.26 |
| DD[26] | 9.69 | 35.79 | 47.87 |

TABLE 21
Example 7

| Sn | 11 | 12 | 14 | 15 |
|---|---|---|---|---|
| KA | 1.0000000E+00 | 1.0000000E+00 | 1.0000000E+00 | 1.0000000E+00 |
| A4 | −2.0341624E−05 | −6.3794294E−05 | 1.5148923E−04 | 2.6226079E−04 |
| A6 | −1.5430302E−06 | −2.6186961E−06 | 2.1619009E−06 | 3.1684389E−06 |
| A8 | 2.3463878E−08 | 7.5008615E−08 | −5.2727186E−08 | −3.0367190E−08 |
| A10 | 2.4404045E−09 | 3.7169150E−09 | 1.2961122E−08 | 8.9576091E−09 |
| A12 | 2.7333716E−11 | −2.9414898E−10 | −3.4264585E−10 | −8.7134701E−11 |
| A14 | −1.3352297E−11 | 2.2510723E−12 | −1.8801159E−12 | −1.4493900E−11 |
| A16 | 5.4402112E−13 | 2.5363150E−13 | −2.3246146E−13 | 5.3592089E−13 |
| A18 | −7.6317593E−15 | −6.9795297E−15 | 2.8550102E−14 | 9.6601973E−16 |
| A20 | 1.8914071E−17 | 4.6802449E−17 | −5.4940340E−16 | −1.7543994E−16 |

| Sn | 21 | 22 | 23 | 24 |
|---|---|---|---|---|
| KA | 1.0000000E+00 | 1.0000000E+00 | 1.0000000E+00 | 1.0000000E+00 |
| A4 | −7.8171189E−05 | 7.4905767E−06 | 1.1409915E−05 | −7.8477882E−06 |
| A6 | −1.7498493E−07 | −8.2518050E−07 | −1.6875830E−06 | −1.4977289E−06 |
| A8 | −3.7756843E−09 | 6.6629691E−09 | 2.4833645E−08 | 4.6418819E−08 |
| A10 | 1.3152300E−09 | 4.9273086E−10 | 3.0032688E−09 | 1.0839228E−09 |
| A12 | −1.3892995E−10 | 2.2000223E−11 | −1.0850323E−10 | −8.1596423E−11 |
| A14 | 9.0155524E−12 | −8.4613978E−13 | −9.9361753E−13 | 5.1397656E−13 |
| A16 | −2.4769694E−13 | −1.5937071E−15 | 9.3225734E−14 | 3.6690710E−14 |
| A18 | 2.5183959E−15 | 2.9668419E−16 | −1.0902372E−15 | −5.3752017E−16 |

### Example 8

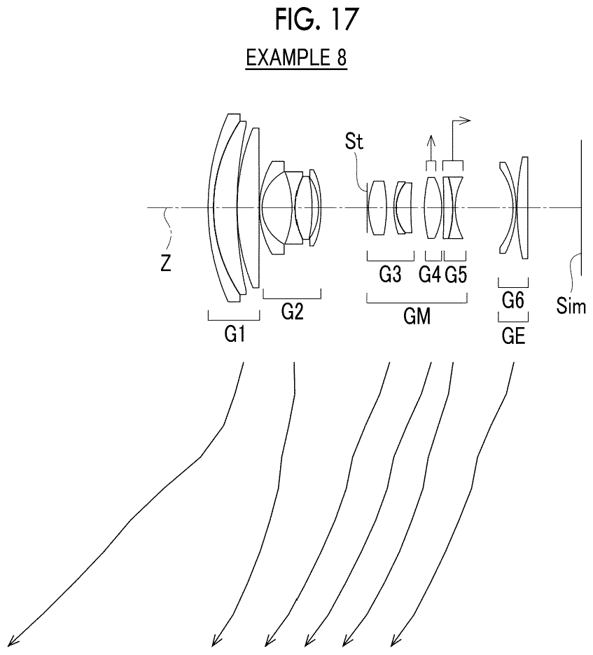

A configuration and a moving path of a variable magnification optical system of Example 8 are illustrated in FIG. 17. The variable magnification optical system of Example 8 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, and the sixth lens group G6 having a negative refractive power. The intermediate group GM consists of the third lens group G3, the fourth lens group G4, and the fifth lens group G5. The final lens group GE consists of the sixth lens group G6. During changing the magnification from the wide angle end to the telephoto end, the six lens groups move on different moving paths along the optical axis Z by changing spacings with respect to adjacent lens groups. The vibration-proof group consists of the fourth lens group G4. The focus lens group consists of the fifth lens group G5 and moves to the image side during the focusing from the infinite distance object to the short range object.

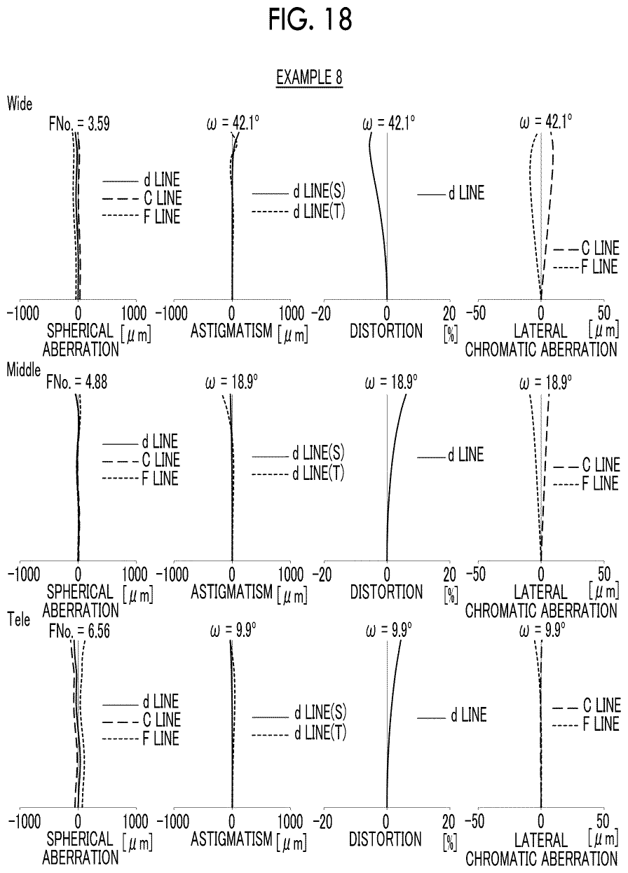

For the variable magnification optical system of Example 8, Table 22 shows basic lens data, Table 23 shows specifications and a variable surface spacing, Table 24 shows aspherical coefficients, and FIG. 18 illustrates each aberration diagram.

TABLE 22
Example 8

| Sn | R | D | Nd | νd | ED | SG |
|---|---|---|---|---|---|---|
| 1 | 50.8023 | 1.1065 | 1.94348 | 34.25 | 40.00 | 5.33 |
| 2 | 34.0735 | 4.7874 | 1.54202 | 74.23 | | 3.61 |
| 3 | 83.8226 | 0.0421 | | | | |
| 4 | 46.1074 | 4.4895 | 1.51303 | 79.17 | | |
| 5 | −3116.2724 | DD[5] | | | | |
| 6 | 20.3142 | 0.5140 | 1.85526 | 43.40 | | |
| 7 | 8.8515 | 6.1003 | | | | |
| 8 | −21.2861 | 0.6153 | 1.77515 | 51.60 | | |
| 9 | 15.8317 | 3.3996 | 1.84217 | 23.45 | | |
| 10 | −36.1271 | 1.3085 | | | | |
| *11 | −14.4393 | 0.5103 | 1.81462 | 45.23 | | |
| *12 | −34.5028 | DD[12] | | | | |
| 13 (St) | ∞ | 0.2503 | | | | |
| *14 | 14.3042 | 3.6857 | 1.62850 | 60.57 | | |
| *15 | −29.6357 | 1.4981 | | | | |
| 16 | 17.7396 | 0.4950 | 1.98891 | 27.55 | | |
| 17 | 8.6112 | 2.9758 | 1.43600 | 89.81 | | |
| 18 | 66.3035 | DD[18] | | | | |
| *19 | 24.9133 | 3.5541 | 1.47393 | 84.50 | | 3.32 |
| *20 | −15.1401 | DD[20] | | | | |
| 21 | −174.1219 | 1.8205 | 1.93502 | 25.84 | | |
| 22 | −25.1900 | 0.5060 | 1.59644 | 64.28 | | |
| 23 | 14.1672 | DD[23] | | | | |
| 24 | −14.6600 | 0.6193 | 1.89228 | 24.66 | | |
| 25 | −22.3987 | 0.2000 | | | | |
| 26 | 53.0960 | 2.1806 | 1.59003 | 40.31 | | |
| 27 | ∞ | DD[27] | | | 21.698 | |

TABLE 23
Example 8

| | Wide | Middle | Tele |
|---|---|---|---|
| Zr | 1.0 | 2.4 | 4.7 |
| f | 16.53 | 39.10 | 77.85 |
| Bf | 10.96 | 22.16 | 36.01 |
| FNo. | 3.59 | 4.88 | 6.56 |
| 2ω[°] | 84.2 | 37.8 | 19.8 |
| DD[5] | 0.09 | 18.22 | 31.44 |
| DD[12] | 9.44 | 3.23 | 0.89 |
| DD[18] | 2.76 | 2.58 | 2.28 |
| DD[20] | 0.42 | 3.33 | 3.66 |
| DD[23] | 11.82 | 9.03 | 9.25 |
| DD[27] | 10.96 | 22.16 | 36.01 |

TABLE 24
Example 8

| Sn | 11 | 12 | 14 | 15 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.7491768E−04 | −1.9530783E−04 | −7.5947253E−05 | 3.9806912E−05 |
| A5 | −5.9677481E−06 | −2.9310874E−06 | 4.8459356E−06 | 2.4898289E−06 |
| A6 | 3.0344823E−06 | 2.9605670E−06 | −1.5748570E−06 | −1.8973773E−06 |
| A7 | −3.2199115E−08 | −1.0231623E−07 | 5.2370807E−08 | 3.5153896E−07 |
| A8 | −4.3788174E−08 | −3.8267597E−08 | 2.6137044E−08 | −1.2465038E−08 |
| A9 | −2.0741523E−09 | 1.9429317E−09 | −1.6261292E−09 | −2.5055492E−09 |
| A10 | 5.6595241E−10 | 1.3435209E−10 | −3.7503824E−10 | −1.0529055E−10 |

| Sn | 19 | 20 |
|---|---|---|
| KA | 1.0000000E+00 | 1.0000000E+00 |
| A3 | 0.0000000E+00 | 0.0000000E+00 |
| A4 | −5.8659555E−05 | 1.7740222E−05 |
| A5 | −5.1029930E−06 | −6.4093396E−06 |
| A6 | 5.6549800E−06 | 5.0236482E−06 |
| A7 | −2.3522089E−06 | −1.9677829E−06 |
| A8 | 4.3283051E−07 | 3.2566601E−07 |
| A9 | −3.5715074E−08 | −2.3133064E−08 |
| A10 | 9.1650045E−10 | 2.9993819E−10 |

### Example 9

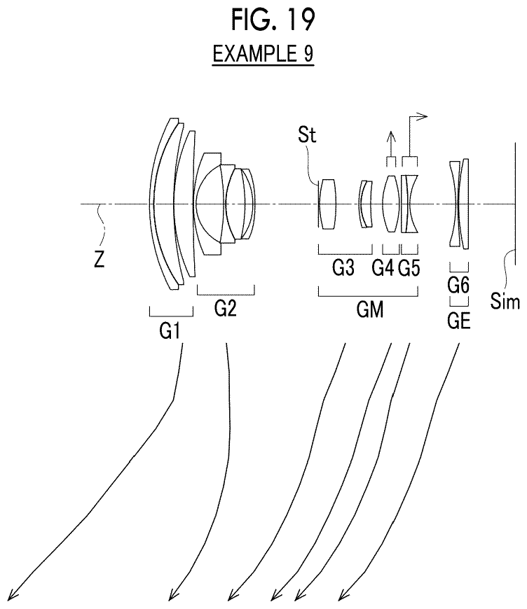

A configuration and a moving path of a variable magnification optical system of Example 9 are illustrated in FIG. 19. The variable magnification optical system of Example 9 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, and the sixth lens group G6 having a negative refractive power. The intermediate group GM consists of the third lens group G3, the fourth lens group G4, and the fifth lens group G5. The final lens group GE consists of the sixth lens group G6. During changing the magnification from the wide angle end to the telephoto end, the fourth lens group G4 and the sixth lens group G6 move on the same moving path along the optical axis Z, and the first lens group G1, the second lens group G2, the third lens group G3, the fourth lens group G4, and the fifth lens group G5 move on different moving paths along the optical axis Z by changing spacings with respect to adjacent lens groups. The vibration-proof group consists of the fourth lens group G4. The focus lens group consists of the fifth lens group G5 and moves to the image side during the focusing from the infinite distance object to the short range object.

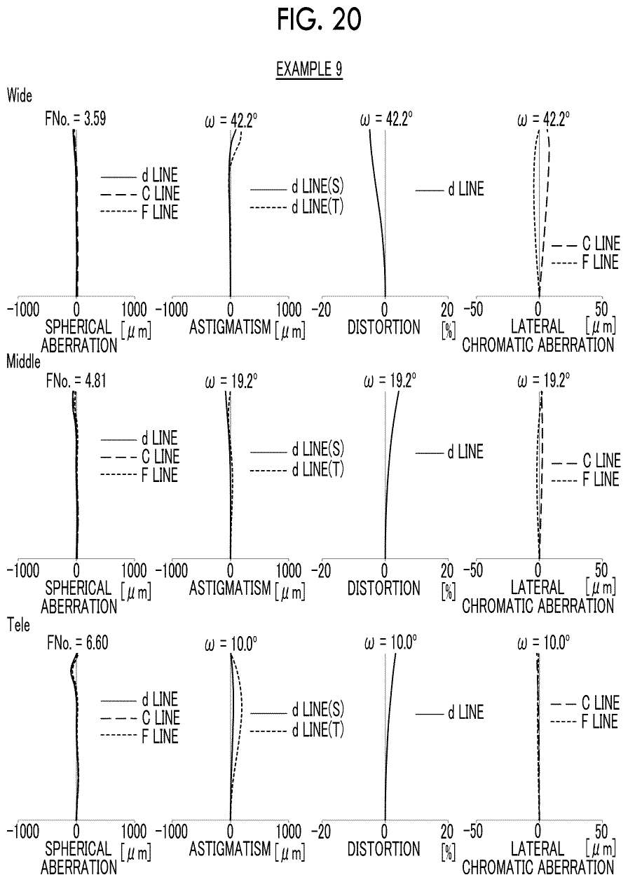

For the variable magnification optical system of Example 9, Table 25 shows basic lens data, Table 26 shows specifications and a variable surface spacing, Table 27 shows aspherical coefficients, and FIG. 20 illustrates each aberration diagram.

TABLE 25
Example 9

| Sn | R | D | Nd | νd | ED | SG | |
|---|---|---|---|---|---|---|---|
| 1 | 43.3659 | 0.9999 | 1.90910 | 29.32 | 40.00 | 4.77 | |
| 2 | 33.6394 | 4.6481 | 1.48749 | 70.32 | | 2.45 | |
| 3 | 71.4271 | 0.0442 | | | | | |
| 4 | 40.6063 | 4.5002 | 1.47284 | 85.29 | | | |
| 5 | 321.1756 | DD[5] | | | | | |
| 6 | 29.3629 | 0.6148 | 1.82729 | 46.27 | | | |
| 7 | 10.0143 | 6.4349 | | | | | |
| 8 | −48.4327 | 0.4998 | 1.92432 | 36.34 | | | |
| 9 | 16.7254 | 4.4935 | 1.83805 | 23.10 | | | |
| 10 | −35.5216 | 1.8319 | | | | | |
| *11 | −15.6603 | 0.4994 | 1.53409 | 55.87 | | 1.01 | Pla |
| *12 | −39.1576 | DD[12] | | | | | |
| 13 (St) | ∞ | 0.2498 | | | | | |
| *14 | 18.5629 | 3.8096 | 1.58042 | 68.90 | | | |
| *15 | −38.9597 | 5.3721 | | | | | |
| 16 | 20.9050 | 0.4997 | 2.00001 | 24.68 | | | |
| 17 | 11.0842 | 2.2702 | 1.43600 | 85.24 | | | |
| 18 | 40.5655 | DD[18] | | | | | |
| *19 | 15.0841 | 3.7875 | 1.43599 | 83.16 | | 3.06 | |
| *20 | −18.4336 | DD[20] | | | | | |
| 21 | 1372.4118 | 1.4710 | 1.82702 | 23.65 | | | |
| 22 | −56.5126 | 0.5099 | 1.48749 | 70.32 | | | |
| 23 | 12.8467 | DD[23] | | | | | |
| *24 | −32.9812 | 0.4999 | 1.53409 | 55.87 | | 1.01 | Pla |
| *25 | 66.4433 | 0.2000 | | | | | |
| 26 | 47.0345 | 2.2500 | 1.64727 | 33.86 | | | |
| 27 | ∞ | DD[27] | | | 20.881 | | |

TABLE 26
Example 9

| | Wide | Middle | Tele |
|---|---|---|---|
| Zr | 1.0 | 2.4 | 4.7 |
| f | 16.50 | 39.02 | 77.69 |
| Bf | 11.00 | 22.61 | 39.01 |
| FNo. | 3.59 | 4.81 | 6.60 |
| 2ω[°] | 84.4 | 38.4 | 20.0 |
| DD[5] | 0.09 | 16.20 | 27.41 |
| DD[12] | 14.88 | 4.75 | 0.90 |
| DD[18] | 2.77 | 1.98 | 2.13 |
| DD[20] | 0.50 | 2.28 | 1.88 |
| DD[23] | 10.72 | 8.94 | 9.34 |
| DD[27] | 11.00 | 22.61 | 39.01 |

TABLE 27
Example 9

| Sn | 11 | 12 | 14 | 15 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.4792954E−04 | −1.9624698E−04 | −7.3459586E−05 | −3.1727723E−05 |
| A5 | −5.5782663E−06 | −3.1626945E−06 | 2.2726393E−06 | 8.0473699E−07 |
| A6 | 3.0494523E−06 | 3.0022576E−06 | −1.7105631E−06 | −2.0034506E−06 |
| A7 | −2.0204121E−08 | −7.7586176E−08 | 3.7767693E−08 | 3.2744043E−07 |
| A8 | −3.7233488E−08 | −3.9349927E−08 | 2.6658439E−08 | −1.4742243E−08 |
| A9 | −1.4935997E−09 | 9.3397306E−10 | −1.0806356E−09 | −2.5423651E−09 |
| A10 | 3.8532883E−10 | 2.1478113E−10 | −5.1047309E−10 | −5.4291707E−11 |

| Sn | 19 | 20 |
|---|---|---|
| KA | 1.0000000E+00 | 1.0000000E+00 |
| A3 | 0.0000000E+00 | 0.0000000E+00 |
| A4 | −6.3978293E−05 | 6.4644939E−05 |
| A5 | −1.9674417E−06 | −3.8899779E−06 |
| A6 | 5.6872656E−06 | 5.0727946E−06 |
| A7 | −2.3672115E−06 | −1.9692539E−06 |
| A8 | 4.2986856E−07 | 3.2811766E−07 |
| A9 | −3.4871158E−08 | −2.3040904E−08 |
| A10 | 8.9238594E−10 | 3.7358485E−10 |

| Sn | 24 | 25 |
|---|---|---|
| KA | 1.0000000E+00 | 1.0000000E+00 |
| A4 | −1.6366329E−05 | −2.7188423E−05 |
| A6 | 4.7216100E−08 | 3.2477299E−08 |
| A8 | −9.0546131E−10 | −1.4828345E−10 |
| A10 | 3.8720083E−12 | −7.8497175E−12 |
| A12 | −2.1376842E−13 | 4.6163753E−14 |
| A14 | 2.0547577E−15 | −3.4770064E−16 |
| A16 | 6.5452010E−19 | 2.1790013E−18 |

### Example 10

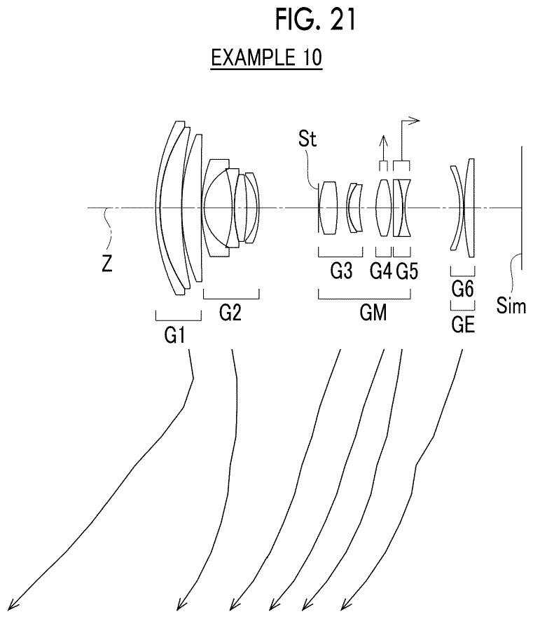

A configuration and a moving path of a variable magnification optical system of Example 10 are illustrated in FIG. 21. The variable magnification optical system of Example 10 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, and the sixth lens group G6 having a positive refractive power. The intermediate group GM consists of the third lens group G3, the fourth lens group G4, and the fifth lens group G5. The final lens group GE consists of the sixth lens group G6. During changing the magnification from the wide angle end to the telephoto end, the six lens groups move on different moving paths along the optical axis Z by changing spacings with respect to adjacent lens groups. The vibration-proof group consists of the fourth lens group G4. The focus lens group consists of the fifth lens group G5 and moves to the image side during the focusing from the infinite distance object to the short range object.

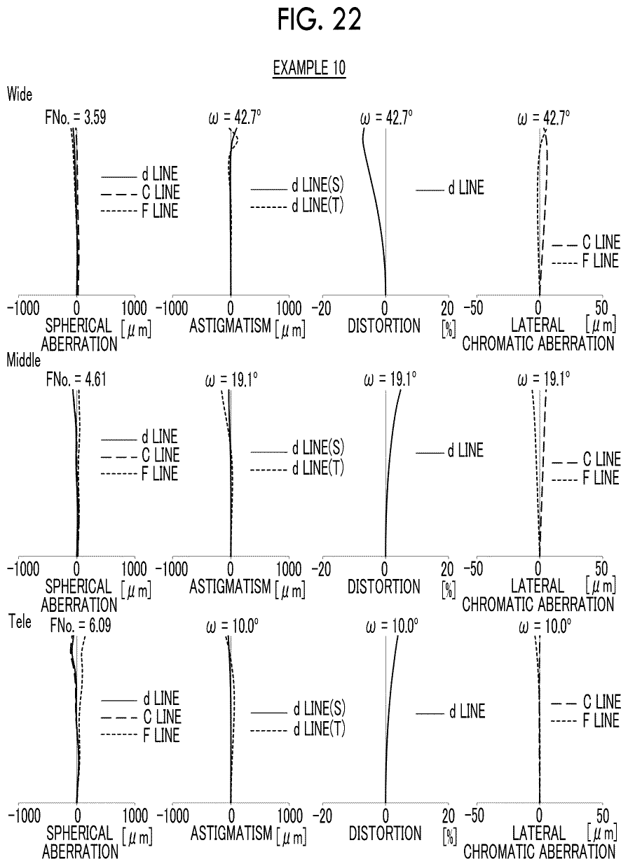

For the variable magnification optical system of Example 10, Table 28 shows basic lens data, Table 29 shows specifications and a variable surface spacing, Table 30 shows aspherical coefficients, and FIG. 22 illustrates each aberration diagram.

TABLE 28
Example 10

| Sn | R | D | Nd | νd | ED | SG |
|---|---|---|---|---|---|---|
| 1 | 44.9579 | 0.9999 | 1.96355 | 32.33 | 40.00 | 5.38 |
| 2 | 33.3330 | 4.9828 | 1.49741 | 81.54 | | 3.55 |
| 3 | 82.7959 | 0.0451 | | | | |
| 4 | 43.9623 | 4.5000 | 1.49263 | 82.27 | | |
| 5 | 1152.4400 | DD[5] | | | | |
| 6 | 32.7437 | 0.5819 | 1.82464 | 46.54 | | |
| 7 | 10.0927 | 6.4637 | | | | |
| 8 | −28.3172 | 0.5099 | 1.79398 | 49.67 | | |
| 9 | 29.3502 | 2.8717 | 1.88332 | 20.83 | | |
| 10 | −47.4848 | 2.3243 | | | | |
| *11 | −13.7427 | 0.5188 | 1.45743 | 87.63 | | |
| *12 | −37.9204 | DD[12] | | | | |
| 13 (St) | ∞ | 0.2499 | | | | |
| *14 | 15.5535 | 4.1000 | 1.67539 | 56.15 | | |
| *15 | −41.4854 | 2.1380 | | | | |
| 16 | 16.1557 | 0.4995 | 1.98488 | 23.61 | | |
| 17 | 8.7186 | 2.4855 | 1.43599 | 86.64 | | |
| 18 | 21.8079 | DD[18] | | | | |
| *19 | 16.7177 | 3.5503 | 1.43600 | 90.90 | | 3.15 |
| *20 | −20.4541 | DD[20] | | | | |
| 21 | −2174.7260 | 2.1546 | 1.93607 | 20.51 | | |
| 22 | −22.0404 | 0.5097 | 1.77540 | 44.63 | | |
| 23 | 17.0772 | DD[23] | | | | |
| 24 | −21.0288 | 0.8349 | 2.00001 | 15.00 | | |
| 25 | −26.4869 | 0.2000 | | | | |
| 26 | 56.0623 | 2.2382 | 1.75142 | 54.03 | | |
| 27 | ∞ | DD[27] | | | 22.665 | |

TABLE 29
Example 10

| | Wide | Middle | Tele |
|---|---|---|---|
| Zr | 1.0 | 2.4 | 4.7 |
| f | 16.50 | 39.02 | 77.70 |
| Bf | 11.02 | 22.78 | 39.00 |
| FNo. | 3.59 | 4.61 | 6.09 |
| 2ω[°] | 85.4 | 38.2 | 20.0 |
| DD[5] | 0.09 | 16.53 | 29.16 |
| DD[12] | 13.60 | 3.98 | 0.90 |
| DD[18] | 3.80 | 3.46 | 2.75 |
| DD[20] | 0.49 | 4.25 | 3.93 |
| DD[23] | 12.70 | 8.12 | 7.68 |
| DD[27] | 11.02 | 22.78 | 39.00 |

TABLE 30
Example 10

| Sn | 11 | 12 | 14 | 15 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.5985490E−04 | −2.0097712E−04 | −6.6714169E−05 | −5.8035247E−06 |
| A5 | −5.5601724E−06 | −2.7640721E−06 | 3.4838218E−06 | 1.1120059E−06 |
| A6 | 3.0006079E−06 | 3.1105173E−06 | −1.5945336E−06 | −1.9631413E−06 |
| A7 | −1.7184228E−08 | −7.7514820E−08 | 4.3569860E−08 | 3.3751700E−07 |
| A8 | −3.7238018E−08 | −3.8431571E−08 | 2.2865886E−08 | −1.4741335E−08 |
| A9 | −1.2610375E−09 | 6.8995537E−10 | −1.5349781E−09 | −3.0078120E−09 |
| A10 | 3.6362704E−10 | 2.3030915E−10 | −4.0053096E−10 | −2.6961931E−11 |

| Sn | 19 | 20 |
|---|---|---|
| KA | 1.0000000E+00 | 1.0000000E+00 |
| A3 | 0.0000000E+00 | 0.0000000E+00 |
| A4 | −4.0922045E−05 | 5.3263078E−05 |
| A5 | −5.0782463E−06 | −6.7723176E−06 |
| A6 | 5.5545577E−06 | 4.9800857E−06 |
| A7 | −2.3574952E−06 | −1.9501258E−06 |
| A8 | 4.3784681E−07 | 3.3148889E−07 |
| A9 | −3.4631181E−08 | −2.2521757E−08 |
| A10 | 6.9300543E−10 | 1.5788535E−10 |

### Example 11

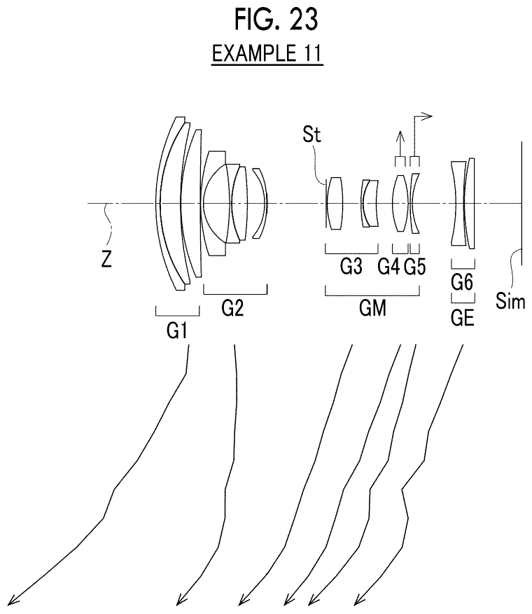

A configuration and a moving path of a variable magnification optical system of Example 11 are illustrated in FIG. 23. The variable magnification optical system of Example 11 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, and the sixth lens group G6 having a negative refractive power. The intermediate group GM consists of the third lens group G3, the fourth lens group G4, and the fifth lens group G5. The final lens group GE consists of the sixth lens group G6. During changing the magnification from the wide angle end to the telephoto end, the six lens groups move on different moving paths along the optical axis Z by changing spacings with respect to adjacent lens groups. The vibration-proof group consists of the fourth lens group G4. The focus lens group consists of the fifth lens group G5 and moves to the image side during the focusing from the infinite distance object to the short range object.

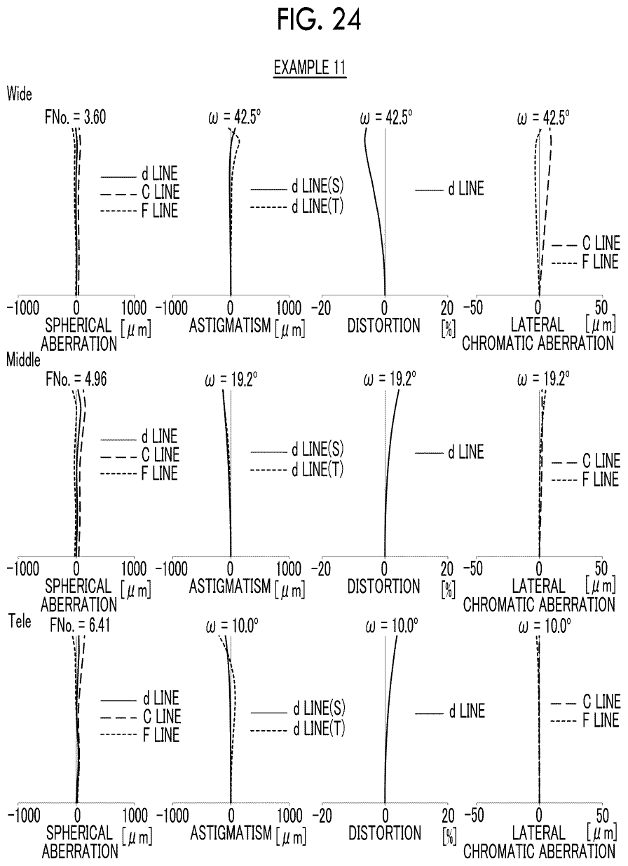

For the variable magnification optical system of Example 11, Table 31 shows basic lens data, Table 32 shows specifications and a variable surface spacing, Table 33 shows aspherical coefficients, and FIG. 24 illustrates each aberration diagram.

TABLE 31
Example 11

| Sn | R | D | Nd | νd | ED | SG |
|---|---|---|---|---|---|---|
| 1 | 44.7294 | 0.9999 | 1.92200 | 36.58 | 40.00 | 5.22 |
| 2 | 33.3329 | 4.7079 | 1.50868 | 79.83 | | 3.56 |
| 3 | 74.2507 | 0.0863 | | | | |
| 4 | 42.7193 | 4.5002 | 1.49796 | 81.46 | | |
| 5 | 644.1687 | DD[5] | | | | |
| 6 | 38.8779 | 0.6257 | 1.81883 | 47.13 | | |
| 7 | 10.7056 | 6.0395 | | | | |
| 8 | −51.7864 | 0.4996 | 1.94988 | 33.73 | | |
| 9 | 20.6392 | 3.6127 | 1.91229 | 19.92 | | |
| 10 | −69.9647 | 3.9834 | | | | |
| *11 | −14.0630 | 0.4997 | 1.43599 | 72.37 | | |
| *12 | −28.6881 | DD[12] | | | | |
| 13 (St) | ∞ | 0.2501 | | | | |
| *14 | 17.0291 | 3.5772 | 1.77296 | 49.78 | | |
| *15 | −39.1523 | 4.2273 | | | | |
| 16 | 30.8758 | 0.4993 | 2.00001 | 25.70 | | |
| 17 | 9.9072 | 3.0306 | 1.45449 | 88.08 | | |
| 18 | 30.8993 | DD[18] | | | | |
| *19 | 16.5492 | 3.6224 | 1.45063 | 78.00 | | 2.96 |
| *20 | −19.5580 | DD[20] | | | | |
| 21 | 49.3470 | 0.4997 | 1.53988 | 75.08 | | |
| 22 | 15.5845 | DD[22] | | | | |
| 23 | −38.8528 | 1.7844 | 1.76161 | 52.99 | | |
| 24 | 84.4459 | 0.2000 | | | | |
| 25 | 45.9827 | 2.2502 | 1.91362 | 19.32 | | |
| 26 | ∞ | DD[26] | | | 20.874 | |

TABLE 32
Example 11

| | Wide | Middle | Tele |
|---|---|---|---|
| Zr | 1.0 | 2.4 | 4.7 |
| f | 16.50 | 39.02 | 77.68 |
| Bf | 11.00 | 25.10 | 36.03 |
| FNo. | 3.60 | 4.96 | 6.41 |
| 2ω[°] | 85.0 | 38.4 | 20.0 |
| DD[5] | 0.09 | 15.17 | 28.49 |
| DD[12] | 13.60 | 4.52 | 0.90 |
| DD[18] | 3.72 | 1.79 | 2.91 |
| DD[20] | 0.49 | 3.06 | 2.58 |
| DD[22] | 10.05 | 6.54 | 9.76 |
| DD[26] | 11.00 | 25.10 | 36.03 |

TABLE 33
Example 11

| Sn | 11 | 12 | 14 | 15 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.6840998E−04 | −2.0136786E−04 | −6.4854752E−05 | −7.1036911E−06 |
| A5 | −5.7750595E−06 | −3.4474563E−06 | 2.9735709E−06 | 1.0028361E−06 |
| A6 | 3.0231941E−06 | 2.9306754E−06 | −1.6130067E−06 | −1.9304512E−06 |
| A7 | −2.0466348E−08 | −8.3388519E−08 | 5.1124588E−08 | 3.3415488E−07 |
| A8 | −3.8910999E−08 | −3.6086538E−08 | 2.5259246E−08 | −1.6365622E−08 |
| A9 | −9.9886747E−10 | 1.1054580E−09 | −2.1011645E−09 | −2.7345074E−09 |
| A10 | 3.8247467E−10 | 2.0575083E−10 | −4.4213319E−10 | −9.9549508E−11 |

| Sn | 19 | 20 |
|---|---|---|
| KA | 1.0000000E+00 | 1.0000000E+00 |
| A3 | 0.0000000E+00 | 0.0000000E+00 |
| A4 | −4.9409428E−05 | 3.5250010E−05 |
| A5 | −3.8939162E−06 | −4.1476175E−06 |
| A6 | 5.7179920E−06 | 5.0846682E−06 |
| A7 | −2.3621195E−06 | −1.9580567E−06 |
| A8 | 4.2967336E−07 | 3.2888842E−07 |
| A9 | −3.5164699E−08 | −2.3738140E−08 |
| A10 | 8.8741099E−10 | 3.9029800E−10 |

### Example 12

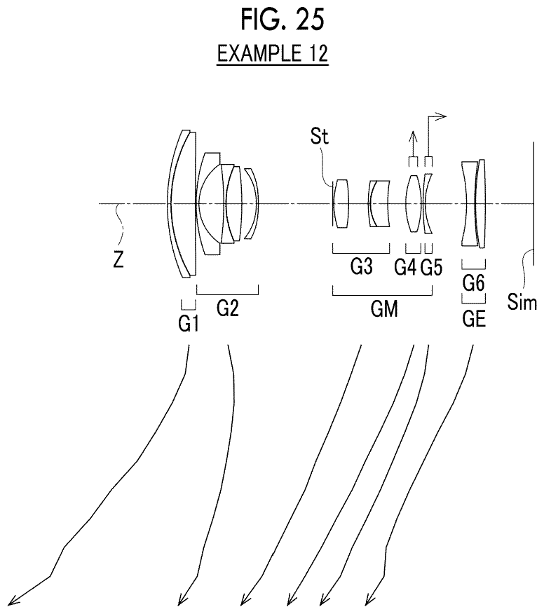

A configuration and a moving path of a variable magnification optical system of Example 12 are illustrated in FIG. 25. The variable magnification optical system of Example 12 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, and the sixth lens group G6 having a negative refractive power. The intermediate group GM consists of the third lens group G3, the fourth lens group G4, and the fifth lens group G5. The final lens group GE consists of the sixth lens group G6. During changing the magnification from the wide angle end to the telephoto end, the six lens groups move on different moving paths along the optical axis Z by changing spacings with respect to adjacent lens groups. The vibration-proof group consists of the fourth lens group G4. The focus lens group consists of the fifth lens group G5 and moves to the image side during the focusing from the infinite distance object to the short range object.

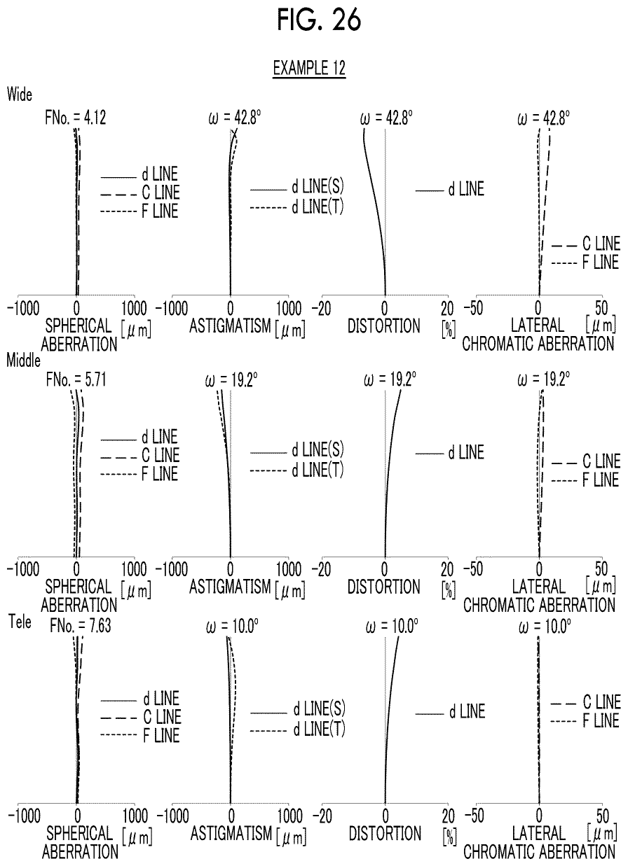

For the variable magnification optical system of Example 12, Table 34 shows basic lens data, Table 35 shows specifications and a variable surface spacing, Table 36 shows aspherical coefficients, and FIG. 26 illustrates each aberration diagram.

TABLE 34
Example 12

| Sn | R | D | Nd | νd | ED | SG |
|---|---|---|---|---|---|---|
| 1 | 43.2614 | 0.8489 | 1.96487 | 32.19 | 34.00 | 5.38 |
| 2 | 33.3333 | 5.6409 | 1.56317 | 71.53 | | 3.65 |
| 3 | 6468.0709 | DD[3] | | | | |
| 4 | 35.2171 | 0.6182 | 1.89172 | 39.67 | | |
| 5 | 10.9709 | 5.7422 | | | | |
| 6 | −66.0667 | 0.5051 | 1.86435 | 42.47 | | |
| 7 | 20.8856 | 3.6565 | 1.86538 | 21.73 | | |
| 8 | −63.9199 | 3.3612 | | | | |
| *9 | −15.2738 | 0.4717 | 1.49508 | 63.43 | | |
| *10 | −29.8237 | DD[10] | | | | |
| 11 (St) | ∞ | 0.2500 | | | | |
| *12 | 16.3577 | 3.4068 | 1.70243 | 54.66 | | |
| *13 | −39.8946 | 4.5408 | | | | |
| 14 | 29.5530 | 0.4969 | 1.98034 | 27.61 | | |
| 15 | 9.7865 | 3.9916 | 1.46630 | 86.28 | | |
| 16 | 32.5477 | DD[16] | | | | |
| *17 | 16.6209 | 3.5927 | 1.43601 | 76.85 | | 2.98 |
| *18 | −20.5861 | DD[18] | | | | |
| 19 | 52.2787 | 0.4877 | 1.52686 | 77.06 | | |
| 20 | 15.5721 | DD[20] | | | | |
| 21 | −35.0064 | 1.8786 | 1.76976 | 52.15 | | |
| 22 | 68.2393 | 0.2000 | | | | |
| 23 | 54.7409 | 2.2500 | 1.98636 | 23.21 | | |
| 24 | −204.8278 | DD[24] | | | 20.396 | |

TABLE 35
Example 12

| | Wide | Middle | Tele |
|---|---|---|---|
| Zr | 1.0 | 2.4 | 4.7 |
| f | 16.44 | 38.89 | 77.43 |
| Bf | 11.18 | 25.79 | 35.98 |
| FNo. | 4.12 | 5.71 | 7.63 |
| 2ω[°] | 85.6 | 38.4 | 20.0 |
| DD[3] | 0.18 | 16.43 | 30.42 |
| DD[10] | 17.04 | 5.73 | 0.87 |
| DD[16] | 4.16 | 2.88 | 2.61 |
| DD[18] | 0.42 | 3.55 | 4.56 |
| DD[20] | 9.56 | 6.04 | 9.79 |
| DD[24] | 11.18 | 25.79 | 35.98 |

TABLE 36
Example 12

| Sn | 9 | 10 | 12 | 13 |
|---|---|---|---|---|
| KA | 1.0000000E+00 | 1.0000000E+00 | 1.0000000E+00 | 1.0000000E+00 |
| A3 | 0.0000000E+00 | 0.0000000E+00 | 0.0000000E+00 | 0.0000000E+00 |
| A4 | −1.6770501E−04 | −2.0336755E−04 | −6.4003536E−05 | −8.7639053E−06 |
| A5 | −5.6959626E−06 | −3.5106426E−06 | 2.7787040E−06 | 1.1008520E−06 |
| A6 | 3.0321613E−06 | 2.9285665E−06 | −1.6157721E−06 | −1.9277847E−06 |
| A7 | −2.0036326E−08 | −8.3039764E−08 | 5.1692933E−08 | 3.3304646E−07 |
| A8 | −3.8943278E−08 | −3.5791778E−08 | 2.5315614E−08 | −1.6438424E−08 |
| A9 | −9.7509632E−10 | 1.1239612E−09 | −2.1187762E−09 | −2.7612100E−09 |
| A10 | 3.9058379E−10 | 2.0638923E−10 | −4.4072868E−10 | −1.0001982E−10 |

| Sn | 17 | 18 |
|---|---|---|
| KA | 1.0000000E+00 | 1.0000000E+00 |
| A3 | 0.0000000E+00 | 0.0000000E+00 |
| A4 | −4.9747841E−05 | 3.1571784E−05 |
| A5 | −3.7736424E−06 | −4.2869282E−06 |
| A6 | 5.7255872E−06 | 5.0768195E−06 |
| A7 | −2.3632306E−06 | −1.9572634E−06 |
| A8 | 4.2918810E−07 | 3.2931433E−07 |
| A9 | −3.5138885E−08 | −2.3749765E−08 |
| A10 | 8.9281150E−10 | 3.8465639E−10 |

### Example 13

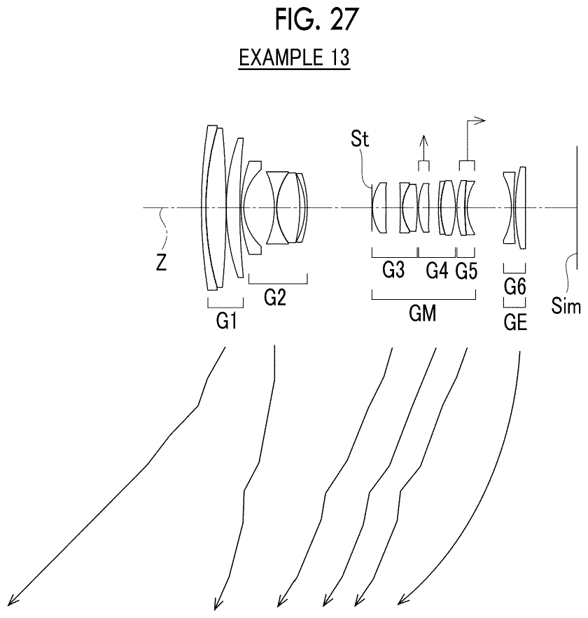

A configuration and a moving path of a variable magnification optical system of Example 13 are illustrated in FIG. 27. The variable magnification optical system of Example 13 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, and the sixth lens group G6 having a negative refractive power. The intermediate group GM consists of the third lens group G3, the fourth lens group G4, and the fifth lens group G5. The final lens group GE consists of the sixth lens group G6. During changing the magnification from the wide angle end to the telephoto end, the six lens groups move on different moving paths along the optical axis Z by changing spacings with respect to adjacent lens groups. The vibration-proof group consists of one lens closest to the object side in the fourth lens group G4. The focus lens group consists of the fifth lens group G5 and moves to the image side during the focusing from the infinite distance object to the short range object.

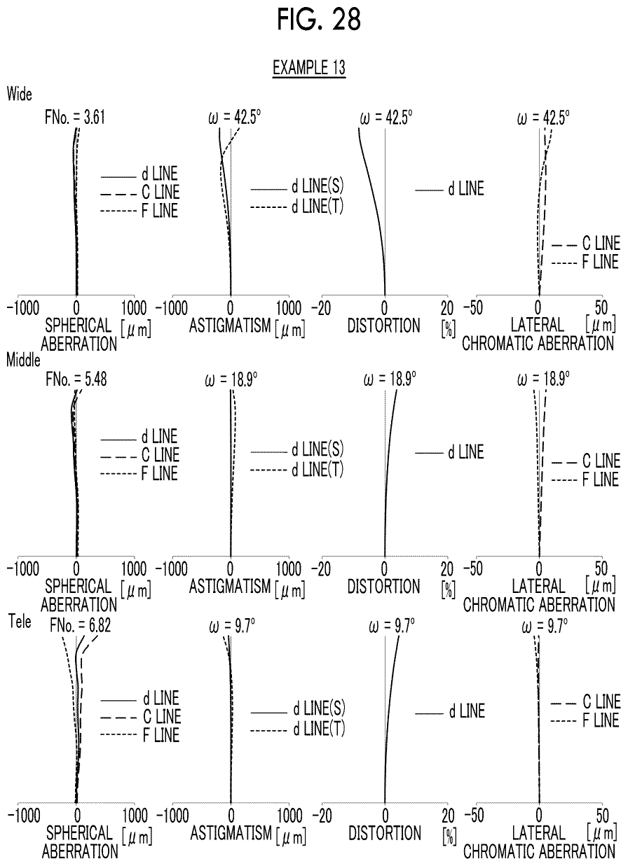

For the variable magnification optical system of Example 13, Table 37 shows basic lens data, Table 38 shows specifications and a variable surface spacing, Table 39 shows aspherical coefficients, and FIG. 28 illustrates each aberration diagram.

TABLE 37
Example 13

| Sn | R | D | Nd | νd | ED | SG |
|---|---|---|---|---|---|---|
| 1 | 133.5670 | 0.9476 | 1.97689 | 30.09 | 38.00 | 5.30 |
| 2 | 71.8020 | 4.3019 | 1.54435 | 74.40 | | 3.61 |
| 3 | −216.7659 | 0.0542 | | | | |
| 4 | 52.8438 | 2.8781 | 1.54481 | 74.33 | | |
| 5 | 170.7024 | DD[5] | | | | |
| 6 | 34.8870 | 0.5567 | 2.00001 | 28.60 | | |
| 7 | 12.5466 | 6.5190 | | | | |
| 8 | −21.1607 | 0.5068 | 1.69429 | 56.75 | | |
| 9 | 14.4339 | 4.8037 | 1.85955 | 22.65 | | |
| 10 | −37.3578 | 1.1105 | | | | |
| 11 | −17.3240 | 0.4958 | 1.97753 | 26.20 | | |
| 12 | −27.7685 | DD[12] | | | | |
| 13 (St) | ∞ | 0.0977 | | | | |
| *14 | 11.4233 | 2.8880 | 1.62898 | 35.42 | | |
| *15 | −121.9364 | 3.0569 | | | | |
| 16 | −162.8561 | 0.4882 | 1.99978 | 26.84 | | |
| 17 | 9.9411 | 3.1184 | 1.43602 | 90.89 | | |
| 18 | −50.5203 | DD[18] | | | | |
| *19 | 18.0510 | 2.2143 | 1.43633 | 90.85 | | 3.15 |
| *20 | −68.8706 | 2.0442 | | | | |
| 21 | 56.4962 | 0.4951 | 1.99916 | 15.04 | | |
| 22 | 20.3846 | 3.1341 | 1.86288 | 30.23 | | |
| 23 | −22.9020 | DD[23] | | | | |
| 24 | 22.4685 | 1.7043 | 1.98989 | 17.04 | | |
| 25 | 61.0882 | 0.5088 | 1.90301 | 38.52 | | |
| 26 | 12.0467 | DD[26] | | | | |
| 27 | −17.1604 | 0.4961 | 1.84138 | 37.38 | | |
| 28 | 121.0330 | 0.3630 | | | | |
| 29 | 42.4081 | 2.1431 | 2.00069 | 25.50 | | |
| 30 | ∞ | DD[30] | | | 18.877 | |

TABLE 38
Example 13

| | Wide | Middle | Tele |
|---|---|---|---|
| Zr | 1.0 | 2.4 | 4.7 |
| f | 16.89 | 39.94 | 79.53 |
| Bf | 11.00 | 25.54 | 35.20 |
| FNo. | 3.61 | 5.48 | 6.82 |
| 2ω[°] | 85.0 | 37.8 | 19.4 |
| DD[5] | 0.30 | 15.61 | 34.24 |
| DD[12] | 13.81 | 5.94 | 2.06 |
| DD[18] | 0.27 | 0.43 | 0.43 |
| DD[23] | 0.30 | 0.28 | 0.33 |
| DD[26] | 9.43 | 9.15 | 9.45 |
| DD[30] | 11.00 | 25.54 | 35.20 |

TABLE 39
Example 13

| Sn | 14 | 15 | 19 | 20 |
|---|---|---|---|---|
| KA | 1.0000000E+00 | 1.0000000E+00 | 1.0000000E+00 | 1.0000000E+00 |
| A4 | 1.4998692E−05 | 1.2075224E−04 | 6.4251120E−05 | 1.2828373E−04 |
| A6 | 3.1114307E−07 | 5.1855396E−07 | 2.4332316E−06 | 1.9572700E−06 |
| A8 | 1.3092437E−07 | 9.8895613E−08 | −2.4146394E−08 | 4.3936482E−08 |
| A10 | −9.8591835E−09 | −3.8310514E−09 | 2.7131878E−09 | −9.1147963E−10 |
| A12 | 4.1750781E−10 | −9.3426618E−11 | −4.1885565E−11 | 7.2714451E−11 |
| A14 | −6.7428784E−12 | 1.7165458E−11 | 4.9776393E−14 | −1.1690321E−12 |
| A16 | −5.1116477E−15 | −5.7478070E−13 | 2.0867521E−14 | 4.2543523E−15 |
| A18 | 1.1729684E−15 | 6.8175235E−15 | −1.6031092E−16 | 3.2193548E−16 |
| A20 | 0.0000000E+00 | 0.0000000E+00 | 0.0000000E+00 | 0.0000000E+00 |

### Example 14

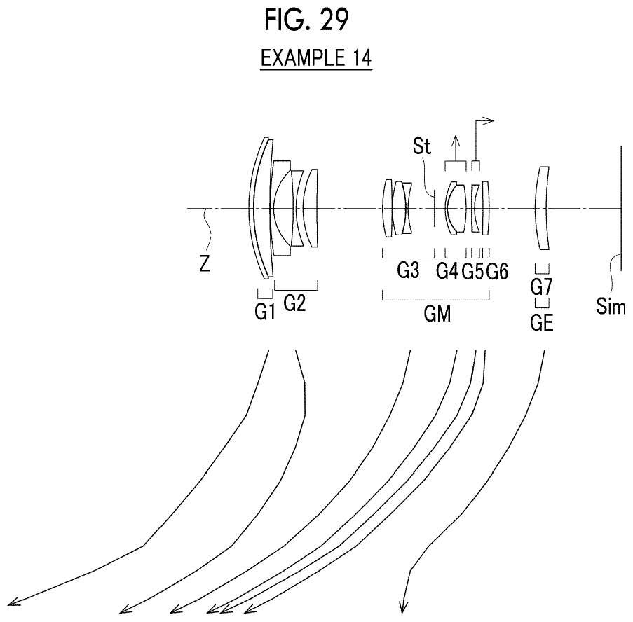

A configuration and a moving path of a variable magnification optical system of Example 14 are illustrated in FIG. 29. The variable magnification optical system of Example 14 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, the sixth lens group G6 having a positive refractive power, and a seventh lens group G7 having a positive refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, the seven lens groups move on different moving paths along the optical axis Z by changing spacings with respect to adjacent lens groups. The vibration-proof group consists of the fourth lens group G4. The focus lens group consists of the fifth lens group G5 and moves to the image side during the focusing from the infinite distance object to the short range object.

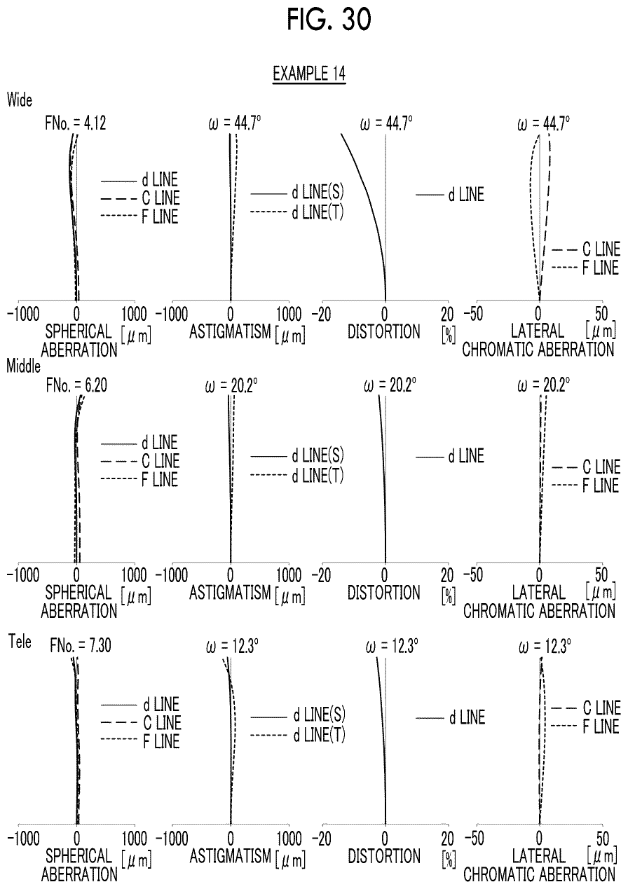

For the variable magnification optical system of Example 14, Table 40 shows basic lens data, Table 41 shows specifications and a variable surface spacing, Table 42 shows aspherical coefficients, and FIG. 30 illustrates each aberration diagram.

TABLE 40
Example 14

| Sn | R | D | Nd | νd | ED | SG |
|---|---|---|---|---|---|---|
| 1 | 40.3211 | 1.0000 | 1.59282 | 68.60 | 32.298 | 3.70 |
| 2 | 39.3148 | 3.5099 | 1.56930 | 42.01 | | 2.47 |
| 3 | 169.4901 | DD[3] | | | | |
| 4 | 72.9146 | 0.7501 | 1.94335 | 34.27 | | |
| 5 | 12.1321 | 4.1990 | | | | |
| 6 | −91.1946 | 0.6250 | 1.87696 | 41.18 | | |
| 7 | 22.8569 | 1.5003 | | | | |
| 8 | 21.1781 | 3.0002 | 1.88707 | 20.65 | | |
| 9 | 248.9003 | DD[9] | | | | |
| 10 | 27.6003 | 2.0482 | 2.00001 | 28.60 | | |
| 11 | −162.7313 | 0.0485 | | | | |
| 12 | 22.4983 | 2.9182 | 1.70215 | 46.66 | | |
| 13 | −21.3349 | 0.5000 | 1.93607 | 29.26 | | |
| 14 | 20.3808 | 5.6933 | | | | |
| 15 (St) | ∞ | DD[15] | | | | |
| 16 | 14.0593 | 0.4988 | 1.81576 | 27.56 | | |
| 17 | 8.1255 | 4.0237 | 1.68846 | 58.28 | | 3.97 |
| *18 | −25.5188 | DD[18] | | | | |
| 19 | 355.7476 | 0.4999 | 1.82691 | 46.31 | | |
| 20 | 14.0457 | DD[20] | | | | |
| *21 | −103.2084 | 1.3476 | 1.88600 | 20.70 | | |
| *22 | −54.3072 | DD[22] | | | | |
| 23 | 41.7176 | 2.3752 | 1.92879 | 33.00 | | |
| 24 | 72.2972 | DD[24] | | | 18.838 | |

TABLE 41
Example 14

| | Wide | Middle | Tele |
|---|---|---|---|
| Zr | 1.0 | 2.4 | 4.0 |
| f | 16.69 | 39.47 | 66.75 |
| Bf | 16.19 | 33.90 | 46.79 |
| FNo. | 4.12 | 6.20 | 7.30 |
| 2ω[°] | 89.4 | 40.4 | 24.6 |
| DD[3] | 0.10 | 12.75 | 23.00 |
| DD[9] | 14.17 | 2.71 | 0.17 |
| DD[15] | 2.30 | 0.13 | 0.20 |
| DD[18] | 1.20 | 1.10 | 0.09 |
| DD[20] | 1.81 | 3.42 | 4.99 |
| DD[22] | 9.94 | 12.46 | 31.11 |
| DD[24] | 16.19 | 33.90 | 46.79 |

TABLE 42
Example 14

| Sn | 18 | 21 | 22 |
|---|---|---|---|
| KA | 1.0000000E+00 | 1.0000000E+00 | 1.0000000E+00 |
| A4 | 1.1353581E−04 | 9.6692588E−05 | 6.4966316E−05 |
| A6 | −1.0671160E−06 | −1.7358598E−06 | −1.3946563E−06 |
| A8 | 5.5480841E−08 | 4.8477074E−08 | 3.4695684E−08 |
| A10 | −3.0737488E−09 | −2.1189588E−09 | −1.0773911E−09 |
| A12 | 1.0247447E−10 | 8.3606739E−11 | 2.7650354E−11 |
| A14 | −1.0238489E−12 | −1.6778444E−12 | −1.9374096E−13 |
| A16 | −3.2329760E−14 | 1.2938007E−14 | −4.9079099E−15 |
| A18 | 7.1789484E−16 | −1.8741931E−17 | 5.1715910E−17 |
| A20 | 0.0000000E+00 | 0.0000000E+00 | 0.0000000E+00 |

### Example 15

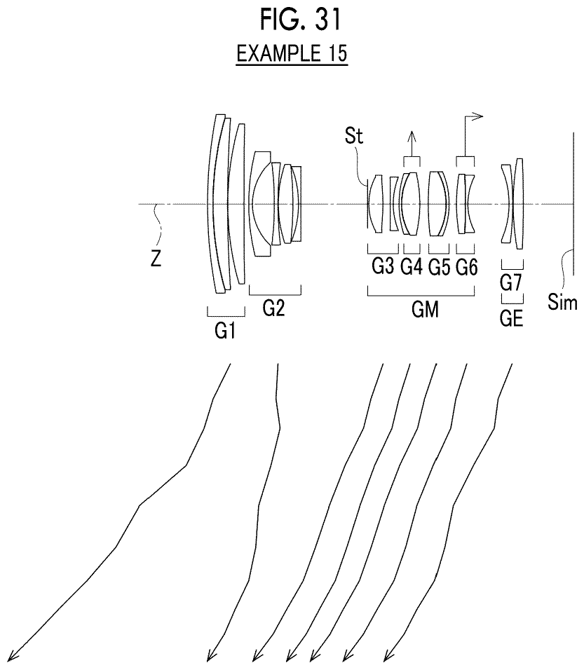

A configuration and a moving path of a variable magnification optical system of Example 15 are illustrated in FIG. 31. The variable magnification optical system of Example 15 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a negative refractive power, and the seventh lens group G7 having a negative refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, the seven lens groups move on different moving paths along the optical axis Z by changing spacings with respect to adjacent lens groups. The vibration-proof group consists of the fourth lens group G4. The focus lens group consists of the sixth lens group G6 and moves to the image side during the focusing from the infinite distance object to the short range object.

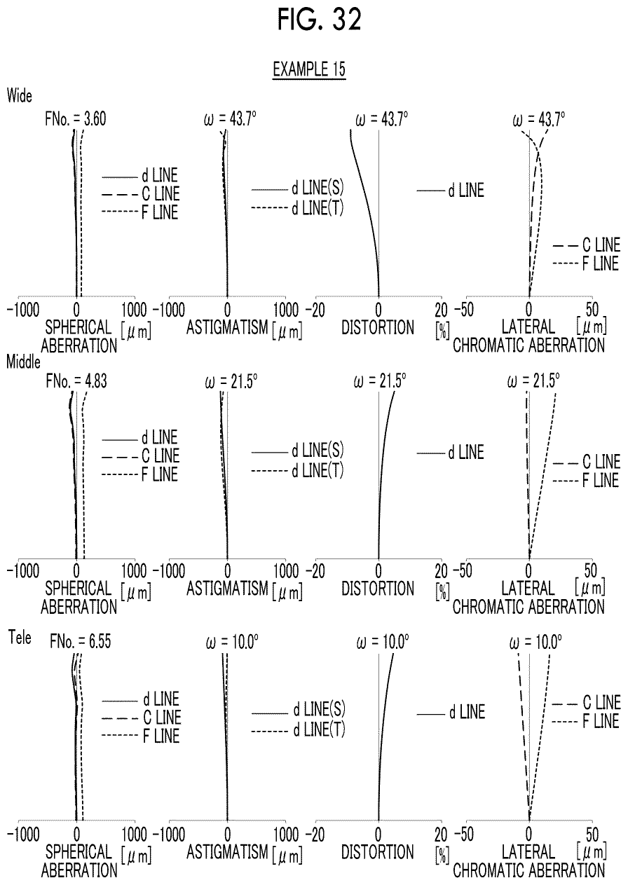

For the variable magnification optical system of Example 15, Table 43 shows basic lens data, Table 44 shows specifications and a variable surface spacing, Table 45 shows aspherical coefficients, and FIG. 32 illustrates each aberration diagram.

TABLE 43
Example 15

| Sn | R | D | Nd | νd | ED | SG |
|---|---|---|---|---|---|---|
| 1 | 93.5458 | 1.1250 | 1.92000 | 19.00 | 36.40 | 3.50 |
| 2 | 63.5980 | 2.9770 | 1.48749 | 70.24 | | 2.46 |
| 3 | 252.1946 | 0.0448 | | | | |
| 4 | 58.4823 | 3.2985 | 1.62830 | 61.42 | | |
| 5 | 1031.6507 | DD[5] | | | | |
| 6 | 44.3832 | 0.7498 | 1.94580 | 34.14 | | |
| 7 | 11.4814 | 4.4717 | | | | |
| 8 | −66.8283 | 0.7502 | 1.93978 | 34.76 | | |
| 9 | 69.5140 | 0.0704 | | | | |
| 10 | 24.7517 | 2.9690 | 1.99473 | 17.16 | | |
| 11 | −70.1181 | 1.1528 | | | | |
| 12 | −20.5178 | 0.4997 | 1.86634 | 42.27 | | |
| 13 | −2075.3423 | DD[13] | | | | |
| 14 (St) | ∞ | 0.2501 | | | | |
| *15 | 11.9820 | 2.8762 | 1.61881 | 63.85 | | |
| *16 | −34.0737 | 1.5091 | | | | |
| 17 | −484.9814 | 0.6001 | 1.95967 | 29.11 | | |
| 18 | 14.3256 | DD[18] | | | | |
| 19 | 19.8695 | 0.5001 | 1.90634 | 38.18 | | |
| 20 | 12.3784 | 3.7450 | 1.53901 | 47.69 | | 2.48 |
| *21 | −23.3140 | DD[21] | | | | |
| 22 | 53.3584 | 3.5505 | 1.76188 | 52.96 | | |
| 23 | −13.2220 | 0.6094 | 1.97015 | 22.30 | | |
| 24 | −16.3555 | DD[24] | | | | |
| 25 | 35.7765 | 1.8259 | 1.99738 | 28.62 | | |
| 26 | −126.9629 | 0.5098 | 1.88300 | 40.76 | | |
| 27 | 11.9649 | DD[27] | | | | |
| 28 | −18.1516 | 0.7502 | 1.91991 | 36.79 | | |
| 29 | −60.6688 | 0.1000 | | | | |
| 30 | 52.2792 | 2.0650 | 1.44292 | 67.26 | | |
| 31 | −204.8839 | DD[31] | | | 18.35 | |

TABLE 44
Example 15

| | Wide | Middle | Tele |
|---|---|---|---|
| Zr | 1.0 | 2.1 | 4.7 |
| f | 16.34 | 34.31 | 77.13 |
| Bf | 10.28 | 22.30 | 36.33 |
| FNo. | 3.60 | 4.83 | 6.55 |
| 2ω[°] | 87.4 | 43.0 | 20.0 |
| DD[5] | 1.00 | 15.53 | 31.86 |
| DD[13] | 13.63 | 6.60 | 1.50 |
| DD[18] | 1.20 | 1.92 | 2.56 |
| DD[21] | 1.71 | 1.36 | 1.24 |
| DD[24] | 1.51 | 2.01 | 2.07 |
| DD[27] | 8.41 | 6.51 | 7.52 |
| DD[31] | 10.28 | 22.30 | 36.33 |

TABLE 45
Example 15

| Sn | 15 | 16 | 21 |
|---|---|---|---|
| KA | 1.0000000E+00 | 1.0000000E+00 | 1.0000000E+00 |
| A4 | −1.7213070E−05 | 1.5139913E−04 | 6.7347893E−05 |
| A6 | 1.6810195E−06 | 1.4129080E−06 | 6.8628039E−07 |
| A8 | 4.4016648E−08 | −4.9229593E−09 | −5.0372635E−09 |
| A10 | −6.8508999E−09 | −1.2636993E−09 | −3.5680498E−11 |
| A12 | 2.6682650E−10 | 1.6375045E−10 | −1.4161378E−11 |
| A14 | 6.6554512E−12 | −1.0258186E−11 | 1.6099670E−12 |
| A16 | −5.5185189E−13 | 7.5063223E−13 | −5.7446965E−14 |
| A18 | 1.0055299E−14 | −2.6674484E−14 | 8.8273973E−16 |
| A20 | −3.4607195E−17 | 3.5075545E−16 | −5.0004753E−18 |

### Example 16

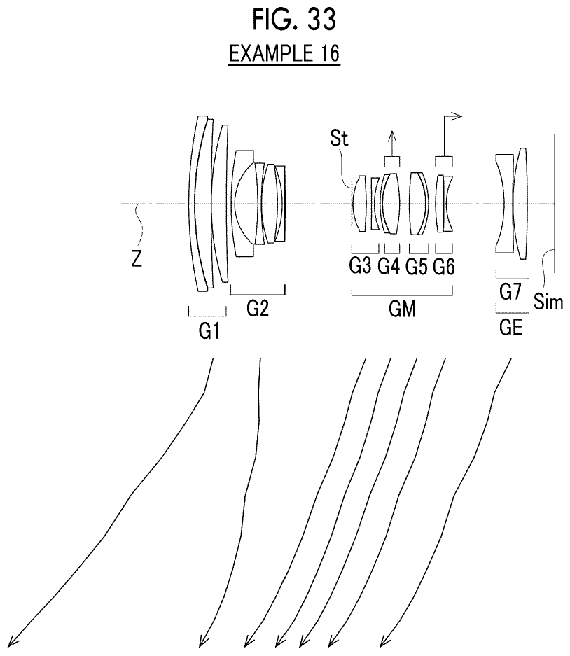

A configuration and a moving path of a variable magnification optical system of Example 16 are illustrated in FIG. 33. The variable magnification optical system of Example 16 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a negative refractive power, and the seventh lens group G7 having a negative refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, the seven lens groups move on different moving paths along the optical axis Z by changing spacings with respect to adjacent lens groups. The vibration-proof group consists of the fourth lens group G4. The focus lens group consists of the sixth lens group G6 and moves to the image side during the focusing from the infinite distance object to the short range object.

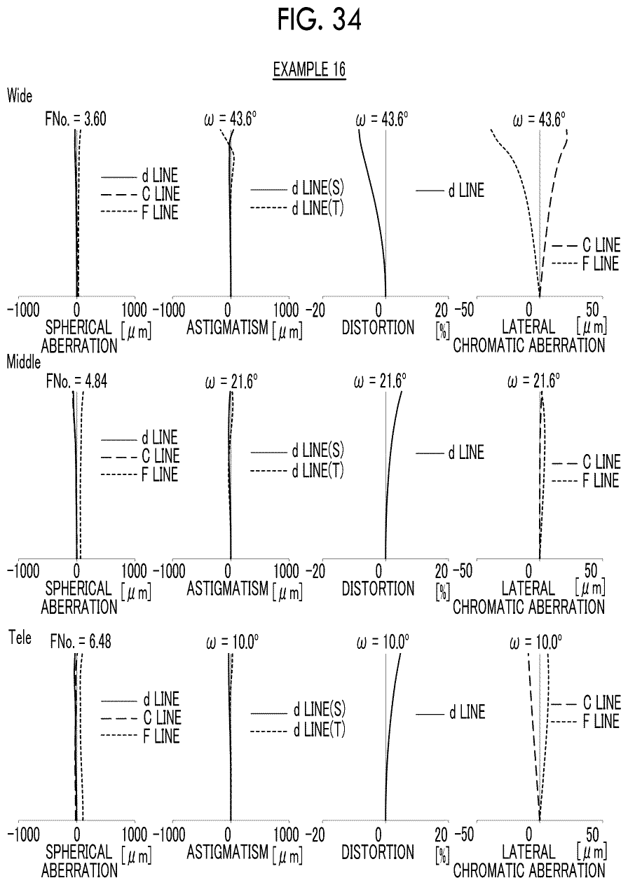

For the variable magnification optical system of Example 16, Table 46 shows basic lens data, Table 47 shows specifications and a variable surface spacing, Table 48 shows aspherical coefficients, and FIG. 34 illustrates each aberration diagram.

TABLE 46
Example 16

| Sn | R | D | Nd | νd | ED | SG | |
|---|---|---|---|---|---|---|---|
| 1 | 87.1795 | 1.2500 | 1.91981 | 19.01 | 36.80 | 3.50 | |
| 2 | 58.8499 | 3.4497 | 1.48749 | 70.32 | | 2.45 | |
| 3 | 354.8003 | 0.0434 | | | | | |
| 4 | 58.6537 | 3.1808 | 1.68747 | 58.33 | | | |
| 5 | 422.1665 | DD[5] | | | | | |
| 6 | 57.9541 | 0.7501 | 1.86393 | 42.52 | | | |
| 7 | 11.3240 | 4.8557 | | | | | |
| 8 | −59.9428 | 0.7502 | 2.00001 | 19.68 | | | |
| 9 | 55.7012 | 0.0354 | | | | | |
| 10 | 24.8283 | 3.3490 | 1.96816 | 16.59 | | | |
| 11 | −48.1353 | 1.0235 | | | | | |
| 12 | −20.8934 | 0.4994 | 1.77936 | 51.17 | | | |
| 13 | −415.5152 | DD[13] | | | | | |
| 14 (St) | ∞ | 0.2500 | | | | | |
| *15 | 11.9795 | 2.8112 | 1.61881 | 63.85 | | | |
| *16 | −34.9824 | 1.0949 | | | | | |
| 17 | −310.2383 | 0.6000 | 1.95125 | 30.51 | | | |
| 18 | 14.3621 | DD[18] | | | | | |
| 19 | 19.7814 | 0.5001 | 1.91144 | 37.66 | | | |
| 20 | 12.6082 | 3.6255 | 1.52996 | 63.85 | | 2.78 | |
| *21 | −24.3203 | DD[21] | | | | | |
| 22 | 52.7793 | 3.4735 | 1.75006 | 41.61 | | | |
| 23 | −12.8621 | 0.5752 | 2.00000 | 16.88 | | | |
| 24 | −16.4500 | DD[24] | | | | | |
| 25 | 35.8962 | 1.7378 | 1.97723 | 18.40 | | | |
| 26 | −126.1802 | 0.5094 | 1.88300 | 40.76 | | | |
| 27 | 11.9725 | DD[27] | | | | | |
| *28 | −26.0890 | 1.7817 | 1.64176 | 22.46 | | 1.22 | Pla |
| *29 | 111.2672 | 0.1000 | | | | | |
| 30 | 43.3874 | 3.0002 | 1.43600 | 67.00 | | | |
| 31 | −208.3166 | DD[31] | | | 23.287 | | |

TABLE 47
Example 16

| | Wide | Middle | Tele |
|---|---|---|---|
| Zr | 1.0 | 2.1 | 4.7 |
| f | 16.27 | 34.17 | 76.80 |
| Bf | 5.76 | 17.85 | 33.29 |
| FNo. | 3.60 | 4.84 | 6.48 |
| 2ω[°] | 87.2 | 43.2 | 20.0 |
| DD[5] | 0.99 | 15.28 | 31.29 |
| DD[13] | 14.03 | 6.87 | 1.49 |
| DD[18] | 1.20 | 1.78 | 2.49 |
| DD[21] | 2.03 | 1.82 | 1.46 |
| DD[24] | 1.49 | 1.63 | 1.55 |
| DD[27] | 12.18 | 9.97 | 9.23 |
| DD[31] | 5.76 | 17.85 | 33.29 |

TABLE 48
Example 16

| Sn | 15 | 16 | 21 | 28 |
|---|---|---|---|---|
| KA | 1.0000000E+00 | 1.0000000E+00 | 1.0000000E+00 | 1.0000000E+00 |
| A4 | −9.6563418E−06 | 1.4698217E−04 | 6.5681690E−05 | −3.4194461E−05 |
| A6 | 7.3007111E−07 | 9.4280681E−08 | 6.3507140E−07 | 3.9770094E−08 |
| A8 | 2.3237464E−08 | 6.8453817E−08 | −1.8769955E−08 | −2.6249819E−10 |
| A10 | 7.9184850E−10 | −2.7164323E−09 | 1.2712629E−09 | 1.5025521E−10 |
| A12 | −5.9189022E−11 | 1.4045796E−10 | −4.3592831E−11 | −2.2826642E−12 |
| A14 | 9.5572117E−13 | −7.8531764E−12 | 4.8864181E−13 | −2.6568578E−14 |
| A16 | 1.8174952E−13 | 5.5771787E−13 | 1.2501539E−14 | 1.4959030E−16 |
| A18 | −8.2501215E−15 | −1.8893137E−14 | −4.1895969E−16 | 1.3184233E−17 |
| A20 | 1.1619738E−16 | 2.4780225E−16 | 3.4546373E−18 | −1.2428563E−19 |

| Sn | 29 |
|---|---|
| KA | 1.0000000E+00 |
| A4 | −3.6505153E−05 |
| A6 | −1.6795064E−08 |
| A8 | 5.7519745E−09 |
| A10 | −6.4779144E−11 |
| A12 | −4.2512222E−13 |
| A14 | 7.1437626E−15 |
| A16 | 3.4712053E−17 |
| A18 | −5.2834220E−19 |
| A20 | 5.7437455E−22 |

### Example 17

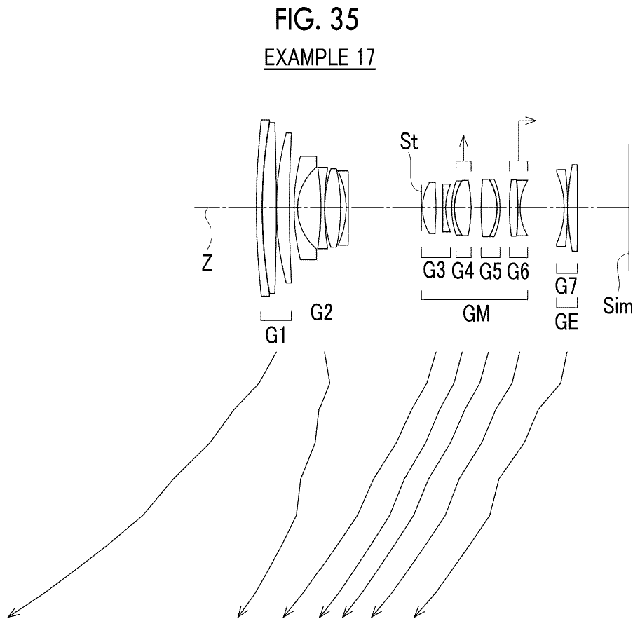

A configuration and a moving path of a variable magnification optical system of Example 17 are illustrated in FIG. 35. The variable magnification optical system of Example 17 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a negative refractive power, and the seventh lens group G7 having a negative refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, the seven lens groups move on different moving paths along the optical axis Z by changing spacings with respect to adjacent lens groups. The vibration-proof group consists of the fourth lens group G4. The focus lens group consists of the sixth lens group G6 and moves to the image side during the focusing from the infinite distance object to the short range object.

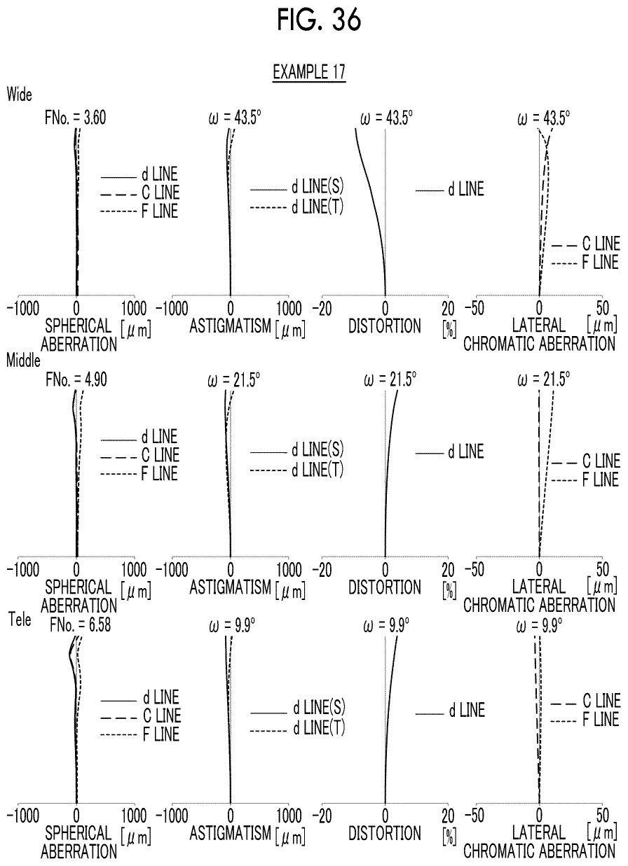

For the variable magnification optical system of Example 17, Table 49 shows basic lens data, Table 50 shows specifications and a variable surface spacing, Table 51 shows aspherical coefficients, and FIG. 36 illustrates each aberration diagram.

TABLE 49
Example 17

| Sn | R | D | Nd | νd | ED | SG |
|---|---|---|---|---|---|---|
| 1 | 187.5654 | 1.2501 | 1.96146 | 16.93 | 40.00 | 3.83 |
| 2 | 121.8289 | 3.0100 | 1.61974 | 62.75 | | 3.77 |
| 3 | −602.7968 | 0.0492 | | | | |
| 4 | 70.3451 | 2.7499 | 1.51031 | 79.58 | | |
| 5 | 323.3656 | DD[5] | | | | |
| 6 | 50.9488 | 0.7501 | 1.97942 | 30.70 | | |
| 7 | 12.6887 | 4.9067 | | | | |
| 8 | −71.6847 | 0.7499 | 1.93120 | 35.64 | | |
| 9 | 61.9517 | 0.0488 | | | | |
| 10 | 30.7067 | 3.4002 | 1.94493 | 18.36 | | |
| 11 | −44.9780 | 1.1690 | | | | |
| 12 | −21.2823 | 0.4997 | 1.71846 | 56.80 | | |
| 13 | −546.9633 | DD[13] | | | | |
| 14 (St) | ∞ | 0.2498 | | | | |
| *15 | 12.4825 | 2.8665 | 1.60578 | 41.74 | | |
| *16 | −41.9177 | 1.4784 | | | | |
| 17 | −308.5332 | 0.6000 | 1.92480 | 27.95 | | |
| 18 | 14.8517 | DD[18] | | | | |
| 19 | 20.3432 | 0.5776 | 1.78754 | 47.64 | | |
| 20 | 12.5265 | 3.5862 | 1.52450 | 66.99 | | 2.92 |
| *21 | −26.5441 | DD[21] | | | | |
| 22 | 61.3690 | 3.4047 | 1.76239 | 52.91 | | |
| 23 | −13.6797 | 0.6578 | 1.95512 | 17.24 | | |
| 24 | −17.3624 | DD[24] | | | | |
| 25 | 44.9341 | 1.8182 | 1.99834 | 15.30 | | |
| 26 | −79.7413 | 0.5098 | 1.89883 | 26.90 | | |
| 27 | 13.2079 | DD[27] | | | | |
| 28 | −21.2641 | 0.7498 | 1.77410 | 51.71 | | |
| 29 | −80.8941 | 0.1000 | | | | |
| 30 | 53.8178 | 2.0002 | 1.64284 | 60.52 | | |
| 31 | −1160.2235 | DD[31] | | | 19.643 | |

TABLE 50
Example 17

| | Wide | Middle | Tele |
|---|---|---|---|
| Zr | 1.0 | 2.1 | 4.7 |
| f | 16.55 | 34.75 | 78.12 |
| Bf | 11.05 | 25.64 | 43.79 |
| FNo. | 3.60 | 4.90 | 6.58 |
| 2ω[°] | 87.0 | 43.0 | 19.8 |
| DD[5] | 1.00 | 18.04 | 40.01 |
| DD[13] | 15.64 | 7.27 | 1.50 |
| DD[18] | 1.27 | 2.26 | 3.37 |
| DD[21] | 2.13 | 1.68 | 1.38 |
| DD[24] | 1.98 | 1.86 | 1.50 |
| DD[27] | 9.41 | 7.76 | 8.39 |
| DD[31] | 11.05 | 25.64 | 43.79 |

TABLE 51
Example 17

| Sn | 15 | 16 | 21 |
|---|---|---|---|
| KA | 1.0000000E+00 | 1.0000000E+00 | 1.0000000E+00 |
| A4 | 2.9920408E−06 | 1.2831914E−04 | 7.0356418E−05 |
| A6 | 5.8910335E−07 | −1.1785356E−07 | 5.4766410E−07 |
| A8 | 4.3642720E−08 | 1.0080086E−07 | −9.8198316E−09 |
| A10 | 3.7932733E−10 | −3.0090674E−09 | 4.8193219E−10 |
| A12 | −1.0584732E−10 | 1.0955704E−10 | −1.7241375E−11 |
| A14 | 2.8906333E−12 | −1.1224139E−11 | 3.4369826E−13 |
| A16 | 1.7200216E−13 | 8.4353005E−13 | −2.7250043E−15 |
| A18 | −8.5387059E−15 | −2.5384178E−14 | 0.0000000E+00 |
| A20 | 1.1006258E−16 | 2.8167917E−16 | 0.0000000E+00 |

### Example 18

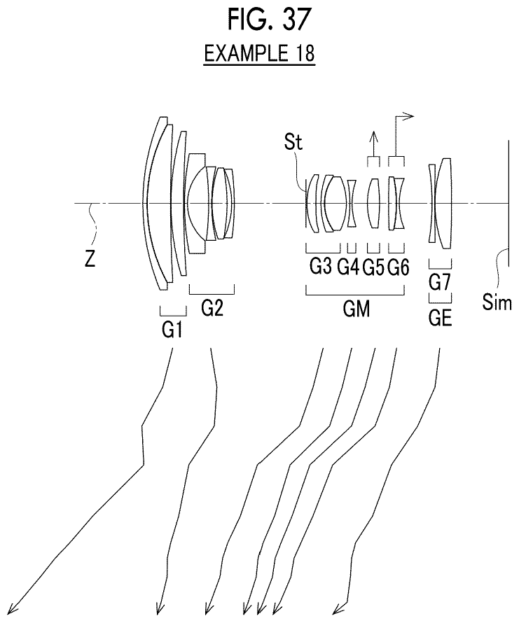

A configuration and a moving path of a variable magnification optical system of Example 18 are illustrated in FIG. 37. The variable magnification optical system of Example 18 consists of, in order from the object side to the image side, the first lens group G1 having a positive refractive power, the second lens group G2 having a negative refractive power, the third lens group G3 having a positive refractive power, the fourth lens group G4 having a negative refractive power, the fifth lens group G5 having a positive refractive power, the sixth lens group G6 having a negative refractive power, and the seventh lens group G7 having a positive refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, the seven lens groups move on different moving paths along the optical axis Z by changing spacings with respect to adjacent lens groups. The vibration-proof group consists of the fifth lens group G5. The focus lens group consists of the sixth lens group G6 and moves to the image side during the focusing from the infinite distance object to the short range object.

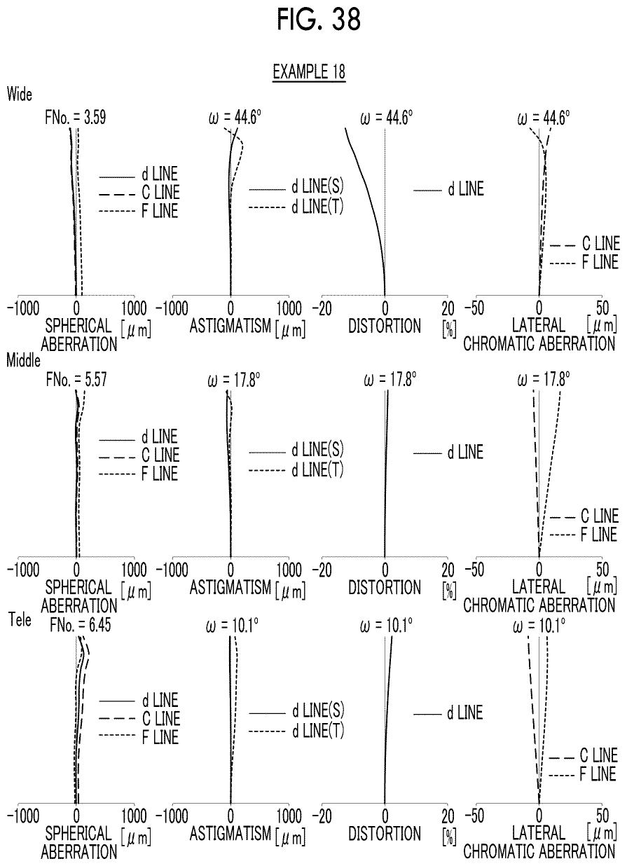

For the variable magnification optical system of Example 18, Table 52 shows basic lens data, Table 53 shows specifications and a variable surface spacing, Table 54 shows aspherical coefficients, and FIG. 38 illustrates each aberration diagram.

TABLE 52
Example 18

| Sn | R | D | Nd | νd | ED | SG | |
|---|---|---|---|---|---|---|---|
| 1 | 50.8121 | 0.9750 | 1.96297 | 16.85 | 37.969 | 3.87 | |
| 2 | 37.4228 | 5.2877 | 1.48749 | 70.32 | | 2.45 | |
| 3 | 317.8228 | 0.1000 | | | | | |
| 4 | 58.2073 | 2.8401 | 1.66773 | 36.32 | | | |
| 5 | 218.8034 | DD[5] | | | | | |
| 6 | 58.3863 | 0.6750 | 1.85057 | 43.88 | | | |
| 7 | 10.8949 | 4.7850 | | | | | |
| 8 | −62.4825 | 0.6749 | 1.91822 | 36.96 | | | |
| 9 | 35.8110 | 0.1000 | | | | | |
| 10 | 24.6042 | 3.3654 | 1.90342 | 20.10 | | | |
| 11 | −41.7645 | 1.0484 | | | | | |
| 12 | −18.3882 | 0.6002 | 1.85656 | 43.27 | | | |
| 13 | −57.4405 | DD[13] | | | | | |
| 14 (St) | ∞ | 0.2498 | | | | | |
| *15 | 16.9899 | 1.9998 | 1.57328 | 69.21 | | | |
| *16 | 100.3411 | 1.1248 | | | | | |
| 17 | 18.4885 | 0.8272 | 1.78285 | 26.12 | | | |
| 18 | 10.2381 | 4.9171 | 1.55126 | 52.78 | | | |
| 19 | −14.1057 | DD[19] | | | | | |
| 20 | −26.8984 | 0.4999 | 1.56630 | 42.57 | | | |
| 21 | 16.0063 | DD[21] | | | | | |
| *22 | 15.5981 | 2.7289 | 1.51679 | 74.11 | | 3.27 | |
| *23 | −34.0712 | DD[23] | | | | | |
| 24 | 166.1458 | 1.7502 | 1.87515 | 23.55 | | | |
| 25 | −29.7613 | 0.6598 | 1.74590 | 31.96 | | | |
| 26 | 14.9108 | DD[26] | | | | | |
| *27 | −55.3272 | 0.6199 | 1.53409 | 55.87 | | 1.01 | Pla |
| *28 | 337.8526 | 0.0489 | | | | | |
| 29 | 28.7246 | 3.7502 | 1.43601 | 67.00 | | | |
| 30 | −185.9954 | DD[30] | | | 20.302 | | |

TABLE 53
Example 18

| | Wide | Middle | Tele |
|---|---|---|---|
| Zr | 1.0 | 2.7 | 4.7 |
| f | 16.48 | 43.88 | 77.80 |
| Bf | 12.90 | 28.08 | 37.03 |
| FNo. | 3.59 | 5.57 | 6.45 |
| 2ω[°] | 89.2 | 35.6 | 20.2 |
| DD[5] | 0.20 | 11.02 | 25.35 |
| DD[13] | 16.06 | 4.69 | 1.70 |
| DD[19] | 0.80 | 1.95 | 2.96 |
| DD[21] | 3.46 | 2.13 | 1.30 |
| DD[23] | 2.05 | 1.92 | 0.60 |
| DD[26] | 7.39 | 11.11 | 11.14 |
| DD[30] | 12.90 | 28.08 | 37.03 |

TABLE 54
Example 18

| Sn | 15 | 16 | 22 | 23 |
|---|---|---|---|---|
| KA | 1.0000000E+00 | 1.0000000E+00 | 1.0000000E+00 | 1.0000000E+00 |
| A4 | 1.4090512E−04 | 2.5471160E−04 | −8.7415201E−06 | 6.5758318E−05 |
| A6 | 7.8973357E−07 | 2.0560609E−06 | 5.8224735E−07 | 3.7420194E−07 |
| A8 | 6.8049440E−08 | 3.9389054E−08 | 6.0353398E−08 | 6.5455917E−08 |
| A10 | −1.4755165E−09 | 4.3800419E−11 | −6.8564501E−10 | −2.9832030E−10 |
| A12 | −5.2798156E−13 | −2.1462941E−11 | 6.0408566E−11 | 3.9043048E−11 |
| A14 | 2.3160035E−13 | −8.9521802E−14 | −2.3434172E−12 | −1.9948235E−12 |
| A16 | −1.4151797E−15 | 5.2752943E−15 | 4.2985799E−14 | 4.7627894E−14 |

| Sn | 27 | 28 |
|---|---|---|
| KA | 1.0000000E+00 | 1.0000000E+00 |
| A4 | −2.0427306E−06 | −1.5144538E−06 |
| A6 | 8.8760565E−09 | −3.1734004E−08 |
| A8 | −3.6882543E−10 | 1-0972962E−10 |
| A10 | −7.2677492E−12 | −1.0252865E−12 |
| A12 | −8.0605612E−15 | −9.7513660E−14 |
| A14 | 1.4365232E−16 | −1.1377262E−15 |
| A16 | −2.4288603E−17 | 7.5740996E−18 |

### Example 19

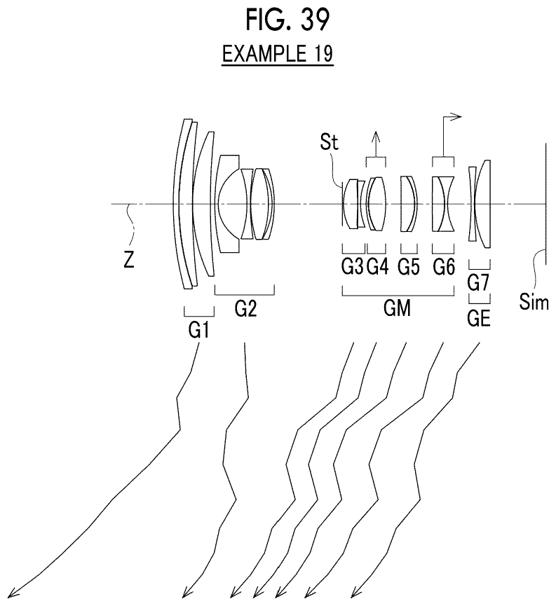

A configuration and a moving path of a variable magnification optical system of Example 19 are illustrated in FIG. 39. The variable magnification optical system of Example 19 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a negative refractive power, and the seventh lens group G7 having a positive refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, the seven lens groups move on different moving paths along the optical axis Z by changing spacings with respect to adjacent lens groups. The vibration-proof group consists of the fourth lens group G4. The focus lens group consists of the sixth lens group G6 and moves to the image side during the focusing from the infinite distance object to the short range object.

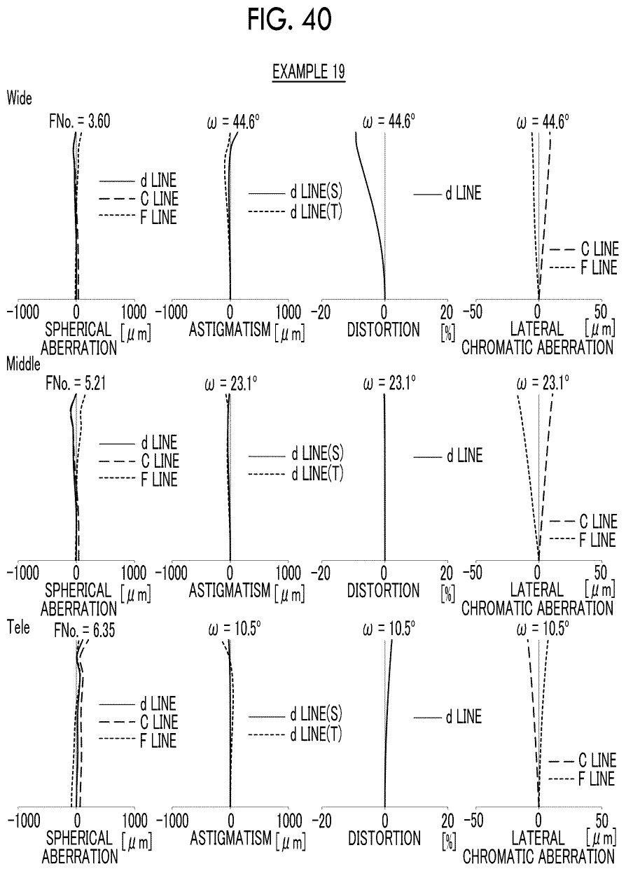

For the variable magnification optical system of Example 19, Table 55 shows basic lens data, Table 56 shows specifications and a variable surface spacing, Table 57 shows aspherical coefficients, and FIG. 40 illustrates each aberration diagram.

TABLE 55
Example 19

| Sn | R | D | Nd | νd | ED | SG |
|---|---|---|---|---|---|---|
| 1 | 82.8543 | 1.2501 | 1.96295 | 16.85 | 40.00 | 3.87 |
| 2 | 64.4811 | 3.0101 | 1.71741 | 56.85 | | 4.05 |
| 3 | 169.2211 | 0.0442 | | | | |
| 4 | 42.1252 | 3.9348 | 1.54832 | 73.79 | | |
| 5 | 170.1996 | DD[5] | | | | |
| 6 | 52.3004 | 0.7498 | 1.85055 | 43.89 | | |
| 7 | 9.7755 | 6.3987 | | | | |
| 8 | −25.4767 | 0.7500 | 1.94259 | 34.47 | | |
| 9 | 55.7309 | 0.0867 | | | | |
| 10 | 29.8367 | 3.9163 | 1.92730 | 22.96 | | |
| 11 | −25.2078 | 0.8225 | | | | |
| 12 | −16.8110 | 0.4999 | 1.86519 | 34.12 | | |
| 13 | −27.2706 | DD[13] | | | | |
| 14 (St) | ∞ | 0.2503 | | | | |
| *15 | 13.4259 | 3.1282 | 1.65662 | 33.10 | | |
| *16 | −54.2571 | 0.0480 | | | | |
| 17 | −305.8677 | 0.5998 | 1.84201 | 44.76 | | |
| 18 | 14.9828 | DD[18] | | | | |
| 19 | 18.5723 | 0.5001 | 1.94164 | 18.51 | | |
| 20 | 12.7453 | 3.8261 | 1.54885 | 73.71 | | 3.62 |
| *21 | −21.8137 | DD[21] | | | | |
| 22 | −420.7509 | 3.0040 | 1.74734 | 54.45 | | |
| 23 | −12.5766 | 0.5751 | 1.98753 | 15.62 | | |
| 24 | −17.4131 | DD[24] | | | | |
| 25 | 393.7668 | 2.7467 | 2.00000 | 20.38 | | |
| 26 | −15.1127 | 0.6757 | 1.92915 | 34.19 | | |
| 27 | 14.5682 | DD[27] | | | | |
| 28 | −68.0139 | 0.7498 | 1.43615 | 90.87 | | |
| 29 | 95.4264 | 0.1000 | | | | |
| 30 | 24.5882 | 3.3805 | 1.46394 | 66.60 | | |
| 31 | ∞ | DD[31] | | | 20.533 | |

TABLE 56
Example 19

| | Wide | Middle | Tele |
|---|---|---|---|
| Zr | 1.0 | 2.1 | 1.7 |
| f | 15.88 | 33.36 | 74.97 |
| Bf | 12.40 | 26.95 | 40.93 |
| FNo. | 3.60 | 5.21 | 6.35 |
| 2ω[°] | 89.2 | 46.2 | 21.0 |
| DD[5] | 0.99 | 7.27 | 29.68 |
| DD[13] | 15.00 | 4.76 | 1.52 |
| DD[18] | 1.27 | 1.24 | 1.32 |
| DD[21] | 3.43 | 2.30 | 1.71 |
| DD[24] | 3.33 | 3.00 | 1.50 |
| DD[27] | 5.21 | 7.21 | 7.42 |
| DD[31] | 12.40 | 26.95 | 40.93 |

TABLE 57
Example 19

| Sn | 15 | 16 | 21 |
|---|---|---|---|
| KA | 1.0000000E+00 | 1.0000000E4+00 | 1.0000000E+00 |
| A4 | 4.3931328E−05 | 1.6167722E−04 | 3.7070427E−05 |
| A6 | 8.2931270E−07 | −3.8683750E−08 | 3.3335377E−07 |
| A8 | 6.1630471E−08 | 1.5570662E−07 | −9.3426327E−09 |
| A10 | 1.0906064E−09 | −3.6595348E−09 | 6.7774240E−10 |
| A12 | −1.2942679E−10 | 1.0674455E−10 | −4.0981169E−11 |
| A14 | 2.8708419E−12 | −9.1405877E−12 | 1.0344912E−12 |
| A16 | 1.6632962E−13 | 7.2893510E−13 | −9.1444458E−15 |
| A18 | −7.6096797E−15 | −2.2409489E−14 | 0.0000000E+00 |
| A20 | 8.9469248E−17 | 2.4989701E−16 | 0.0000000E+00 |

### Example 20

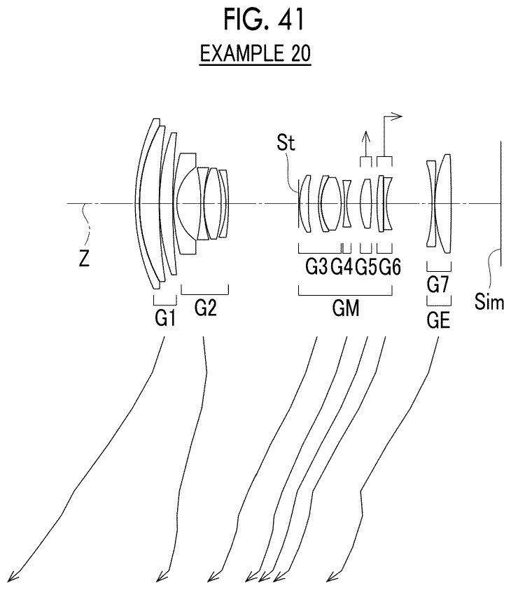

A configuration and a moving path of a variable magnification optical system of Example 20 are illustrated in FIG. 41. The variable magnification optical system of Example 20 consists of, in order from the object side to the image side, the first lens group G1 having a positive refractive power, the second lens group G2 having a negative refractive power, the third lens group G3 having a positive refractive power, the fourth lens group G4 having a negative refractive power, the fifth lens group G5 having a positive refractive power, the sixth lens group G6 having a negative refractive power, and the seventh lens group G7 having a negative refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, the seven lens groups move on different moving paths along the optical axis Z by changing spacings with respect to adjacent lens groups. The vibration-proof group consists of the fifth lens group G5. The focus lens group consists of the sixth lens group G6 and moves to the image side during the focusing from the infinite distance object to the short range object.

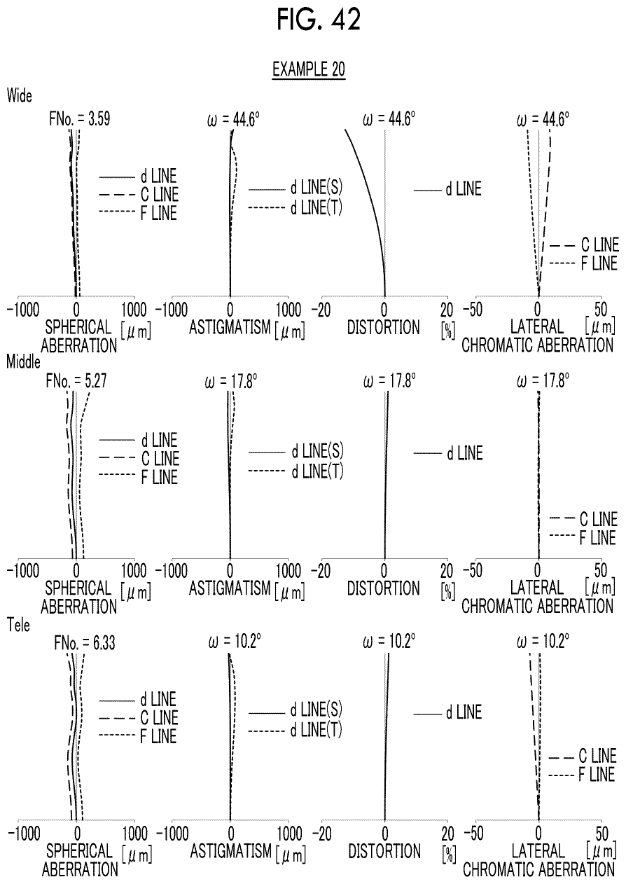

For the variable magnification optical system of Example 20, Table 58 shows basic lens data, Table 59 shows specifications and a variable surface spacing, Table 60 shows aspherical coefficients, and FIG. 42 illustrates each aberration diagram.

TABLE 58
Example 20

| Sn | R | D | Nd | νd | ED | SG | |
|---|---|---|---|---|---|---|---|
| 1 | 47.1699 | 0.9744 | 1.91999 | 19.00 | 37.852 | 3.50 | |
| 2 | 36.5503 | 4.5294 | 1.48749 | 70.32 | | 2.45 | |
| 3 | 113.9701 | 0.0459 | | | | | |
| 4 | 48.7685 | 3.0342 | 1.72608 | 56.41 | | | |
| 5 | 145.9591 | DD[5] | | | | | |
| 6 | 43.2518 | 0.7498 | 1.81868 | 47.15 | | | |
| 7 | 10.2768 | 5.5309 | | | | | |
| 8 | −41.1496 | 0.6750 | 1.95504 | 33.20 | | | |
| 9 | 29.4039 | 0.0429 | | | | | |
| 10 | 21.8803 | 3.9526 | 1.87729 | 21.14 | | | |
| 11 | −30.6235 | 1.0656 | | | | | |
| 12 | −19.1933 | 0.6002 | 1.90309 | 38.51 | | | |
| 13 | −55.5214 | DD[13] | | | | | |
| 14 (St) | ∞ | 0.2502 | | | | | |
| *15 | 16.2974 | 2.0002 | 1.51407 | 79.01 | | | |
| *16 | 117.3430 | 2.2996 | | | | | |
| 17 | 19.3371 | 0.6181 | 1.83129 | 30.86 | | | |
| 18 | 11.3061 | 4.5865 | 1.55460 | 71.68 | | | |
| 19 | −14.7813 | DD[19] | | | | | |
| 20 | −38.4197 | 0.4987 | 1.53162 | 52.06 | | | |
| 21 | 14.1164 | DD[21] | | | | | |
| *22 | 15.2672 | 2.5680 | 1.52071 | 78.00 | | 3.58 | |
| *23 | −40.6155 | DD[23] | | | | | |
| 24 | 39.3028 | 1.5000 | 1.97562 | 27.32 | | | |
| 25 | 1229.3792 | 0.6600 | 1.85514 | 43.42 | | | |
| 26 | 13.8920 | DD[26] | | | | | |
| *27 | −46.2970 | 0.6277 | 1.53409 | 55.87 | | 1.01 | Pla |
| *28 | 86.3952 | 0.0450 | | | | | |
| 29 | 28.2701 | 3.7502 | 1.43599 | 68.86 | | | |
| 30 | −249.9767 | DD[30] | | | 22.58 | | |

TABLE 59
Example 20

| | Wide | Middle | Tele |
|---|---|---|---|
| Zr | 1.0 | 2.7 | 4.7 |
| f | 16.48 | 43.87 | 77.78 |
| Bf | 11.40 | 28.85 | 37.03 |
| FNo. | 3.59 | 5.27 | 6.33 |
| 2ω[°] | 89.2 | 35.6 | 20.4 |
| DD[5] | 0.20 | 17.87 | 25.44 |
| DD[13] | 15.97 | 4.07 | 1.70 |
| DD[19] | 0.80 | 2.00 | 2.61 |
| DD[21] | 3.11 | 2.36 | 1.30 |
| DD[23] | 1.25 | 1.23 | 0.53 |
| DD[26] | 10.47 | 10.51 | 10.48 |
| DD[30] | 11.40 | 28.85 | 37.03 |

TABLE 60
Example 20

| Sn | 15 | 16 | 22 | 23 |
|---|---|---|---|---|
| KA | 1.0000000E+00 | 1.0000000E+00 | 1.0000000E+00 | 1.0000000E+00 |
| A4 | 9.8053258E−05 | 2.2994523E−04 | −2.0075025E−05 | 4.3031894E−05 |
| A6 | 1.0842912E−06 | 2.2778894E−06 | 6.5435826E−07 | 7.6211609E−07 |
| A8 | 3.8794600E−08 | 4.9220305E−08 | 3.6812162E−08 | 4.3578874E−08 |
| A10 | 2.2199020E−09 | −5.1050943E−11 | −6.8343036E−10 | −2.3493250E−09 |
| A12 | −1.8829006E−10 | −5.2347472E−11 | 4.5958770E−11 | 1.3580424E−10 |
| A14 | 4.3973685E−12 | 1.0207273E−12 | −1.4175832E−12 | −3.3959052E−12 |
| A16 | −3.5489579E−14 | −5.4887628E−15 | 2.7622060E−14 | 4.6697998E−14 |

| Sn | 27 | 28 |
|---|---|---|
| KA | 1.0000000E+00 | 1.0000000E+00 |
| A4 | −1.8719691E−05 | −2.7388770E−05 |
| A6 | −2.2914054E−08 | −3.3233893E−08 |
| A8 | 1.2529642E−09 | 5.2965218E−10 |
| A10 | −2.8025362E−11 | −8.1360959E−13 |
| A12 | −2.7824530E−14 | −1.7025909E−13 |
| A14 | 1.3607818E−15 | −1.1199301E−15 |
| A16 | −4.4593483E−17 | 7.3219396E−18 |

### Example 21

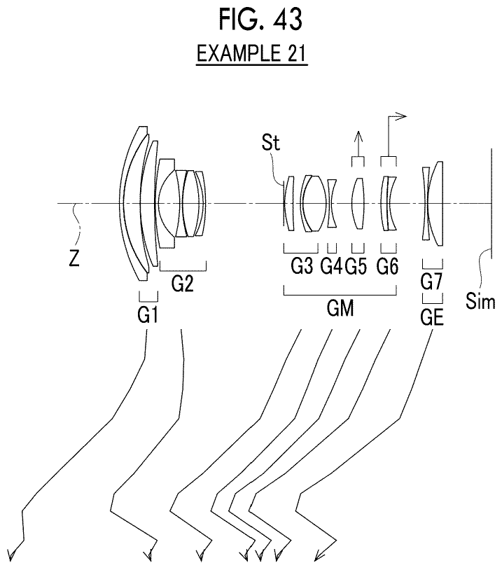

A configuration and a moving path of a variable magnification optical system of Example 21 are illustrated in FIG. 43. The variable magnification optical system of Example 21 consists of, in order from the object side to the image side, the first lens group G1 having a positive refractive power, the second lens group G2 having a negative refractive power, the third lens group G3 having a positive refractive power, the fourth lens group G4 having a negative refractive power, the fifth lens group G5 having a positive refractive power, the sixth lens group G6 having a negative refractive power, and the seventh lens group G7 having a negative refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, the seven lens groups move on different moving paths along the optical axis Z by changing spacings with respect to adjacent lens groups. The vibration-proof group consists of the fifth lens group G5. The focus lens group consists of the sixth lens group G6 and moves to the image side during the focusing from the infinite distance object to the short range object.

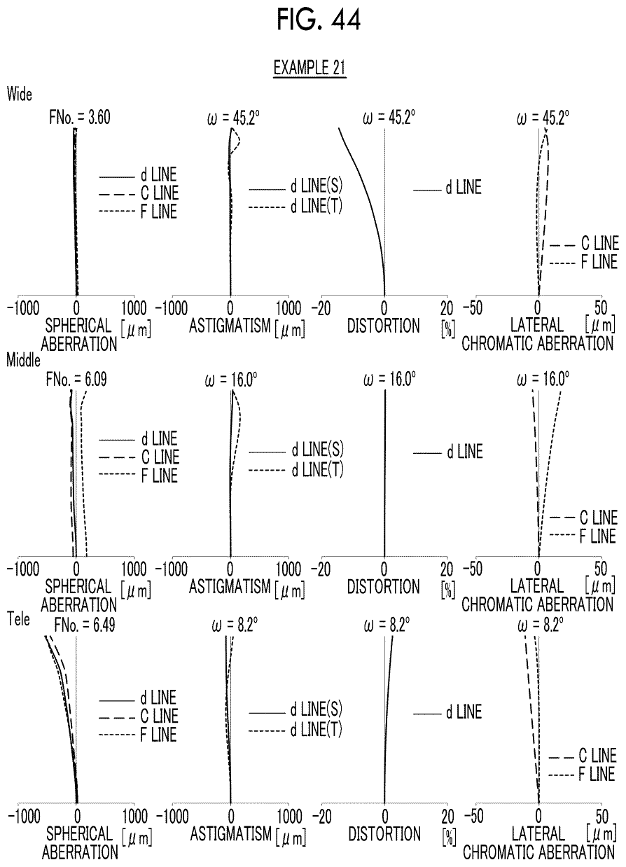

For the variable magnification optical system of Example 21, Table 61 shows basic lens data, Table 62 shows specifications and a variable surface spacing, Table 63 shows aspherical coefficients, and FIG. 44 illustrates each aberration diagram.

TABLE 61
Example 21

| Sn | R | D | Nd | νd | ED | SG |
|---|---|---|---|---|---|---|
| 1 | 43.5455 | 0.9990 | 1.96283 | 16.86 | 36.454 | 3.87 |
| 2 | 30.7129 | 4.0574 | 1.53615 | 72.45 | | 3.40 |
| 3 | 63.8189 | 0.0486 | | | | |
| 4 | 43.6738 | 3.4895 | 1.92999 | 35.76 | | |
| 5 | 161.2041 | DD[5] | | | | |
| 6 | 59.6117 | 0.7498 | 1.95745 | 32.95 | | |
| 7 | 11.6065 | 5.2076 | | | | |
| 8 | −37.3462 | 0.6751 | 1.95974 | 32.72 | | |
| 9 | 34.3701 | 0.0467 | | | | |
| 10 | 27.8531 | 4.0022 | 1.92655 | 18.67 | | |
| 11 | −27.7699 | 1.0277 | | | | |
| 12 | −18.6950 | 0.6001 | 1.88060 | 40.81 | | |
| 13 | −42.5444 | DD[13] | | | | |
| 14 (St) | ∞ | 0.2501 | | | | |
| *15 | 20.8182 | 2.0001 | 1.43600 | 90.90 | | |
| *16 | 293.1967 | 1.8225 | | | | |
| 17 | 20.5249 | 0.6181 | 1.81167 | 28.57 | | |
| 18 | 12.5026 | 5.6918 | 1.51465 | 59.18 | | |
| 19 | −14.4407 | DD[19] | | | | |
| 20 | −45.2385 | 0.4982 | 1.52271 | 50.74 | | |
| 21 | 15.2676 | DD[21] | | | | |
| *22 | 16.7393 | 2.9720 | 1.52995 | 76.59 | | 3.59 |
| *23 | −43.7069 | DD[23] | | | | |
| 24 | 33.1762 | 1.5002 | 1.97867 | 30.78 | | |
| 25 | 73.2769 | 0.6601 | 1.93093 | 34.16 | | |
| 26 | 14.9336 | DD[26] | | | | |
| 27 | −68.5120 | 0.6197 | 1.79613 | 49.45 | | |
| 28 | 90.6467 | 0.0502 | | | | |
| 29 | 24.9224 | 3.6550 | 1.44456 | 65.40 | | |
| 30 | ∞ | DD[30] | | | 21.817 | |

TABLE 62
Example 21

| | Wide | Middle | Tele |
|---|---|---|---|
| Zr | 1.0 | 3.0 | 5.8 |
| f | 16.50 | 49.51 | 96.54 |
| Bf | 11.99 | 36.83 | 40.85 |
| FNo. | 3.60 | 6.09 | 6.49 |
| 2ω[°] | 90.4 | 32.0 | 16.4 |
| DD[5] | 0.19 | 10.82 | 26.22 |
| DD[13] | 19.01 | 6.60 | 2.10 |
| DD[19] | 0.79 | 2.45 | 4.51 |
| DD[21] | 5.01 | 3.68 | 1.29 |
| DD[23] | 4.14 | 2.09 | 0.59 |
| DD[26] | 8.63 | 9.46 | 7.64 |
| DD[30] | 11.99 | 36.83 | 40.85 |

TABLE 63
Example 21

| Sn | 15 | 16 | 22 | 23 |
|---|---|---|---|---|
| KA | 1.0000000E+00 | 1.0000000E+00 | 1.0000000E+00 | 1.0000000E+00 |
| A4 | 2.6363196E−06 | 1.1702401E−04 | −2.0650814E−05 | 2.0912634E−05 |
| A6 | −1.2609196E−06 | −3.9539917E−07 | 2.1333243E−07 | 6.6195590E−07 |
| A8 | 5.8545021E−08 | 2.6283008E−08 | 2.4851681E−08 | −1.0384288E−08 |
| A10 | −1.6768347E−09 | 1.2636581E−10 | −1.8912516E−09 | −6.2427525E−10 |
| A12 | −1.9740547E−11 | −6.8899468E−11 | 8.3333385E−11 | 6.6238505E−11 |
| A14 | 9.0052899E−13 | 1.5351102E−12 | −1.6564024E−12 | −1.7058174E−12 |
| A16 | −8.4503217E−15 | −1.1098755E−14 | 1.3685509E−14 | 1.6132345E−14 |

### Example 22

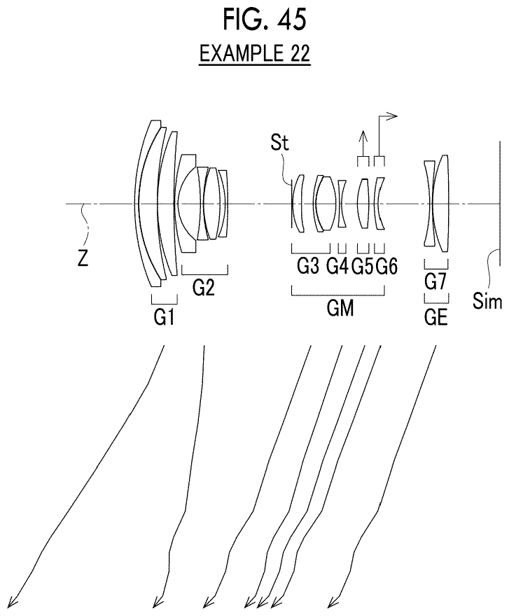

A configuration and a moving path of a variable magnification optical system of Example 22 are illustrated in FIG. 45. The variable magnification optical system of Example 22 consists of, in order from the object side to the image side, the first lens group G1 having a positive refractive power, the second lens group G2 having a negative refractive power, the third lens group G3 having a positive refractive power, the fourth lens group G4 having a negative refractive power, the fifth lens group G5 having a positive refractive power, the sixth lens group G6 having a negative refractive power, and the seventh lens group G7 having a negative refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, the third lens group G3, the fifth lens group G5, and the seventh lens group G7 move on the same moving path along the optical axis Z, and the first lens group G1, the second lens group G2, the third lens group G3, the fourth lens group G4, and the sixth lens group G6 move on different moving paths along the optical axis Z by changing spacings with respect to adjacent lens groups. The vibration-proof group consists of the fifth lens group G5. The focus lens group consists of the sixth lens group G6 and moves to the image side during the focusing from the infinite distance object to the short range object.

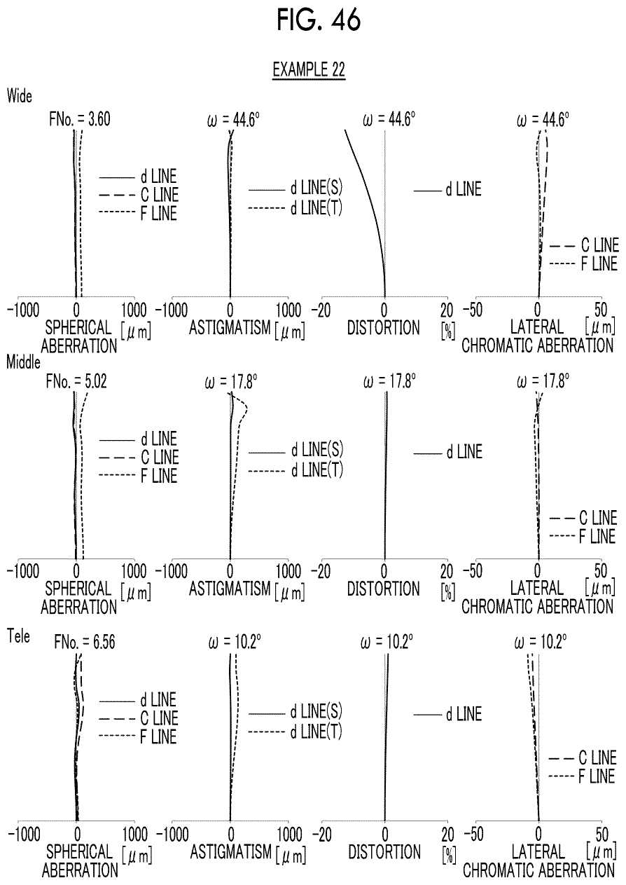

For the variable magnification optical system of Example 22, Table 64 shows basic lens data, Table 65 shows specifications and a variable surface spacing, Table 66 shows aspherical coefficients, and FIG. 46 illustrates each aberration diagram.

TABLE 64
Example 22

| Sn | R | D | Nd | νd | ED | SG | |
|---|---|---|---|---|---|---|---|
| 1 | 49.0827 | 0.9499 | 1.96463 | 16.78 | 37.8 | 4.41 | |
| 2 | 32.3324 | 4.2506 | 1.48749 | 70.32 | | 2.45 | |
| 3 | 71.7212 | 0.0488 | | | | | |
| 4 | 42.1906 | 3.7622 | 1.87728 | 33.98 | | | |
| 5 | 175.4657 | DD[5] | | | | | |
| 6 | 39.1750 | 0.7502 | 1.95698 | 33.00 | | | |
| 7 | 10.6574 | 5.1482 | | | | | |
| 8 | −46.4929 | 0.6752 | 1.94663 | 34.06 | | | |
| 9 | 30.2944 | 0.0664 | | | | | |
| 10 | 22.6806 | 3.7487 | 1.93718 | 18.14 | | | |
| 11 | −34.7010 | 1.1970 | | | | | |
| 12 | −19.1842 | 0.6000 | 1.85849 | 43.07 | | | |
| 13 | −90.3731 | DD[13] | | | | | |
| 14 (St) | ∞ | 0.2502 | | | | | |
| *15 | 16.5805 | 2.0015 | 1.48910 | 82.81 | | | |
| *16 | 127.7628 | 2.6764 | | | | | |
| 17 | 19.5092 | 0.6195 | 1.79787 | 25.11 | | | |
| 18 | 11.6037 | 4.6084 | 1.54260 | 55.84 | | | |
| 19 | −14.2254 | DD[19] | | | | | |
| 20 | −53.5298 | 0.4997 | 1.55146 | 45.35 | | | |
| 21 | 13.8107 | DD[21] | | | | | |
| *22 | 14.6194 | 2.6164 | 1.53558 | 63.33 | | 2.83 | |
| *23 | −43.0280 | DD[23] | | | | | |
| 24 | 25.9649 | 0.8752 | 1.87217 | 35.37 | | | |
| 25 | 13.3883 | DD[25] | | | | | |
| *26 | −36.3521 | 0.6255 | 1.53409 | 55.87 | | 1.01 | Pla |
| *27 | 60.3581 | 0.0489 | | | | | |
| 28 | 27.5309 | 3.6939 | 1.43624 | 66.96 | | | |
| 29 | −237.5524 | DD[29] | | | 21.971 | | |

TABLE 65
Example 22

| | Wide | Middle | Tele |
|---|---|---|---|
| Zr | 1.0 | 2.7 | 4.7 |
| f | 16.48 | 43.88 | 77.79 |
| Bf | 11.78 | 25.04 | 36.46 |
| FNo. | 3.60 | 5.02 | 6.56 |
| 2ω[°] | 89.2 | 35.6 | 20.4 |
| DD[5] | 0.20 | 17.74 | 24.27 |
| DD[13] | 14.68 | 5.77 | 1.70 |
| DD[19] | 0.80 | 1.86 | 3.13 |
| DD[21] | 3.63 | 2.56 | 1.30 |
| DD[23] | 1.25 | 1.01 | 0.84 |
| DD[25] | 11.73 | 11.97 | 12.14 |
| DD[29] | 11.78 | 25.04 | 36.46 |

TABLE 66
Example 22

| Sn | 15 | 16 | 22 | 23 |
|---|---|---|---|---|
| KA | 1.0000000E+00 | 1.0000000E+00 | 1.0000000E+00 | 1.0000000E+00 |
| A4 | 9.9548012E−05 | 2.5391925E−04 | −3.4398744E−05 | 3.0324734E−05 |
| A6 | 8.9059584E−07 | 2.1621440E−06 | 4.3440896E−07 | 4.7648539E−07 |
| A8 | 6.3470299E−08 | 6.0349953E−08 | 1.7540860E−08 | 1.2139385E−08 |
| A10 | −8.7640336E−11 | −1.0693169E−10 | −8.4271527E−10 | −1.0221849E−09 |
| A12 | −1.1575259E−10 | −1.0800520E−10 | 7.9525416E−11 | 1.0578515E−10 |
| A14 | 3.3814399E−12 | 3.2154886E−12 | −2.6434870E−12 | −3.4253124E−12 |
| A16 | −3.2623864E−14 | −3.3184535E−14 | 3.7145980E−14 | 4.6190579E−14 |

| Sn | 26 | 27 |
|---|---|---|
| KA | 1.0000000E+00 | 1.0000000E+00 |
| A4 | −4.0253485E−06 | −1.4468301E−05 |
| A6 | −2.8475465E−08 | −7.9965125E−08 |
| A8 | −7.6099345E−11 | 3.4799038E−10 |
| A10 | −1.2448489E−11 | −1.0779906E−13 |
| A12 | 2.6111746E−14 | −7.8979813E−14 |
| A14 | 4.8431992E−16 | −4.4471437E−16 |
| A16 | −1.8103737E−17 | 4.1718725E−18 |

### Example 23

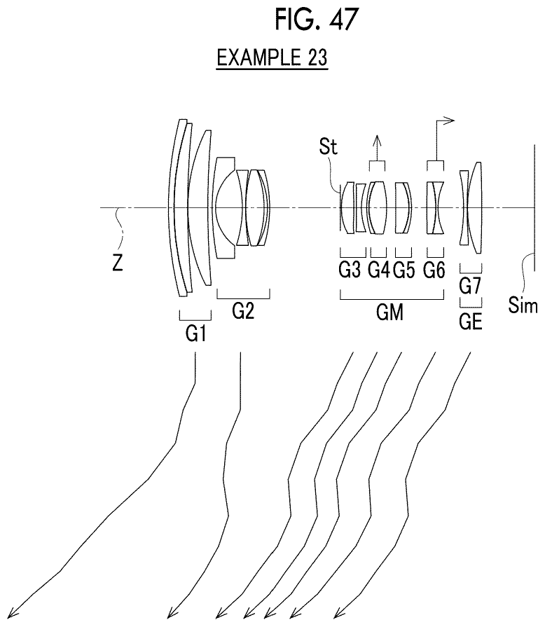

A configuration and a moving path of a variable magnification optical system of Example 23 are illustrated in FIG. 47. The variable magnification optical system of Example 23 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a negative refractive power, and the seventh lens group G7 having a positive refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, the third lens group G3, the fifth lens group G5, and the seventh lens group G7 move on the same moving path along the optical axis Z, and the first lens group G1, the second lens group G2, the third lens group G3, the fourth lens group G4, and the sixth lens group G6 move on different moving paths along the optical axis Z by changing spacings with respect to adjacent lens groups. The vibration-proof group consists of the fourth lens group G4. The focus lens group consists of the sixth lens group G6 and moves to the image side during the focusing from the infinite distance object to the short range object.

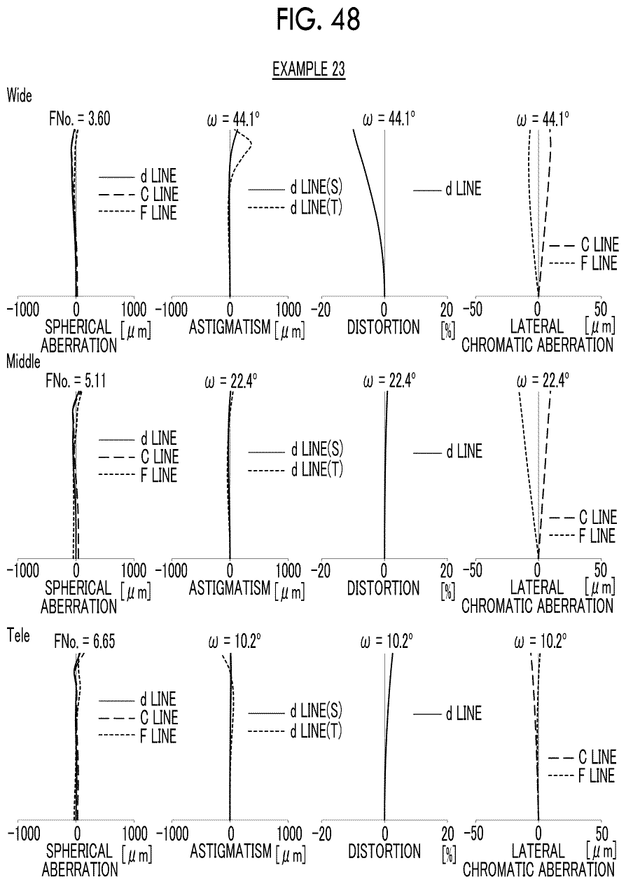

For the variable magnification optical system of Example 23, Table 67 shows basic lens data, Table 68 shows specifications and a variable surface spacing, Table 69 shows aspherical coefficients, and FIG. 48 illustrates each aberration diagram.

TABLE 67
Example 23

| Sn | R | D | Nd | νd | ED | SG |
|---|---|---|---|---|---|---|
| 1 | 81.2644 | 1.2499 | 1.96420 | 16.79 | 40.00 | 3.91 |
| 2 | 63.1890 | 3.0849 | 1.48749 | 70.32 | | 2.45 |
| 3 | 178.8183 | 0.0430 | | | | |
| 4 | 39.6875 | 4.5248 | 1.59459 | 66.69 | | |
| 5 | 198.4956 | DD[5] | | | | |
| 6 | 60.9712 | 0.7498 | 1.87173 | 41.72 | | |
| 7 | 10.5852 | 6.0461 | | | | |
| 8 | −27.4948 | 0.7498 | 1.97135 | 31.45 | | |
| 9 | 54.8777 | 0.0384 | | | | |
| 10 | 31.5014 | 4.1520 | 1.91962 | 21.93 | | |
| 11 | −23.3709 | 0.7513 | | | | |
| 12 | −17.1432 | 0.4997 | 1.87640 | 39.95 | | |
| 13 | −29.6058 | DD[13] | | | | |
| 14 (St) | ∞ | 0.2500 | | | | |
| *15 | 13.3726 | 2.8053 | 1.65816 | 34.18 | | |
| *16 | −55.2347 | 0.5897 | | | | |
| 17 | −313.1551 | 1.1308 | 1.83907 | 29.17 | | |
| 18 | 14.9033 | DD[18] | | | | |
| 19 | 18.7107 | 0.5001 | 1.94513 | 20.80 | | |
| 20 | 12.7184 | 4.0032 | 1.54857 | 73.75 | | 3.62 |
| *21 | −21.3620 | DD[21] | | | | |
| 22 | −349.6613 | 2.9960 | 1.74835 | 51.54 | | |
| 23 | −12.5305 | 0.5750 | 1.99348 | 29.27 | | |
| 24 | −17.4813 | DD[24] | | | | |
| 25 | 334.8704 | 2.0071 | 1.99874 | 24.79 | | |
| 26 | −23.0198 | 0.5099 | 1.83481 | 42.74 | | |
| 27 | 13.8655 | DD[27] | | | | |
| *28 | −42.9929 | 0.7965 | 1.53409 | 55.87 | | |
| *29 | 82.1838 | 0.1000 | | | | |
| 30 | 26.5504 | 3.2192 | 1.45971 | 66.73 | | |
| 31 | −250.0225 | DD[31] | | | 19.727 | |

TABLE 68
Example 23

| | Wide | Middle | Tele |
|---|---|---|---|
| Zr | 1.0 | 2.1 | 4.7 |
| f | 16.26 | 34.15 | 76.76 |
| Bf | 11.95 | 26.65 | 42.82 |
| FNo. | 3.60 | 5.11 | 6.65 |
| 2ω[°] | 88.2 | 44.8 | 20.4 |
| DD[5] | 0.99 | 7.74 | 26.88 |
| DD[13] | 15.86 | 5.11 | 1.50 |
| DD[18] | 1.20 | 1.75 | 2.07 |
| DD[21] | 2.05 | 1.49 | 1.18 |
| DD[24] | 3.49 | 3.12 | 1.50 |
| DD[27] | 5.77 | 6.14 | 7.76 |
| DD[31] | 11.95 | 26.65 | 42.82 |

TABLE 69
Example 23

| Sn | 15 | 16 | 21 | 28 |
|---|---|---|---|---|
| KA | 1.0000000E+00 | 1.0000000E+00 | 1.0000000E+00 | 1.0000000E+00 |
| A4 | 4.7163028E−05 | 1.6234724E−04 | 4.4037332E−05 | −1.3451581E−05 |
| A6 | 7.9290126E−07 | 1.0559759E−07 | 1.9156929E−07 | −1.2050066E−07 |
| A8 | 6.3340993E−08 | 1.5545831E−07 | −1.6370867E−08 | −1.0319052E−12 |
| A10 | 1.3178645E−09 | −3.7961938E−09 | 1.1277946E−09 | −7.1459461E−11 |
| A12 | −1.3597730E−10 | 9.0150329E−11 | −4.3166891E−11 | −1.8670230E−12 |
| A14 | 2.3114633E−12 | −8.0582172E−12 | 7.8900149E−13 | 5.7953222E−14 |
| A16 | 2.1083793E−13 | 7.3058793E−13 | −5.4745850E−15 | 1.3937177E−16 |
| A18 | −8.2039340E−15 | −2.3011450E−14 | 0.0000000E+00 | −1.5669585E−17 |
| A20 | 9.1102327E−17 | 2.6328326E−16 | 0.0000000E+00 | 1.2503115E−19 |

| Sn | 29 |
|---|---|
| KA | 1.0000000E+00 |
| A4 | −1.2789492E−05 |
| A6 | 1.4143377E−09 |
| A8 | −1.8176168E−09 |
| A10 | −7.0511642E−11 |
| A12 | 1.3571808E−12 |
| A14 | 4.4644818E−16 |
| A16 | −5.0194596E−17 |
| A18 | −2.5007591E−18 |
| A20 | 2.4988187E−20 |

### Example 24

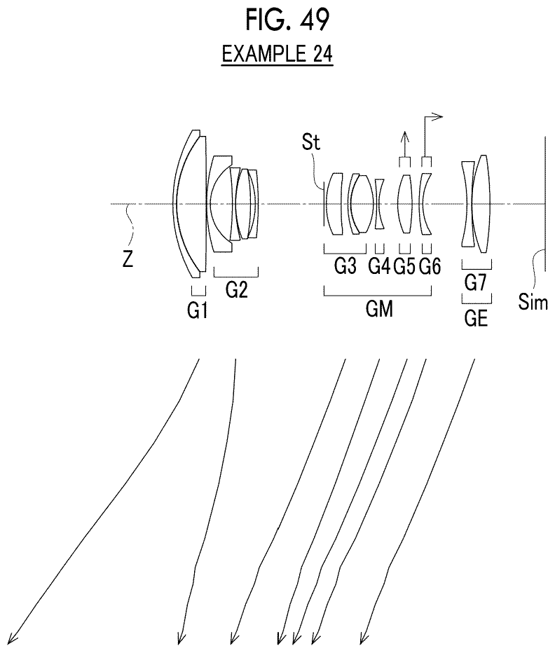

A configuration and a moving path of a variable magnification optical system of Example 24 are illustrated in FIG. 49. The variable magnification optical system of Example 24 consists of, in order from the object side to the image side, the first lens group G1 having a positive refractive power, the second lens group G2 having a negative refractive power, the third lens group G3 having a positive refractive power, the fourth lens group G4 having a negative refractive power, the fifth lens group G5 having a positive refractive power, the sixth lens group G6 having a negative refractive power, and the seventh lens group G7 having a negative refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, the third lens group G3, the fifth lens group G5, and the seventh lens group G7 move on the same moving path along the optical axis Z, and the first lens group G1, the second lens group G2, the third lens group G3, the fourth lens group G4, and the sixth lens group G6 move on different moving paths along the optical axis Z by changing spacings with respect to adjacent lens groups. The vibration-proof group consists of the fifth lens group G5. The focus lens group consists of the sixth lens group G6 and moves to the image side during the focusing from the infinite distance object to the short range object.

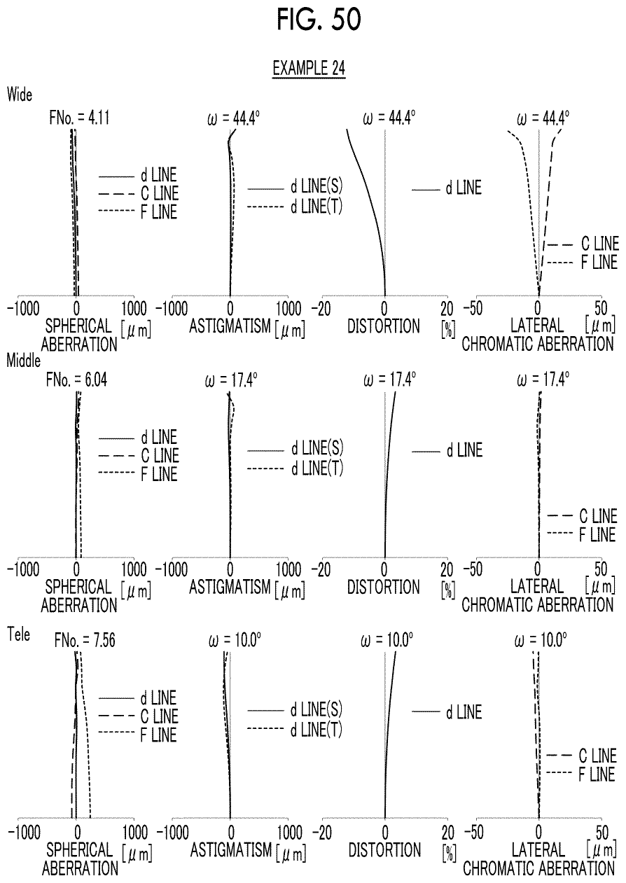

For the variable magnification optical system of Example 24, Table 70 shows basic lens data, Table 71 shows specifications and a variable surface spacing, Table 72 shows aspherical coefficients, and FIG. 50 illustrates each aberration diagram.

TABLE 70
Example 24

| Sn | R | D | Nd | νd | ED | SG | |
|---|---|---|---|---|---|---|---|
| 1 | 32.0784 | 0.7751 | 1.85796 | 26.62 | 31.013 | 4.15 | |
| 2 | 23.6804 | 6.1341 | 1.48749 | 70.32 | | 2.45 | |
| 3 | −896.9484 | DD[3] | | | | | |
| 4 | 35.0618 | 0.7500 | 1.91528 | 37.27 | | | |
| 5 | 9.9505 | 4.5666 | | | | | |
| 6 | −59.6845 | 0.6752 | 1.94655 | 26.41 | | | |
| 7 | 29.6186 | 0.0100 | | | | | |
| 8 | 20.7956 | 3.0800 | 1.92439 | 18.78 | | | |
| 9 | −42.8334 | 0.9801 | | | | | |
| 10 | −16.8880 | 0.5998 | 1.84104 | 44.86 | | | |
| 11 | −66.2426 | DD[11] | | | | | |
| 12 (St) | ∞ | 0.4600 | | | | | |
| *13 | 16.9669 | 3.0802 | 1.56863 | 56.67 | | | |
| *14 | 298.4165 | 1.3716 | | | | | |
| 15 | 19.3326 | 0.6055 | 1.74338 | 27.83 | | | |
| 16 | 11.0832 | 4.6741 | 1.53005 | 58.62 | | | |
| 17 | −12.8870 | DD[17] | | | | | |
| 18 | −42.1286 | 0.4669 | 1.55593 | 44.51 | | | |
| 19 | 13.2651 | DD[19] | | | | | |
| *20 | 15.2341 | 2.9719 | 1.51153 | 79.39 | | 3.57 | |
| *21 | −35.8034 | DD[21] | | | | | |
| *22 | 35.3200 | 0.7615 | 1.53409 | 55.87 | | 1.01 | Pla |
| *23 | 12.5906 | DD[23] | | | | | |
| 24 | −33.1556 | 1.0001 | 1.78988 | 49.33 | | | |
| 25 | 73.8055 | 0.0100 | | | | | |
| 26 | 28.0368 | 3.7500 | 1.45433 | 88.11 | | | |
| 27 | −67.5257 | DD[27] | | | 20.579 | | |

TABLE 71
Example 24

| | Wide | Middle | Tele |
|---|---|---|---|
| Zr | 1.0 | 2.7 | 4.7 |
| f | 16.50 | 43.94 | 77.90 |
| Bf | 3.45 | 3.45 | 3.45 |
| FNo. | 4.11 | 6.04 | 7.56 |
| 2ω[°] | 88.8 | 34.8 | 20.0 |
| DD[3] | 0.09 | 18.26 | 28.05 |
| DD[11] | 13.53 | 5.01 | 1.61 |
| DD[17] | 0.70 | 1.91 | 3.31 |
| DD[19] | 3.87 | 2.68 | 1.26 |
| DD[21] | 1.47 | 1.48 | 1.14 |
| DD[23] | 9.13 | 9.12 | 9.46 |
| DD[27] | 11.45 | 25.65 | 35.27 |

TABLE 72
Example 24

| Sn | 13 | 14 | 20 | 21 |
|---|---|---|---|---|
| KA | 1.0000000E+00 | 1.0000000E+00 | 1.0000000E+00 | 1.0000000E+00 |
| A4 | 6.8288731E−05 | 2.3246707E−04 | −3.6826962E−05 | 3.2817475E−05 |
| A6 | 2.7296183E−07 | 1.6697071E−06 | 3.8750933E−08 | −1.1073723E−06 |
| A8 | 1.1128033E−09 | −1.6198991E−08 | −3.8315282E−10 | 7.4437364E−08 |
| A10 | 1.1290782E−09 | 1.2096898E−09 | 5.7157871E−10 | −3.0141926E−09 |
| A12 | −1.1527862E−10 | −6.1912528E−11 | 8.0484116E−12 | 1.3223828E−10 |
| A14 | 3.0966735E−12 | 7.5395677E−13 | −6.9051125E−13 | −3.2471741E−12 |
| A16 | −2.9102881E−14 | −5.2916146E−16 | 1.0501480E−14 | 3.2983066E−14 |

| Sn | 22 | 23 |
|---|---|---|
| KA | 1.0000000E+00 | 1.0000000E+00 |
| A4 | 4.4489088E−05 | 3.7536988E−05 |
| A6 | −1.1905810E−06 | −8.0000969E−07 |
| A8 | 1.1112207E−08 | 1.1345756E−08 |
| A10 | 1.2128604E−09 | 1.1691984E−10 |
| A12 | −4.6948133E−11 | −1.3063805E−11 |
| A14 | 4.4553124E−13 | 1.6404714E−13 |
| A16 | 2.5767893E−15 | 2.5215323E−15 |

### Example 25

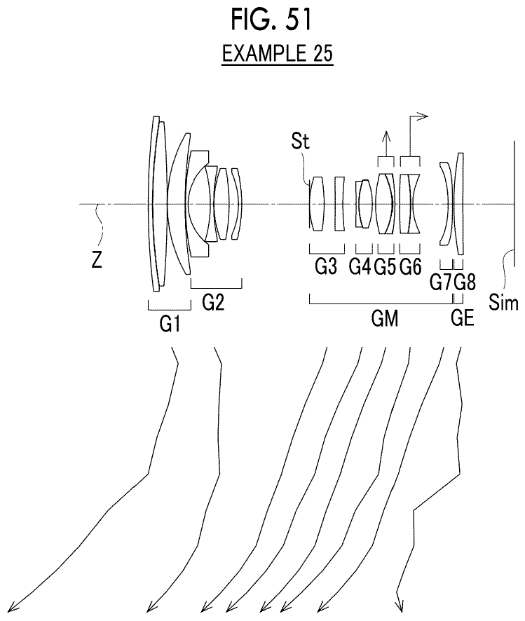

A configuration and a moving path of a variable magnification optical system of Example 25 are illustrated in FIG. 51. The variable magnification optical system of Example 25 consists of, in order from the object side to the image side, the first lens group G1 having a positive refractive power, the second lens group G2 having a negative refractive power, the third lens group G3 having a positive refractive power, the fourth lens group G4 having a negative refractive power, the fifth lens group G5 having a positive refractive power, the sixth lens group G6 having a negative refractive power, the seventh lens group G7 having a negative refractive power, and an eighth lens group G8 having a positive refractive power. The intermediate group GM consists of the third lens group G3, the fourth lens group G4, the fifth lens group G5, the sixth lens group G6, and the seventh lens group G7. The final lens group GE consists of the eighth lens group G8. During changing the magnification from the wide angle end to the telephoto end, the third lens group G3, the fifth lens group G5, and the seventh lens group G7 move on the same moving path along the optical axis Z, and the first lens group G1, the second lens group G2, the third lens group G3, the fourth lens group G4, the sixth lens group G6, and the eighth lens group G8 move on different moving paths along the optical axis Z by changing spacings with respect to adjacent lens groups. The vibration-proof group consists of the fifth lens group G5. The focus lens group consists of the sixth lens group G6 and moves to the image side during the focusing from the infinite distance object to the short range object.

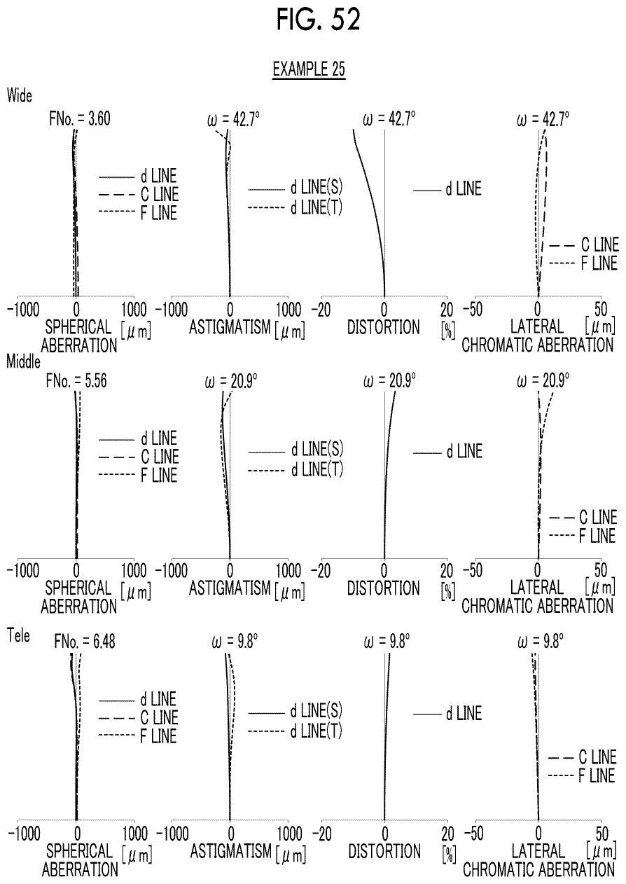

For the variable magnification optical system of Example 25, Table 73 shows basic lens data, Table 74 shows specifications and a variable surface spacing, Table 75 shows aspherical coefficients, and FIG. 52 illustrates each aberration diagram.

TABLE 73
Example 25

| Sn | R | D | Nd | νd | ED | SG | |
|---|---|---|---|---|---|---|---|
| 1 | 164.2836 | 0.9892 | 1.89330 | 20.34 | 38.469 | 3.58 | |
| 2 | 114.9630 | 3.3142 | 1.49782 | 82.57 | | 3.86 | |
| 3 | −233.8491 | 0.0172 | | | | | |
| 4 | 32.0546 | 4.0416 | 1.60653 | 64.82 | | | |
| 5 | 98.6824 | DD[5] | | | | | |
| 6 | 56.5737 | 0.5989 | 1.94363 | 34.36 | | | |
| 7 | 11.4197 | 5.0557 | | | | | |
| 8 | −30.0268 | 0.7499 | 1.78923 | 50.16 | | | |
| 9 | 38.1956 | 0.0748 | | | | | |
| 10 | 22.4673 | 3.4384 | 1.84752 | 22.62 | | | |
| 11 | −42.0614 | 2.1252 | | | | | |
| 12 | −17.0271 | 0.7498 | 1.78354 | 50.74 | | | |
| 13 | −31.9720 | DD[13] | | | | | |
| 14 (St) | ∞ | 0.0000 | | | | | |
| *15 | 17.5119 | 3.3418 | 1.62329 | 62.20 | | | |
| *16 | −34.7608 | 2.5002 | | | | | |
| 17 | −979.3129 | 1.7502 | 1.43599 | 67.00 | | | |
| 18 | 51.2498 | DD[18] | | | | | |
| 19 | −385.5983 | 0.6498 | 1.94693 | 30.89 | | | |
| 20 | 16.3984 | 3.0602 | 1.43601 | 81.47 | | | |
| 21 | −16.0234 | DD[21] | | | | | |
| 22 | 25.7418 | 3.7568 | 1.83539 | 43.12 | | 4.75 | |
| 23 | −14.5174 | 0.4992 | 2.00001 | 28.60 | | | |
| 24 | −44.5827 | DD[24] | | | | | |
| 25 | 126.5290 | 2.5000 | 1.88300 | 40.76 | | | |
| 26 | −38.9439 | 0.5093 | 1.74359 | 54.83 | | | |
| 27 | 14.3917 | DD[27] | | | | | |
| *28 | −28.7385 | 1.0000 | 1.53409 | 55.87 | | 1.01 | Pla |
| *29 | −130.6648 | DD[29] | | | | | |
| 30 | 64.0946 | 2.0484 | 1.92025 | 18.99 | | | |
| 31 | 1035.5683 | DD[31] | | | 23 | | |

TABLE 74
Example 25

| | Wide | Middle | Tele |
|---|---|---|---|
| Zr | 1.0 | 2.1 | 4.7 |
| f | 17.09 | 35.90 | 80.68 |
| Bf | 11.72 | 11.97 | 25.14 |
| FNo. | 3.60 | 5.56 | 6.48 |
| 2ω[°] | 85.4 | 41.8 | 19.6 |
| DD[5] | 0.10 | 6.69 | 21.97 |
| DD[13] | 15.41 | 3.82 | 2.10 |
| DD[18] | 3.00 | 2.58 | 0.69 |
| DD[21] | 0.75 | 1.17 | 3.06 |
| DD[24] | 1.08 | 4.34 | 0.29 |
| DD[27] | 8.03 | 4.77 | 8.82 |
| DD 29 | 0.31 | 10.41 | 15.45 |
| DD[31] | 11.72 | 11.97 | 25.14 |

TABLE 75
Example 25

| Sn | 15 | 16 | 28 | 29 |
|---|---|---|---|---|
| KA | 1.0000000E+00 | 1.0000000E+00 | 1.0000000E+00 | 1.0000000E+00 |
| A4 | −3.0862544E−05 | 3.5432939E−05 | −7.9512221E−05 | −8.9979434E−05 |
| A6 | −3.3504037E−07 | −3.7613126E−07 | 4.4842622E−08 | 2.1964566E−07 |
| A8 | 2.5734080E−09 | −1.3783142E−09 | 1.6057276E−09 | −2.4601445E−09 |
| A10 | −2.0660072E−10 | −1.3519127E−10 | −9.8850230E−11 | −2.6801668E−11 |

### Example 26

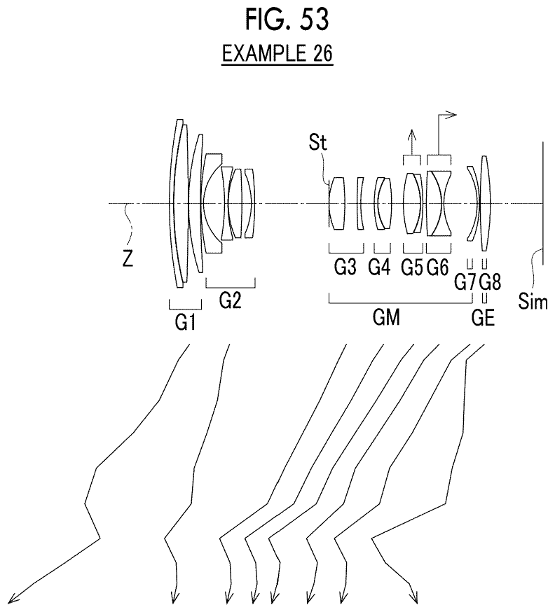

A configuration and a moving path of a variable magnification optical system of Example 26 are illustrated in FIG. 53. The variable magnification optical system of Example 26 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a negative refractive power, the seventh lens group G7 having a negative refractive power, and the eighth lens group G8 having a positive refractive power. The intermediate group GM consists of the third lens group G3, the fourth lens group G4, the fifth lens group G5, the sixth lens group G6, and the seventh lens group G7. The final lens group GE consists of the eighth lens group G8. During changing the magnification from the wide angle end to the telephoto end, the eight lens groups move on different moving paths along the optical axis Z by changing spacings with respect to adjacent lens groups. The vibration-proof group consists of the fifth lens group G5. The focus lens group consists of the sixth lens group G6 and moves to the image side during the focusing from the infinite distance object to the short range object.

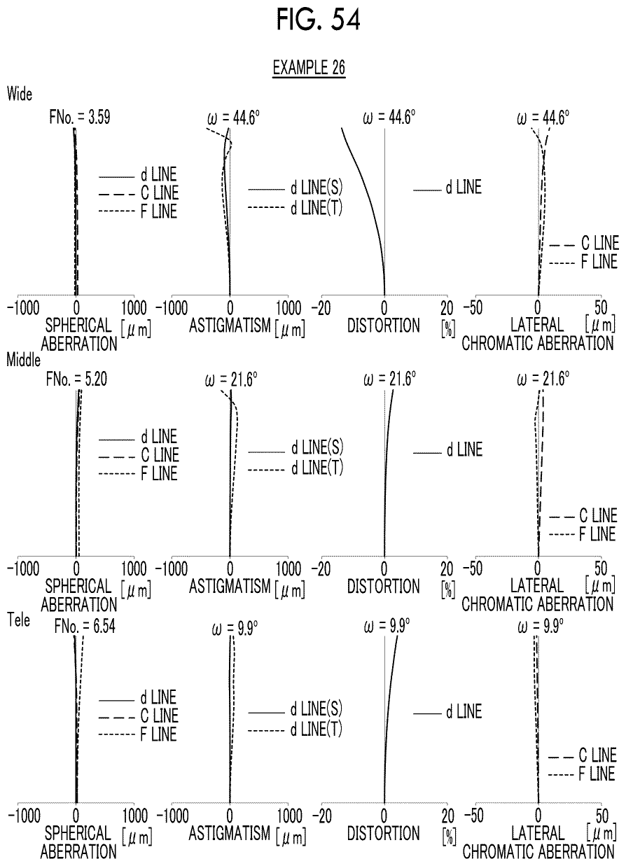

For the variable magnification optical system of Example 26, Table 76 shows basic lens data, Table 77 shows specifications and a variable surface spacing, Table 78 shows aspherical coefficients, and FIG. 54 illustrates each aberration diagram.

TABLE 76
Example 26

| Sn | R | D | Nd | νd | ED | SG |
|---|---|---|---|---|---|---|
| 1 | 110.5158 | 0.9476 | 1.97465 | 16.32 | 37.2850 | 4.70 |
| 2 | 83.0029 | 3.2278 | 1.57357 | 69.95 | | 3.67 |
| 3 | −574.5598 | 0.1000 | | | | |
| 4 | 56.6719 | 2.6378 | 1.53829 | 75.32 | | |
| 5 | 231.6890 | DD[5] | | | | |
| 6 | 57.4045 | 0.5713 | 1.81571 | 47.45 | | |
| 7 | 12.4399 | 4.6801 | | | | |
| 8 | −47.5905 | 0.7502 | 1.68995 | 58.21 | | |
| 9 | 30.2587 | 0.0748 | | | | |
| 10 | 20.3568 | 3.0069 | 1.85112 | 22.44 | | |
| 11 | −157.6479 | 2.1251 | | | | |
| 12 | −18.1193 | 0.7498 | 1.76708 | 52.43 | | |
| 13 | −67.3428 | DD[13] | | | | |
| 14 (St) | ∞ | 0.0000 | | | | |
| *15 | 15.1892 | 3.5180 | 1.55966 | 72.06 | | |
| *16 | −57.2926 | 2.7502 | | | | |
| 17 | 115.7506 | 0.8001 | 1.43600 | 82.51 | | |
| 18 | 28.3264 | DD[18] | | | | |
| 19 | 24.4672 | 0.8000 | 2.00001 | 28.03 | | |
| 20 | 11.6099 | 3.0602 | 1.51158 | 64.62 | | |
| 21 | −37.0761 | DD[21] | | | | |
| 22 | 27.4357 | 3.8347 | 1.80184 | 48.87 | | 4.44 |
| 23 | −15.1182 | 0.4996 | 2.00001 | 28.52 | | |
| 24 | −42.0442 | DD[24] | | | | |
| 25 | 118.9909 | 3.3776 | 1.89256 | 20.64 | | |
| 26 | −13.2371 | 0.5093 | 1.85138 | 32.15 | | |
| 27 | 15.0304 | DD[27] | | | | |
| *28 | −17.4479 | 0.4925 | 1.71108 | 50.33 | | |
| *29 | −27.9601 | DD[29] | | | | |
| 30 | 134.7553 | 2.2327 | 1.61313 | 43.42 | | |
| 31 | −64.6392 | DD[31] | | | 22 | |

TABLE 77
Example 26

| | Wide | Middle | Tele |
|---|---|---|---|
| Zr | 1.0 | 2.1 | 4.7 |
| f | 16.65 | 34.97 | 78.59 |
| Bf | 11.72 | 18.89 | 26.72 |
| FNo. | 3.59 | 5.20 | 6.54 |
| 2ω[°] | 89.2 | 43.2 | 19.8 |
| DD[5] | 0.10 | 12.96 | 27.84 |
| DD[13] | 16.40 | 10.53 | 2.52 |
| DD[18] | 3.00 | 0.67 | 0.52 |
| DD[21] | 2.61 | 0.62 | 0.10 |
| DD[24 | 0.79 | 0.20 | 2.91 |
| DD[27] | 7.41 | 8.15 | 8.03 |
| DD[29] | 0.20 | 10.95 | 13.95 |
| DD[31] | 11.72 | 18.89 | 26.72 |

TABLE 78
Example 26

| Sn | 15 | 16 | 28 | 29 |
|---|---|---|---|---|
| KA | 1.0000000E+00 | 1.0000000E+00 | 1.0000000E+00 | 1.0000000E+00 |
| A4 | −3.4263630E−05 | 2.9352506E−05 | −3.4533142E−05 | −2.8868498E−05 |
| A6 | −1.3709107E−07 | −1.7374340E−07 | 1.1948261E−07 | 9.6060506E−08 |
| A8 | −2.1707452E−10 | −6.7282139E−10 | 8.9943399E−10 | 4.3541594E−10 |
| A10 | −6.8512735E−11 | −6.7769564E−11 | −5.5306362E−11 | −4.1415592E−11 |

### Example 27

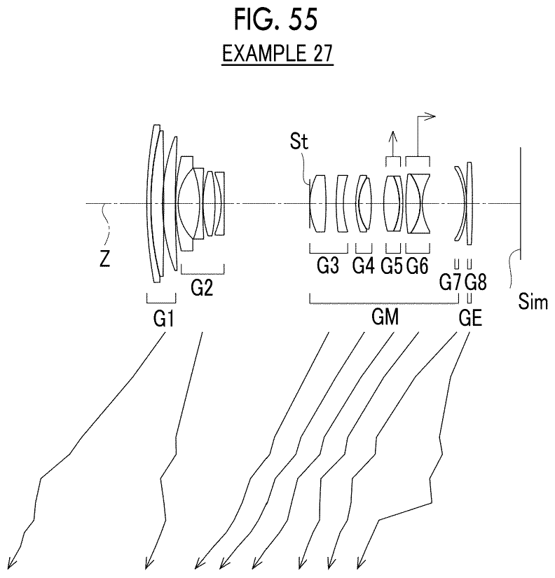

A configuration and a moving path of a variable magnification optical system of Example 27 are illustrated in FIG. 55. The variable magnification optical system of Example 27 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a negative refractive power, the seventh lens group G7 having a negative refractive power, and the eighth lens group G8 having a positive refractive power. The intermediate group GM consists of the third lens group G3, the fourth lens group G4, the fifth lens group G5, the sixth lens group G6, and the seventh lens group G7. The final lens group GE consists of the eighth lens group G8. During changing the magnification from the wide angle end to the telephoto end, the eight lens groups move on different moving paths along the optical axis Z by changing spacings with respect to adjacent lens groups. The vibration-proof group consists of the fifth lens group G5. The focus lens group consists of the sixth lens group G6 and moves to the image side during the focusing from the infinite distance object to the short range object.

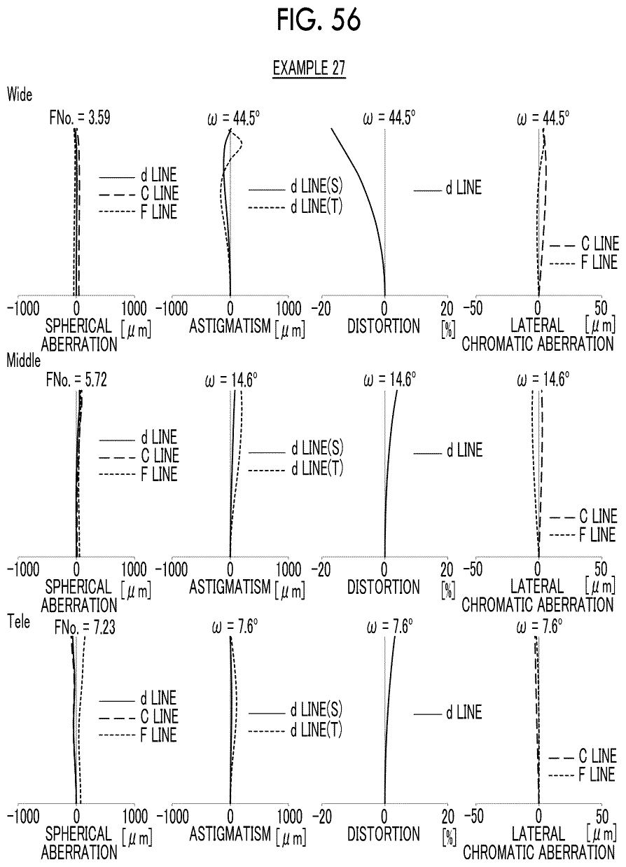

For the variable magnification optical system of Example 27, Table 79 shows basic lens data, Table 80 shows specifications and a variable surface spacing, Table 81 shows aspherical coefficients, and FIG. 56 illustrates each aberration diagram.

TABLE 79
Example 27

| Sn | R | D | Nd | νd | ED | SG |
|---|---|---|---|---|---|---|
| 1 | 115.3186 | 0.9898 | 1.92846 | 18.58 | 38.1381 | 3.49 |
| 2 | 79.1806 | 3.1270 | 1.55301 | 73.08 | | 3.63 |
| 3 | −1081.7074 | 0.1000 | | | | |
| 4 | 49.0680 | 3.1129 | 1.57035 | 70.44 | | |
| 5 | 304.5036 | DD[5] | | | | |
| 6 | 53.6981 | 0.5879 | 1.85063 | 43.88 | | |
| 7 | 13.1044 | 5.2502 | | | | |
| 8 | −27.3630 | 0.7498 | 1.86930 | 41.97 | | |
| 9 | 165.4745 | 0.0751 | | | | |
| 10 | 28.5357 | 2.9133 | 1.86632 | 21.68 | | |
| 11 | −46.1861 | 1.5082 | | | | |
| 12 | −19.5576 | 0.7498 | 1.72507 | 56.47 | | |
| 13 | −629.6624 | DD[13] | | | | |
| 14 (St) | ∞ | 0.0000 | | | | |
| *15 | 15.8721 | 3.9325 | 1.56783 | 70.06 | | |
| *16 | −82.7607 | 2.5001 | | | | |
| 17 | 56.9784 | 1.7502 | 1.58253 | 68.57 | | |
| 18 | 24.7857 | DD[18] | | | | |
| 19 | 23.8470 | 0.7499 | 2.00000 | 28.44 | | |
| 20 | 12.0765 | 3.0599 | 1.50478 | 65.49 | | |
| 21 | −35.9131 | DD[21] | | | | |
| 22 | 26.6783 | 3.8648 | 1.64973 | 58.14 | | 3.81 |
| 23 | −17.4939 | 0.8252 | 1.98045 | 30.60 | | |
| 24 | −35.2155 | DD[24] | | | | |
| 25 | 61.3298 | 3.5002 | 1.86962 | 23.85 | | |
| 26 | −13.0296 | 0.5030 | 1.85879 | 34.88 | | |
| 27 | 14.6582 | DD[27] | | | | |
| *28 | −21.0948 | 0.4865 | 1.62343 | 48.24 | | |
| *29 | −30.8100 | DD[29] | | | | |
| 30 | 195.8824 | 1.4610 | 1.66490 | 32.51 | | |
| 31 | −192.5464 | DD[31] | | | 21 | |

TABLE 80
Example 27

| | Wide | Middle | Tele |
|---|---|---|---|
| Zr | 1.0 | 3.0 | 5.9 |
| f | 17.46 | 52.38 | 103.01 |
| Bf | 11.72 | 21.46 | 39.02 |
| FNo. | 3.59 | 5.71 | 7.23 |
| 2ω[°] | 88.6 | 29.2 | 15.2 |
| DD[5] | 0.10 | 20.21 | 24.61 |
| DD[13] | 20.72 | 11.94 | 2.09 |
| DD[18] | 3.00 | 0.28 | 0.40 |
| DD[21] | 3.00 | 1.29 | 3.75 |
| DD[24] | 0.74 | 0.33 | 5.93 |
| DD[27] | 10.26 | 8.66 | 8.12 |
| DD[29] | 0.00 | 15.72 | 3.94 |
| DD[31] | 11.72 | 21.46 | 39.02 |

TABLE 81
Example 27

| Sn | 15 | 16 | 28 | 29 |
|---|---|---|---|---|
| KA | 1.0000000E+00 | 1.0000000E+00 | 1.0000000E+00 | 1.0000000E+00 |
| A4 | −3.4764119E−05 | 1.6127642E−05 | −3.6510296E−05 | −4.0750223E−05 |
| A6 | −1.3327630E−07 | −1.4763540E−07 | 1.7427058E−07 | 4.0469409E−08 |
| A8 | 5.9598219E−10 | −5.5094104E−10 | 7.0573373E−11 | 8.8137762E−10 |
| A10 | −8.7812605E−11 | −8.1122913E−11 | −5.1288062E−11 | −5.1229951E−11 |

### Example 28

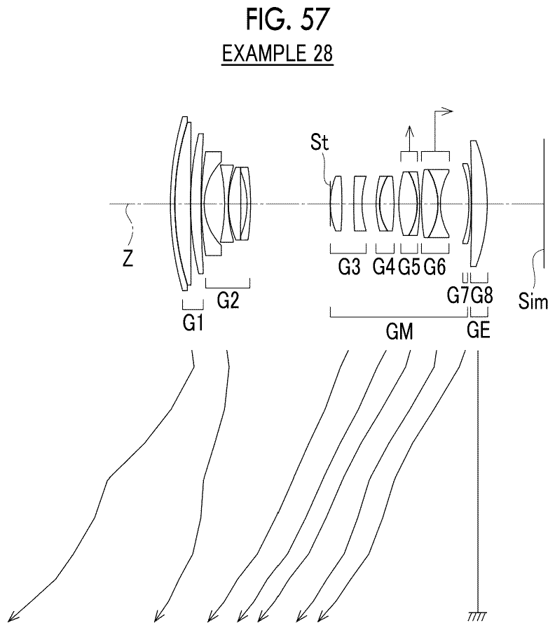

A configuration and a moving path of a variable magnification optical system of Example 28 are illustrated in FIG. 57. The variable magnification optical system of Example 28 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a negative refractive power, the seventh lens group G7 having a negative refractive power, and the eighth lens group G8 having a positive refractive power. The intermediate group GM consists of the third lens group G3, the fourth lens group G4, the fifth lens group G5, the sixth lens group G6, and the seventh lens group G7. The final lens group GE consists of the eighth lens group G8. During changing the magnification from the wide angle end to the telephoto end, seven lens groups including the first lens group G1 to the seventh lens group G7 move on different moving paths along the optical axis Z by changing spacings with respect to adjacent lens groups, and the eighth lens group G8 is fixed with respect to the image plane Sim. The vibration-proof group consists of the fifth lens group G5. The focus lens group consists of the sixth lens group G6 and moves to the image side during the focusing from the infinite distance object to the short range object.

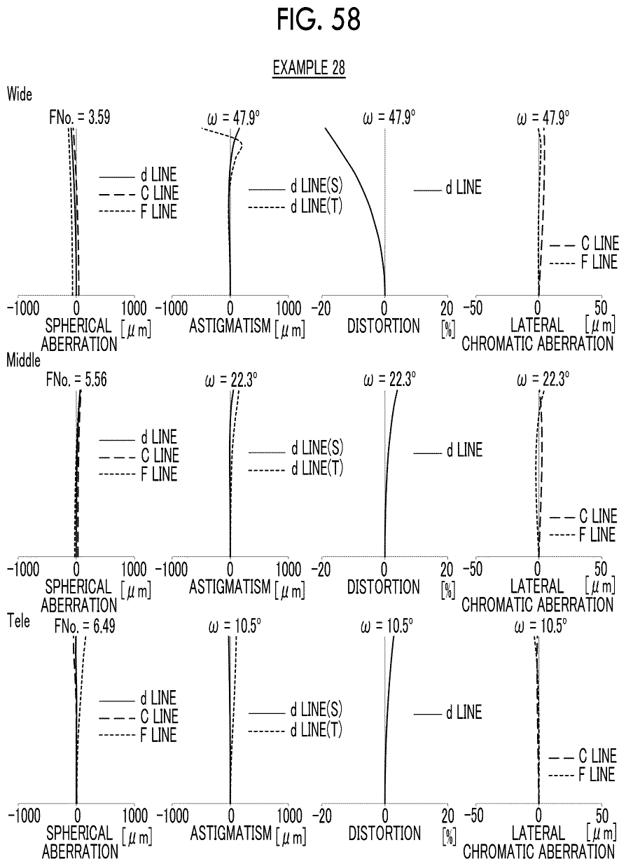

For the variable magnification optical system of Example 28, Table 82 shows basic lens data, Table 83 shows specifications and a variable surface spacing, Table 84 shows aspherical coefficients, and FIG. 58 illustrates each aberration diagram.

TABLE 82
Example 28

| Sn | R | D | Nd | νd | ED | SG |
|---|---|---|---|---|---|---|
| 1 | 72.3867 | 0.9484 | 1.98677 | 15.66 | 35.4113 | 5.49 |
| 2 | 62.0450 | 3.3405 | 1.57176 | 70.22 | | 3.66 |
| 3 | 1402.1606 | 0.1000 | | | | |
| 4 | 69.3868 | 2.2167 | 1.56401 | 71.40 | | |
| 5 | 219.6581 | DD[5] | | | | |
| 6 | 73.4735 | 0.5724 | 1.91927 | 36.36 | | |
| 7 | 13.5145 | 4.3499 | | | | |
| 8 | −40.1073 | 0.7498 | 1.54004 | 67.60 | | |
| 9 | 30.0838 | 0.0748 | | | | |
| 10 | 21.1993 | 2.5809 | 1.89466 | 20.27 | | |
| 11 | −663.9479 | 1.3601 | | | | |
| 12 | −19.2010 | 0.7498 | 1.73719 | 55.48 | | |
| 13 | −58.4702 | DD[13] | | | | |
| 14 (St) | ∞ | 0.0000 | | | | |
| *15 | 16.0686 | 2.4757 | 1.67245 | 59.07 | | |
| *16 | −77.1411 | 2.5000 | | | | |
| 17 | 106.8679 | 1.7502 | 1.43601 | 68.14 | | |
| 18 | 20.5589 | DD[18] | | | | |
| 19 | 23.9532 | 0.7498 | 2.00001 | 25.11 | | |
| 20 | 11.3929 | 3.0602 | 1.51000 | 77.56 | | |
| 21 | −53.7614 | DD[21] | | | | |
| 22 | 26.0491 | 3.9087 | 1.85925 | 42.78 | | 4.82 |
| 23 | −14.2775 | 0.4981 | 2.00001 | 25.95 | | |
| 24 | −50.8816 | DD[24] | | | | |
| 25 | 49.4431 | 3.5002 | 1.97338 | 20.43 | | |
| 26 | −14.5388 | 0.5089 | 1.96802 | 31.50 | | |
| 27 | 14.2362 | DD[27] | | | | |
| *28 | −34.1599 | 0.4897 | 1.65245 | 43.06 | | |
| *29 | −86.0367 | DD[29] | | | | |
| 30 | −449.4683 | 3.3276 | 1.87187 | 40.66 | | |
| 31 | −41.6661 | 12.0721 | | | 27.8 | |

TABLE 83
Example 28

| | Wide | Middle | Tele |
|---|---|---|---|
| Zr | 1.0 | 2.1 | 4.7 |
| f | 15.85 | 33.29 | 74.83 |
| Bf | 12.07 | 12.07 | 12.07 |
| FNo. | 3.59 | 5.56 | 6.49 |
| 2ω[°] | 95.6 | 44.6 | 21.0 |
| DD[5] | 0.10 | 13.06 | 23.75 |
| DD[13] | 16.84 | 10.00 | 2.51 |
| DD[18] | 3.00 | 1.29 | 1.28 |
| DD[21] | 1.03 | 0.10 | 0.19 |
| DD[24] | 0.40 | 0.55 | 2.93 |
| DD[27] | 6.06 | 5.28 | 4.47 |
| DD[29] | 0.09 | 15.22 | 31.43 |

TABLE 84
Example 28

| Sn | 15 | 16 | 28 | 29 |
|---|---|---|---|---|
| KA | 1.0000000E+00 | 1.0000000E+00 | 1.0000000E+00 | 1.0000000E+00 |
| A4 | −2.6003699E−05 | 2.1954299E−05 | −5.1978918E−05 | −3.7148523E−05 |
| A6 | 2.7177642E−08 | 6.1257445E−09 | 1.1008695E−07 | −1.2179098E−08 |
| A8 | −2.3919007E−09 | −3.2465116E−09 | −1.3938800E−09 | −4.5674923E−10 |
| A10 | −8.4344215E−11 | −7.6780163E−11 | 1.7171352E−12 | −2.8251562E−11 |

### Example 29

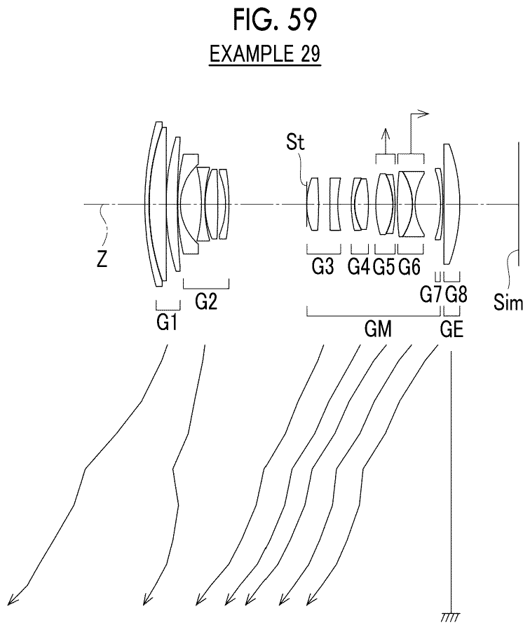

A configuration and a moving path of a variable magnification optical system of Example 29 are illustrated in FIG. 59. The variable magnification optical system of Example 29 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a negative refractive power, the seventh lens group G7 having a negative refractive power, and the eighth lens group G8 having a positive refractive power. The intermediate group GM consists of the third lens group G3, the fourth lens group G4, the fifth lens group G5, the sixth lens group G6, and the seventh lens group G7. The final lens group GE consists of the eighth lens group G8. During changing the magnification from the wide angle end to the telephoto end, seven lens groups including the first lens group G1 to the seventh lens group G7 move on different moving paths along the optical axis Z by changing spacings with respect to adjacent lens groups, and the eighth lens group G8 is fixed with respect to the image plane Sim. The vibration-proof group consists of the fifth lens group G5. The focus lens group consists of the sixth lens group G6 and moves to the image side during the focusing from the infinite distance object to the short range object.

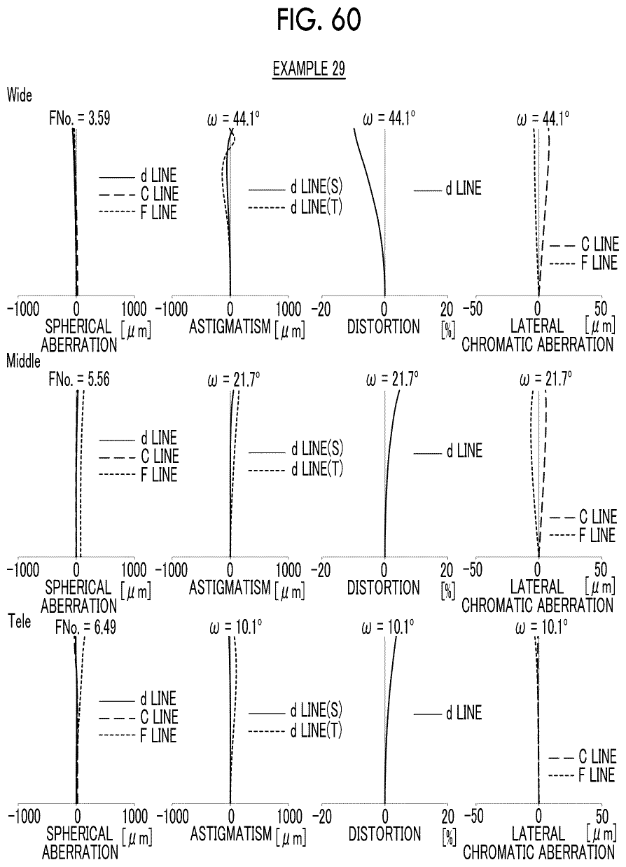

For the variable magnification optical system of Example 29, Table 85 shows basic lens data, Table 86 shows specifications and a variable surface spacing, Table 87 shows aspherical coefficients, and FIG. 60 illustrates each aberration diagram.

TABLE 85
Example 29

| Sn | R | D | Nd | νd | ED | SG |
|---|---|---|---|---|---|---|
| 1 | 73.1706 | 0.9487 | 1.90749 | 19.63 | 35.972 | 3.53 |
| 2 | 55.4275 | 3.7842 | 1.55707 | 72.46 | | 3.63 |
| 3 | 4271.4412 | 0.1000 | | | | |
| 4 | 55.6993 | 2.4909 | 1.66543 | 59.41 | | |
| 5 | 172.8580 | DD[5] | | | | |
| 6 | 53.3970 | 0.5721 | 1.93026 | 35.73 | | |
| 7 | 12.6306 | 4.6804 | | | | |
| 8 | −36.3428 | 0.7498 | 1.61415 | 62.08 | | |
| 9 | 32.8573 | 0.0748 | | | | |
| 10 | 21.6473 | 2.8148 | 1.89372 | 20.31 | | |
| 11 | −162.4456 | 1.7208 | | | | |
| 12 | −19.0520 | 0.7502 | 1.76355 | 52.79 | | |
| 13 | −53.7404 | DD[13] | | | | |
| 14 (St) | ∞ | −0.0002 | | | | |
| *15 | 16.5304 | 2.6449 | 1.58721 | 67.84 | | |
| *16 | −69.3922 | 2.5000 | | | | |
| 17 | 315.0209 | 1.7502 | 1.43601 | 69.10 | | |
| 18 | 28.7143 | DD[18] | | | | |
| 19 | 26.7715 | 0.7498 | 2.00000 | 25.34 | | |
| 20 | 12.0166 | 3.0602 | 1.56897 | 61.26 | | |
| 21 | −34.9907 | DD[21] | | | | |
| 22 | 25.2489 | 3.7894 | 1.79783 | 47.90 | | 4.47 |
| 23 | −15.8360 | 0.4995 | 2.00001 | 27.84 | | |
| 24 | −45.6926 | DD[24] | | | | |
| 25 | 72.0763 | 3.3663 | 1.91193 | 20.54 | | |
| 26 | −13.7710 | 0.5851 | 1.88720 | 33.83 | | |
| 27 | 13.0877 | DD[27] | | | | |
| *28 | −30.2759 | 0.4963 | 1.66178 | 35.42 | | |
| *29 | −86.8087 | DD[29] | | | | |
| 30 | −1756.2311 | 3.4869 | 1.80886 | 46.07 | | |
| 31 | −41.6660 | 13.0814 | | | 27.8 | |

TABLE 86
Example 29

| | Wide | Middle | Tele |
|---|---|---|---|
| Zr | 1.0 | 2.1 | 4.7 |
| f | 16.24 | 34.11 | 76.66 |
| Bf | 13.08 | 13.08 | 13.08 |
| FNo. | 3.59 | 5.56 | 6.49 |
| 2ω[°] | 88.2 | 43.4 | 20.2 |
| DD[5] | 0.10 | 11.20 | 21.85 |
| DD[13] | 17.15 | 11.14 | 2.60 |
| DD[18] | 3.00 | 1.00 | 1.36 |
| DD[21] | 1.63 | 0.31 | 0.31 |
| DD[24] | 0.49 | 0.29 | 2.31 |
| DD[27] | 5.65 | 5.71 | 5.90 |
| DD[29] | 0.29 | 16.94 | 29.42 |

TABLE 87
Example 29

| Sn | 15 | 16 | 28 | 29 |
|---|---|---|---|---|
| KA | 1.0000000E+00 | 1.0000000E+00 | 1.0000000E+00 | 1.0000000E+00 |
| A4 | −1.3932738E−05 | 3.9415871E−05 | −4.2588299E−05 | −2.6928874E−05 |
| A6 | −1.1810153E−07 | −1.5600125E−07 | 1.5483024E−07 | 4.3056909E−08 |
| A8 | 5.3286661E−10 | −5.4905218E−10 | 3.6869838E−10 | 2.9210869E−10 |
| A10 | −6.3296436E−11 | −5.3761228E−11 | −5.3571560E−11 | −5.4384669E−11 |

### Example 30

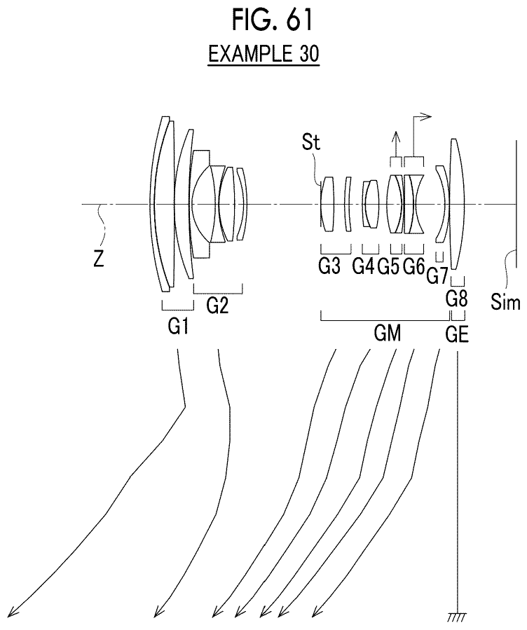

A configuration and a moving path of a variable magnification optical system of Example 30 are illustrated in FIG. 61. The variable magnification optical system of Example 30 consists of, in order from the object side to the image side, the first lens group G1 having a positive refractive power, the second lens group G2 having a negative refractive power, the third lens group G3 having a positive refractive power, the fourth lens group G4 having a negative refractive power, the fifth lens group G5 having a positive refractive power, the sixth lens group G6 having a negative refractive power, the seventh lens group G7 having a negative refractive power, and the eighth lens group G8 having a positive refractive power. The intermediate group GM consists of the third lens group G3, the fourth lens group G4, the fifth lens group G5, the sixth lens group G6, and the seventh lens group G7. The final lens group GE consists of the eighth lens group G8. During changing the magnification from the wide angle end to the telephoto end, seven lens groups including the first lens group G1 to the seventh lens group G7 move on different moving paths along the optical axis Z by changing spacings with respect to adjacent lens groups, and the eighth lens group G8 is fixed with respect to the image plane Sim. The vibration-proof group consists of the fifth lens group G5. The focus lens group consists of the sixth lens group G6 and moves to the image side during the focusing from the infinite distance object to the short range object.

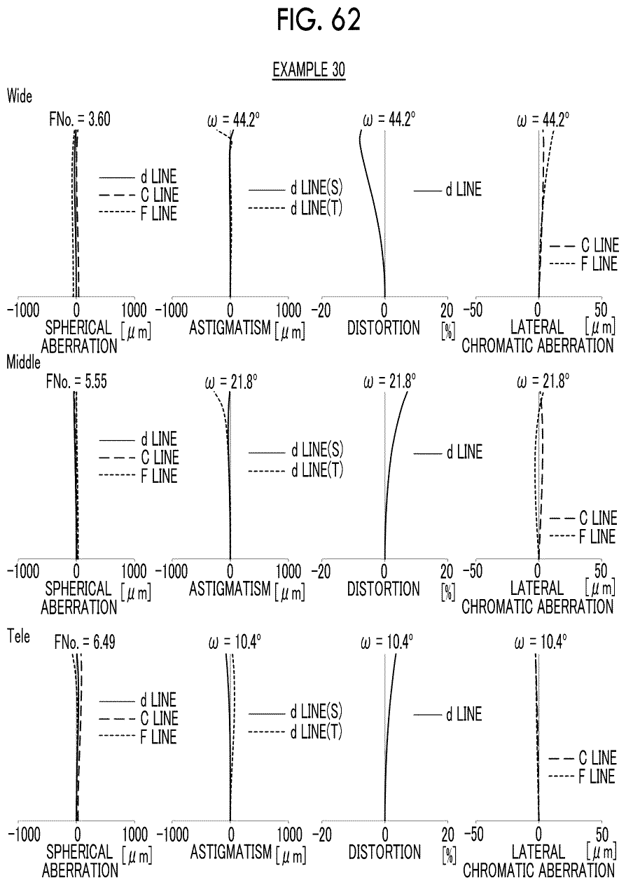

For the variable magnification optical system of Example 30, Table 88 shows basic lens data, Table 89 shows specifications and a variable surface spacing, Table 90 shows aspherical coefficients, and FIG. 62 illustrates each aberration diagram.

TABLE 88
Example 30

| Sn | R | D | Nd | νd | ED | SG | |
|---|---|---|---|---|---|---|---|
| 1 | 70.7657 | 0.9720 | 1.85894 | 22.13 | 38.521 | 3.65 | |
| 2 | 52.4331 | 4.5247 | 1.48749 | 70.32 | | 2.45 | |
| 3 | −1021.8664 | 0.1000 | | | | | |
| 4 | 43.2530 | 3.2987 | 1.61240 | 63.90 | | | |
| 5 | 133.3774 | DD[5] | | | | | |
| 6 | 74.9758 | 0.5954 | 1.91143 | 37.66 | | | |
| 7 | 11.3671 | 5.2502 | | | | | |
| 8 | −34.3192 | 0.7498 | 1.63455 | 52.51 | | | |
| 9 | 23.9783 | 0.0748 | | | | | |
| 10 | 18.1249 | 3.5002 | 1.85358 | 22.32 | | | |
| 11 | −75.1012 | 2.0453 | | | | | |
| 12 | −18.1684 | 0.7498 | 1.76897 | 50.45 | | | |
| 13 | −31.8457 | DD[13] | | | | | |
| 14 | ∞ | 0.0000 | | | | | |
| (St) | | | | | | | |
| *15 | 17.3733 | 2.9341 | 1.68477 | 58.47 | | | |
| *16 | −63.5655 | 2.4062 | | | | | |
| 17 | 41.5490 | 0.9998 | 1.43600 | 67.00 | | | |
| 18 | 40.0264 | DD[18] | | | | | |
| 19 | 45.9201 | 0.6498 | 1.99816 | 26.24 | | | |
| 20 | 12.1856 | 3.0598 | 1.45231 | 88.41 | | | |
| 21 | −26.9241 | DD[21] | | | | | |
| 22 | 23.2156 | 3.3490 | 1.81037 | 46.42 | | 4.55 | |
| 23 | −14.8157 | 0.4967 | 2.00001 | 26.54 | | | |
| 24 | −43.6269 | DD[24] | | | | | |
| 25 | −394.3116 | 2.0000 | 1.87260 | 21.94 | | | |
| 26 | −22.2651 | 0.5037 | 1.67000 | 57.35 | | | |
| 27 | 12.4690 | DD[27] | | | | | |
| *28 | −17.0781 | 1.0000 | 1.53409 | 55.87 | | 1.01 | Pla |
| *29 | −32.7514 | DD[29] | | | | | |
| 30 | 261.0752 | 3.3067 | 1.87290 | 34.19 | | | |
| 31 | −57.5450 | 11.6940 | | | 29.04 | | |

TABLE 89
Example 30

| | Wide | Middle | Tele |
|---|---|---|---|
| Zr | 1.0 | 2.1 | 4.7 |
| f | 15.80 | 33.17 | 74.56 |
| Bf | 11.69 | 11.69 | 11.69 |
| FNo. | 3.60 | 5.55 | 6.49 |
| 2ω[°] | 88.2 | 43.6 | 20.8 |
| DD[5] | 0.09 | 12.45 | 23.84 |
| DD[13] | 16.47 | 6.49 | 3.22 |
| DD[18] | 3.00 | 1.55 | 0.40 |
| DD[21] | 1.75 | 3.30 | 1.51 |
| DD[24] | 0.19 | 1.45 | 0.13 |
| DD[27] | 6.53 | 7.22 | 8.43 |
| DD[29] | 0.07 | 6.30 | 28.64 |

TABLE 90
Example 30

| Sn | 15 | 16 | 28 | 29 |
|---|---|---|---|---|
| KA | 1.0000000E+00 | 1.0000000E+00 | 1.0000000E+00 | 1.0000000E+00 |
| A4 | −2.4021145E−05 | 2.4039341E−05 | −3.4584625E−05 | −3.3499050E−05 |
| A6 | −3.4418126E−08 | −5.9132235E−08 | 1.9783995E−07 | 7.8321831E−08 |
| A8 | −4.7434325E−09 | −5.3319527E−09 | −4.0886067E−09 | −2.7223200E−09 |
| A10 | −5.0963592E−11 | −4.5346949E−11 | −3.2067302E−11 | −1.9375169E−11 |

### Example 31

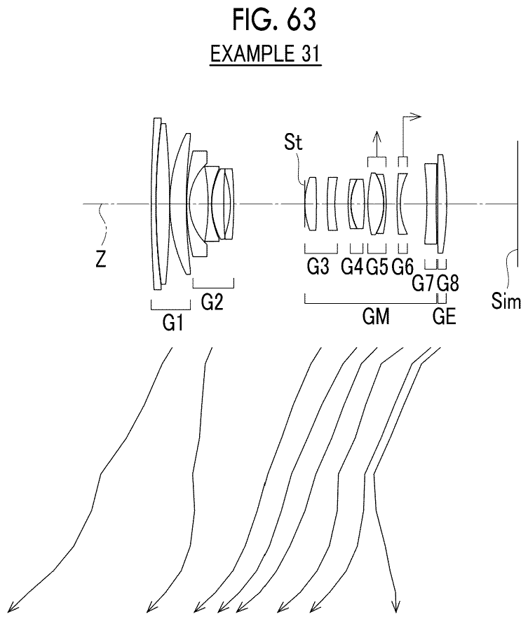

A configuration and a moving path of a variable magnification optical system of Example 31 are illustrated in FIG. 63. The variable magnification optical system of Example 31 consists of, in order from the object side to the image side, the first lens group G1 having a positive refractive power, the second lens group G2 having a negative refractive power, the third lens group G3 having a positive refractive power, the fourth lens group G4 having a negative refractive power, the fifth lens group G5 having a positive refractive power, the sixth lens group G6 having a negative refractive power, the seventh lens group G7 having a negative refractive power, and the eighth lens group G8 having a positive refractive power. The intermediate group GM consists of the third lens group G3, the fourth lens group G4, the fifth lens group G5, the sixth lens group G6, and the seventh lens group G7. The final lens group GE consists of the eighth lens group G8. During changing the magnification from the wide angle end to the telephoto end, the eight lens groups move on different moving paths along the optical axis Z by changing spacings with respect to adjacent lens groups. The vibration-proof group consists of the fifth lens group G5. The focus lens group consists of the sixth lens group G6 and moves to the image side during the focusing from the infinite distance object to the short range object.

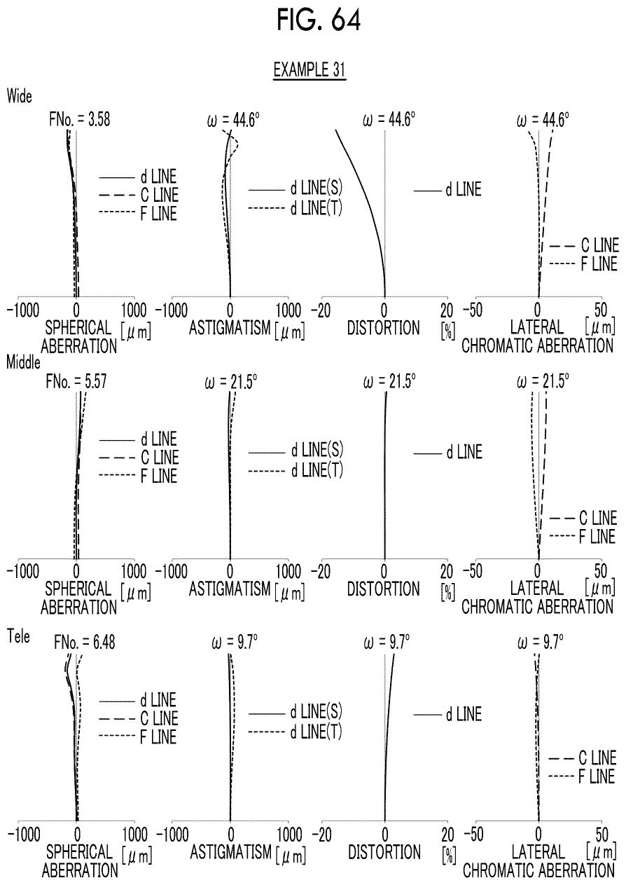

For the variable magnification optical system of Example 31, Table 91 shows basic lens data, Table 92 shows specifications and a variable surface spacing, Table 93 shows aspherical coefficients, and FIG. 64 illustrates each aberration diagram.

TABLE 91
Example 31

| Sn | R | D | Nd | νd | ED | SG | |
|---|---|---|---|---|---|---|---|
| 1 | 296.2211 | 1.0748 | 1.89328 | 23.77 | 37.679 | 3.97 | |
| 2 | 144.3430 | 3.0927 | 1.45600 | 91.37 | | 3.67 | |
| 3 | −184.1828 | 0.0400 | | | | | |
| 4 | 36.1093 | 3.7486 | 1.64214 | 60.56 | | | |
| 5 | 123.8474 | DD[5] | | | | | |
| 6 | 51.3321 | 0.5987 | 1.99593 | 25.89 | | | |
| 7 | 12.6826 | 4.2525 | | | | | |
| 8 | −48.4302 | 0.7502 | 1.48187 | 83.91 | | | |
| 9 | 19.3121 | 0.0749 | | | | | |
| 10 | 17.1133 | 2.6985 | 1.97954 | 17.34 | | | |
| 11 | 110.5142 | 1.5303 | | | | | |
| 12 | −20.7155 | 0.7498 | 1.84136 | 44.83 | | | |
| 13 | −93.3775 | DD[13] | | | | | |
| 14 (St) | ∞ | −0.0002 | | | | | |
| *15 | 15.8001 | 2.6467 | 1.66770 | 59.30 | | | |
| *16 | −133.8809 | 2.4243 | | | | | |
| 17 | 57.5808 | 1.7496 | 1.45597 | 87.86 | | | |
| 18 | 32.3525 | DD[18] | | | | | |
| 19 | 32.7270 | 0.6498 | 1.97472 | 28.89 | | | |
| 20 | 12.0103 | 3.0602 | 1.43890 | 89.07 | | | |
| *21 | −49.0315 | DD[21] | | | | | |
| 22 | 30.5176 | 3.6058 | 1.80674 | 41.75 | | 4.41 | |
| 23 | −13.7408 | 0.5345 | 1.99832 | 26.52 | | | |
| 24 | −35.0784 | DD[24] | | | | | |
| 25 | 71.4081 | 0.7498 | 1.53775 | 74.70 | | | |
| 26 | 15.5248 | DD[26] | | | | | |
| *27 | −97.0163 | 2.0983 | 1.53409 | 55.87 | | 1.01 | Pla |
| *28 | 115.0260 | DD[28] | | | | | |
| 29 | 1399.6421 | 2.0202 | 1.92934 | 22.46 | | | |
| 30 | −70.7308 | DD[30] | | | 22.4 | | |

TABLE 92
Example 31

| | Wide | Middle | Tele |
|---|---|---|---|
| Zr | 1.0 | 2.1 | 4.7 |
| f | 17.07 | 35.84 | 80.56 |
| Bf | 16.14 | 31.22 | 26.20 |
| FNo. | 3.58 | 5.57 | 6.48 |
| 2ω[°] | 89.2 | 43.0 | 19.4 |
| DD[5] | 0.10 | 11.88 | 22.58 |
| DD[13] | 16.01 | 8.33 | 2.09 |
| DD[18] | 3.00 | 0.30 | 0.35 |
| DD[21] | 0.78 | 1.67 | 0.31 |
| DD[24] | 2.46 | 1.72 | 5.82 |
| DD[26] | 6.03 | 5.72 | 7.10 |
| DD[28] | 0.36 | 0.24 | 17.66 |
| DD[30] | 16.14 | 31.22 | 26.20 |

TABLE 93
Example 31

| Sn | 15 | 16 | 21 | 27 |
|---|---|---|---|---|
| KA | 1.0000000E+00 | 1.0000000E+00 | 1.0000000E+00 | 1.0000000E+00 |
| A4 | −2.8444523E−05 | 1.7608966E−05 | −8.3184597E−07 | −5.6722830E−05 |
| A6 | −7.7389389E−07 | −7.3581886E−07 | 2.1569744E−07 | 4.5048957E−07 |
| A8 | 2.0997449E−08 | 1.2598256E−08 | −5.5606756E−09 | 2.5104175E−09 |
| A10 | −6.2342478E−10 | −5.0038590E−10 | 1.2224695E−10 | −3.0361670E−11 |

| Sn | 28 |
|---|---|
| KA | 1.0000000E+00 |
| A4 | −5.8374861E−05 |
| A6 | 3.3713288E−07 |
| A8 | 9.2349890E−10 |
| A10 | −1.9630698E−11 |

### Example 32

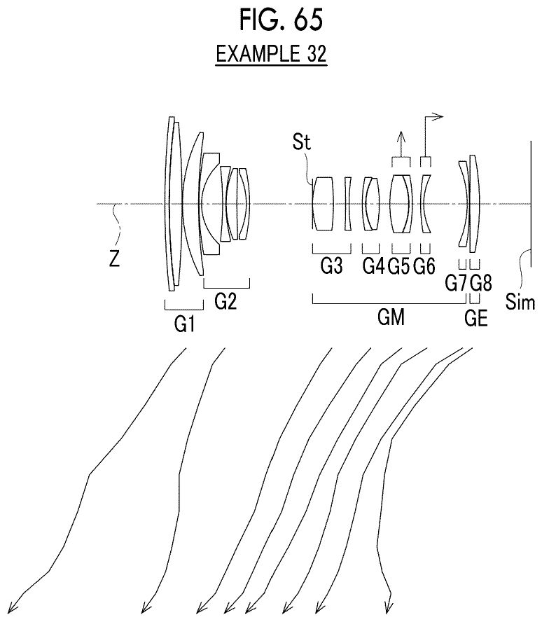

A configuration and a moving path of a variable magnification optical system of Example 32 are illustrated in FIG. 65. The variable magnification optical system of Example 32 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a negative refractive power, the seventh lens group G7 having a negative refractive power, and the eighth lens group G8 having a positive refractive power. The intermediate group GM consists of the third lens group G3, the fourth lens group G4, the fifth lens group G5, the sixth lens group G6, and the seventh lens group G7. The final lens group GE consists of the eighth lens group G8. During changing the magnification from the wide angle end to the telephoto end, the eight lens groups move on different moving paths along the optical axis Z by changing spacings with respect to adjacent lens groups. The vibration-proof group consists of the fifth lens group G5. The focus lens group consists of the sixth lens group G6 and moves to the image side during the focusing from the infinite distance object to the short range object.

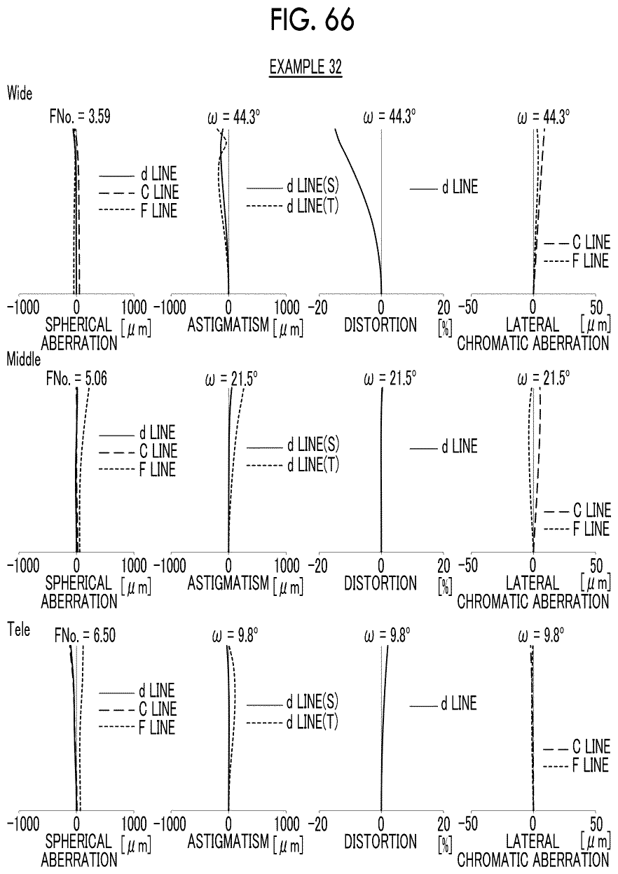

For the variable magnification optical system of Example 32, Table 94 shows basic lens data, Table 95 shows specifications and a variable surface spacing, Table 96 shows aspherical coefficients, and FIG. 66 illustrates each aberration diagram.

TABLE 94
Example 32

| Sn | R | D | Nd | νd | ED | SG | |
|---|---|---|---|---|---|---|---|
| 1 | 195.7510 | 0.9984 | 1.98229 | 15.89 | 37.294 | 5.15 | |
| 2 | 154.9245 | 2.8970 | 1.48749 | 70.32 | | 2.45 | |
| 3 | −206.7616 | 0.1000 | | | | | |
| 4 | 35.2821 | 3.6416 | 1.59066 | 67.30 | | | |
| 5 | 108.6201 | DD[5] | | | | | |
| 6 | 60.5854 | 0.5727 | 1.94896 | 33.82 | | | |
| 7 | 12.4638 | 4.7732 | | | | | |
| 8 | −75.2553 | 0.7500 | 1.81553 | 47.47 | | | |
| 9 | 31.9025 | 0.0750 | | | | | |
| 10 | 20.9153 | 2.4242 | 1.97896 | 16.05 | | | |
| 11 | 156.6917 | 2.1252 | | | | | |
| 12 | −16.4445 | 0.7498 | 1.89207 | 39.64 | | | |
| 13 | −36.8745 | DD[13] | | | | | |
| 14 (St) | ∞ | 0.0000 | | | | | |
| *15 | 17.6046 | 4.7134 | 1.72547 | 53.88 | | | |
| *16 | −47.9752 | 2.7500 | | | | | |
| 17 | −198.9519 | 0.8000 | 1.61426 | 38.52 | | | |
| 18 | 40.1547 | DD[18] | | | | | |
| 19 | 29.8496 | 0.8000 | 1.99750 | 28.85 | | | |
| 20 | 12.4132 | 3.0600 | 1.49930 | 62.56 | | | |
| 21 | −29.4984 | DD[21] | | | | | |
| 22 | 25.0587 | 4.3100 | 1.73474 | 43.43 | | 3.81 | |
| 23 | −15.2452 | 0.7830 | 2.00000 | 28.60 | | | |
| 24 | −35.6000 | DD[24] | | | | | |
| 25 | 38.1997 | 0.7028 | 1.89243 | 39.60 | | | |
| 26 | 14.1176 | DD[26] | | | | | |
| *27 | −23.0135 | 0.4961 | 1.53409 | 55.87 | | 1.01 | Pla |
| *28 | −94.1511 | DD[28] | | | | | |
| 29 | 2068.2602 | 2.1932 | 1.92544 | 18.73 | | | |
| 30 | −57.0137 | DD[30] | | | 22 | | |

TABLE 95
Example 32

| | Wide | Middle | Tele |
|---|---|---|---|
| Zr | 1.0 | 2.1 | 4.7 |
| f | 17.09 | 35.90 | 80.69 |
| Bf | 11.69 | 31.62 | 31.17 |
| FNo. | 3.59 | 5.06 | 6.50 |
| 2ω[°] | 88.6 | 43.0 | 19.6 |
| DD[5] | 0.10 | 11.66 | 21.60 |
| DD[13] | 14.17 | 9.65 | 2.50 |
| DD[18] | 3.00 | 0.37 | 0.45 |
| DD[21] | 2.39 | 1.28 | 0.20 |
| DD[24] | 1.89 | 0.32 | 4.49 |
| DD[26] | 9.87 | 7.48 | 9.24 |
| DD[28] | 0.10 | 2.73 | 13.91 |
| DD[30] | 11.69 | 31.62 | 31.17 |

TABLE 96
Example 32

| Sn | 15 | 16 | 27 | 28 |
|---|---|---|---|---|
| KA | 1.0000000E+00 | 1.0000000E+00 | 1.0000000E+00 | 1.0000000E+00 |
| A4 | −3.1976888E−05 | 2.0494818E−05 | −1.8488145E−05 | −3.1453765E−05 |
| A6 | −1.3775773E−07 | −1.9287851E−07 | 1.7840078E−07 | 5.1838090E−08 |
| A8 | −7.3555961E−10 | −2.1646010E−09 | −3.3848463E−09 | −2.0543022E−09 |
| A10 | −3.1540709E−11 | −1.8333017E−11 | 4.3386089E−11 | 1.7906320E−11 |

### Example 33

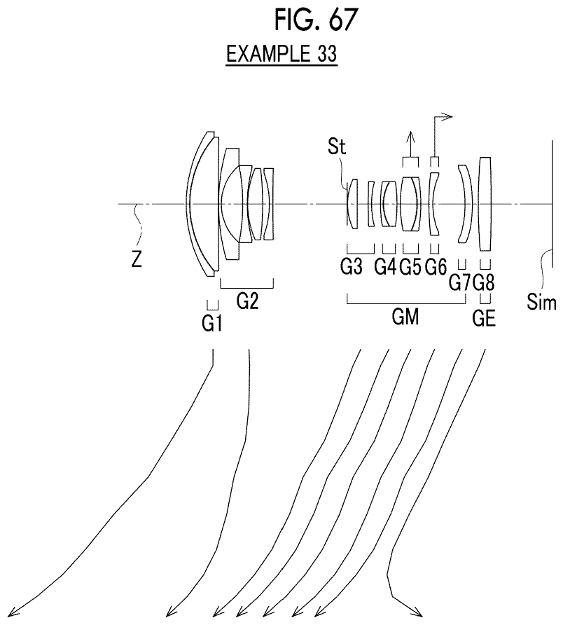

A configuration and a moving path of a variable magnification optical system of Example 33 are illustrated in FIG. 67. The variable magnification optical system of Example 33 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a positive refractive power, the sixth lens group G6 having a negative refractive power, the seventh lens group G7 having a negative refractive power, and the eighth lens group G8 having a positive refractive power. The intermediate group GM consists of the third lens group G3, the fourth lens group G4, the fifth lens group G5, the sixth lens group G6, and the seventh lens group G7. The final lens group GE consists of the eighth lens group G8. During changing the magnification from the wide angle end to the telephoto end, the third lens group G3, the fifth lens group G5, and the seventh lens group G7 move on the same moving path along the optical axis Z, and the first lens group G1, the second lens group G2, the third lens group G3, the fourth lens group G4, the sixth lens group G6, and the eighth lens group G8 move on different moving paths along the optical axis Z by changing spacings with respect to adjacent lens groups. The vibration-proof group consists of the fifth lens group G5. The focus lens group consists of the sixth lens group G6 and moves to the image side during the focusing from the infinite distance object to the short range object.

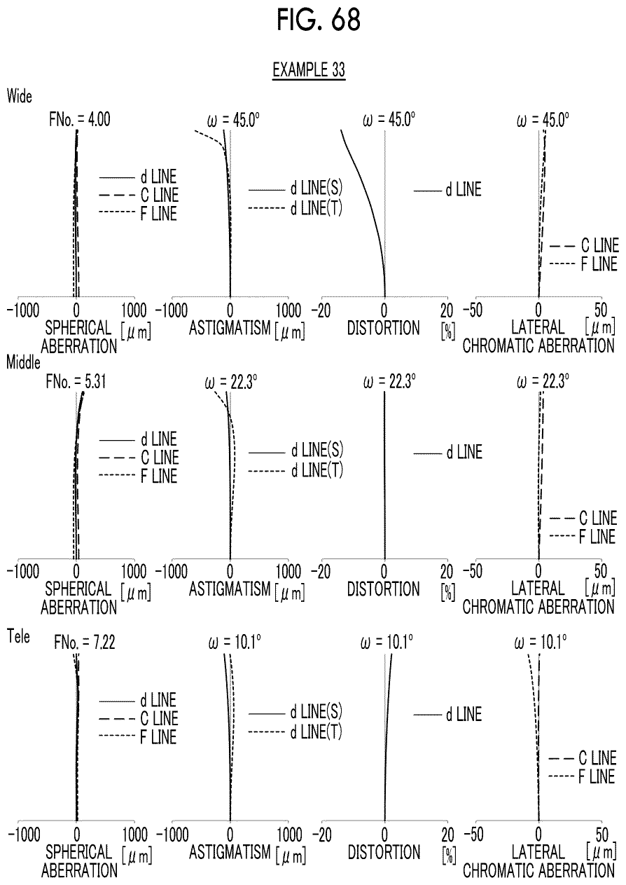

For the variable magnification optical system of Example 33, Table 97 shows basic lens data, Table 98 shows specifications and a variable surface spacing, Table 99 shows aspherical coefficients, and FIG. 68 illustrates each aberration diagram.

TABLE 97
Example 33

| Sn | R | D | Nd | νd | ED | SG | |
|---|---|---|---|---|---|---|---|
| 1 | 30.3867 | 0.7963 | 1.86562 | 31.79 | 32.479 | 4.62 | |
| 2 | 23.4224 | 6.4085 | 1.48749 | 70.32 | | 2.45 | |
| 3 | 1066.2678 | DD[3] | | | | | |
| 4 | 45.1230 | 0.6109 | 1.97318 | 22.74 | | | |
| 5 | 11.4080 | 4.8177 | | | | | |
| 6 | −46.7420 | 1.0389 | 1.76698 | 51.68 | | | |
| 7 | 31.4134 | 0.0751 | | | | | |
| 8 | 19.7917 | 3.3691 | 1.92371 | 18.96 | | | |
| 9 | −67.2287 | 1.5011 | | | | | |
| 10 | −20.9086 | 0.8019 | 1.58285 | 68.37 | | | |
| 11 | 365.9387 | DD[11] | | | | | |
| 12 | ∞ | 0.0820 | | | | | |
| (St) | | | | | | | |
| *13 | 12.9114 | 2.1628 | 1.72976 | 56.23 | | | |
| *14 | −1532.2856 | 2.4920 | | | | | |
| 15 | 224.3305 | 0.7502 | 1.62155 | 35.95 | | | |
| 16 | 20.1829 | DD[16] | | | | | |
| 17 | 28.9448 | 0.6501 | 1.83831 | 43.97 | | | |
| 18 | 9.6783 | 3.0600 | 1.47452 | 85.00 | | | |
| 19 | −37.2050 | DD[19] | | | | | |
| 20 | 28.2422 | 3.7836 | 1.76834 | 41.49 | | 4.03 | |
| 21 | −14.2774 | 0.8250 | 1.98435 | 24.49 | | | |
| 22 | −36.4545 | DD[22] | | | | | |
| 23 | 64.9571 | 0.8748 | 1.53775 | 74.70 | | | |
| 24 | 16.1462 | DD[24] | | | | | |
| *25 | −29.3802 | 1.6608 | 1.66121 | 20.35 | | 1.23 | Pla |
| *26 | −36.4274 | DD[26] | | | | | |
| 27 | 124.0446 | 2.9040 | 1.48749 | 70.32 | | | |
| 28 | −276.2238 | DD[28] | | | 21 | | |

TABLE 98
Example 33

| | Wide | Middle | Tele |
|---|---|---|---|
| Zr | 1.0 | 2.1 | 4.7 |
| f | 16.48 | 34.60 | 77.77 |
| Bf | 13.76 | 26.57 | 27.99 |
| FNo. | 4.00 | 5.31 | 7.22 |
| 2ω[°] | 90.0 | 44.6 | 20.2 |
| DD[3] | 0.06 | 11.24 | 27.54 |
| DD[11] | 16.58 | 6.96 | 2.10 |
| DD[16] | 1.99 | 1.18 | 0.92 |
| DD[19] | 0.75 | 1.55 | 1.82 |
| DD[22] | 1.83 | 2.79 | 2.89 |
| DD[24] | 7.24 | 6.28 | 6.18 |
| DD[26] | 1.32 | 1.51 | 20.16 |
| DD[28] | 13.76 | 26.57 | 27.99 |

TABLE 99
Example 33

| Sn | 13 | 14 | 25 | 26 |
|---|---|---|---|---|
| KA | 1.0000000E+00 | 1.0000000E+00 | 1.0000000E+00 | 1.0000000E+00 |
| A4 | −3.4460342E−05 | 1.5417418E−05 | −6.8209639E−05 | −6.4977777E−05 |
| A6 | −1.1239881E−07 | 9.2727183E−09 | 1.1164236E−07 | 3.0875466E−08 |
| A8 | −1.6976413E−09 | −5.3977575E−09 | −1.0230737E−09 | −1.1719729E−09 |
| A10 | 1.4572808E−12 | 7.1723311E−11 | −5.9601202E−11 | −3.4696594E−11 |
| A12 | −4.5982843E−15 | −1.0791785E−15 | 1.0509654E−16 | 5.7004631E−16 |
| A14 | −3.1165267E−19 | −5.7822146E−17 | −2.7448917E−18 | −5.5193196E−19 |
| A16 | 3.1734675E−18 | −5.1685882E−20 | 2.8847831E−21 | 3.9178655E−21 |
| A18 | −6.6660151E−20 | −2.9795919E−21 | −2.3374996E−24 | −1.1864116E−23 |
| A20 | 6.6082519E−22 | −2.5569392E−20 | 1.1168505E−26 | −3.6249737E−27 |

### Example 34

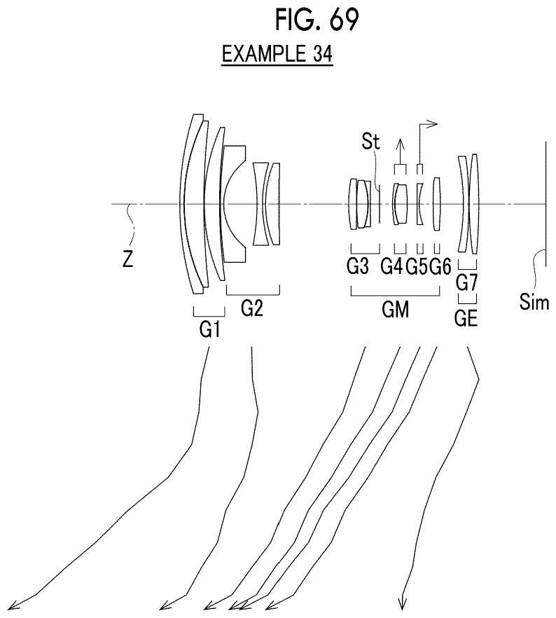

A configuration and a moving path of a variable magnification optical system of Example 34 are illustrated in FIG. 69. The variable magnification optical system of Example 34 consists of, in order from the object side to the image side, the first lens group G1 having a positive refractive power, the second lens group G2 having a negative refractive power, the third lens group G3 having a positive refractive power, the fourth lens group G4 having a positive refractive power, the fifth lens group G5 having a negative refractive power, the sixth lens group G6 having a positive refractive power, and the seventh lens group G7 having a positive refractive power. The intermediate group GM consists of the third lens group G3, the fourth lens group G4, the fifth lens group G5, and the sixth lens group G6. The final lens group GE consists of the seventh lens group G7. During changing the magnification from the wide angle end to the telephoto end, the fourth lens group G4 and the sixth lens group G6 move on the same moving path along the optical axis Z, and the first lens group G1, the second lens group G2, the third lens group G3, the fourth lens group G4, the fifth lens group G5, and the seventh lens group G7 move on different moving paths along the optical axis Z by changing spacings with respect to adjacent lens groups. The vibration-proof group consists of the fourth lens group G4. The focus lens group consists of the fifth lens group G5 and moves to the image side during the focusing from the infinite distance object to the short range object.

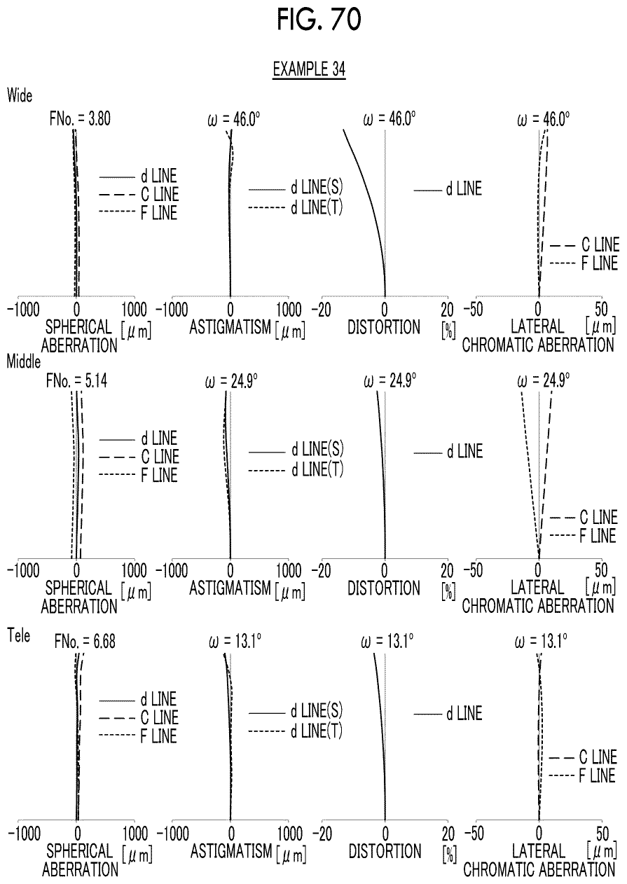

For the variable magnification optical system of Example 34, Table 100 shows basic lens data, Table 101 shows specifications and a variable surface spacing, Table 102 shows aspherical coefficients, and FIG. 70 illustrates each aberration diagram.

TABLE 100
Example 34

| Sn | R | D | Nd | νd | ED | SG | |
|---|---|---|---|---|---|---|---|
| 1 | 68.5049 | 1.0000 | 1.43599 | 67.00 | 41 | 2.846 | |
| 2 | 43.4663 | 4.5102 | 1.49782 | 82.57 | | 3.860 | |
| 3 | 166.6567 | 0.1000 | | | | | |
| 4 | 43.2581 | 3.5001 | 1.48749 | 70.32 | | | |
| 5 | 126.1014 | DD[5] | | | | | |
| 6 | 101.9488 | 0.7500 | 1.83880 | 45.09 | | | |
| 7 | 12.3392 | 7.6235 | | | | | |
| 8 | −48.4486 | 1.2500 | 1.72940 | 56.25 | | | |
| 9 | 31.3029 | 0.6958 | | | | | |
| 10 | 24.9863 | 3.0002 | 1.89854 | 22.65 | | | |
| 11 | 483.2379 | DD[11] | | | | | |
| 12 | 30.9477 | 1.8102 | 1.72416 | 56.51 | | | |
| 13 | −265.4524 | 0.0399 | | | | | |
| *14 | 46.1987 | 2.5869 | 1.49782 | 82.57 | | | |
| 15 | −16.1324 | 0.5100 | 1.59668 | 38.33 | | | |
| 16 | 206.5891 | 2.1249 | | | | | |
| 17 (St) | ∞ | DD[17] | | | | | |
| 18 | 26.3158 | 0.5099 | 1.72830 | 28.58 | | | |
| 19 | 12.2860 | 2.8370 | 1.81091 | 47.94 | | 4.496 | |
| *20 | −32.4112 | DD[20] | | | | | |
| 21 | 311.1399 | 0.5002 | 1.82944 | 41.02 | | | |
| 22 | 13.0196 | DD[22] | | | | | |
| *23 | −256.9485 | 1.6312 | 1.53409 | 55.87 | | 1.01 | Pla |
| *24 | −36.3077 | DD[24] | | | | | |
| *25 | −49.5045 | 1.2545 | 1.53409 | 55.87 | | 1.01 | Pla |
| *26 | −90.3783 | 0.1000 | | | | | |
| 27 | 83.3308 | 2.1760 | 1.71323 | 48.36 | | | |
| 28 | −125.0056 | DD[28] | | | 22.771 | | |

TABLE 101
Example 34

| | Wide | Middle | Tele |
|---|---|---|---|
| Zr | 1.0 | 2.0 | 4.0 |
| f | 15.78 | 31.43 | 63.13 |
| Bf | 15.37 | 22.58 | 30.28 |
| FNo. | 3.80 | 5.14 | 6.68 |
| 2ω[°] | 92.0 | 49.8 | 26.2 |
| DD[5] | 0.20 | 7.75 | 25.16 |
| DD[11] | 15.91 | 4.06 | 0.14 |
| DD[17] | 2.98 | 0.89 | 0.71 |
| DD[20] | 2.23 | 1.68 | 0.10 |
| DD[22] | 3.23 | 3.78 | 5.37 |
| DD[24] | 5.25 | 13.77 | 29.37 |
| DD[28] | 15.37 | 22.58 | 30.28 |

TABLE 102
Example 34

| Sn | 14 | 20 | 23 | 24 |
|---|---|---|---|---|
| KA | 1.0000000E+00 | 1.0000000E+00 | 1.0000000E+00 | 1.0000000E+00 |
| A4 | −2.0791375E−05 | 7.8029601E−05 | 2.5396058E−04 | 1.8278365E−04 |
| A6 | 1.5301327E−06 | −7.7373187E−07 | −4.5468664E−07 | 4.8792574E−07 |
| A8 | −3.1483996E−07 | 4.3499579E−08 | 4.3724715E−08 | 8.4975637E−09 |
| A10 | 3.7157734E−08 | −3.8723483E−09 | −1.7437821E−10 | 5.0098492E−10 |
| A12 | −2.5259135E−09 | 3.0322968E−10 | 2.6120367E−12 | 2.1406133E−11 |
| A14 | 1.0044277E−10 | −1.6152130E−11 | −1.4275217E−12 | −2.1266292E−12 |
| A16 | −2.2755595E−12 | 4.7419440E−13 | 3.2556556E−14 | 3.8001878E−14 |
| A18 | 2.6609593E−14 | −5.5991444E−15 | 2.5102742E−16 | 1.4481697E−16 |
| A20 | −1.1980152E−16 | 0.0000000E+00 | −7.7857911E−18 | −5.5063189E−18 |

| Sn | 25 | 26 |
|---|---|---|
| KA | 1.0000000E+00 | 1.0000000E+00 |
| A4 | −2.1863997E−06 | −6.3989928E−06 |
| A6 | 1.0621788E−07 | 5.2899017E−08 |
| A8 | −1.5350112E−09 | −5.5135492E−10 |
| A10 | 9.1698144E−12 | 4.4443676E−12 |
| A12 | 1.1720976E−13 | −2.1429370E−14 |
| A14 | −2.0665893E−15 | 1.4508529E−16 |
| A16 | 7.9052334E−19 | −3.8342299E−18 |
| A18 | 1.0658479E−19 | 2.0604934E−20 |
| A20 | −4.1875453E−22 | 0.0000000E+00 |

Tables 103 to 116 show the corresponding values of Conditional Expressions (1) to (48) of the variable magnification optical systems of Examples 1 to 34. A field without a corresponding lens shows “-”. For Conditional Expression (44), in a case where there are a plurality of corresponding lenses, corresponding values of the plurality of lenses are shown. Preferable ranges of the conditional expressions may be set using the corresponding values of the examples shown in Tables 103 to 116 as the upper limits and the lower limits of the conditional expressions.

TABLE 103

| Expression Number | | Example 1 | Example 2 | Example 3 | Example 4 | Example 5 |
|---|---|---|---|---|---|---|
| (1) | Bfw/(ft × tan ωt) | 0.792 | 0.886 | 0.839 | 0.886 | 1.042 |
| (2) | TLw/(ft × tan ωt) | 5.717 | 6.361 | 6.165 | 6.352 | 5.796 |
| (3) | TLw/ft | 0.998 | 1.110 | 1.087 | 1.109 | 1.032 |
| (4) | FNot/(ft/fw) | 1.527 | 1.306 | 1.376 | 1.321 | 1.544 |
| (5) | fw/(ft × tan ωt) | 1.217 | 1.217 | 1.204 | 1.217 | 1.192 |
| (6) | (fw × TLw)/ft² | 0.212 | 0.236 | 0.231 | 0.235 | 0.219 |
| (7) | f1/(−f2) | 5.973 | 6.041 | 7.811 | 5.799 | 6.193 |
| (8) | fw/fE | −0.177 | −0.160 | 0.062 | −0.185 | −0.002 |
| (9) | f1/(fw × ft)^{1/2} | 1.981 | 2.209 | 2.290 | 2.132 | 2.368 |
| (10) | (−f2)/(fw × ft)^{1/2} | 0.332 | 0.366 | 0.293 | 0.368 | 0.382 |
| (11) | f1/(ft/FNot) | 6.562 | 6.260 | 6.837 | 6.109 | 7.935 |
| (12) | TLw/fw | 4.699 | 5.229 | 5.120 | 5.222 | 4.861 |
| (13) | TLt/ft | 1.500 | 1.615 | 1.624 | 1.564 | 1.579 |
| (14) | TLt/(ft × tan ωt) | 8.594 | 9.256 | 9.209 | 8.964 | 8.863 |
| (15) | (tan ωw)/FNow | 0.219 | 0.250 | 0.257 | 0.253 | 0.226 |
| (16) | DDG1STw/f1 | 0.484 | 0.509 | 0.461 | 0.543 | 0.418 |
| (17) | Denw/{(fw × tan ωw) × log (ft/fw)} | 1.859 | 2.251 | 2.032 | 2.304 | 1.648 |
| (18) | Denw/(fw × ft)^{1/2} | 0.519 | 0.626 | 0.581 | 0.650 | 0.477 |
| (19) | DDG1STw/TLw | 0.443 | 0.466 | 0.447 | 0.481 | 0.442 |
| (20) | fw/Dexw | 0.512 | 0.457 | 0.413 | 0.462 | 0.415 |
| (21) | (−M1)/TLt | 0.335 | 0.313 | 0.331 | 0.291 | 0.346 |
| (22) | (−M2)/TLt | 0.108 | 0.086 | 0.111 | 0.079 | 0.106 |
| (23) | fw/fMw | 0.909 | 0.817 | 0.954 | 0.817 | 0.817 |
| (24) | ft/fMt | 4.280 | 3.833 | 5.219 | 3.839 | 3.897 |
| (25) | D1sum/(ft/FNot) | 0.727 | 0.908 | 0.868 | 0.938 | 0.619 |

TABLE 104

| Expression Number | | Example 1 | Example 2 | Example 3 | Example 4 | Example 5 |
|---|---|---|---|---|---|---|
| (26) | β2t/β2w | 2.041 | 1.990 | 1.802 | 1.913 | 1.820 |
| (27) | ν1pave | 76.25 | 86.26 | 81.37 | 84.43 | 70.32 |
| (28) | fMw/fp | 1.046 | 1.130 | 0.812 | 1.093 | 1.190 |
| (29) | EDf/EDr | 1.707 | 2.084 | 1.785 | 2.081 | 1.626 |
| (30) | EDf/TLw | 0.441 | 0.465 | 0.474 | 0.465 | 0.385 |
| (31) | d1/EDf | 0.025 | 0.025 | 0.025 | 0.025 | 0.024 |
| (32) | d1/(Denw × tan ωw) | 0.051 | 0.050 | 0.052 | 0.048 | 0.047 |
| (33) | d2 × (1/R2f − 1/R2r) | 0.048 | 0.150 | 0.083 | 0.232 | 0.243 |
| (34) | d1/f1 | 0.012 | 0.013 | 0.012 | 0.013 | 0.009 |
| (35) | d1/D1sum | 0.109 | 0.088 | 0.096 | 0.086 | 0.114 |
| (36) | G12ave | 4.24 | 3.03 | 4.47 | 4.47 | 3.26 |
| (37) | ν2 | 82.57 | 82.28 | 81.54 | 85.42 | 70.32 |
| (38) | ν3 | 69.92 | 90.23 | 81.20 | 83.44 | — |
| (39) | fL21/f2 | 1.322 | 1.180 | 1.717 | 1.173 | 1.085 |
| (40) | (RL21f + RL21r)/(RL21f − RL21r) | 1.871 | 1.678 | 1.795 | 1.480 | 1.700 |
| (41) | fL22/f2 | 3.371 | 2.277 | 1.721 | 2.299 | 1.906 |
| (42) | ft/fw | 4.709 | 4.710 | 4.710 | 4.710 | 4.709 |
| (43) | f2/f3 | −0.760 | −0.751 | −0.684 | −0.726 | −0.768 |
| (44) | GP | 1.01 | — | — | — | 1.23 |
| | | | | | | 1.01 |
| (45) | \|fIS/ft\| | 0.223 | 0.230 | 0.282 | 0.247 | 0.271 |
| (46) | GISave | 2.89 | 3.57 | 3.15 | 3.15 | 3.25 |
| (47) | (REnf + REnr)/(REnf − REnr) | — | — | −8.448 | — | −0.143 |
| (48) | (REpf + REpr)/(REpf − REpr) | — | — | −1.000 | — | −0.551 |

TABLE 105

| Expression Number | | Example 6 | Example 7 | Example 8 | Example 9 | Example 10 |
|---|---|---|---|---|---|---|
| (1) | Bfw/(ft × tan ωt) | 0.840 | 0.705 | 0.807 | 0.803 | 0.804 |
| (2) | TLw/(ft × tan ωt) | 5.498 | 6.241 | 5.605 | 6.237 | 6.165 |
| (3) | TLw/ft | 1.139 | 1.270 | 0.978 | 1.100 | 1.087 |
| (4) | FNot/(ft/fw) | 1.552 | 1.742 | 1.393 | 1.402 | 1.293 |
| (5) | fw/(ft × tan ωt) | 1.025 | 1.143 | 1.217 | 1.204 | 1.204 |
| (6) | (fw × TLw)/ft² | 0.242 | 0.295 | 0.208 | 0.234 | 0.231 |
| (7) | f1/(−f2) | 5.760 | 4.497 | 9.637 | 6.972 | 7.868 |
| (8) | fw/fE | 0.165 | −0.153 | −0.146 | −0.171 | 0.077 |
| (9) | f1/(fw × ft)^{1/2} | 2.178 | 2.944 | 2.408 | 2.357 | 2.287 |
| (10) | (−f2)/(fw × ft)^{1/2} | 0.378 | 0.655 | 0.250 | 0.338 | 0.291 |
| (11) | f1/(ft/FNot) | 7.338 | 10.634 | 7.278 | 7.171 | 6.417 |
| (12) | TLw/fw | 5.362 | 5.460 | 4.607 | 5.179 | 5.119 |
| (13) | TLt/ft | 1.811 | 1.890 | 1.595 | 1.624 | 1.624 |
| (14) | TLt/(ft × tan ωt) | 8.744 | 9.291 | 9.140 | 9.209 | 9.210 |
| (15) | (tan ωw)/FNow | 0.277 | 0.239 | 0.252 | 0.253 | 0.257 |
| (16) | DDG1STw/f1 | 0.627 | 0.441 | 0.375 | 0.468 | 0.458 |
| (17) | Denw/{(fw × tan ωw) × log (ft/fw)} | 1.473 | 2.080 | 1.855 | 2.133 | 2.011 |
| (18) | Denw/(fw × ft)^{1/2} | 0.520 | 0.627 | 0.520 | 0.600 | 0.575 |
| (19) | DDG1STw/TLw | 0.553 | 0.493 | 0.426 | 0.463 | 0.444 |
| (20) | fw/Dexw | 0.417 | 0.463 | 0.487 | 0.473 | 0.381 |
| (21) | (−M1)/TLt | 0.371 | 0.328 | 0.387 | 0.323 | 0.331 |
| (22) | (−M2)/TLt | 0.215 | 0.091 | 0.134 | 0.106 | 0.100 |
| (23) | fw/fMw | 0.733 | 0.723 | 1.098 | 0.863 | 0.936 |
| (24) | ft/fMt | 3.592 | 2.656 | 5.861 | 4.314 | 5.141 |
| (25) | D1sum/(ft/FNot) | 0.435 | 0.933 | 0.879 | 0.866 | 0.825 |

TABLE 106

| Expression Number | | Example 6 | Example 7 | Example 8 | Example 9 | Example 10 |
|---|---|---|---|---|---|---|
| (26) | β2t/β2w | 1.600 | 1.737 | 1.846 | 1.760 | 1.869 |
| (27) | ν1pave | 56.46 | 33.40 | 76.70 | 77.81 | 81.91 |
| (28) | fMw/fp | 1.278 | 0.747 | 0.949 | 0.970 | 1.022 |
| (29) | EDf/EDr | 1.590 | 2.028 | 1.843 | 1.916 | 1.765 |
| (30) | EDf/TLw | 0.413 | 0.455 | 0.525 | 0.468 | 0.474 |
| (31) | d1/EDf | 0.127 | 0.032 | 0.028 | 0.025 | 0.025 |
| (32) | d1/(Denw × tan ωw) | — | 0.062 | 0.066 | 0.051 | 0.053 |
| (33) | d2 × (1/R2f − 1/R2r) | — | 0.066 | 0.083 | 0.073 | 0.089 |
| (34) | d1/f1 | — | 0.013 | 0.013 | 0.012 | 0.012 |
| (35) | d1/D1sum | — | 0.149 | 0.106 | 0.098 | 0.095 |
| (36) | G12ave | — | 3.02 | 4.47 | 3.61 | 4.46 |
| (37) | ν2 | — | 70.24 | 74.23 | 70.32 | 81.54 |
| (38) | ν3 | — | 83.04 | 79.17 | 85.29 | 82.27 |
| (39) | fL21/f2 | 1.167 | 0.857 | 2.090 | 1.540 | 1.720 |
| (40) | (RL21f + RL21r)/(RL21f − RL21r) | 1.767 | 1.211 | 2.544 | 2.035 | 1.891 |
| (41) | fL22/f2 | 1.886 | 1.056 | 1.298 | 1.107 | 1.738 |
| (42) | ft/fw | 4.709 | 4.300 | 4.710 | 4.708 | 4.709 |
| (43) | f2/f3 | −0.699 | 0.393 | −0.480 | −0.455 | −0.471 |
| (44) | −GP | — | 1.01 | — | 1.01 | — |
| | | | 1.01 | | 1.01 | |
| (45) | \|fIS/ft\| | 0.578 | 0.431 | 0.263 | 0.254 | 0.280 |
| (46) | GISave | 3.13 | 3.08 | 3.32 | 3.06 | 3.15 |
| (47) | (REnf + REnr)/(REnf − REnr) | — | — | −4.789 | −0.337 | −8.706 |
| (48) | (REpf + REpr)/(REpf − REpr) | — | — | −1.000 | −1.000 | −1.000 |

TABLE 107

| Expression Number | | Example 11 | Example 12 | Example 13 | Example 14 | Example 15 |
|---|---|---|---|---|---|---|
| (1) | Bfw/(ft × tan ωt) | 0.803 | 0.819 | 0.809 | 1.112 | 0.756 |
| (2) | TLw/(ft × tan ωt) | 6.165 | 6.188 | 5.887 | 5.514 | 5.496 |
| (3) | TLw/ft | 1.087 | 1.091 | 1.006 | 1.202 | 0.969 |
| (4) | FNot/(ft/fw) | 1.362 | 1.620 | 1.448 | 1.825 | 1.388 |
| (5) | fw/(ft × tan ωt) | 1.205 | 1.204 | 1.242 | 1.147 | 1.201 |
| (6) | (fw × TLw)/ft² | 0.231 | 0.232 | 0.214 | 0.301 | 0.205 |
| (7) | f1/(−f2) | 7.263 | 7.576 | 6.879 | 6.408 | 7.346 |
| (8) | fw/fE | −0.139 | −0.163 | −0.535 | 0.163 | −0.396 |
| (9) | f1/(fw × ft)^{1/2} | 2.279 | 2.725 | 2.491 | 2.752 | 2.517 |
| (10) | (−f2)/(fw × ft)^{1/2} | 0.314 | 0.360 | 0.362 | 0.429 | 0.343 |
| (11) | f1/(ft/FNot) | 6.731 | 9.581 | 7.829 | 10.045 | 7.588 |
| (12) | TLw/fw | 5.118 | 5.139 | 4.739 | 4.808 | 4.574 |
| (13) | TLt/ft | 1.624 | 1.629 | 1.592 | 2.111 | 1.557 |
| (14) | TLt/(ft × tan ωt) | 9.211 | 9.241 | 9.315 | 9.680 | 8.829 |
| (15) | (tan ωw)/FNow | 0.255 | 0.225 | 0.254 | 0.240 | 0.265 |
| (16) | DDG1STw/f1 | 0.481 | 0.392 | 0.397 | 0.436 | 0.366 |
| (17) | Denw/{(fw × tan ωw) × log (ft/fw)} | 2.085 | 1.752 | 1.756 | 1.603 | 1.695 |
| (18) | Denw/(fw × ft)^{1/2} | 0.593 | 0.503 | 0.499 | 0.477 | 0.502 |
| (19) | DDG1STw/TLw | 0.465 | 0.451 | 0.453 | 0.499 | 0.438 |
| (20) | fw/Dexw | 0.450 | 0.445 | 0.612 | 0.428 | 0.599 |
| (21) | (−M1)/TLt | 0.331 | 0.330 | 0.368 | 0.430 | 0.378 |
| (22) | (−M2)/TLt | 0.106 | 0.091 | 0.100 | 0.268 | 0.121 |
| (23) | fw/fMw | 0.880 | 0.817 | 0.960 | 0.750 | 1.024 |
| (24) | ft/fMt | 4.441 | 4.396 | 4.510 | 2.791 | 4.910 |
| (25) | D1sum/(ft/FNot) | 0.849 | 0.640 | 0.702 | 0.493 | 0.632 |

TABLE 108

| Expression Number | | Example 11 | Example 12 | Example 13 | Example 14 | Example 15 |
|---|---|---|---|---|---|---|
| (26) | β2t/β2w | 1.862 | 1.641 | 1.878 | 1.452 | 1.774 |
| (27) | ν1pave | 80.65 | 71.53 | 74.37 | 42.01 | 65.83 |
| (28) | fMw/fp | 1.188 | 1.188 | 1.051 | 0.938 | 1.087 |
| (29) | EDf/EDr | 1.916 | 1.667 | 2.013 | 1.715 | 1.984 |
| (30) | EDf/TLw | 0.474 | 0.402 | 0.475 | 0.402 | 0.487 |
| (31) | d1/EDf | 0.025 | 0.025 | 0.025 | 0.031 | 0.031 |
| (32) | d1/(Denw × tan ωw) | 0.051 | 0.051 | 0.057 | 0.063 | 0.066 |
| (33) | d2 × (1/R2f − 1/R2r) | 0.078 | 0.168 | 0.056 | 0.069 | 0.035 |
| (34) | d1/f1 | 0.012 | 0.009 | 0.010 | 0.011 | 0.013 |
| (35) | d1/D1sum | 0.097 | 0.131 | 0.116 | 0.222 | 0.151 |
| (36) | G12ave | 4.39 | 4.51 | 4.46 | 3.08 | 2.98 |
| (37) | ν2 | 79.83 | 71.53 | 74.40 | 42.01 | 70.24 |
| (38) | ν3 | 81.46 | — | 74.33 | — | 61.42 |
| (39) | fL21/f2 | 1.623 | 1.409 | 1.495 | 1.083 | 1.361 |
| (40) | (RL21f + RL21r)/(RL21f − RL21r) | 1.760 | 1.905 | 2.123 | 1.399 | 1.698 |
| (41) | fL22/f2 | 1.379 | 1.427 | 0.926 | 1.450 | 2.973 |
| (42) | ft/fw | 4.708 | 4.710 | 4.709 | 3.999 | 4.720 |
| (43) | f2/f3 | −0.476 | −0.520 | −0.279 | −0.362 | −0.170 |
| (44) | GP | — | — | — | — | — |
| (45) | \|fIS/ft\| | 0.264 | 0.281 | 0.415 | 0.226 | 0.339 |
| (46) | GISave | 2.96 | 2.98 | 3.15 | 3.97 | — |
| (47) | (REnf + REnr)/(REnf − REnr) | −0.370 | −0.322 | −0.752 | — | −1.854 |
| (48) | (REpf + REpr)/(REpf − REpr) | −1.000 | −0.578 | −1.000 | — | −0.593 |

TABLE 109

| Expression Number | | Example 16 | Example 17 | Example 18 | Example 19 | Example 20 |
|---|---|---|---|---|---|---|
| (1) | Bfw/(ft × tan ωt) | 0.425 | 0.810 | 0.931 | 0.892 | 0.815 |
| (2) | TLw/(ft × tan ωt) | 5.681 | 5.843 | 5.952 | 5.950 | 5.988 |
| (3) | TLw/ft | 1.002 | 1.020 | 1.060 | 1.103 | 1.077 |
| (4) | FNot/(ft/fw) | 1.373 | 1.394 | 1.366 | 1.345 | 1.341 |
| (5) | fw/(ft × tan ωt) | 1.201 | 1.214 | 1.189 | 1.143 | 1.178 |
| (6) | (fw × TLw)/ft² | 0.212 | 0.216 | 0.225 | 0.234 | 0.228 |
| (7) | f1/(−f2) | 6.486 | 7.789 | 6.279 | 5.399 | 6.288 |
| (8) | fw/fE | −0.292 | −0.231 | 0.104 | 0.126 | −0.008 |
| (9) | f1/(fw × ft)^{1/2} | 2.380 | 3.086 | 2.130 | 2.161 | 2.086 |
| (10) | (−f2)/(fw × ft)^{1/2} | 0.367 | 0.396 | 0.339 | 0.400 | 0.332 |
| (11) | f1/(ft/FNot) | 7.097 | 9.345 | 6.324 | 6.315 | 6.077 |
| (12) | TLw/fw | 4.728 | 4.813 | 5.005 | 5.206 | 5.085 |
| (13) | TLt/ft | 1.563 | 1.755 | 1.539 | 1.669 | 1.539 |
| (14) | TLt/(ft × tan ωt) | 8.865 | 10.057 | 8.638 | 9.005 | 8.553 |
| (15) | (tan ωw)/FNow | 0.265 | 0.264 | 0.275 | 0.274 | 0.275 |
| (16) | DDG1STw/f1 | 0.407 | 0.317 | 0.481 | 0.502 | 0.500 |
| (17) | Denw/{(fw × tan ωw) × log (ft/fw)} | 1.769 | 1.697 | 1.731 | 1.786 | 1.738 |
| (18) | Denw/(fw × ft)^{1/2} | 0.523 | 0.500 | 0.530 | 0.546 | 0.532 |
| (19) | DDG1STw/TLw | 0.445 | 0.442 | 0.445 | 0.453 | 0.446 |
| (20) | fw/Dexw | 0.602 | 0.535 | 0.421 | 0.460 | 0.435 |
| (21) | (−M1)/TLt | 0.359 | 0.419 | 0.311 | 0.339 | 0.300 |
| (22) | (−M2)/TLt | 0.107 | 0.135 | 0.101 | 0.110 | 0.089 |
| (23) | fw/fMw | 0.956 | 0.922 | 0.896 | 0.839 | 0.880 |
| (24) | ft/fMt | 4.495 | 4.197 | 4.663 | 3.379 | 4.528 |
| (25) | D1sum/(ft/FNot) | 0.669 | 0.595 | 0.763 | 0.698 | 0.699 |

TABLE 110

| Expression Number | | Example 16 | Example 17 | Example 18 | Example 19 | Example 20 |
|---|---|---|---|---|---|---|
| (26) | β2t/β2w | 1.874 | 1.751 | 1.773 | 2.097 | 1.827 |
| (27) | ν1pave | 64.33 | 71.17 | 53.32 | 65.32 | 63.37 |
| (28) | fMw/fp | 1.153 | 1.108 | 0.872 | 1.133 | 0.865 |
| (29) | EDf/EDr | 1.580 | 2.036 | 1.870 | 1.948 | 1.676 |
| (30) | EDf/TLw | 0.478 | 0.502 | 0.460 | 0.484 | 0.452 |
| (31) | d1/EDf | 0.034 | 0.031 | 0.026 | 0.031 | 0.026 |
| (32) | d1/(Denw × tan ωw) | 0.071 | 0.073 | 0.052 | 0.067 | 0.052 |
| (33) | d2 × (1/R2f − 1/R2r) | 0.049 | 0.030 | 0.125 | 0.029 | 0.084 |
| (34) | d1/f1 | 0.015 | 0.011 | 0.013 | 0.017 | 0.013 |
| (35) | d1/D1sum | 0.158 | 0.177 | 0.106 | 0.152 | 0.114 |
| (36) | G12ave | 2.98 | 3.80 | 3.16 | 3.96 | 2.97 |
| (37) | ν2 | 70.32 | 62.75 | 70.32 | 56.85 | 70.32 |
| (38) | ν3 | 58.33 | 79.58 | 36.32 | 73.79 | 56.41 |
| (39) | fL21/f2 | 1.266 | 1.223 | 1.305 | 1.032 | 1.401 |
| (40) | (RL21f + RL21r)/(RL21f − RL21r) | 1.486 | 1.663 | 1.459 | 1.460 | 1.623 |
| (41) | fL22/f2 | 2.219 | 2.499 | 2.034 | 1.337 | 1.505 |
| (42) | ft/fw | 4.720 | 4.720 | 4.721 | 4.721 | 4.720 |
| (43) | f2/f3 | −0.145 | −0.131 | −0.927 | −0.105 | −0.859 |
| (44) | GP | 1.22 | — | 1.01 | — | 1.01 |
| (45) | \|fIS/ft\| | 0.353 | 0.349 | 0.271 | 0.304 | 0.278 |
| (46) | GISave | — | — | 3.27 | 3.62 | 3.58 |
| (47) | (REnf + REnr)/(REnf − REnr) | −0.620 | −1.713 | −0.719 | −0.168 | −0.302 |
| (48) | (REpf + REpr)/(REpf − REpr) | −0.655 | −0.911 | −0.732 | −1.000 | −1.000 |

TABLE 111

| Expression Number | | Example 21 | Example 22 | Example 23 | Example 24 | Example 25 |
|---|---|---|---|---|---|---|
| (1) | Bfw/(ft × tan ωt) | 0.862 | 0.842 | 0.865 | 0.251 | 0.841 |
| (2) | TLw/(ft × tan ωt) | 6.541 | 5.986 | 5.987 | 5.603 | 5.968 |
| (3) | TLw/ft | 0.943 | 1.077 | 1.077 | 0.988 | 1.031 |
| (4) | FNot/(ft/fw) | 1.109 | 1.390 | 1.409 | 1.601 | 1.373 |
| (5) | fw/(ft × tan ωt) | 1.186 | 1.177 | 1.177 | 1.201 | 1.226 |
| (6) | (fw × TLw)/ft² | 0.161 | 0.228 | 0.228 | 0.209 | 0.218 |
| (7) | f1/(−f2) | 5.307 | 6.507 | 5.381 | 7.798 | 4.640 |
| (8) | fw/fE | −0.041 | −0.095 | 0.006 | −0.183 | 0.230 |
| (9) | f1/(fw × ft)^{1/2} | 1.619 | 1.994 | 2.088 | 2.366 | 1.570 |
| (10) | (−f2)/(fw × ft)^{1/2} | 0.305 | 0.306 | 0.388 | 0.303 | 0.338 |
| (11) | f1/(ft/FNot) | 4.343 | 6.021 | 6.392 | 8.233 | 4.682 |
| (12) | TLw/fw | 5.515 | 5.084 | 5.085 | 4.664 | 4.867 |
| (13) | TLt/ft | 1.289 | 1.537 | 1.630 | 1.500 | 1.491 |
| (14) | TLt/(ft × tan ωt) | 8.945 | 8.542 | 9.057 | 8.505 | 8.632 |
| (15) | (tan ωw)/FNow | 0.280 | 0.274 | 0.269 | 0.238 | 0.256 |
| (16) | DDG1STw/f1 | 0.621 | 0.505 | 0.525 | 0.373 | 0.629 |
| (17) | Denw/{(fw × tan ωw) × log (ft/fw)} | 1.482 | 1.661 | 1.871 | 1.498 | 1.771 |
| (18) | Denw/(fw × ft)^{1/2} | 0.473 | 0.508 | 0.563 | 0.455 | 0.507 |
| (19) | DDG1STw/TLw | 0.441 | 0.431 | 0.469 | 0.411 | 0.441 |
| (20) | fw/Dexw | 0.427 | 0.426 | 0.497 | 0.382 | 0.471 |
| (21) | (−M1)/TLt | 0.269 | 0.299 | 0.339 | 0.341 | 0.309 |
| (22) | (−M2)/TLt | 0.060 | 0.098 | 0.132 | 0.102 | 0.127 |
| (23) | fw/fMw | 0.810 | 0.884 | 0.866 | 0.964 | 0.957 |
| (24) | ft/fMt | 5.095 | 4.666 | 3.531 | 5.259 | 4.282 |
| (25) | D1sum/(ft/FNot) | 0.578 | 0.760 | 0.771 | 0.671 | 0.672 |

TABLE 112

| Expression Number | | Example 21 | Example 22 | Example 23 | Example 24 | Example 25 |
|---|---|---|---|---|---|---|
| (26) | β2t/β2w | 2.275 | 1.810 | 1.943 | 1.718 | 2.170 |
| (27) | ν1pave | 54.11 | 52.15 | 68.51 | 70.32 | 73.70 |
| (28) | fMw/fp | 0.877 | 0.900 | 1.129 | 0.803 | 0.932 |
| (29) | EDf/EDr | 1.671 | 1.721 | 2.028 | 1.507 | 1.673 |
| (30) | EDf/TLw | 0.401 | 0.451 | 0.484 | 0.403 | 0.463 |
| (31) | d1/EDf | 0.027 | 0.025 | 0.031 | 0.025 | 0.026 |
| (32) | d1/(Denw × tan ωw) | 0.053 | 0.053 | 0.065 | 0.049 | 0.057 |
| (33) | d2 × (1/R2f − 1/R2r) | 0.069 | 0.072 | 0.032 | 0.266 | 0.043 |
| (34) | d1/f1 | 0.015 | 0.013 | 0.017 | 0.009 | 0.017 |
| (35) | d1/D1sum | 0.116 | 0.105 | 0.140 | 0.112 | 0.118 |
| (36) | G12ave | 3.63 | 3.43 | 3.18 | 3.30 | 3.72 |
| (37) | ν2 | 72.45 | 70.32 | 70.32 | 70.32 | 82.57 |
| (38) | ν3 | 35.76 | 33.98 | 66.69 | — | 64.82 |
| (39) | fL21/f2 | 1.246 | 1.412 | 1.079 | 1.416 | 1.215 |
| (40) | (RL21f + RL21r)/(RL21f − RL21r) | 1.484 | 1.747 | 1.420 | 1.793 | 1.506 |
| (41) | fL22/f2 | 1.525 | 1.758 | 1.369 | 1.915 | 1.688 |
| (42) | ft/fw | 5.851 | 4.720 | 4.721 | 4.721 | 4.721 |
| (43) | f2/f3 | −0.764 | −0.783 | −0.118 | −0.857 | −0.573 |
| (44) | GP | — | 1.01 | — | 1.01 | 1.01 |
| (45) | \|fIS/ft\| | 0.241 | 0.266 | 0.298 | 0.274 | 0.290 |
| (46) | GISave | 3.59 | 2.83 | 3.62 | 3.57 | 4.75 |
| (47) | (REnf + REnr)/(REnf − REnr) | −0.139 | −0.248 | −0.313 | −0.380 | — |
| (48) | (REpf + REpr)/(REpf − REpr) | −1.000 | −0.792 | −0.808 | −0.413 | — |

TABLE 113

| Expression Number | | Example 26 | Example 27 | Example 28 | Example 29 | Example 30 |
|---|---|---|---|---|---|---|
| (1) | Bfw/(ft × tan ωt) | 0.854 | 0.853 | 0.870 | 0.958 | 0.854 |
| (2) | TLw/(ft × tan ωt) | 6.050 | 6.645 | 5.725 | 6.079 | 6.018 |
| (3) | TLw/ft | 1.056 | 0.887 | 1.061 | 1.083 | 1.105 |
| (4) | FNot/(ft/fw) | 1.386 | 1.225 | 1.375 | 1.375 | 1.375 |
| (5) | fw/(ft × tan ωt) | 1.214 | 1.270 | 1.143 | 1.189 | 1.155 |
| (6) | (fw × TLw)/ft² | 0.224 | 0.150 | 0.225 | 0.229 | 0.234 |
| (7) | f1/(−f2) | 6.672 | 6.005 | 6.146 | 5.471 | 4.928 |
| (8) | fw/fE | 0.233 | 0.119 | 0.302 | 0.308 | 0.291 |
| (9) | f1/(fw × ft)^{1/2} | 2.279 | 1.742 | 2.404 | 2.022 | 1.929 |
| (10) | (−f2)/(fw × ft)^{1/2} | 0.341 | 0.290 | 0.391 | 0.370 | 0.392 |
| (11) | f1/(ft/FNot) | 6.859 | 5.186 | 7.180 | 6.040 | 5.764 |
| (12) | TLw/fw | 4.984 | 5.231 | 5.010 | 5.111 | 5.212 |
| (13) | TLt/ft | 1.569 | 1.259 | 1.583 | 1.545 | 1.615 |
| (14) | TLt/(ft × tan ωt) | 8.992 | 9.433 | 8.540 | 8.674 | 8.800 |
| (15) | (tan ωw)/FNow | 0.275 | 0.272 | 0.307 | 0.270 | 0.269 |
| (16) | DDG1STw/f1 | 0.429 | 0.541 | 0.410 | 0.504 | 0.580 |
| (17) | Denw/{(fw × tan ωw) × log (ft/fw)} | 1.627 | 1.474 | 1.477 | 1.739 | 1.874 |
| (18) | Denw/(fw × ft)^{1/2} | 0.498 | 0.457 | 0.505 | 0.523 | 0.563 |
| (19) | DDG1STw/TLw | 0.426 | 0.438 | 0.428 | 0.433 | 0.467 |
| (20) | fw/Dexw | 0.459 | 0.472 | 0.417 | 0.425 | 0.416 |
| (21) | (−M1)/TLt | 0.327 | 0.296 | 0.330 | 0.299 | 0.316 |
| (22) | (−M2)/TLt | 0.102 | 0.107 | 0.130 | 0.116 | 0.119 |
| (23) | fw/fMw | 1.001 | 0.952 | 0.914 | 0.913 | 0.861 |
| (24) | ft/fMt | 5.511 | 7.300 | 5.024 | 4.990 | 3.997 |
| (25) | D1sum/(ft/FNot) | 0.575 | 0.514 | 0.573 | 0.620 | 0.774 |

TABLE 114

| Expression Number | | Example 26 | Example 27 | Example 28 | Example 29 | Example 30 |
|---|---|---|---|---|---|---|
| (26) | B2t/B2w | 1.763 | 1.788 | 1.589 | 1.702 | 1.996 |
| (27) | ν1pave | 72.64 | 71.76 | 70.81 | 65.94 | 67.11 |
| (28) | fMw/fp | 0.762 | 0.771 | 0.867 | 0.774 | 0.907 |
| (29) | EDf/EDr | 1.695 | 1.816 | 1.274 | 1.294 | 1.326 |
| (30) | EDf/TLw | 0.449 | 0.418 | 0.446 | 0.433 | 0.468 |
| (31) | d1/EDf | 0.025 | 0.026 | 0.027 | 0.026 | 0.025 |
| (32) | d1/(Denw × tan ωw) | 0.053 | 0.052 | 0.049 | 0.053 | 0.052 |
| (33) | d2 × (1/R2f − 1/R2r) | 0.045 | 0.042 | 0.051 | 0.067 | 0.091 |
| (34) | d1/f1 | 0.011 | 0.013 | 0.011 | 0.013 | 0.015 |
| (35) | d1/D1sum | 0.137 | 0.135 | 0.144 | 0.130 | 0.109 |
| (36) | G12ave | 4.18 | 3.56 | 4.58 | 3.58 | 3.05 |
| (37) | ν2 | 69.95 | 73.08 | 70.22 | 72.46 | 70.32 |
| (38) | ν3 | 75.32 | 70.44 | 71.40 | 59.41 | 63.90 |
| (39) | fL21/f2 | 1.585 | 1.667 | 1.344 | 1.373 | 1.099 |
| (40) | (RL21f + RL21r)/(RL21f − RL21r) | 1.553 | 1.646 | 1.451 | 1.620 | 1.357 |
| (41) | fL22/f2 | 2.162 | 2.191 | 2.354 | 2.146 | 1.647 |
| (42) | ft/fw | 4.720 | 5.900 | 4.721 | 4.720 | 4.719 |
| (43) | f2/f3 | −0.457 | −0.402 | −0.505 | −0.428 | −0.666 |
| (44) | GP | — | — | — | — | 1.01 |
| (45) | \|fIS/ft\| | 0.325 | 0.297 | 0.318 | 0.326 | 0.303 |
| (46) | GISave | 4.44 | 3.81 | 4.82 | 4.47 | 4.55 |
| (47) | (REnf + REnr)/(REnf − REnr) | — | — | — | — | — |
| (48) | (REpf + REpr)/(REpf − REpr) | — | — | — | — | — |

TABLE 115

| Expression Number | | Example 31 | Example 32 | Example 33 | Example 34 |
|---|---|---|---|---|---|
| (1) | Bfw/(ft × tan ωt) | 1.172 | 0.839 | 0.993 | 1.046 |
| (2) | TLw/(ft × tan ωt) | 6.030 | 5.950 | 5.933 | 5.696 |
| (3) | TLw/ft | 1.031 | 1.028 | 1.057 | 1.326 |
| (4) | FNot/(ft/fw) | 1.373 | 1.377 | 1.530 | 1.670 |
| (5) | fw/(ft × tan ωt) | 1.240 | 1.226 | 1.190 | 1.074 |
| (6) | (fw × TLw)/ft² | 0.218 | 0.218 | 0.224 | 0.331 |
| (7) | f1/(−f2) | 5.539 | 6.251 | 6.641 | 5.275 |
| (8) | fw/fE | 0.235 | 0.285 | 0.094 | 0.056 |
| (9) | f1/(fw × ft)^{1/2} | 1.765 | 1.719 | 2.453 | 2.692 |
| (10) | (−f2)/(fw × ft)^{1/2} | 0.319 | 0.275 | 0.369 | 0.510 |
| (11) | f1/(ft/FNot) | 5.265 | 5.143 | 8.152 | 8.991 |
| (12) | TLw/fw | 4.864 | 4.852 | 4.988 | 5.303 |
| (13) | TLt/ft | 1.493 | 1.528 | 1.649 | 2.054 |
| (14) | TLt/(ft × tan ωt) | 8.733 | 8.845 | 9.259 | 8.825 |
| (15) | (tan ωw)/FNow | 0.275 | 0.272 | 0.250 | 0.273 |
| (16) | DDG1STw/f1 | 0.530 | 0.523 | 0.411 | 0.537 |
| (17) | Denw/{(fw × tan ωw) × log (ft/fw)} | 1.620 | 1.556 | 1.656 | 2.216 |
| (18) | Denw/(fw × ft)^{1/2} | 0.495 | 0.471 | 0.514 | 0.691 |
| (19) | DDG1STw/TLw | 0.418 | 0.402 | 0.439 | 0545 |
| (20) | fw/Dexw | 0.385 | 0.422 | 0.395 | 0.448 |
| (21) | (−M1)/TLt | 0.310 | 0.327 | 0.359 | 0.355 |
| (22) | (−M2)/TLt | 0.123 | 0.153 | 0.145 | 0.162 |
| (23) | fw/fMw | 0.916 | 1.121 | 0.842 | 0.733 |
| (24) | ft/fMt | 5.092 | 6.169 | 4.109 | 2.656 |
| (25) | D1sum/(ft/FNot) | 0.640 | 0.615 | 0.669 | 0.964 |

TABLE 116

| Expression Number | | Example 31 | Example 32 | Example 33 | Example 34 |
|---|---|---|---|---|---|
| (26) | β2t/β2w | 1.880 | 1.828 | 1.784 | 1.631 |
| (27) | ν1pave | 75.97 | 68.81 | 70.32 | 76.45 |
| (28) | fMw/fp | 0.874 | 0.833 | 1.115 | 0.561 |
| (29) | EDf/EDr | 1.682 | 1.695 | 1.547 | 1.801 |
| (30) | EDf/TLw | 0.454 | 0.450 | 0.395 | 0.490 |
| (31) | d1/EDf | 0.029 | 0.027 | 0.025 | 0.024 |
| (32) | d1/(Denw × tan ωw) | 0.059 | 0.058 | 0.043 | 0.044 |
| (33) | d2 × (1/R2f − 1/R2r) | 0.038 | 0.033 | 0.268 | 0.077 |
| (34) | d1/f1 | 0.016 | 0.016 | 0.009 | 0.012 |
| (35) | d1/D1sum | 0.135 | 0.131 | 0.111 | 0.110 |
| (36) | G12ave | 3.82 | 3.80 | 3.54 | 3.35 |
| (37) | ν2 | 91.37 | 70.32 | 70.32 | 82.57 |
| (38) | ν3 | 60.56 | 67.30 | — | 70.32 |
| (39) | fL21/f2 | 1.442 | 1.629 | 1.197 | 1.043 |
| (40) | (RL21f + RL21r)/(RL21f − RL21r) | 1.656 | 1.518 | 1.677 | 1.275 |
| (41) | fL22/f2 | 2.416 | 2.682 | 1.842 | 1.608 |
| (42) | ft/fw | 4.719 | 4.721 | 4.719 | 4.001 |
| (43) | f2/f3 | −0.505 | −0.424 | −0.601 | −0.522 |
| (44) | GP | 1.01 | 1.01 | 1.23 | 1.01 |
| | | | | | 1.01 |
| (45) | \|fIS/ft\| | 0.310 | 0.317 | 0.336 | 0.263 |
| (46) | GISave | 4.41 | 3.81 | 4.03 | 4.50 |
| (47) | (REnf + REnr)/(REnf − REnr) | — | — | — | −3.422 |
| (48) | (REpf + REpr)/(REpf − REpr) | — | — | — | −0.200 |

The variable magnification optical systems of Examples 1 to 34 maintain high optical performance by favorably correcting various aberrations in the entire magnification range, while being configured to be reduced in size. A full angle of view of the variable magnification optical systems of Examples 1 to 34 at the wide angle end is larger than 80°, and a wide angle of view is secured.

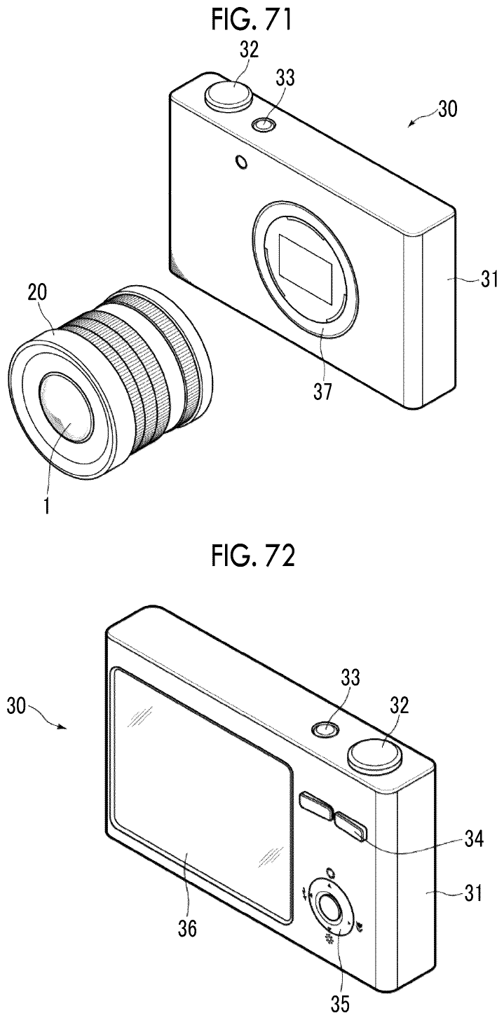

Next, an imaging apparatus according to the embodiment of the present disclosure will be described. FIGS. 71 and 72 illustrate external views of a camera 30 that is the imaging apparatus according to one embodiment of the present disclosure. FIG. 71 illustrates a perspective view of the camera 30 seen from its front surface side, and FIG. 72 illustrates a perspective view of the camera 30 seen from its rear surface side. The camera 30 is a so-called mirrorless type digital camera on which an interchangeable lens 20 can be attachably and detachably mounted. The interchangeable lens 20 is configured to include a variable magnification optical system 1 according to one embodiment of the present disclosure accommodated in a lens barrel.

The camera 30 comprises a camera body 31, and a shutter button 32 and a power button 33 are provided on an upper surface of the camera body 31. An operator 34, an operator 35, and a display unit 36 are provided on a rear surface of the camera body 31. The display unit 36 can display a captured image and an image within an angle of view before capturing.

An imaging opening on which light from an imaging target is incident is provided in a center portion of a front surface of the camera body 31, and a mount 37 is provided at a position corresponding to the imaging opening. The interchangeable lens 20 is mounted on the camera body 31 through the mount 37.

An imaging element such as a charge coupled device (CCD) or a complementary metal oxide semiconductor (CMOS) that outputs an imaging signal corresponding to a subject image formed by the interchangeable lens 20, a signal processing circuit that processes the imaging signal output from the imaging element to generate an image, a recording medium for recording the generated image, and the like are provided in the camera body 31. In the camera 30, a static image or a video can be captured by pressing the shutter button 32, and image data obtained by this capturing is recorded on the recording medium.

While the disclosed technology has been described above using the embodiment and the examples, the disclosed technology is not limited to the embodiment and the examples and can be subjected to various modifications. For example, the curvature radius, the surface spacing, the refractive index, the Abbe number, and the aspherical coefficient of each lens are not limited to the values shown in each example and may have other values.

The imaging apparatus according to the embodiment of the present disclosure is also not limited to the examples and can have various aspects of, for example, a camera of a type other than a mirrorless type, a film camera, a video camera, and a security camera.

The following appendices are further disclosed with respect to the embodiment and the examples described above.

### Appendix 1

A variable magnification optical system consisting of, in order from an object side to an image side, a first lens group having a positive refractive power, a second lens group having a negative refractive power, an intermediate group, and a final lens group having a refractive power,
wherein the intermediate group consists of two or more and five or fewer lens groups,
during changing magnification, a spacing between the first lens group and the second lens group changes, a spacing between the second lens group and the intermediate group changes, a spacing between the intermediate group and the final lens group changes, and all spacings between adjacent lens groups in the intermediate group change, and
in a case where a back focus of an entire system as an air conversion distance at a wide angle end is denoted by Bfw,
a focal length of the entire system in a state where an infinite distance object is in focus at a telephoto end is denoted by ft, and
a maximum half angle of view in the state where the infinite distance object is in focus at the telephoto end is denoted by ωt,
Conditional Expression (1) is satisfied, which is represented by

$$0. 4 < Bfw / ( ft \times tan ω t ) < 1.7 . \qquad ( 1 )$$

### Appendix 2

The variable magnification optical system according to Appendix 1,
wherein, in a case where a sum of a distance on an optical axis from a lens surface of the first lens group closest to the object side to a lens surface of the final lens group closest to the image side and the back focus of the entire system as the air conversion distance in a state where the infinite distance object is in focus at the wide angle end is denoted by TLw,
Conditional Expression (2) is satisfied, which is represented by

$$4 < TLw / ( ft \times tan ω t ) < 7. \qquad ( 2 )$$

### Appendix 3

The variable magnification optical system according to Appendix 1 or 2,
wherein, in a case where a sum of a distance on an optical axis from a lens surface of the first lens group closest to the object side to a lens surface of the final lens group closest to the image side and the back focus of the entire system as the air conversion distance in a state where the infinite distance object is in focus at the wide angle end is denoted by TLw,
Conditional Expression (3) is satisfied, which is represented by

$$0.75 < TLw / ft < 1.35 . \qquad ( 3 )$$

### Appendix 4

The variable magnification optical system according to any one of Appendices 1 to 3,
wherein, in a case where an open F-number in the state where the infinite distance object is in focus at the telephoto end is denoted by FNot, and
a focal length of the entire system in a state where the infinite distance object is in focus at the wide angle end is denoted by fw,
Conditional Expression (4) is satisfied, which is represented by

$$1.1 < FNot / ( ft / fw ) < 3. \qquad ( 4 )$$

### Appendix 5

The variable magnification optical system according to any one of Appendices 1 to 4,
wherein, in a case where a focal length of the entire system in a state where the infinite distance object is in focus at the wide angle end is denoted by fw,
Conditional Expression (5) is satisfied, which is represented by

$$0.9 < fw / ( ft \times tan ω t ) < 1.32 . \qquad ( 5 )$$

### Appendix 6

The variable magnification optical system according to any one of Appendices 1 to 5,
wherein, in a case where a focal length of the entire system in a state where the infinite distance object is in focus at the wide angle end is denoted by fw, and
a sum of a distance on an optical axis from a lens surface of the first lens group closest to the object side to a lens surface of the final lens group closest to the image side and the back focus of the entire system as the air conversion distance in a state where the infinite distance object is in focus at the wide angle end is denoted by TLw,
Conditional Expression (6) is satisfied, which is represented by

$$0.11 < ( f w \times T Lw ) / {ft}^{2} < 0.6 . \qquad ( 6 )$$

### Appendix 7

The variable magnification optical system according to any one of Appendices 1 to 6,
wherein the first lens group includes at least two lenses, and
in a case where a sum of a distance on an optical axis from a lens surface of the first lens group closest to the object side to a lens surface of the final lens group closest to the image side and the back focus of the entire system as the air conversion distance in a state where the infinite distance object is in focus at the wide angle end is denoted by TLw,
an open F-number in the state where the infinite distance object is in focus at the telephoto end is denoted by FNot, and
a focal length of the entire system in a state where the infinite distance object is in focus at the wide angle end is denoted by fw,
Conditional Expressions (2-3), (3), (4-2), and (5) are satisfied, which are represented by

$$4.7 < TLw / ( ft \times tan ω t ) < 6.7 , \qquad ( 2 - 3 )$$

$$0.75 < TLw / ft < 1.35 , \qquad ( 3 )$$

$$1.28 < F Not / ( ft / fw ) < 1.9 , and \qquad ( 4 - 2 )$$

$$0.9 < fw / ( ft \times tan ω t ) < 1.32 . \qquad ( 5 )$$

### Appendix 8

The variable magnification optical system according to any one of Appendices 1 to 7,
wherein, in a case where a focal length of the first lens group is denoted by f1, and
a focal length of the second lens group is denoted by f2,
Conditional Expression (7) is satisfied, which is represented by

$$2 < f 1 / ( - f 2 ) < 15. \qquad ( 7 )$$

### Appendix 9

The variable magnification optical system according to any one of Appendices 1 to 8,
wherein, in a case where a focal length of the entire system in a state where the infinite distance object is in focus at the wide angle end is denoted by fw, and
a focal length of the final lens group is denoted by fE,
Conditional Expression (8) is satisfied, which is represented by

$$- 1 < fw / fE < 1. \qquad ( 8 )$$

### Appendix 10

The variable magnification optical system according to any one of Appendices 1 to 9,
wherein, in a case where a focal length of the first lens group is denoted by f1, and
a focal length of the entire system in a state where the infinite distance object is in focus at the wide angle end is denoted by fw,
Conditional Expression (9) is satisfied, which is represented by

$$0.5 < f 1 / {( fw \times ft )}^{1 / 2} < 5. \qquad ( 9 )$$

### Appendix 11

The variable magnification optical system according to any one of Appendices 1 to 10,
wherein, in a case where a focal length of the second lens group is denoted by f2, and
a focal length of the entire system in a state where the infinite distance object is in focus at the wide angle end is denoted by fw,
Conditional Expression (10) is satisfied, which is represented by

$$0.1 < ( - f 2 ) / {( fw \times ft )}^{1 / 2} < 1. \qquad ( 10 )$$

### Appendix 12

The variable magnification optical system according to any one of Appendices 1 to 11,
wherein, in a case where a focal length of the first lens group is denoted by f1, and
an open F-number in the state where the infinite distance object is in focus at the telephoto end is denoted by FNot,
Conditional Expression (11) is satisfied, which is represented by

$$4 < f 1 / ( ft / FNot ) < 15. \qquad ( 11 )$$

### Appendix 13

The variable magnification optical system according to any one of Appendices 1 to 12,
wherein, in a case where a sum of a distance on an optical axis from a lens surface of the first lens group closest to the object side to a lens surface of the final lens group closest to the image side and the back focus of the entire system as the air conversion distance in a state where the infinite distance object is in focus at the wide angle end is denoted by TLw, and
a focal length of the entire system in a state where the infinite distance object is in focus at the wide angle end is denoted by fw,
Conditional Expression (12) is satisfied, which is represented by

$$3.5 < TLw / fw < 6.5 . \qquad ( 12 )$$

### Appendix 14

The variable magnification optical system according to any one of Appendices 1 to 13,
wherein, in a case where a sum of a distance on an optical axis from a lens surface of the first lens group closest to the object side to a lens surface of the final lens group closest to the image side and the back focus of the entire system as the air conversion distance in the state where the infinite distance object is in focus at the telephoto end is denoted by TLt,
Conditional Expression (13) is satisfied, which is represented by

$$1 < TLt / ft < 2.5 . \qquad ( 13 )$$

### Appendix 15

The variable magnification optical system according to any one of Appendices 1 to 14,
wherein, in a case where a sum of a distance on an optical axis from a lens surface of the first lens group closest to the object side to a lens surface of the final lens group closest to the image side and the back focus of the entire system as the air conversion distance in the state where the infinite distance object is in focus at the telephoto end is denoted by TLt,
Conditional Expression (14) is satisfied, which is represented by

$$7 < TLt / ( ft \times tan ω t ) < 11.5 . \qquad ( 14 )$$

### Appendix 16

The variable magnification optical system according to any one of Appendices 1 to 15,
wherein, in a case where a maximum half angle of view in a state where the infinite distance object is in focus at the wide angle end is denoted by ωw, and
an open F-number in the state where the infinite distance object is in focus at the wide angle end is denoted by FNow,
Conditional Expression (15) is satisfied, which is represented by

$$0.17 < tan ω w / FNow < 0.35 . \qquad ( 15 )$$

### Appendix 17

The variable magnification optical system according to any one of Appendices 1 to 16,
wherein an aperture stop is disposed closer to the image side than a lens surface of the second lens group closest to the image side, and
in a case where a distance on an optical axis from a lens surface of the first lens group closest to the object side to the aperture stop in a state where the infinite distance object is in focus at the wide angle end is denoted by DDG1STw, and
a focal length of the first lens group is denoted by f1,
Conditional Expression (16) is satisfied, which is represented by

$$0.15 < DDG 1 STw / f 1 < 1. \qquad ( 16 )$$

### Appendix 18

The variable magnification optical system according to any one of Appendices 1 to 17,
wherein, in a case where a distance on an optical axis from a lens surface of the first lens group closest to the object side to a paraxial entrance pupil position in a state where the infinite distance object is in focus at the wide angle end is denoted by Denw,
a focal length of the entire system in the state where the infinite distance object is in focus at the wide angle end is denoted by fw, and
a maximum half angle of view in the state where the infinite distance object is in focus at the wide angle end is denoted by ωw,
Conditional Expression (17) is satisfied, which is represented by

$$1 < Denw / \{ ( fw \times tan ω w ) \times log ( ft / fw ) \} < 3.5 . \qquad ( 17 )$$

### Appendix 19

The variable magnification optical system according to any one of Appendices 1 to 18,
wherein, in a case where a distance on an optical axis from a lens surface of the first lens group closest to the object side to a paraxial entrance pupil position in a state where the infinite distance object is in focus at the wide angle end is denoted by Denw, and
a focal length of the entire system in the state where the infinite distance object is in focus at the wide angle end is denoted by fw,
Conditional Expression (18) is satisfied, which is represented by

$$0.3 < Denw / {( fw \times ft )}^{1 / 2} < 1. \qquad ( 18 )$$

### Appendix 20

The variable magnification optical system according to any one of Appendices 1 to 19,
wherein the variable magnification optical system includes an aperture stop, and
in a case where a distance on an optical axis from a lens surface of the first lens group closest to the object side to the aperture stop in a state where the infinite distance object is in focus at the wide angle end is denoted by DDG1STw, and
a sum of a distance on the optical axis from the lens surface of the first lens group closest to the object side to a lens surface of the final lens group closest to the image side and the back focus of the entire system as the air conversion distance in the state where the infinite distance object is in focus at the wide angle end is denoted by TLw,
Conditional Expression (19) is satisfied, which is represented by

$$0.25 < DDG 1 STw / TLw < 0.6 . \qquad ( 19 )$$

### Appendix 21

The variable magnification optical system according to any one of Appendices 1 to 20,
wherein, in a case where a focal length of the entire system in a state where the infinite distance object is in focus at the wide angle end is denoted by fw, and
a sum of a distance on an optical axis from a paraxial exit pupil position to a lens surface of the final lens group closest to the image side and the back focus of the entire system as the air conversion distance in the state where the infinite distance object is in focus at the wide angle end is denoted by Dexw,
Conditional Expression (20) is satisfied, which is represented by

$$0.3 < fw / Dexw < 0.65 . \qquad ( 20 )$$

### Appendix 22

The variable magnification optical system according to any one of Appendices 1 to 21,
wherein, in a case where a moving amount of the first lens group during changing magnification from the wide angle end to the telephoto end is denoted by M1,
a sign of M1 is positive in moving from the object side to the image side and is negative in moving from the image side to the object side, and
a sum of a distance on an optical axis from a lens surface of the first lens group closest to the object side to a lens surface of the final lens group closest to the image side and the back focus of the entire system as the air conversion distance in the state where the infinite distance object is in focus at the telephoto end is denoted by TLt,
Conditional Expression (21) is satisfied, which is represented by

$$0.2 < ( - M 1 ) / TLt < 0.5 . \qquad ( 21 )$$

### Appendix 23

The variable magnification optical system according to any one of Appendices 1 to 22,
wherein, in a case where a moving amount of the second lens group during changing magnification from the wide angle end to the telephoto end is denoted by M2,
a sign of M2 is positive in moving from the object side to the image side and is negative in moving from the image side to the object side, and
a sum of a distance on an optical axis from a lens surface of the first lens group closest to the object side to a lens surface of the final lens group closest to the image side and the back focus of the entire system as the air conversion distance in the state where the infinite distance object is in focus at the telephoto end is denoted by TLt,
Conditional Expression (22) is satisfied, which is represented by

$$0.04 < ( - M 2 ) / TLt < 0.4 . \qquad ( 22 )$$

### Appendix 24

The variable magnification optical system according to any one of Appendices 1 to 23,
wherein, in a case where a focal length of the entire system in a state where the infinite distance object is in focus at the wide angle end is denoted by fw, and
a focal length of the intermediate group in the state where the infinite distance object is in focus at the wide angle end is denoted by fMw,
Conditional Expression (23) is satisfied, which is represented by

$$0.3 < fw / fMw < 2. \qquad ( 23 )$$

### Appendix 25

The variable magnification optical system according to any one of Appendices 1 to 24,
wherein, in a case where a focal length of the intermediate group in the state where the infinite distance object is in focus at the telephoto end is denoted by fMt,
Conditional Expression (24) is satisfied, which is represented by

$$1 < ft / fMt < 10. \qquad ( 24 )$$

### Appendix 26

The variable magnification optical system according to any one of Appendices 1 to 25,
wherein, in a case where a distance on an optical axis from a lens surface of the first lens group closest to the object side to a lens surface of the first lens group closest to the image side is denoted by D1sum, and
an open F-number in the state where the infinite distance object is in focus at the telephoto end is denoted by FNot,
Conditional Expression (25) is satisfied, which is represented by

$$0.2 < D 1 sum / ( ft / FNot ) < 1.6 . \qquad ( 25 )$$

### Appendix 27

The variable magnification optical system according to any one of Appendices 1 to 26,
wherein, in a case where a lateral magnification of the second lens group in the state where the infinite distance object is in focus at the telephoto end is denoted by β2t, and
a lateral magnification of the second lens group in a state where the infinite distance object is in focus at the wide angle end is denoted by β2w,
Conditional Expression (26) is satisfied, which is represented by

$$1 < β 2 t / β 2 w < 3. \qquad ( 26 )$$

### Appendix 28

The variable magnification optical system according to any one of Appendices 1 to 27,
wherein, in a case where an average value of Abbe numbers based on a d line for all positive lenses of the first lens group is denoted by v1pave,
Conditional Expression (27) is satisfied, which is represented by

$$40 < ν 1 pave < 95. \qquad ( 27 )$$

### Appendix 29

The variable magnification optical system according to any one of Appendices 1 to 28,
wherein a surface, on the image side, of an Lp positive lens that is a positive lens having a strongest positive refractive power among non-cemented single lenses of the intermediate group is a convex surface, and
in a case where a focal length of the Lp positive lens is fp, and
a focal length of the intermediate group in a state where the infinite distance object is in focus at the wide angle end is denoted by fMw,
Conditional Expression (28) is satisfied, which is represented by

$$0.4 < fMw / fp < 2. \qquad ( 28 )$$

### Appendix 30

The variable magnification optical system according to Appendix 29,
wherein the Lp positive lens is a biconvex lens.

### Appendix 31

The variable magnification optical system according to Appendix 30,
wherein a surface of the Lp positive lens on the object side and the surface of the Lp positive lens on the image side are aspherical surfaces.

### Appendix 32

The variable magnification optical system according to any one of Appendices 1 to 31,
wherein, in a case where an effective diameter of a lens surface of the first lens group closest to the object side is denoted by EDf, and
an effective diameter of a lens surface of the final lens group closest to the image side is denoted by EDr,
Conditional Expression (29) is satisfied, which is represented by

$$1.2 < EDf / EDr < 3. \qquad ( 29 )$$

### Appendix 33

The variable magnification optical system according to any one of Appendices 1 to 32,
wherein, in a case where an effective diameter of a lens surface of the first lens group closest to the object side is denoted by EDf, and
a sum of a distance on an optical axis from the lens surface of the first lens group closest to the object side to a lens surface of the final lens group closest to the image side and the back focus of the entire system as the air conversion distance in a state where the infinite distance object is in focus at the wide angle end is denoted by TLw,
Conditional Expression (30) is satisfied, which is represented by

$$0.25 < EDf / TLw < 0.6 . \qquad ( 30 )$$

### Appendix 34

The variable magnification optical system according to any one of Appendices 1 to 33,
wherein the first lens group includes, in consecutive order from a position closest to the object side to the image side, a first lens that is a negative lens, and a second lens that is a positive lens.

### Appendix 35

The variable magnification optical system according to Appendix 34,
wherein, in a case where a center thickness of the first lens is denoted by d1 and
an effective diameter of a lens surface of the first lens group closest to the object side is denoted by EDf,
Conditional Expression (31) is satisfied, which is represented by

$$0.01 < d 1 / EDf < 0.4 . \qquad ( 31 )$$

### Appendix 36

The variable magnification optical system according to Appendix 34 or 35,
wherein, in a case where a center thickness of the first lens is denoted by d1,
a distance on an optical axis from a lens surface of the first lens group closest to the object side to a paraxial entrance pupil position in a state where the infinite distance object is in focus at the wide angle end is denoted by Denw, and
a maximum half angle of view in a state where the infinite distance object is in focus at the wide angle end is denoted by ωw,
Conditional Expression (32) is satisfied, which is represented by

$$0.01 < d 1 / ( Denw \times tan ω w ) < 0 \text{.15} . \qquad ( 32 )$$

### Appendix 37

The variable magnification optical system according to any one of Appendices 34 to 36,
wherein, in a case where a center thickness of the second lens is denoted by d2,
a paraxial curvature radius of a surface of the second lens on the object side is denoted by R2f, and
a paraxial curvature radius of a surface of the second lens on the image side is denoted by R2r,
Conditional Expression (33) is satisfied, which is represented by

$$0.01 < d 2 \times ( 1 / R 2 f - 1 / R 2 r ) < 0.4 . \qquad ( 33 )$$

### Annendix 38

The variable magnification optical system according to any one of Appendices 34 to 37,
wherein, in a case where a center thickness of the first lens is denoted by d1, and
a focal length of the first lens group is denoted by f1,
Conditional Expression (34) is satisfied, which is represented by

$$0.005 < d 1 / f 1 < 0.025 . \qquad ( 34 )$$

### Appendix 39

The variable magnification optical system according to any one of Appendices 34 to 38,
wherein, in a case where a center thickness of the first lens is denoted by d1, and
a distance on an optical axis from a lens surface of the first lens group closest to the object side to a lens surface of the first lens group closest to the image side is denoted by D1sum,
Conditional Expression (35) is satisfied, which is represented by

$$0.05 < d 1 / D 1 sum < 0.3 . \qquad ( 35 )$$

### Appendix 40

The variable magnification optical system according to any one of Appendices 34 to 39,
wherein, in a case where an average value of a relative density of the first lens and a relative density of the second lens is denoted by G12ave,
Conditional Expression (36) is satisfied, which is represented by

$$2 < G 12 ave < 5.5 . \qquad ( 36 )$$

### Appendix 41

The variable magnification optical system according to any one of Appendices 34 to 40,
wherein the first lens group consists of, in order from the object side to the image side, the first lens, the second lens, and one positive lens.

### Appendix 42

The variable magnification optical system according to any one of Appendices 34 to 41,
wherein the first lens and the second lens are cemented, and
in a case where an Abbe number based on a d line for the second lens is denoted by v2,
Conditional Expression (37) is satisfied, which is represented by

$$40 < ν 2 < 95. \qquad ( 37 )$$

### Appendix 43

The variable magnification optical system according to Appendix 41,
wherein, in a case where an Abbe number based on a d line for the positive lens closest to the image side in the first lens group is denoted by v3,
Conditional Expression (38) is satisfied, which is represented by

$$40 < v 3 < 95. \qquad ( 38 )$$

### Appendix 44

The variable magnification optical system according to any one of Appendices 1 to 43,
wherein a negative lens is disposed closest to the object side in the second lens group, and
the second lens group further includes at least one negative lens different from the negative lens closest to the object side and at least one positive lens.

### Appendix 45

The variable magnification optical system according to Appendix 44,
wherein, in a case where a focal length of the negative lens closest to the object side in the second lens group is denoted by fL21, and
a focal length of the second lens group is denoted by f2,
Conditional Expression (39) is satisfied, which is represented by

$$0.5 < fL 21 / f 2 < 3. \qquad ( 39 )$$

### Appendix 46

The variable magnification optical system according to Appendix 44 or 45,
wherein, in a case where a paraxial curvature radius of a surface, on the object side, of the negative lens closest to the object side in the second lens group is denoted by RL21f, and
a paraxial curvature radius of a surface, on the image side, of the negative lens closest to the object side in the second lens group is denoted by RL21r,
Conditional Expression (40) is satisfied, which is represented by

$$0.5 < ( RL 21 f + RL 21 r ) / ( RL 21 f - RL 21 r ) < 3.5 . \qquad ( 40 )$$

### Appendix 47

The variable magnification optical system according to any one of Appendices 44 to 46,
wherein, in a case where a focal length of a lens that is the second from the object side in the second lens group is denoted by fL22, and
a focal length of the second lens group is denoted by f2, Conditional Expression (41) is satisfied, which is represented by

$$0.4 < fL 22 / f 2 < 5. \qquad ( 41 )$$

### Appendix 48

The variable magnification optical system according to any one of Appendices 1 to 47,
wherein, in a case where a focal length of the entire system in a state where the infinite distance object is in focus at the wide angle end is denoted by fw,
Conditional Expression (42) is satisfied, which is represented by

$$2.5 < ft / fw < 7. \qquad ( 42 )$$

### Appendix 49

The variable magnification optical system according to any one of Appendices 1 to 48,
wherein, in a case where a focal length of the second lens group is denoted by f2, and
a focal length of a lens group closest to the object side in the intermediate group is denoted by f3,
Conditional Expression (43) is satisfied, which is represented by

$$- 1.2 < f 2 / f 3 < 1. \qquad ( 43 )$$

### Appendix 50

The variable magnification optical system according to any one of Appendices 1 to 49,
wherein the variable magnification optical system includes at least three aspherical surfaces.

### Appendix 51

The variable magnification optical system according to Appendix 50,
wherein the variable magnification optical system includes at least one plastic lens of which a surface on the object side and a surface on the image side are aspherical surfaces, and
in a case where a relative density of the plastic lens is denoted by GP,
Conditional Expression 44 is satisfied, which is represented by

$$0.8 < GP < 1.5 . \qquad ( 44 )$$

### Appendix 52

The variable magnification optical system according to Appendix 51,
wherein the plastic lens is disposed in at least one of a position closest to the image side in the intermediate group or the final lens group.

### Appendix 53

The variable magnification optical system according to any one of Appendices 1 to 52,
wherein the intermediate group includes at least one cemented lens consisting of one positive lens and one negative lens.

### Appendix 54

The variable magnification optical system according to any one of Appendices 1 to 53,
wherein the intermediate group includes a vibration-proof group that moves in a direction intersecting with an optical axis during image shake correction, and
in a case where a focal length of the vibration-proof group is denoted by fIS,
Conditional Expression (45) is satisfied, which is represented by

$$0 \text{.1} < \vert fIS / ft \vert < 0.7 . \qquad ( 45 )$$

### Appendix 55

The variable magnification optical system according to Appendix 54,
wherein the vibration-proof group includes a biconvex lens.

### Appendix 56

The variable magnification optical system according to Appendix 55,
wherein, in a case where an average value of relative densities of all biconvex lenses of the vibration-proof group is denoted by GISave,
Conditional Expression (46) is satisfied, which is represented by

$$2 < GISave < 5. \qquad ( 46 )$$

### Appendix 57

The variable magnification optical system according to any one of Appendices 1 to 56,
wherein, during changing the magnification, the first lens group, the second lens group, and all lens groups in the intermediate group move.

### Appendix 58

The variable magnification optical system according to any one of Appendices 1 to 57,
wherein the intermediate group has a positive refractive power as a whole in an entire magnification range.

### Appendix 59

The variable magnification optical system according to any one of Appendices 1 to 58,
wherein one of the lens groups included in the intermediate group is a focus lens group that moves along an optical axis during changing the magnification and during focusing.

### Appendix 60

The variable magnification optical system according to Appendix 59,
wherein the focus lens group consists of one positive lens and one negative lens.

### Appendix 61

The variable magnification optical system according to Appendix 60,
wherein the focus lens group consists of a cemented lens in which the positive lens and the negative lens are cemented.

### Appendix 62

The variable magnification optical system according to Appendix 59,
wherein the focus lens group consists of one negative lens.

### Appendix 63

The variable magnification optical system according to any one of Appendices 59 to 62,
wherein only one focus lens group is included in the intermediate group.

### Appendix 64

The variable magnification optical system according to any one of Appendices 59 to 63,
wherein the variable magnification optical system includes a vibration-proof group that moves in a direction intersecting with an optical axis during image shake correction, and the focus lens group is disposed closer to the image side than the vibration-proof group.

### Appendix 65

The variable magnification optical system according to any one of Appendices 59 to 64,
wherein the focus lens group is a lens group closest to the image side in the intermediate group.

### Appendix 66

The variable magnification optical system according to any one of Appendices 1 to 65,
wherein the final lens group consists of, in order from the object side to the image side, one negative lens of which a surface on the object side is a concave surface, and one positive lens.

### Appendix 67

The variable magnification optical system according to Appendix 66,
wherein, in a case where a paraxial curvature radius of the surface, on the object side, of the negative lens of the final lens group is denoted by REnf, and
a paraxial curvature radius of a surface, on the image side, of the negative lens of the final lens group is denoted by REnr,
Conditional Expression (47) is satisfied, which is represented by

$$- 15 < ( REnf + REnr ) / ( REnf - REnr ) < - 0.1 . \qquad ( 47 )$$

### Appendix 68

The variable magnification optical system according to Appendix 66 or 67,
wherein, in a case where a paraxial curvature radius of a surface, on the object side, of the positive lens of the final lens group is denoted by REpf, and
a paraxial curvature radius of a surface, on the image side, of the positive lens of the final lens group is denoted by REpr,
Conditional Expression (48) is satisfied, which is represented by

$$- 1.3 < ( REpf + REpr ) / ( REpf - REpr ) < - 0.1 . \qquad ( 48 )$$

### Appendix 69

The variable magnification optical system according to any one of Appendices 1 to 68,
wherein moving paths of each lens group that moves during changing magnification from the wide angle end to the telephoto end include exactly five or six moving paths that are different from each other.

### Appendix 70

The variable magnification optical system according to Appendix 69,
wherein the variable magnification optical system includes a plurality of lens groups that move on the same moving path during changing the magnification from the wide angle end to the telephoto end.

### Appendix 71

The variable magnification optical system according to Appendix 70,
wherein at least one lens that moves along an optical axis during focusing is disposed between the plurality of lens groups that move on the same moving path.

### Appendix 72

The variable magnification optical system according to any one of Appendices 1 to 71,
wherein the intermediate group consists of, in order from the object side to the image side, a lens group having a positive refractive power, and a lens group having a negative refractive power.

### Appendix 73

The variable magnification optical system according to any one of Appendices 1 to 71,
wherein the intermediate group consists of, in order from the object side to the image side, a lens group having a negative refractive power, a lens group having a positive refractive power, and a lens group having a negative refractive power.

### Appendix 74

The variable magnification optical system according to any one of Appendices 1 to 71,
wherein the intermediate group consists of, in order from the object side to the image side, a lens group having a positive refractive power, a lens group having a positive refractive power, and a lens group having a negative refractive power.

### Appendix 75

The variable magnification optical system according to any one of Appendices 1 to 71,
wherein the intermediate group consists of, in order from the object side to the image side, a lens group having a positive refractive power, a lens group having a positive refractive power, a lens group having a negative refractive power, and a lens group having a positive refractive power.

### Appendix 76

The variable magnification optical system according to any one of Appendices 1 to 71,
wherein the intermediate group consists of, in order from the object side to the image side, a lens group having a positive refractive power, a lens group having a positive refractive power, a lens group having a positive refractive power, and a lens group having a negative refractive power.

### Appendix 77

The variable magnification optical system according to any one of Appendices 1 to 71,
wherein the intermediate group consists of, in order from the object side to the image side, a lens group having a positive refractive power, a lens group having a negative refractive power, a lens group having a positive refractive power, and a lens group having a negative refractive power.

### Appendix 78

The variable magnification optical system according to any one of Appendices 1 to 71,
wherein the intermediate group consists of, in order from the object side to the image side, a lens group having a positive refractive power, a lens group having a negative refractive power, a lens group having a positive refractive power, a lens group having a negative refractive power, and a lens group having a negative refractive power.

### Appendix 79

The variable magnification optical system according to Appendix 78,
wherein, during changing the magnification, the final lens group is fixed with respect to an image plane.

### Appendix 80

The variable magnification optical system according to any one of Appendices 1 to 71,
wherein the intermediate group consists of, in order from the object side to the image side, a lens group having a positive refractive power, a lens group having a positive refractive power, a lens group having a positive refractive power, a lens group having a negative refractive power, and a lens group having a negative refractive power.

### Appendix 81

The variable magnification optical system according to Appendix 80,
wherein, during changing the magnification, the final lens group is fixed with respect to an image plane.

### Appendix 82

An imaging apparatus comprising:
the variable magnification optical system according to any one of Appendices 1 to 81.

All documents, patent applications, and technical standards described in the present specification are incorporated in the present specification by reference to the same extent as in a case where individual documents, patent applications, and technical standards are specifically and individually indicated to be incorporated by reference.

What is claimed is:

1. A variable magnification optical system consisting of, in order from an object side to an image side, a first lens group having a positive refractive power, a second lens group having a negative refractive power, an intermediate group, and a final lens group having a refractive power,
wherein the intermediate group consists of two or more and five or fewer lens groups,
during changing magnification, a spacing between the first lens group and the second lens group changes, a spacing between the second lens group and the intermediate group changes, a spacing between the intermediate group and the final lens group changes, and all spacings between adjacent lens groups in the intermediate group change, and
in a case where a back focus of the variable magnification optical system as an air conversion distance at a wide angle end is denoted by Bfw,
a focal length of the variable magnification optical system in a state where an infinite distance object is in focus at a telephoto end is denoted by ft, and
a maximum half angle of view in the state where the infinite distance object is in focus at the telephoto end is denoted by ωt,
Conditional Expression (1) is satisfied, which is represented by
$$0.4 < Bfw / ( ft \times tan ω t ) < 1.7 . \qquad ( 1 )$$

2. The variable magnification optical system according to claim 1,
wherein, in a case where a sum of a distance on an optical axis from a lens surface of the first lens group closest to the object side to a lens surface of the final lens group closest to the image side and the back focus of the variable magnification optical system as the air conversion distance in a state where the infinite distance object is in focus at the wide angle end is denoted by TLw,
Conditional Expression (2) is satisfied, which is represented by
$$4 < TLw / ( ft \times tan ω t ) < 7. \qquad ( 2 )$$

3. The variable magnification optical system according to claim 1,
wherein, in a case where a sum of a distance on an optical axis from a lens surface of the first lens group closest to the object side to a lens surface of the final lens group closest to the image side and the back focus of the variable magnification optical system as the air conversion distance in a state where the infinite distance object is in focus at the wide angle end is denoted by TLw,
Conditional Expression (3) is satisfied, which is represented by
$$0.75 < TLw / ft < 1.35 . \qquad ( 3 )$$

4. The variable magnification optical system according to claim 1,
wherein, in a case where an open F-number in the state where the infinite distance object is in focus at the telephoto end is denoted by FNot, and
a focal length of the variable magnification optical system in a state where the infinite distance object is in focus at the wide angle end is denoted by fw,
Conditional Expression (4) is satisfied, which is represented by
$$1.1 < FNot / ( ft / fw ) < 3. \qquad ( 4 )$$

5. The variable magnification optical system according to claim 1,
wherein, in a case where a focal length of the variable magnification optical system in a state where the infinite distance object is in focus at the wide angle end is denoted by fw,
Conditional Expression (5) is satisfied, which is represented by
$$0.9 < fw / ( ft \times tan ω t ) < 1.32 . \qquad ( 5 )$$

6. The variable magnification optical system according to claim 1,
wherein, in a case where a focal length of the variable magnification optical system in a state where the infinite distance object is in focus at the wide angle end is denoted by fw, and
a sum of a distance on an optical axis from a lens surface of the first lens group closest to the object side to a lens surface of the final lens group closest to the image side and the back focus of the variable magnification optical system as the air conversion distance in a state where the infinite distance object is in focus at the wide angle end is denoted by TLw,
Conditional Expression (6) is satisfied, which is represented by
$$0.11 < ( f w \times T L w ) / {ft}^{2} < 0.6 . \qquad ( 6 )$$

7. The variable magnification optical system according to claim 1,
wherein the first lens group includes at least two lenses, and
in a case where a sum of a distance on an optical axis from a lens surface of the first lens group closest to the object side to a lens surface of the final lens group closest to the image side and the back focus of the variable magnification optical system as the air conversion distance in a state where the infinite distance object is in focus at the wide angle end is denoted by TLw,
an open F-number in the state where the infinite distance object is in focus at the telephoto end is denoted by FNot, and
a focal length of the variable magnification optical system in a state where the infinite distance object is in focus at the wide angle end is denoted by fw,
Conditional Expressions (2-3), (3), (4-2), and (5) are satisfied, which are represented by
$$4.7 < TLw / ( ft \times tan ω t ) < 6.7 , \qquad ( 2 - 3 )$$
$$0.75 < TLw / ft < 1.35 , \qquad ( 3 )$$
$$1.28 < F N o t / ( ft / fw ) < 1.9 , and \qquad ( 4 - 2 )$$
$$0.9 < fw / ( ft \times tan ω t ) < 1.32 . \qquad ( 5 )$$

8. The variable magnification optical system according to claim 1,
wherein, in a case where a focal length of the first lens group is denoted by f1, and
a focal length of the second lens group is denoted by f2,
Conditional Expression (7) is satisfied, which is represented by
$$2 < f 1 / ( - f 2 ) < 15. \qquad ( 7 )$$

9. The variable magnification optical system according to claim 1,
wherein, in a case where a focal length of the variable magnification optical system in a state where the infinite distance object is in focus at the wide angle end is denoted by fw, and
a focal length of the final lens group is denoted by fE,
Conditional Expression (8) is satisfied, which is represented by
$$- 1 < f w / f E < 1. \qquad ( 8 )$$

10. The variable magnification optical system according to claim 1,
wherein, in a case where a focal length of the first lens group is denoted by f1, and
a focal length of the variable magnification optical system in a state where the infinite distance object is in focus at the wide angle end is denoted by fw,
Conditional Expression (9) is satisfied, which is represented by
$$0.5 < f 1 / {( fw \times ft )}^{1 / 2} < 5. \qquad ( 9 )$$

11. The variable magnification optical system according to claim 1,
wherein, in a case where a focal length of the second lens group is denoted by f2, and
a focal length of the variable magnification optical system in a state where the infinite distance object is in focus at the wide angle end is denoted by fw,
Conditional Expression (10) is satisfied, which is represented by
$$0.1 < ( - f 2 ) / {( fw \times ft )}^{1 / 2} < 1. \qquad ( 10 )$$

12. The variable magnification optical system according to claim 1,
wherein, in a case where a focal length of the first lens group is denoted by f1, and
an open F-number in the state where the infinite distance object is in focus at the telephoto end is denoted by FNot,
Conditional Expression (11) is satisfied, which is represented by
$$4 < f 1 / ( ft / FNot ) < 15. \qquad ( 11 )$$

13. The variable magnification optical system according to claim 1,
wherein, in a case where a sum of a distance on an optical axis from a lens surface of the first lens group closest to the object side to a lens surface of the final lens group closest to the image side and the back focus of the variable magnification optical system as the air conversion distance in a state where the infinite distance object is in focus at the wide angle end is denoted by TLw, and
a focal length of the variable magnification optical system in a state where the infinite distance object is in focus at the wide angle end is denoted by fw,
Conditional Expression (12) is satisfied, which is represented by
$$3.5 < T L w / f w < 6.5 . \qquad ( 12 )$$

14. The variable magnification optical system according to claim 1,
wherein, in a case where a sum of a distance on an optical axis from a lens surface of the first lens group closest to the object side to a lens surface of the final lens group closest to the image side and the back focus of the variable magnification optical system as the air conversion distance in the state where the infinite distance object is in focus at the telephoto end is denoted by TLt,
Conditional Expression (13) is satisfied, which is represented by
$$1 < TLt / ft < 2.5 . \qquad ( 13 )$$

15. The variable magnification optical system according to claim 1,
wherein, in a case where a sum of a distance on an optical axis from a lens surface of the first lens group closest to the object side to a lens surface of the final lens group closest to the image side and the back focus of the variable magnification optical system as the air conversion distance in the state where the infinite distance object is in focus at the telephoto end is denoted by TLt,
Conditional Expression (14) is satisfied, which is represented by
$$7 < T L t / ( ft \times tan ω t ) < 11.5 . \qquad ( 14 )$$

16. The variable magnification optical system according to claim 1,
wherein, in a case where a maximum half angle of view in a state where the infinite distance object is in focus at the wide angle end is denoted by ωw, and
an open F-number in the state where the infinite distance object is in focus at the wide angle end is denoted by FNow,
Conditional Expression 15) is satisfied, which is represented by
$$0.17 < tan ω w / FNow < 0.35 . \qquad ( 15 )$$

17. The variable magnification optical system according to claim 1,
wherein an aperture stop is disposed closer to the image side than a lens surface of the second lens group closest to the image side, and
in a case where a distance on an optical axis from a lens surface of the first lens group closest to the object side to the aperture stop in a state where the infinite distance object is in focus at the wide angle end is denoted by DDG1STw, and
a focal length of the first lens group is denoted by f1,
Conditional Expression (16) is satisfied, which is represented by
$$0.15 < DDG 1 STw / f 1 < 1. \qquad ( 16 )$$

18. The variable magnification optical system according to claim 1,
wherein, in a case where a distance on an optical axis from a lens surface of the first lens group closest to the object side to a paraxial entrance pupil position in a state where the infinite distance object is in focus at the wide angle end is denoted by Denw,
a focal length of the variable magnification optical system in the state where the infinite distance object is in focus at the wide angle end is denoted by fw, and
a maximum half angle of view in the state where the infinite distance object is in focus at the wide angle end is denoted by ωw,
Conditional Expression (17) is satisfied, which is represented by
$$1 < D e n w / \{ ( f w \times tan ω w ) \times log ( ft / fw ) \} < 3.5 . \qquad ( 17 )$$

19. The variable magnification optical system according to claim 1,
wherein, in a case where a distance on an optical axis from a lens surface of the first lens group closest to the object side to a paraxial entrance pupil position in a state where the infinite distance object is in focus at the wide angle end is denoted by Denw, and
a focal length of the variable magnification optical system in the state where the infinite distance object is in focus at the wide angle end is denoted by fw,
Conditional Expression (18) is satisfied, which is represented by
$$0.3 < Denw / {( fw \times f t )}^{1 / 2} < 1. \qquad ( 18 )$$

20. The variable magnification optical system according to claim 1,
wherein the variable magnification optical system includes an aperture stop, and
in a case where a distance on an optical axis from a lens surface of the first lens group closest to the object side to the aperture stop in a state where the infinite distance object is in focus at the wide angle end is denoted by DDG1STw, and
a sum of a distance on the optical axis from the lens surface of the first lens group closest to the object side to a lens surface of the final lens group closest to the image side and the back focus of the variable magnification optical system as the air conversion distance in the state where the infinite distance object is in focus at the wide angle end is denoted by TLw,
Conditional Expression (19) is satisfied, which is represented by
$$0.25 < DDG 1 STw / TLw < 0.6 . \qquad ( 19 )$$

21. The variable magnification optical system according to claim 1,
wherein, in a case where a focal length of the variable magnification optical system in a state where the infinite distance object is in focus at the wide angle end is denoted by fw, and
a sum of a distance on an optical axis from a paraxial exit pupil position to a lens surface of the final lens group closest to the image side and the back focus of the variable magnification optical system as the air conversion distance in the state where the infinite distance object is in focus at the wide angle end is denoted by Dexw,
Conditional Expression (20) is satisfied, which is represented by
$$0.3 < fw / Dexw < 0.65 . \qquad ( 20 )$$

22. The variable magnification optical system according to claim 1,
wherein, in a case where a moving amount of the first lens group during changing magnification from the wide angle end to the telephoto end is denoted by M1,
a sign of M1 is positive in moving from the object side to the image side and is negative in moving from the image side to the object side, and
a sum of a distance on an optical axis from a lens surface of the first lens group closest to the object side to a lens surface of the final lens group closest to the image side and the back focus of the variable magnification optical system as the air conversion distance in the state where the infinite distance object is in focus at the telephoto end is denoted by TLt,
Conditional Expression (21) is satisfied, which is represented by
$$0.2 < ( - M 1 ) / TLt < 0.5 . \qquad ( 21 )$$

23. The variable magnification optical system according to claim 1,
wherein, in a case where a moving amount of the second lens group during changing magnification from the wide angle end to the telephoto end is denoted by M2,
a sign of M2 is positive in moving from the object side to the image side and is negative in moving from the image side to the object side, and
a sum of a distance on an optical axis from a lens surface of the first lens group closest to the object side to a lens surface of the final lens group closest to the image side and the back focus of the variable magnification optical system as the air conversion distance in the state where the infinite distance object is in focus at the telephoto end is denoted by TLt,
Conditional Expression (22) is satisfied, which is represented by
$$0.04 < ( - M 2 ) / TLt < 0.4 . \qquad ( 22 )$$

24. The variable magnification optical system according to claim 1,
wherein, in a case where a focal length of the variable magnification optical system in a state where the infinite distance object is in focus at the wide angle end is denoted by fw, and
a focal length of the intermediate group in the state where the infinite distance object is in focus at the wide angle end is denoted by fMw,
Conditional Expression (23) is satisfied, which is represented by
$$0.3 < fw / fMw < 2. \qquad ( 23 )$$

25. The variable magnification optical system according to claim 1,
wherein, in a case where a focal length of the intermediate group in the state where the infinite distance object is in focus at the telephoto end is denoted by fMt,
Conditional Expression (24) is satisfied, which is represented by
$$1 < ft / fMt < 10. \qquad ( 24 )$$

26. The variable magnification optical system according to claim 1,
wherein, in a case where a distance on an optical axis from a lens surface of the first lens group closest to the object side to a lens surface of the first lens group closest to the image side is denoted by D1sum, and
an open F-number in the state where the infinite distance object is in focus at the telephoto end is denoted by FNot,
Conditional Expression (25) is satisfied, which is represented by
$$0.2 < D 1 sum / ( ft / FNot ) < 1.6 . \qquad ( 25 )$$

27. The variable magnification optical system according to claim 1,
wherein, in a case where a lateral magnification of the second lens group in the state where the infinite distance object is in focus at the telephoto end is denoted by β2t, and
a lateral magnification of the second lens group in a state where the infinite distance object is in focus at the wide angle end is denoted by β2w,
Conditional Expression (26) is satisfied, which is represented by
$$1 < β2 t / β 2 w < 3. \qquad ( 26 )$$

28. The variable magnification optical system according to claim 1,
wherein, in a case where an average value of Abbe numbers based on a d line for all positive lenses of the first lens group is denoted by v1pave,
Conditional Expression (27) is satisfied, which is represented by
$$40 < v 1 pave < 95. \qquad ( 27 )$$

29. The variable magnification optical system according to claim 1,
wherein a surface, on the image side, of an Lp positive lens that is a positive lens having a strongest positive refractive power among non-cemented single lenses of the intermediate group is a convex surface, and
in a case where a focal length of the Lp positive lens is fp, and
a focal length of the intermediate group in a state where the infinite distance object is in focus at the wide angle end is denoted by fMw,
Conditional Expression (28) is satisfied, which is represented by
$$0.4 < fMw / fp < 2. \qquad ( 28 )$$

30. The variable magnification optical system according to claim 29,
wherein the Lp positive lens is a biconvex lens.

31. The variable magnification optical system according to claim 30,
wherein a surface of the Lp positive lens on the object side and the surface of the Lp positive lens on the image side are aspherical surfaces.

32. The variable magnification optical system according to claim 1,
wherein, in a case where an effective diameter of a lens surface of the first lens group closest to the object side is denoted by EDf, and
an effective diameter of a lens surface of the final lens group closest to the image side is denoted by EDr,
Conditional Expression (29) is satisfied, which is represented by
$$1.2 < EDf / EDr < 3. \qquad ( 29 )$$

33. The variable magnification optical system according to claim 1,
wherein, in a case where an effective diameter of a lens surface of the first lens group closest to the object side is denoted by EDf, and
a sum of a distance on an optical axis from the lens surface of the first lens group closest to the object side to a lens surface of the final lens group closest to the image side and the back focus of the variable magnification optical system as the air conversion distance in a state where the infinite distance object is in focus at the wide angle end is denoted by TLw,
Conditional Expression (30) is satisfied, which is represented by
$$0.25 < EDf / TLw < 0.6 . \qquad ( 30 )$$

34. The variable magnification optical system according to claim 1,
wherein the first lens group includes, in consecutive order from a position closest to the object side to the image side, a first lens that is a negative lens, and a second lens that is a positive lens.

35. The variable magnification optical system according to claim 34,
wherein, in a case where a center thickness of the first lens is denoted by d1 and
an effective diameter of a lens surface of the first lens group closest to the object side is denoted by EDf,
Conditional Expression (31) is satisfied, which is represented by
$$0.01 < d 1 / EDf < 0.4 . \qquad ( 31 )$$

36. The variable magnification optical system according to claim 34,
wherein, in a case where a center thickness of the first lens is denoted by d1,
a distance on an optical axis from a lens surface of the first lens group closest to the object side to a paraxial entrance pupil position in a state where the infinite distance object is in focus at the wide angle end is denoted by Denw, and
a maximum half angle of view in a state where the infinite distance object is in focus at the wide angle end is denoted by ωw,
Conditional Expression (32) is satisfied, which is represented by
$$0.01 < d 1 / ( Denw \times tan ω w ) < 0.15 . \qquad ( 32 )$$

37. The variable magnification optical system according to claim 34,
wherein, in a case where a center thickness of the second lens is denoted by d2,
a paraxial curvature radius of a surface of the second lens on the object side is denoted by R2f, and
a paraxial curvature radius of a surface of the second lens on the image side is denoted by R2r,
Conditional Expression (33) is satisfied, which is represented by
$$0.01 < d 2 \times ( 1 / R 2 f - 1 / R 2 r ) < 0.4 . \qquad ( 33 )$$

38. The variable magnification optical system according to claim 34,
wherein, in a case where a center thickness of the first lens is denoted by d1, and
a focal length of the first lens group is denoted by f1,
Conditional Expression (34) is satisfied, which is represented by
$$0.005 < d 1 / f 1 < 0.025 . \qquad ( 34 )$$

39. The variable magnification optical system according to claim 34,
wherein, in a case where a center thickness of the first lens is denoted by d1, and
a distance on an optical axis from a lens surface of the first lens group closest to the object side to a lens surface of the first lens group closest to the image side is denoted by D1sum,
Conditional Expression (35) is satisfied, which is represented by
$$0.05 < d 1 / D 1 sum < 0.3 . \qquad ( 35 )$$

40. The variable magnification optical system according to claim 34,
wherein, in a case where an average value of a relative density of the first lens and a relative density of the second lens is denoted by G12ave,
Conditional Expression (36) is satisfied, which is represented by
$$2 < G 12 ave < 5.5 . \qquad ( 36 )$$

41. The variable magnification optical system according to claim 34,
wherein the first lens group consists of, in order from the object side to the image side, the first lens, the second lens, and one positive lens.

42. The variable magnification optical system according to claim 34,
wherein the first lens and the second lens are cemented, and
in a case where an Abbe number based on a d line for the second lens is denoted by v2,
Conditional Expression (37) is satisfied, which is represented by
$$40 < v 2 < 95. \qquad ( 37 )$$

43. The variable magnification optical system according to claim 41,
wherein, in a case where an Abbe number based on a d line for the positive lens closest to the image side in the first lens group is denoted by v3,
Conditional Expression (38) is satisfied, which is represented by
$$40 < v 3 < 95. \qquad ( 38 )$$

44. The variable magnification optical system according to claim 1,
wherein a negative lens is disposed closest to the object side in the second lens group, and
the second lens group further includes at least one negative lens different from the negative lens closest to the object side and at least one positive lens.

45. The variable magnification optical system according to claim 44,
wherein, in a case where a focal length of the negative lens closest to the object side in the second lens group is denoted by fL21, and
a focal length of the second lens group is denoted by f2,
Conditional Expression (39) is satisfied, which is represented by
$$0.5 < fL 21 / f 2 < 3. \qquad ( 39 )$$

46. The variable magnification optical system according to claim 44,
wherein, in a case where a paraxial curvature radius of a surface, on the object side, of the negative lens closest to the object side in the second lens group is denoted by RL21f, and
a paraxial curvature radius of a surface, on the image side, of the negative lens closest to the object side in the second lens group is denoted by RL21r,
Conditional Expression (40) is satisfied, which is represented by
$$0.5 < ( RL 21 f + RL 21 r ) / ( RL 21 f - R L 21 r ) < 3.5 . \qquad ( 40 )$$

47. The variable magnification optical system according to claim 44,
wherein, in a case where a focal length of a lens that is the second from the object side in the second lens group is denoted by fL22, and
a focal length of the second lens group is denoted by f2,
Conditional Expression (41) is satisfied, which is represented by
$$0. 4 < fL 22 / f 2 < 5. \qquad ( 41 )$$

48. The variable magnification optical system according to claim 1,
wherein, in a case where a focal length of the variable magnification optical system in a state where the infinite distance object is in focus at the wide angle end is denoted by fw,
Conditional Expression (42) is satisfied, which is represented by
$$2.5 < ft / fw < 7. \qquad ( 42 )$$

49. The variable magnification optical system according to claim 1,
wherein, in a case where a focal length of the second lens group is denoted by f2, and
a focal length of a lens group closest to the object side in the intermediate group is denoted by f3,
Conditional Expression (43) is satisfied, which is represented by
$$- 1.2 < f 2 / f 3 < 1. \qquad ( 43 )$$

50. The variable magnification optical system according to claim 1,
wherein the variable magnification optical system includes at least three aspherical surfaces.

51. The variable magnification optical system according to claim 50,
wherein the variable magnification optical system includes at least one plastic lens of which a surface on the object side and a surface on the image side are aspherical surfaces, and
in a case where a relative density of the plastic lens is denoted by GP,
Conditional Expression (44) is satisfied, which is represented by
$$0.8 < G P < 1.5 . \qquad ( 44 )$$

52. The variable magnification optical system according to claim 51,
wherein the plastic lens is disposed in at least one of a position closest to the image side in the intermediate group or the final lens group.

53. The variable magnification optical system according to claim 1,
wherein the intermediate group includes at least one cemented lens consisting of one positive lens and one negative lens.

54. The variable magnification optical system according to claim 1,
wherein the intermediate group includes a vibration-proof group that moves in a direction intersecting with an optical axis during image shake correction, and
in a case where a focal length of the vibration-proof group is denoted by fIS,
Conditional Expression (45) is satisfied, which is represented by
$$0 \text{.1} < \vert fIS / ft \vert < 0.7 . \qquad ( 45 )$$

55. The variable magnification optical system according to claim 54,
wherein the vibration-proof group includes a biconvex lens.

56. The variable magnification optical system according to claim 55,
wherein, in a case where an average value of relative densities of all biconvex lenses of the vibration-proof group is denoted by GISave,
Conditional Expression (46) is satisfied, which is represented by
$$2 < GISave < 5. \qquad ( 46 )$$

57. The variable magnification optical system according to claim 1,
wherein, during changing the magnification, the first lens group, the second lens group, and all lens groups in the intermediate group move.

58. The variable magnification optical system according to claim 1,
wherein the intermediate group has a positive refractive power as a whole in an entire magnification range.

59. The variable magnification optical system according to claim 1,
wherein one of the lens groups included in the intermediate group is a focus lens group that moves along an optical axis during changing the magnification and during focusing.

60. The variable magnification optical system according to claim 59,
wherein the focus lens group consists of one positive lens and one negative lens.

61. The variable magnification optical system according to claim 60,
wherein the focus lens group consists of a cemented lens in which the positive lens and the negative lens are cemented.

62. The variable magnification optical system according to claim 59,
wherein the focus lens group consists of one negative lens.

63. The variable magnification optical system according to claim 59,
wherein only one focus lens group is included in the intermediate group.

64. The variable magnification optical system according to claim 59,
wherein the variable magnification optical system includes a vibration-proof group that moves in a direction intersecting with an optical axis during image shake correction, and
the focus lens group is disposed closer to the image side than the vibration-proof group.

65. The variable magnification optical system according to claim 59,
wherein the focus lens group is a lens group closest to the image side in the intermediate group.

66. The variable magnification optical system according to claim 1,
wherein the final lens group consists of, in order from the object side to the image side, one negative lens of which a surface on the object side is a concave surface, and one positive lens.

67. The variable magnification optical system according to claim 66,
wherein, in a case where a paraxial curvature radius of the surface, on the object side, of the negative lens of the final lens group is denoted by REnf, and
a paraxial curvature radius of a surface, on the image side, of the negative lens of the final lens group is denoted by REnr,
Conditional Expression (47) is satisfied, which is represented by
$$- 15 < ( REnf + REnr ) / ( REnf - REnr ) < - 0.1 . \qquad ( 47 )$$

68. The variable magnification optical system according to claim 66,
wherein, in a case where a paraxial curvature radius of a surface, on the object side, of the positive lens of the final lens group is denoted by REpf, and
a paraxial curvature radius of a surface, on the image side, of the positive lens of the final lens group is denoted by REpr,
Conditional Expression (48) is satisfied, which is represented by
$$- 1.3 < ( REpf + REpr ) / ( REpf - REpr ) < - 0.1 . \qquad ( 48 )$$

69. The variable magnification optical system according to claim 1,
wherein moving paths of each lens group that moves during changing magnification from the wide angle end to the telephoto end include exactly five or six moving paths that are different from each other.

70. The variable magnification optical system according to claim 69,
wherein the variable magnification optical system includes a plurality of lens groups that move on the same moving path during changing the magnification from the wide angle end to the telephoto end.

71. The variable magnification optical system according to claim 70,
wherein at least one lens that moves along an optical axis during focusing is disposed between the plurality of lens groups that move on the same moving path.

72. The variable magnification optical system according to claim 1,
wherein the intermediate group consists of, in order from the object side to the image side, a lens group having a positive refractive power, and a lens group having a negative refractive power.

73. The variable magnification optical system according to claim 1,
wherein the intermediate group consists of, in order from the object side to the image side, a lens group having a negative refractive power, a lens group having a positive refractive power, and a lens group having a negative refractive power.

74. The variable magnification optical system according to claim 1,
wherein the intermediate group consists of, in order from the object side to the image side, a lens group having a positive refractive power, a lens group having a positive refractive power, and a lens group having a negative refractive power.

75. The variable magnification optical system according to claim 1,
wherein the intermediate group consists of, in order from the object side to the image side, a lens group having a positive refractive power, a lens group having a positive refractive power, a lens group having a negative refractive power, and a lens group having a positive refractive power.

76. The variable magnification optical system according to claim 1,
wherein the intermediate group consists of, in order from the object side to the image side, a lens group having a positive refractive power, a lens group having a positive refractive power, a lens group having a positive refractive power, and a lens group having a negative refractive power.

77. The variable magnification optical system according to claim 1,
wherein the intermediate group consists of, in order from the object side to the image side, a lens group having a positive refractive power, a lens group having a negative refractive power, a lens group having a positive refractive power, and a lens group having a negative refractive power.

78. The variable magnification optical system according to claim 1,
wherein the intermediate group consists of, in order from the object side to the image side, a lens group having a positive refractive power, a lens group having a negative refractive power, a lens group having a positive refractive power, a lens group having a negative refractive power, and a lens group having a negative refractive power.

79. The variable magnification optical system according to claim 78,
wherein, during changing the magnification, the final lens group is fixed with respect to an image plane.

80. The variable magnification optical system according to claim 1,
wherein the intermediate group consists of, in order from the object side to the image side, a lens group having a positive refractive power, a lens group having a positive refractive power, a lens group having a positive refractive power, a lens group having a negative refractive power, and a lens group having a negative refractive power.

81. The variable magnification optical system according to claim 80,
wherein, during changing the magnification, the final lens group is fixed with respect to an image plane.

82. An imaging apparatus comprising:
the variable magnification optical system according to claim 1.
